(19) United States
(12) Patent Application Publication
(10) Pub. No.: US 2021/0168407 A1
(43) Pub. Date: Jun. 3, 2021

(54) ENCODING DEVICE, ENCODING METHOD, DECODING DEVICE, AND DECODING METHOD

(71) Applicant: SONY CORPORATION, Tokyo (JP)

(72) Inventor: Masaru IKEDA, Kanagawa (JP)

(73) Assignee: SONY CORPORATION, Tokyo (JP)

(21) Appl. No.: 17/268,320

(22) PCT Filed: Sep. 12, 2019
(86) PCT No.: PCT/JP2019/035819

§ 371 Date: Feb. 12, 2021

(30) Foreign Application Priority Data
Sep. 25, 2018 (JP) 2018-178412
Dec. 28, 2018 (JP) 2018-246543

(51) Int. Cl. H04N 19/82; H04N 19/117; H04N 19/182; H04N 19/176; H04N 19/96

(52) U.S. Cl. CPC H04N 19/82; H04N 19/117; H04N 19/96; H04N 19/176; H04N 19/182

(57) ABSTRACT

There is provided an encoding device, an encoding method, a decoding device, and a decoding method that enable a reduction in an amount of processing. The encoding device and the decoding device perform class classification with respect to a pixel of interest of a decoded image (locally decoded image) by subclass classification of each of a plurality of feature amounts, and convert an initial class of the pixel of interest obtained by the class classification into a merged class obtained by merging the initial class by merging a subclass of the feature amounts according to a merge pattern set in advance for every number of merged classes. Then, the encoding device and the decoding device perform a filtering process that applies to the decoded image a predictive equation that performs a product-sum operation of a tap coefficient of a merged class of the pixel of interest and a pixel of the decoded image, so as to generate a filtered image. The present technology can be applied, for example, in a case of encoding and decoding an image.

### TECHNICAL FIELD

The present technology relates to an encoding device, an encoding method, a decoding device, and a decoding method, and particularly to, for example, an encoding device, an encoding method, a decoding device, and a decoding method that enable reduction in processing amount.

### BACKGROUND ART

As a successor standard to High Efficiency Video Coding (HEVC), work is underway to start standardization of Versatile Video Coding (VVC) (formerly Future Video Coding (FVC)), and as in loop filtering (ILF) used for image encoding and decoding, in addition to a deblocking filter and an adaptive offset filter, a bilateral filter, and an adaptive loop filter (ALF) are being studied (see, for example, Non-Patent Document 1).

Furthermore, a geometry adaptive loop filter (GALF) has been proposed as a filter for improving the existing ALF (see, for example, Non-Patent Document 2).

### CITATION LIST

### Non-Patent Document

Non-Patent Document 1: Algorithm description of Joint Exploration Test Model 7 (JEM7), Aug. 19, 2017
Non-Patent Document 2: Marta Karczewicz, Li Zhang, Wei-Jung Chien, Xiang Li, “Geometry transformation-based adaptive in-loop filter”, IEEE Picture Coding Symposium (PCS), 2016.

### SUMMARY OF THE INVENTION

### Problems to be Solved by the Invention

In the GALF, a class merging process is performed to merge classes so that a plurality of classes shares a tap coefficient used for a filtering process in order to reduce the data amount of the tap coefficient.

In the class merging process, each value of natural numbers equal to or less than an original number of classes is used as the number of merged classes after merging of classes, and an optimum merge pattern for merging the classes is obtained for each number of merged classes. Then, from the optimum merge patterns for respective numbers of merged classes, the merge pattern that minimizes cost is determined as an employed merge pattern to be employed when performing the filtering process.

As described above, in the class merging process, each value of natural numbers equal to or less than the original number of classes is assumed as the number of merged classes after merging classes, and the optimum merge pattern is obtained for each merged class number, and thus the amount of processing becomes large. Note that the employed merge pattern determined by the class merging process needs to be transmitted from an encoding device to a decoding device.

The present technology has been made in view of such a situation, and can reduce the amount of processing.

### Solutions to Problems

A decoding device of the present technology is a decoding device including a decoding unit that decodes encoded data included in an encoded bitstream and generates a decoded image, a class classification unit that performs class classification with respect to a pixel of interest of the decoded image, which is generated by the decoding unit, by subclass classification of each of a plurality of feature amounts, a merge conversion unit that converts an initial class of the pixel of interest obtained by the class classification performed by the class classification unit into a merged class obtained by merging the initial class by merging a subclass of the feature amounts according to a merge pattern set in advance for every number of merged classes, and a filter unit that performs a filtering process that applies to the decoded image a predictive equation that performs a product-sum operation of a tap coefficient of a merged class of the pixel of interest converted by the merge conversion unit and a pixel of the decoded image, so as to generate a filtered image.

A decoding method of the present technology is a decoding method including decoding encoded data included in an encoded bitstream and generating a decoded image, performing class classification with respect to a pixel of interest of the decoded image by subclass classification of each of a plurality of feature amounts, converting an initial class of the pixel of interest obtained by the class classification into a merged class obtained by merging the initial class by merging a subclass of the feature amounts according to a merge pattern set in advance for every number of merged classes, and performing a filtering process that applies to the decoded image a predictive equation that performs a product-sum operation of a tap coefficient of a merged class of the pixel of interest and a pixel of the decoded image, so as to generate a filtered image.

In the decoding device and the decoding method of the present technology, the encoded data included in the encoded bitstream is decoded to generate a decoded image. Moreover, class classification with respect to a pixel of interest of the decoded image is performed by subclass classification of each of a plurality of feature amounts, and an initial class of the pixel of interest obtained by the class classification is converted into a merged class obtained by merging the initial class by merging a subclass of the feature amounts according to a merge pattern set in advance for every number of merged classes. Then, a filtering process that applies to the decoded image a predictive equation that performs a product-sum operation of a tap coefficient of a merged class of the pixel of interest and a pixel of the decoded image, so as to generate a filtered image.

An encoding device of the present technology is an encoding device including a class classification unit that performs class classification with respect to a pixel of interest of a locally decoded image that is locally decoded by subclass classification of each of a plurality of feature amounts, a merge conversion unit that converts an initial class of the pixel of interest obtained by the class classification performed by the class classification unit into a merged class obtained by merging the initial class by merging a subclass of the feature amounts according to a merge pattern set in advance for every number of merged classes, a filter unit that performs a filtering process that applies to the locally decoded image a predictive equation that performs a product-sum operation of a tap coefficient of a merged class of the pixel of interest converted by the merge conversion unit and a pixel of the locally decoded image, so as to generate a filtered image, and an encoding unit that encodes an original image using the filtered image generated by the filter unit.

An encoding method of the present technology is an encoding method including performing class classification with respect to a pixel of interest of a locally decoded image that is locally decoded by subclass classification of each of a plurality of feature amounts, converting an initial class of the pixel of interest obtained by the class classification into a merged class obtained by merging the initial class by merging a subclass of the feature amounts according to a merge pattern set in advance for every number of merged classes, performing a filtering process that applies to the locally decoded image a predictive equation that performs a product-sum operation of a tap coefficient of a merged class of the pixel of interest and a pixel of the locally decoded image, so as to generate a filtered image, and encoding an original image using the filtered image.

In the encoding device and encoding method of the present technology, class classification with respect to a pixel of interest of a locally decoded image that is locally decoded is performed by subclass classification of each of a plurality of feature amounts, and an initial class of the pixel of interest obtained by the class classification is converted into a merged class obtained by merging the initial class by merging a subclass of the feature amounts according to a merge pattern set in advance for every number of merged classes. Moreover, a filtering process is performed that applies to the locally decoded image a predictive equation that performs a product-sum operation of a tap coefficient of a merged class of the pixel of interest and a pixel of the locally decoded image, so as to generate a filtered image. Then, the original image is encoded using the filtered image.

Note that the encoding device and the decoding device may be an independent device or an internal block constituting one device.

Furthermore, the encoding device and the decoding device can be achieved by causing a computer to execute a program. The program can be provided by transmitting via a transmission medium or by recording on a recording medium.

### BRIEF DESCRIPTION OF DRAWINGS

FIG. 1 is a diagram describing an outline of processing of a class classification unit 10 that performs class classification of GALF.

FIG. 2 is a diagram describing how to obtain a direction of the GALF as a defined direction (inclination direction) of a pixel of interest.

FIG. 3 is a diagram describing classes obtained by class classification of the GALF.

FIG. 4 is a flowchart describing processing of the GALF that an encoding device that encodes an image has as one of ILFs.

FIG. 5 is a flowchart describing a merge pattern determination process in step S21.

FIG. 6 is a diagram describing an example of an expression format of a merge pattern.

FIG. 7 is a diagram illustrating an example of a merge pattern for every number of merged classes.

FIG. 8 is a flowchart describing a process of determining the employed number of merged classes in step S22.

FIG. 9 is a diagram illustrating an example of a merge pattern transmitted from an encoding device to a decoding device.

FIG. 10 is a diagram illustrating first examples of merge patterns set in advance.

FIG. 11 is a diagram illustrating first examples of merge patterns set in advance.

FIG. 12 is a diagram describing a method of setting a merge pattern corresponding to the number of merged classes of twenty five for merging twenty five initial classes obtained by the class classification of the GALF into twenty five merged classes.

FIG. 13 is a diagram describing a method of setting a merge pattern corresponding to the number of merged classes of twenty for merging the twenty five initial classes obtained by the class classification of the GALF into twenty merged classes.

FIG. 14 is a diagram describing a method of setting a merge pattern corresponding to the number of merged classes of fifteen for merging the twenty five initial classes obtained by the class classification of the GALF into fifteen merged classes.

FIG. 15 is a diagram describing a method of setting a merge pattern corresponding to the number of merged classes of ten for merging the twenty five initial classes obtained by the class classification of the GALF into ten merged classes.

FIG. 16 is a diagram describing a method of setting a merge pattern corresponding to the number of merged classes of five for merging the twenty five initial classes obtained by the class classification of the GALF into five merged classes.

FIG. 17 is a diagram describing a method of setting a merge pattern corresponding to the number of merged classes of three for merging the twenty five initial classes obtained by the class classification of the GALF into three merged classes.

FIG. 18 is a diagram describing a method of setting a merge pattern corresponding to the number of merged classes of two for merging the twenty five initial classes obtained by the class classification of the GALF into two merged classes.

FIG. 19 is a diagram describing a method of setting a merge pattern corresponding to the number of merged classes of one for merging the twenty five initial classes obtained by the class classification of the GALF into one merged class.

FIG. 20 is a diagram illustrating second examples of merge patterns set in advance.

FIG. 21 is a diagram illustrating second examples of merge patterns set in advance.

FIG. 22 is a diagram describing class classification using ranking as a feature amount of the pixel of interest.

FIG. 23 is a diagram describing class classification using a pixel value as a feature amount of the pixel of interest.

FIG. 24 is a diagram describing a class classification using reliability of the inclination direction as a feature amount of the pixel of interest.

FIG. 25 is a diagram describing a final class obtained by class classification using reliability.

FIG. 26 is a diagram illustrating a third example of a merge pattern set in advance.

FIG. 27 is a diagram illustrating a third example of a merge pattern set in advance.

FIG. 28 is a diagram illustrating a fourth example of a merge pattern set in advance.

FIG. 29 is a diagram describing the class classification of the GALF.

FIG. 30 is a diagram describing subclass merging of inclination intensity ratio subclasses.

FIG. 31 is a diagram describing the subclass merging of direction subclasses.

FIG. 32 is a diagram describing the subclass merging of activity subclasses.

FIG. 33 is a diagram illustrating an example of merging initial classes by the subclass merging of the activity subclasses.

FIG. 34 is a diagram illustrating an example of merging initial classes by the subclass merging of the inclination intensity ratio subclasses.

FIG. 35 is a diagram illustrating an example of merging initial classes by the subclass merging of the direction subclasses.

FIG. 36 is a diagram illustrating a relationship between a number of subclasses after the subclass merging of the inclination intensity ratio subclass, the direction subclass, and the activity subclass, and the number of merged classes.

FIG. 37 is a diagram illustrating an example of a merge pattern obtained by performing the subclass merging and merge pattern selection.

FIG. 38 is a diagram describing partial merging of subclasses.

FIG. 39 is a diagram describing partial merging of subclasses.

FIG. 40 is a diagram illustrating an example of a merge pattern obtained by partial merging of subclasses.

FIG. 41 is a diagram illustrating an example of the relationship between a merge pattern obtained by the subclass merging and merge pattern selection and a merge pattern obtained by the partial merging.

FIG. 42 is a diagram illustrating another example of the relationship between the merge pattern obtained by the subclass merging and the merge pattern selection and the merge pattern obtained by the partial merging.

FIG. 43 is a diagram illustrating a merge pattern corresponding to the number of merged classes of twenty five obtained by the subclass merging and the subclass merging by which the merge pattern is obtained.

FIG. 44 is a diagram illustrating a merge pattern corresponding to the number of merged classes of twenty obtained by the subclass merging and the subclass merging by which the merge pattern is obtained.

FIG. 45 is a diagram illustrating a merge pattern corresponding to the number of merged classes of fifteen obtained by the subclass merging and the subclass merging by which the merge pattern is obtained.

FIG. 46 is a diagram illustrating a merge pattern corresponding to the number of merged classes of twelve obtained by the subclass merging and the subclass merging by which the merge pattern is obtained.

FIG. 47 is a diagram illustrating a merge pattern corresponding to the number of merged classes of ten obtained by the subclass merging and the subclass merging by which the merge pattern is obtained.

FIG. 48 is a diagram illustrating a merge pattern corresponding to the number of merged classes of nine obtained by the subclass merging and the subclass merging by which the merge pattern is obtained.

FIG. 49 is a diagram illustrating a merge pattern corresponding to the number of merged classes of eight obtained by the subclass merging and the subclass merging by which the merge pattern is obtained.

FIG. 50 is a diagram illustrating a merge pattern corresponding to the number of merged classes of six obtained by the subclass merging and the subclass merging by which the merge pattern is obtained.

FIG. 51 is a diagram illustrating a merge pattern corresponding to the number of merged classes of five obtained by the subclass merging and the subclass merging by which the merge pattern is obtained.

FIG. 52 is a diagram illustrating a merge pattern corresponding to the number of merged classes of four obtained by the subclass merging and the subclass merging by which the merge pattern is obtained.

FIG. 53 is a diagram illustrating a merge pattern corresponding to the number of merged classes of three obtained by the subclass merging and the subclass merging by which the merge pattern is obtained.

FIG. 54 is a diagram illustrating a merge pattern corresponding to the number of merged classes of two obtained by the subclass merging and the subclass merging by which the merge pattern is obtained.

FIG. 55 is a diagram illustrating a merge pattern corresponding to the number of merged classes of one obtained by the subclass merging and the subclass merging by which the merge pattern is obtained.

FIG. 56 is a block diagram illustrating a configuration example of a class classification prediction filter to which the present technology is applied.

FIG. 57 is a flowchart describing an example of class classification prediction process performed by the class classification prediction filter 110.

FIG. 58 is a block diagram illustrating a main configuration example of one embodiment of an image processing system to which the present technology is applied.

FIG. 59 is a flowchart describing an outline of an encoding process of an encoding device 160.

FIG. 60 is a flowchart describing an outline of a decoding process of a decoding device 170.

FIG. 61 is a block diagram illustrating a detailed configuration example of the encoding device 160.

FIG. 62 is a flowchart describing an example of the encoding process of the encoding device 160.

FIG. 63 is a flowchart describing an example of a predictive encoding process.

FIG. 64 is a block diagram illustrating a detailed configuration example of the decoding device 170.

FIG. 65 is a flowchart describing an example of the decoding process of the decoding device 170.

FIG. 66 is a flowchart describing an example of a predictive decoding process.

FIG. 67 is a diagram illustrating a merge pattern (3, 1, 5) and the subclass merging in which the merge pattern (3, 1, 5) is obtained.

FIG. 68 is a diagram illustrating a merge pattern (1, 2, 5) and the subclass merging in which the merge pattern (1, 2, 5) is obtained.

FIG. 69 is a diagram illustrating a merge pattern (3, 1, 4) and the subclass merging in which the merge pattern (3, 1, 4) is obtained.

FIG. 70 is a diagram illustrating a merge pattern (2, 1, 4) and the subclass merging in which the merge pattern (2, 1, 4) is obtained.

FIG. 71 is a diagram illustrating a merge pattern (1, 2, 4) and the subclass merging in which the merge pattern (1, 2, 4) is obtained.

FIG. 72 is a diagram illustrating a merge pattern (3, 2, 3) and the subclass merging in which the merge pattern (3, 2, 3) is obtained.

FIG. 73 is a diagram illustrating a merge pattern (3, 1, 3) and the subclass merging in which the merge pattern (3, 1, 3) is obtained.

FIG. 74 is a diagram illustrating a merge pattern (1, 2, 3) and the subclass merging in which the merge pattern (1, 2, 3) is obtained.

FIG. 75 is a diagram illustrating a merge pattern (3, 2, 2) and the subclass merging in which the merge pattern (3, 2, 2) is obtained.

FIG. 76 is a diagram illustrating a merge pattern (3, 1, 2) and the subclass merging in which the merge pattern (3, 1, 2) is obtained.

FIG. 77 is a diagram illustrating a merge pattern (2, 1, 2) and the subclass merging in which the merge pattern (2, 1, 2) is obtained.

FIG. 78 is a diagram illustrating a merge pattern (1, 2, 2) and the subclass merging in which the merge pattern (1, 2, 2) is obtained.

FIG. 79 is a diagram illustrating a merge pattern (3, 2, 1) and the subclass merging in which the merge pattern (3, 2, 1) is obtained.

FIG. 80 is a diagram illustrating a merge pattern (3, 1, 1) and the subclass merging in which the merge pattern (3, 1, 1) is obtained.

FIG. 81 is a diagram illustrating a merge pattern (2, 2, 1) and the subclass merging in which the merge pattern (2, 2, 1) is obtained.

FIG. 82 is a diagram illustrating a merge pattern (2, 1, 1) and the subclass merging in which the merge pattern (2, 1, 1) is obtained.

FIG. 83 is a diagram illustrating a merge pattern (1, 2, 1) and the subclass merging in which the merge pattern (1, 2, 1) is obtained.

FIG. 84 is a diagram illustrating an example of a syntax for transmitting a combination of a number of subclasses.

FIG. 85 is a block diagram illustrating a configuration example of a class classification prediction filter to which the present technology is applied.

FIG. 86 is a flowchart describing an example of a class classification prediction process performed by a class classification prediction filter 410.

FIG. 87 is a block diagram illustrating an outline of one embodiment of an image processing system to which the present technology is applied.

FIG. 88 is a flowchart describing an outline of an encoding process of an encoding device 460.

FIG. 89 is a flowchart describing an outline of a decoding process of a decoding device 470.

FIG. 90 is a block diagram illustrating a detailed configuration example of the encoding device 460.

FIG. 91 is a flowchart describing an example of the encoding process of the encoding device 460.

FIG. 92 is a flowchart describing an example of a predictive encoding process.

FIG. 93 is a block diagram illustrating a detailed configuration example of the decoding device 470.

FIG. 94 is a flowchart describing an example of the decoding process of the decoding device 470.

FIG. 95 is a flowchart describing an example of the predictive decoding process.

FIG. 96 is a diagram describing the class classification of the GALF.

FIG. 97 is a diagram describing a relationship between a merge pattern and subclasses.

FIG. 98 is a diagram describing a first merge rule.

FIG. 99 is a diagram illustrating all merge patterns set according to the first merge rule.

FIG. 100 is a diagram describing a method of merging when setting all the merge patterns according to the first merge rule.

FIG. 101 is a diagram describing a method of merging when setting all the merge patterns according to the first merge rule.

FIG. 102 is a diagram describing a method of merging when setting all the merge patterns according to the first merge rule.

FIG. 103 is a diagram describing a method of merging when setting all the merge patterns according to the first merge rule.

FIG. 104 is a diagram describing a method of merging when setting all the merge patterns according to the first merge rule.

FIG. 105 is a diagram describing a method of merging when setting all the merge patterns according to the first merge rule.

FIG. 106 is a diagram describing a second merge rule.

FIG. 107 is a diagram illustrating all merge patterns set according to the second merge rule.

FIG. 108 is a diagram describing a method of merging when setting all the merge patterns according to the second merge rule.

FIG. 109 is a diagram describing a method of merging when setting all the merge patterns according to the second merge rule.

FIG. 110 is a diagram describing a method of merging when setting all the merge patterns according to the second merge rule.

FIG. 111 is a diagram describing a method of merging when setting all the merge patterns according to the second merge rule.

FIG. 112 is a diagram describing a method of merging when setting all the merge patterns according to the second merge rule.

FIG. 113 is a diagram describing a method of merging when setting all the merge patterns according to the second merge rule.

FIG. 114 is a diagram describing a method of merging when setting all merge patterns according to a third merge rule.

FIG. 115 is a diagram describing a method of merging when setting all the merge patterns according to the third merge rule.

FIG. 116 is a diagram describing a method of merging when setting all the merge patterns according to the third merge rule.

FIG. 117 is a diagram describing a method of merging when setting all the merge patterns according to the third merge rule.

FIG. 118 is a diagram describing a method of merging when setting all the merge patterns according to the third merge rule.

FIG. 119 is a diagram describing a method of merging when setting all the merge patterns according to the third merge rule.

FIG. 120 is a diagram describing a method of merging when setting all merge patterns according to a fourth merge rule.

FIG. 121 is a diagram describing a method of merging when setting all the merge patterns according to the fourth merge rule.

FIG. 122 is a diagram describing a method of merging when setting all the merge patterns according to the fourth merge rule.

FIG. 123 is a diagram describing a method of merging when setting all the merge patterns according to the fourth merge rule.

FIG. 124 is a diagram describing a method of merging when setting all the merge patterns according to the fourth merge rule.

FIG. 125 is a diagram describing a method of merging when setting all the merge patterns according to the fourth merge rule.

FIG. 126 is a block diagram illustrating a configuration example of one embodiment of a computer.

### MODE FOR CARRYING OUT THE INVENTION

<Documents and the like that Support Technical Contents and Terms>

The scope disclosed in the present application includes not only the contents described in the present description and the drawings but also the contents described in the following documents known at the time of filing.

Reference 1: AVC standard (“Advanced video coding for generic audiovisual services”, ITU-T H.264 (April 2017))

Reference 2: HEVC standard (“High efficiency video coding”, ITU-T H.265 (December 2016))

Reference 3: FVC algorithm description of Joint Exploration Test Model 7 (JEM7), Aug. 19 2017

In other words, the contents described in the above-mentioned documents are also the basis for determining the support requirements. For example, even in a case where a quad-tree block structure described in Reference 1 and a quad tree plus binary tree (QTBT) or block structure described in Reference 3 are not directly described in the embodiment, they are within the scope of disclosure of the present technology and meet the support requirements of the claims. Furthermore, for example, technical terms such as parsing, syntax, and semantics are also within the scope of disclosure of the present technology even in a case where there is no direct description in the embodiment, and meet the support requirements of the claims.

Furthermore, in the present description, a “block” (not a block indicating a processing unit) used in the description as a partial area of an image (picture) or a processing unit indicates an arbitrary partial area in the picture unless otherwise specified, and does not limit its size, shape, characteristics, and the like. For example, the “block” includes any partial area (processing unit) such as transform block (TB), transform unit (TU), prediction block (PB), prediction unit (PU), smallest coding unit (SCU), coding unit (CU), largest coding unit (LCU), coding tree block (CTB), coding tree unit (CTU), conversion block, subblock, macroblock, tile, or slice, and the like described in References 1 to 3 above.

Furthermore, upon specifying the size of such a block, not only the block size may be directly specified, but also the block size may be indirectly specified. For example, the block size may be specified using identification information that identifies the size.

Furthermore, for example, the block size may be specified by a ratio or difference with the size of the reference block (for example, LCU, SCU, or the like). For example, in a case of transmitting information for specifying the block size as a syntax element or the like, information for indirectly specifying the size as described above may be used as this information. In this manner, the amount of information of the information can be reduced, and encoding efficiency may be improved. Furthermore, the specification of the block size also includes a specification of the range of the block size (for example, the specification of the range of an allowable block size, or the like).

<Definition>

In the present application, the following terms are defined as follows.

Encoded data is data obtained by encoding an image and is, for example, data obtained by orthogonally transforming and quantizing an image (residual).

An encoded bitstream is a bitstream including encoded data, and if necessary, contains encoding information regarding encoding. The encoding information includes at least information necessary for decoding the encoded data, that is, for example, quantization parameter (QP) in a case where quantization is performed in encoding, and a motion vector in a case where predictive encoding (motion compensation) is performed in encoding, or the like.

A predictive equation is a polynomial that predicts second data from first data. In a case where the first data and the second data are, for example, images (data), the predictive equation is a polynomial that predicts the second image from the first image. Each term of the predictive equation, which is such a polynomial, is formed by the product of one tap coefficient and one or more prediction taps, and thus the predictive equation is an equation for performing a product-sum operation of the tap coefficient and the prediction tap. Assuming that (the pixel value of) the pixel as an i-th prediction tap used for prediction (calculation of the predictive equation) among pixels of the first image is represented by xᵢ, an i-th tap coefficient is represented by wᵢ, and (predicted value of the pixel value of) a pixel of the second image is represented by y′, and a polynomial formed by only first-order terms is used as the predictive equation, the predictive equation is expressed by an equation y′=Σwᵢxᵢ. In the equation y′=Σwᵢxᵢ, Σ represents a summation for i. The tap coefficient wᵢ that constitutes the predictive equation is obtained by learning that statistically minimizes an error y′-y from a true value y of the value y′ obtained by the predictive equation. There is a least squares method as a learning method for obtaining the tap coefficient (hereinafter, also referred to as tap coefficient learning). In the tap coefficient learning, by using a student image as student data (input xᵢ to the predictive equation) that is a learning student, which corresponds to the first image to which the predictive equation is applied, a teacher image as teacher data (true value y of the predicted value obtained by calculation of the predictive equation) as a teacher of learning, which corresponds to the second image desired to be obtained as a result of applying the predictive equation to the first image, coefficients of each term constituting a normal equation (coefficient summation) are added up to obtain a normal equation, and by solving the normal equation, the tap coefficient that minimizes the sum total of squared errors (statistical error) of the predicted value y′ is obtained.

A prediction process is a process of applying the predictive equation to the first image to predict the second image. In the prediction process, a predicted value of the second image is obtained by performing a product-sum operation as the calculation of the predictive equation using (the pixel value of) the pixels of the first image. It can be said that performing the product-sum operation using the first image can be said to be a filtering process that filters the first image, and the prediction process that performs the product-sum operation of the predictive equation (the product-sum operation as the calculation of the predictive equation) using the first image can be said to be a kind of filtering process.

A filtered image means an image obtained as a result of the filtering process. The second image (predicted value thereof) obtained from the first image by the filtering process as the prediction process is a filtered image.

The tap coefficient is a coefficient that constitutes each term of the polynomial that is the predictive equation, and corresponds to a filter coefficient that is multiplied by a signal to be filtered in a tap of a digital filter.

The prediction tap is information such as (pixel values of) pixels used in the calculation of the predictive equation, and is multiplied by the tap coefficient in the predictive equation. The prediction tap includes not only the (pixel values of) the pixels themselves, but also a value obtained from the pixels, for example, the total value or average value of (pixel values of) pixels in a certain block, and the like.

Here, selecting a pixel or the like as the prediction tap to be used in calculation of the predictive equation corresponds to extending (arranging) a connection line for supplying a signal as an input to the tap of the digital filter, and thus selecting a pixel as the prediction tap used in the calculation of the predictive equation will be also referred to as “extending the prediction tap”.

Class classification means classifying (clustering) pixels into one of a plurality of classes. The class classification can be performed using, for example, (pixel values of) the pixels in a peripheral region of the pixel of interest and the encoding information related to the pixels of interest. The encoding information related to the pixel of interest includes, for example, quantization parameters used for quantization of the pixel of interest, deblocking filter (DF) information regarding a deblocking filter applied to the pixel of interest, and the like. The DF information is, for example, information such as which of a strong filter and a weak filter is applied or that none of them are applied in the deblocking filter.

A class classification prediction process is a filtering process as a prediction process performed for every class. The basic principle of the class classification prediction process is described in, for example, Japanese Patent No. 4449489 or the like.

A higher-order term is a term having the product of two or more (pixels as) prediction taps among the terms constituting the polynomial as the predictive equation.

A D-th order term is a term having the product of D prediction taps among the terms constituting the polynomial as the predictive equation. For example, a first-order term is a term having one prediction tap, and a second-order term is a term having the product of two prediction taps. In the product of the prediction taps constituting the D-th order term, the prediction taps that take the product may be the same prediction tap (pixel).

A D-th order coefficient means the tap coefficient that constitutes the D-th order term.

The D-th order tap means (a pixel as) a prediction tap that constitutes the D-th order term. A certain single pixel may be the D-th order tap and also be a D′-order tap different from the D-th order tap. Furthermore, a tap structure of the D-th order tap and a tap structure of the D′-th order tap different from the D-th order tap do not have to be the same.

A direct current (DC) predictive equation is the predictive equation including a DC term.

The DC term is a term of the product of the value representing a DC component of the image as the prediction tap and the tap coefficient among the terms constituting the polynomial as the predictive equation.

A DC tap means the prediction tap of the DC term, that is, a value representing the DC component.

A DC coefficient means the tap coefficient of the DC term.

A first-order predictive equation is a predictive equation formed by only a first-order term.

A higher-order predictive equation is a predictive equation including higher-order terms, that is, a predictive equation formed by a first-order term and a second-order or higher term, or a predictive equation formed by only second-order or higher terms.

Assuming that an i-th prediction tap (pixel value or the like) used for prediction among the pixels of the first image is represented by xᵢ, an i-th tap coefficient is represented by wᵢ, and (predicted value of the pixel value of) a pixel of the second image calculated by the predictive equation is represented by y, the first-order predictive equation is represented by the equation y=Σwᵢxᵢ.

Furthermore, a higher predictive equation formed by only a first-order term and a second-order term is represented by, for example, an equation y=Σwᵢxᵢ+Σ(Σwⱼ, ₖxₖ) xⱼ.

Moreover, for example, the DC predictive equation in which the DC term is included in the first-order predictive equation is represented by an expression Σwᵢxᵢ+w_{DCB}DCB, for example. Here, w_{DCB} represents the DC coefficient, and DCB represents the DC tap.

The tap coefficients of the first-order predictive equation, the higher-order predictive equation, and the DC predictive equation can all be obtained by performing the tap coefficient learning by the least squares method as described above.

In the present embodiment, in order to simplify the explanation, a first-order predictive equation is employed as the predictive equation.

The tap structure means an arrangement of the pixels as the prediction tap (for example, with reference of the position of the pixel of interest). The tap structure can also be said to be how to extend the prediction tap. In a case where the first-order predictive equation is employed, the tap structure can be said to be an arrangement of the tap coefficients, considering a state that the tap coefficient to be multiplied by a pixel constituting the prediction tap is arranged at the position of the pixel. Accordingly, the tap structure means either of the arrangement of the pixels constituting the prediction tap of the pixel of interest, and the arrangement of the tap coefficients in the state that the tap coefficient to be multiplied by a pixel constituting the prediction tap is arranged at the position of the pixel.

Activity (of an image) means how spatial pixel values of an image change.

A decoded image is an image obtained by decoding encoded data obtained by encoding an original image. The decoded image includes an image obtained by decoding the encoded data by a decoding device, and also includes, in a case where the original image is subjected to predictive encoding by the encoding device, an image obtained by local decoding of the predictive encoding. That is, in the case where the original image is subjected to the predictive encoding in the encoding device, a predicted image and a (decoded) residual are added in the local decoding, and an addition result of this addition is the decoded image. In a case where the ILF is used for the local decoding of the encoding device, the decoded image that is the addition result of the predicted image and the residual is a target of the ILF filtering process, but the decoded image after the ILF filtering process is also the filtered image.

An inclination direction (of a pixel) means a direction in which the pixel value is inclined, in particular, for example, a direction in which the inclination of the pixel value is maximum. Note that the direction in which the inclination of the pixel value is maximum is a direction orthogonal to a contour line of the pixel value and is orthogonal to a tangent direction of the contour line of the pixel value, and thus there is a one-to-one relationship with the tangent direction of the contour line of the pixel value. Therefore, the direction in which the inclination of the pixel value is maximum and the tangent direction of the contour line of the pixel value are equivalent information, and when it is mentioned, the inclination direction includes both the direction in which the inclination of the pixel value is maximum and the tangent direction of the contour line of the pixel value. In the present embodiment, the direction in which the inclination of the pixel value is maximum is employed as the inclination direction.

A defined direction means a predetermined discrete direction. As a method of expressing the direction, for example, it is possible to employ a method of expressing a continuous direction by a continuous angle, a method of expression in two types of discrete directions of a horizontal direction and a vertical direction, and a method of dividing 360 degrees around into eight directions at equal angles, and expressing directions in discrete directions of the eight directions, and the like. The defined direction means a direction expressed in a predetermined discrete direction in this manner. For example, the direction used in the GALF described in Non-Patent Document 2, the direction represented by a direction class of the GALF (two directions of either a V direction or an H direction, or a D0 direction or a D1 direction as described later), or the like is an example of the defined direction.

When it is mentioned, the inclination direction includes the direction that is continuously expressed by a continuous angle, and also includes the defined direction. That is, the inclination direction can be expressed in the continuous direction, and can be expressed also in the defined direction.

The inclination feature amount is a feature amount of an image representing the inclination direction. For example, activity in each direction and a gradient vector (gradient) obtained by applying a Sobel filter or the like to the image are examples of the inclination feature amount.

Reliability of the inclination direction means reliability (certainty) of the inclination direction of the pixel obtained by some kind of method.

An initial class is a class in which the tap coefficient is obtained in the tap coefficient learning, and is a class before being merged.

A merged class is a class in which one or more initial classes are merged.

A merged class number is the number of merged classes obtained by merging the initial classes.

A merge pattern represents a correspondence between the initial class and a merged class obtained by merging the initial class, and is expressed, for example, in an expression format or the like in which class numbers of merged classes, in which initial classes of the class numbers representing the initial classes are merged, are arranged in the order of the class numbers.

Hereinafter, an outline of processing of the GALF including the class classification of the GALF will be described before the embodiment of the present technology is described.

<Overview of Class Classification of GALF>

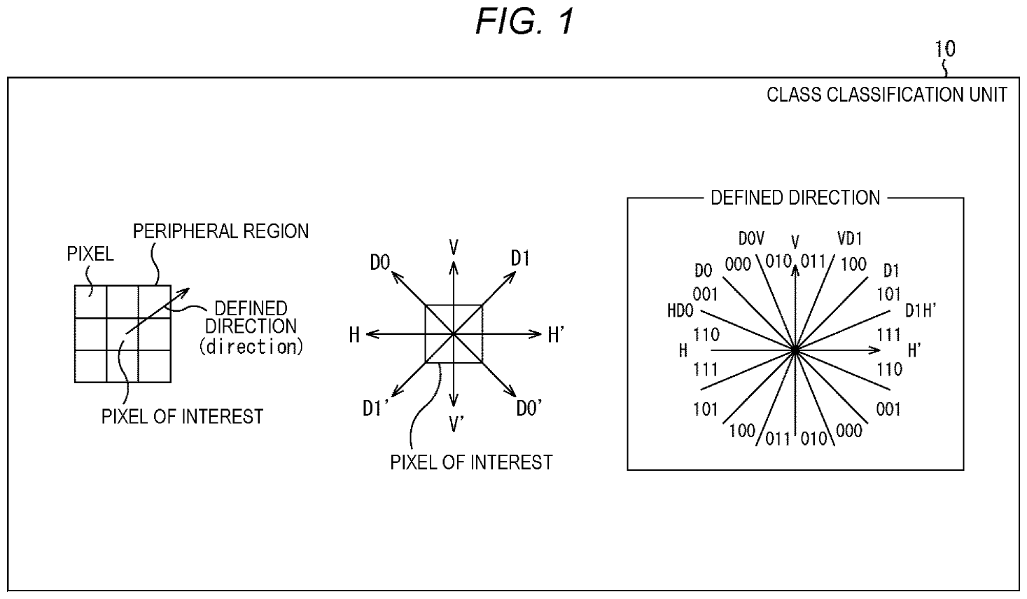

FIG. 1 is a diagram describing an outline of processing of a class classification unit 10 that performs the class classification of the GALF.

That is, FIG. 1 illustrates an outline of class classification of Joint Video. Exploration Team (JVET)-B0060.

The class classification unit 10 sequentially selects pixels as a target of class classification as the pixel of interest in the decoded image (including the decoded image obtained by the local decoding in the encoding device), and obtains an activity in each of a plurality of directions starting from the pixel of interest as the inclination feature amount of the pixel of interest.

The class classification unit 10 employs, as the plurality of directions starting from the pixel of interest, for example, four directions of an upward direction as a vertical direction, a left direction as a horizontal direction, an upper left direction, and an upper right direction starting from the pixel of interest.

Here, as illustrated in FIG. 1, the upward direction, the left direction, the upper left direction, and the upper right direction will be hereinafter also referred to as V direction, H direction, D0 direction, and D1 direction, respectively. Furthermore, with respect to the V direction, the H direction, the D0 direction, and the D1 direction, point symmetric directions (opposite directions) with (the position of) the pixel of interest as the center of symmetry will be also referred to as V′ direction, H′ direction, D0′ direction, and D1′ direction, respectively.

Because an activity of an image is often point-symmetrical, in the class classification of the GALF, activities in two directions of point symmetry are shared (substituted) by an activity in one of the two directions. That is, activities in the V direction and the V′ direction are shared by an activity in the V direction, and activities in the H direction and the H′ direction are shared by an activity in the H direction. Activities in the D0 and D0′ directions are shared by an activity in the D0 direction, and activities in the D1 and D1′ directions are shared by an activity in the D1 direction.

The V direction, H direction, D0 direction, and D1 direction are the directions in which the activity is obtained in the class classification of the GALF, and thus can be considered as activity calculation directions. The activity calculation directions, V direction, H direction, D0 direction, and D1 direction, are (a kind of) defined directions because they are predetermined discrete directions.

The class classification unit 10 obtains activity A(D) in the D direction (representing the V direction, H direction, D0 direction, or D1 direction) of the pixel of interest by applying, for example, a Laplacian filter to the decoded image including the pixel of interest. In this case, the activities A(V), A(H), A(D0), and A(D1) of the pixel of interest in the respective V direction, H direction, D0 direction, and D1 direction can be obtained, for example, according to the following equations.

A(V)=abs((L[y][x]«1)−L[y−1][x]−L[y+1][x])

A(H)=abs((L[y][x]«1)−L[y][x−1]−L[y][x+1])

A(D0)=abs((L[y][x]«1)−L[y−1][x−1]−L[y+1][x+1])

A(D1)=abs((L[y][x]«1)−L[y+1][x−1]−L[y−1][x+1])

Here, L[y][x] represents the pixel value (luminance value) of a pixel at a position of y-th row and x-th column of the decoded image, and in this case, the pixel at the position of y-th row and x-th column of the decoded image is the pixel of interest. Furthermore, abs(v) represents the absolute value of v, and v«b represents shifting v to the left by b bits (multiplying by 2^{b}).

The class classification unit 10 similarly obtains the activity of each of the plurality of pixels in the peripheral region of the pixel of interest. Then, the class classification unit 10 adds the activities of each of the plurality of pixels in the peripheral region of the pixel of interest for each of the V direction, the H direction, the D0 direction, and the D1 direction, so as to obtain an addition value of the activity (hereinafter, also referred to as an activity sum (activity summation)) for each of the V direction, the H direction, the D0 direction, and the D1 direction.

In the present embodiment, for example, as illustrated in FIG. 1, a region of 3×3 pixels in width×height centered on the pixel of interest is the peripheral region as a target for which the activity A(D) as the inclination feature amount is comprehensively used, and the activity A(V) of equation (1) of each of the 3×3 pixels in the peripheral region is added to obtain the activity sum sumA(V) in the V direction of the pixel of interest. The activity sums sumA(H), sumA(D0), and sumA(D1) in the H direction, the D0 direction, and the D1 direction of the pixel of interest are also obtained similarly. Here, the peripheral region is not limited to the region of 3×3 pixels. As the peripheral region for which the inclination feature amount is to be used comprehensively (here, the peripheral region for which the activity A(D) is added), besides the region of 3×3 pixels, any region including the pixel of interest can be employed, such as a region of 6×6 pixels including the pixel of interest, or the like.

The class classification unit 10 uses the activity sums sumA(V), sumA(H), sumA(D0), and sumA(D1) in the V direction, H direction, D0 direction, and D1 direction of the pixel of interest to obtain (set) the direction of the GALF as the defined direction that represents the inclination direction of the pixel of interest.

Here, as illustrated in FIG. 1, the direction of the GALF as the defined direction includes eight directions to which 000 to 111 in binary and 0 to 7 in decimal are assigned. In the GALF, eight directions in total are determined in advance as the direction as the defined direction, which are a direction between the H direction and a direction HD0 that bisects the H direction and the D0 direction, a direction between the direction HD0 and the D0 direction, a direction between the D0 direction and a direction D0V that bisects the D direction and the V direction, a direction between the direction D0V and the V direction, a direction between the V direction and a direction VD1 that bisects the V direction and the D1 direction, a direction between the direction VD1 and the D1 direction, a direction between the D1 direction and a direction D1H′ that bisects the D1 direction and the H′ direction, and a direction between the direction D1H′ and the H′ direction.

A binary number 110 is assigned to the direction between the H direction and the direction HD0, a binary number 001 is assigned to the direction between the direction HD0 and the D0 direction, a binary number 000 is assigned to the direction between the D0 direction and the direction D0V, a binary number 010 is assigned to the direction between the direction D0V and the V direction, a binary number 011 is assigned to the direction between the V direction and the direction VD1, a binary number 100 is assigned to the direction between the direction VD1 and the D1 direction, a binary number 101 is assigned to the direction between the D1 direction and the direction D1H′, and a binary number 111 is assigned to the direction between the direction D1H′ and the H′ direction. Note that in the GALF, each of the eight directions described above and the direction of point symmetry with each of the eight directions are treated as the same direction.

The class classification unit 10 obtains (sets) the direction class representing the inclination direction of the pixel of interest from the direction as the defined direction of the pixel of interest. The direction class of the GALF represents two directions of either the V direction or the H direction, or either the D0 direction or the D1 direction.

Here, obtaining the direction class constitutes a part of the class classification of the GALF performed by the class classification unit 10, and thus can be called subclass classification. The subclass classification for obtaining the direction class will be hereinafter also referred to as direction subclass classification.

The class classification unit 10 performs the class classification of the pixel of interest according to the direction class of the pixel of interest, and the activity sums sumA(V), sumA(H), sumA(D0), and sumA(D1) in the V direction, H direction, D0 direction, and Dl direction.

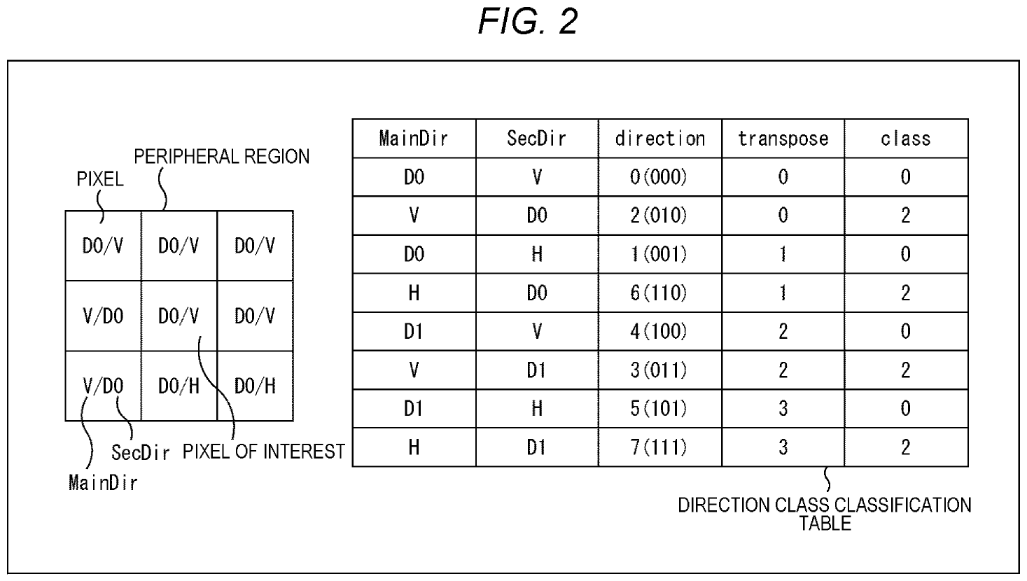

FIG. 2 is a diagram describing how to obtain the direction of the GALF as the defined direction (inclination direction) of the pixel of interest.

FIG. 2 illustrates an example of MainDir and SecDir obtained (set) by using the activity sums sumA(V), sumA(H), sumA(D0), and sumA(D1) in the V direction, H direction, D0 direction, and D1 direction in the class classification of the GALF. Moreover, FIG. 2 illustrates a direction class classification table describing a relationship between the MainDir and SecDir and the direction and a relationship between the direction and transpose and the class used in the class classification of the GALF.

The class classification unit 10 obtains the activity sums sumA(V), sumA(H), sumA(D0), and sumA(D1) in the V direction, the H direction, the D0 direction, and the D1 direction, then compares the activity sums sumA(H) and sumA(V), and determines the larger one as a first winner activity HVhigh and the other is a first loser activity HVlow.

Furthermore, the class classification unit 10 compares the activity sums sumA(D0) and sumA(D1), and sets the larger one as a second winner activity Dhigh and the other as a second loser activity Dlow.

Then, the class classification unit 10 compares a multiplication value HVhigh x Dlow of the first winner activity HVhigh and the second loser activity Dlow, with a multiplication value Dhigh×HVlow of the second winner activity Dhigh and the first loser activity HVlow.

In a case where the multiplication value HVhigh×Dlow is larger than the multiplication value Dhigh×HVlow, the class classification unit 10 determines the direction (H direction or V direction) in which the first winner activity HVhigh is obtained as the Main Dir (Main Direction), and also determines the direction (D0 direction or D1 direction) in which the second winner activity Dhigh is obtained as the SecDir (Second Direction).

On the other hand, in a case where HVhigh×Dlow is not larger than Dhigh×HVlow, the class classification unit 10 determines the direction in which the second winner activity Dhigh is obtained as the MainDir, and determines the direction in which the first winner activity HVhigh is obtained as the SecDir.

In FIG. 2, the MainDir and SecDir of the pixel of interest are in the D0 direction and the V direction, respectively.

In the direction class classification table, the class classification unit 10 determines a direction assigned to the MainDir and SecDir of the pixel of interest as a direction as the defined direction of the pixel of interest. Moreover, the class classification unit 10 determines a transpose and a class assigned to the direction of the pixel of interest as a transpose and a class of the pixel of interest in the direction class classification table.

Here, in the GALF, the filter coefficient is transposed and used for the filtering process, and the transpose represents a method of transposing the filter coefficient. The class represents a direction class. The direction class of the GALF includes two classes represented by decimal numbers 0 and 2. The direction class can be obtained by taking a logical product of the direction of the pixel of interest and the binary number 010. The direction class 0 represents that the inclination direction is the D0 direction or the D1 direction, and the direction class 2 represents that the inclination direction is the V direction or the H direction.

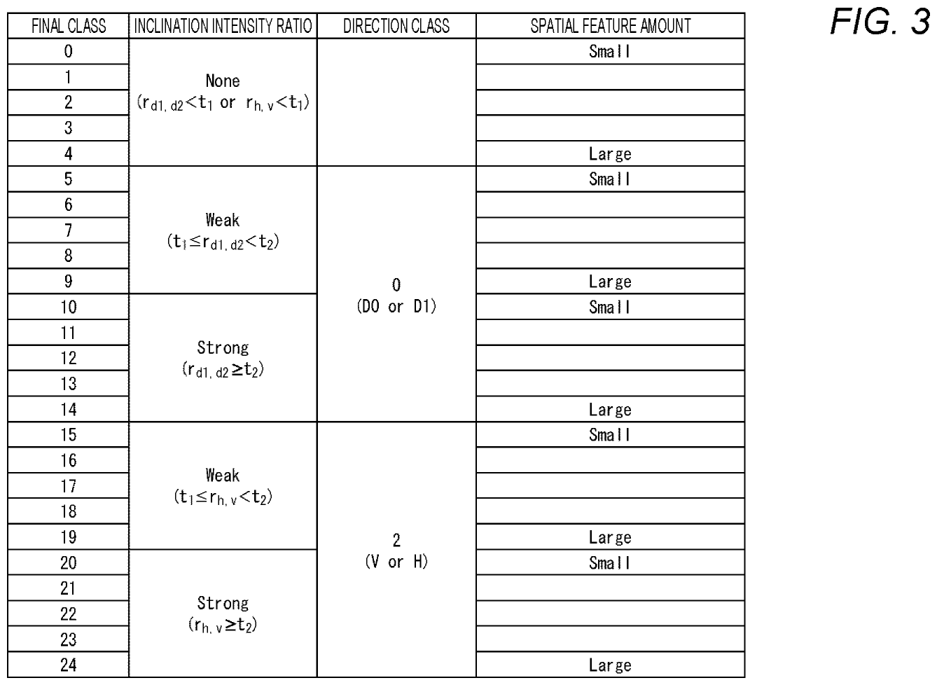

FIG. 3 is a diagram describing classes obtained by the class classification of the GALF.

In the class classification of the GALF performed by the class classification unit 10, the pixel of interest is classified into one of twenty five classes of (final) classes 0 to 24.

That is, the class classification unit 10 uses the direction class of the pixel of interest, and the activity sums sumA(V), sumA(H), sumA(D0), and sumA(D1) in the V direction, H direction, D0 direction, and D1 direction as necessary to obtain the inclination intensity ratio representing the intensity of inclination of the pixel value of the pixel of interest, and obtains (sets) a class representing the inclination intensity ratio of the pixel of interest according to the inclination intensity ratio.

Here, obtaining the class representing the inclination intensity ratio constitutes a part of the class classification of the GALF performed by the class classification unit 10, and thus can be called subclass classification. The subclass classification for obtaining the class representing the inclination intensity ratio will be hereinafter also referred to as inclination intensity ratio subclass classification. The class obtained by the subclass classification will be hereinafter also referred to as a subclass below.

The class classification unit 10 obtains a ratio r_{d1,d2} of the activity sums sumA(D0) and sumA(D1) in the D0 direction and D1 direction, and a ratio r_{h,v} of the activity sums sumA(V) and sumA(H) in the V direction and H direction, as the inclination intensity ratios according to equations (2) and (3), respectively.

r_{d1,d2}=max{sumA(D0), sumA(D1)}/min{sumA(D0), sumA(D1)} (2)

r_{h,v}=max{sumA(V), sumA(H) }/min{sumA(V), sumA(H) } (3)

Here, max{A, B} represents the larger one of A and B, and min{A, B} represents the smaller one of A and B.

In a case where the inclination intensity ratio r_{d1,d2} is less than a first threshold ti and in a case where the inclination intensity ratio r_{h,v} is less than the first threshold t₁, the pixel of interest is classified by the inclination intensity ratio subclass classification into a none class with an extremely small inclination intensity ratio.

In the inclination intensity ratio subclass classification, in a case where the pixel of interest is classified into the none class, the class classification unit 10 invalidates (does not consider) the direction class (subclass) of the pixel of interest, and class classifies the pixel of interest into a final initial class (hereinafter also referred to as final class) according to the activity sums sumA(V), sumA(H), sumA(D0), and sumA(D1) in the V direction, H direction, D0 direction, and D1 direction as the spatial feature amount of the pixel of interest.

That is, the class classification unit 10 obtains a class representing the size of the activity sum according to the activity sums sumA(V), sumA(H), sumA(D0), and sumA(D1).

Here, obtaining a class representing the size of the activity sum is subclass classification similarly to the case of the inclination intensity ratio subclass classification and the like, and will be also referred to as an activity subclass classification below.

In the activity subclass classification, the activity sums sumA(V) and sumA(H) out of the activity sums sumA(V), sumA(H), sumA(D0), and sumA(D1) are used to obtain an index class_idx for the activity subclass that is a subclass obtained by the activity subclass classification.

The index class_idx is obtained according to, for example, an equation class_idx=Clip(0, 15, ((sumA(V)+sumA(H))×24)″13). Here, Clip(0, 15, X) means that X is clipped so that X becomes a value in the range of zero to 15.

In the activity subclass classification, the activity subclass is obtained according to the index class_idx.

That is, in a case where the index class_idx is zero, the activity subclass is 0 (small class), and in a case where the index class_idx is 1, the activity subclass is 1. Furthermore, in a case where the index class_idx is 2 to 6, the activity subclass is set to 2, and in a case where the index class_idx is 7 to 14, the activity subclass is set to 3. Then, in a case where the index class_idx is 15, the activity subclass is 4 (large class).

In a case where the activity subclasses are 0 to 4, the pixel of interest classified into the none class by the inclination intensity ratio subclass classification are class classified into the final classes 0 to 4, respectively.

In a case where the inclination intensity ratio r_{d1,d2} is not less than the first threshold ti, or where the inclination intensity ratio r_{h,v} is not less than the first threshold ti, the direction class of the pixel of interest is validated (considered), and the inclination intensity ratio subclass classification is performed.

That is, in a case where the direction class (subclass) of the pixel of interest is the direction class 0 corresponding to the D0 direction or the D1 direction, the inclination intensity ratio subclass classification according to the inclination intensity ratio r_{d1,d2} of equation (2) (also referred to as the inclination intensity ratio subclass classification using the inclination intensity ratio r_{d1,d2} or the inclination intensity ratio subclass classification of the inclination intensity ratio r_{d1,d2}) is performed.

In a case where the inclination intensity ratio r_{d1,d2} is equal to or greater than the first threshold ti and less than the second threshold t₂, the pixel of interest is classified by the inclination intensity ratio subclass classification into the weak class with a small inclination intensity ratio.

In a case where the pixel of interest is classified into the weak class in the inclination intensity ratio subclass classification, the class classification unit 10 class classifies the pixel of interest into the final class according to the activity sums sumA(V), sumA(H), sumA(D0), and sumA(D1) in the V direction, H direction, D0 direction, and D1 direction as the spatial feature amount of the pixel of interest.

That is, in a case where the activity subclasses obtained by the activity subclass classification according to the activity sums sumA(V), sumA(H), sumA(D0), and sumA(D1) are 0 to 4, the pixels of interest classified into the weak class in the inclination intensity ratio subclass classification are class classified into the final classes 5 to 9, respectively.

In a case where the inclination intensity ratios r_{d1,d2} is equal to or greater than the second threshold t₂, the pixel of interest is classified into a strong class by the inclination intensity ratio subclass classification.

In a case where the pixel of interest is classified into the strong class in the inclination intensity ratio subclass classification, the class classification unit 10 class classifies the pixel of interest into the final class according to the activity sum sumA(V), sumA(H), sumA(D0), and sumA(D1) in the V direction, H direction, D0 direction, and D1 direction as the spatial feature amount of the pixel of interest.

That is, in a case where the activity subclasses obtained by the activity subclass classification according to the activity sums sumA(V), sumA(H), sumA(D0), and sumA(D1) are 0 to 4, the pixels of interest classified into the strong class in the inclination intensity ratio subclass classification are class classified into the final classes 10 to 14, respectively.

On the other hand, in a case where the direction class of the pixel of interest is the direction class 2 corresponding to the V direction or the H direction, the inclination intensity ratio subclass classification according to the inclination intensity ratio r_{h,v} of equation (3) is performed.

In a case where the inclination intensity ratio r_{h,v} is equal to or greater than the first threshold t₁ and less than the second threshold t₂, the pixel of interest is classified by the inclination intensity ratio subclass classification into the weak class with a small inclination intensity ratio.

In a case where the pixel of interest is classified into the weak class in the inclination intensity ratio subclass classification, the class classification unit 10 class classifies the pixel of interest into one of the final classes 15 to 19 according to the activity sums sumA(V), sumA(H), sumA(D0), and sumA(D1) in the V direction, H direction, D0 direction, and D1 direction as the spatial feature amount of the pixel of interest.

That is, in a case where the activity subclasses obtained by the activity subclass classification according to the activity sums sumA(V), sumA(H), sumA(D0), and sumA(D1) are 0 to 4, the pixels of interest classified into the weak class in the inclination intensity ratio subclass classification are class classified into the final classes 15 to 19, respectively.

In a case where the inclination intensity ratio r_{h,v} is equal to or greater than the second threshold t₂, the pixel of interest is classified into the strong class with a large inclination intensity ratio by the inclination intensity ratio subclass classification.

In a case where the pixel of interest is classified into the strong class in the inclination intensity ratio subclass classification, the class classification unit 10 class classifies the pixel of interest into one of the final classes 20 to 24 according to the activity sums sumA(V), sumA(H), sumA(D0), and sumA(D1) in the V direction, H direction, D0 direction, and D1 direction as the spatial feature amount of the pixel of interest.

That is, in a case where the activity subclasses obtained by the activity subclass classification according to the activity sums sumA(V), sumA(H), sumA(D0), and sumA(D1) are 0 to 4, the pixels of interest classified into the strong class in the inclination intensity ratio subclass classification are class classified into the final classes 20 to 24, respectively.

Here, in the present description, the class c means a class whose class number for identification of class is c.

<Processing of GALF>

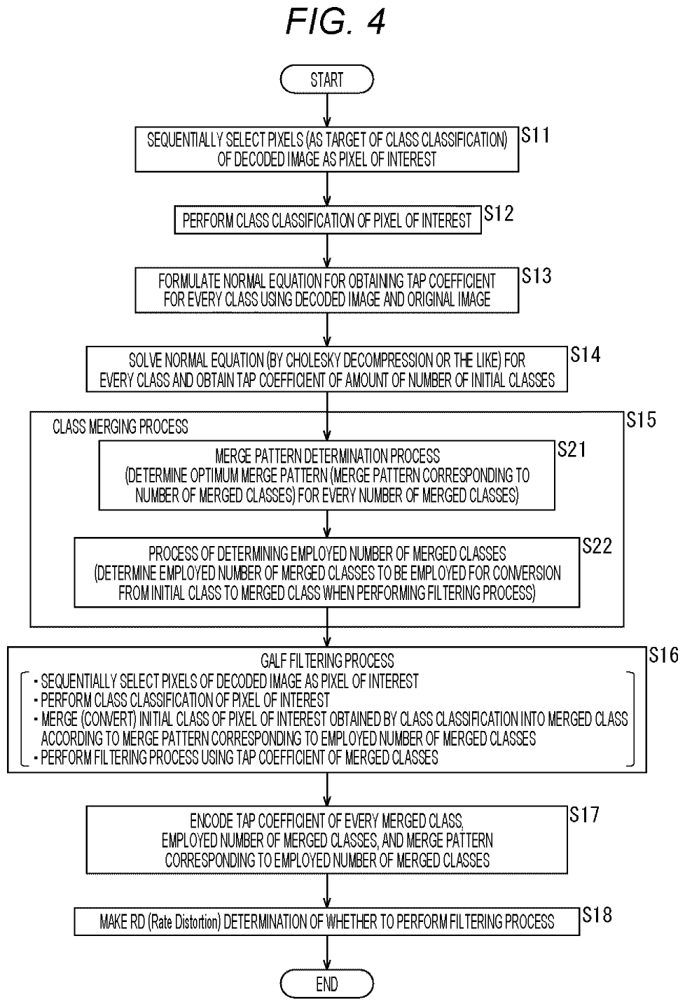

FIG. 4 is a flowchart describing processing of the CALF that the encoding device that encodes an image has as one of the ILFs.

In step S11, the CALF sequentially selects pixels of a decoded image (for example, one picture) obtained by local decoding in the encoding device as the pixel of interest, and the process proceeds to step S12.

In step S12, the CALF performs the class classification of the pixel of interest as described in FIGS. 1 to 3 to classify the pixel of interest into one of the initial classes with the final classes 0 to 24 being the twenty five initial classes 0 to 24, and the process proceeds to step S13.

In step S13, the CALF uses the decoded image and the original image for the decoded image (the image encoded into the encoded data that is decoded into the decoded image) and formulates a normal equation for obtaining the tap coefficient for every initial class, and the process proceeds to step S14.

Here, it is assumed that the i-th prediction tap (pixel value or the like) used for prediction among the pixels of the decoded image is xi, the i-th tap coefficient is represented by wi, and (the predicted value of the pixel value of) a pixel of the original image obtained by the predictive equation is represented by y, respectively. In the CALF, the filtering process as a prediction process is performed for predicting the pixel y of the original image according to the first-order predictive equation y=Σwᵢx₁. In this case, the normal equation for obtaining the tap coefficient w₁, that is, the tap coefficient la, that minimizes the sum total of squared errors of the prediction error of the predicted value y of the pixel value of a pixel of the original image obtained according to the first-order predictive equation y=Σwᵢxᵢ is expressed by an equation XW=Y.

Now, assuming that the number of tap coefficients in each initial class is the same N, Y in the equation XW=Y represents a matrix (column vector) with N rows and one column whose elements are the sum of products of the pixel value y of a pixel of the original image and the pixel value of a pixel of the decoded image (prediction tap) xᵢ. Furthermore, X represents a matrix with N rows and N columns whose elements are the sum of products of the prediction taps xᵢ and xⱼ, and W represents a matrix (column vector) with N rows and one column whose element is the tap coefficient wᵢ. Hereinafter, X in the normal equation XW=Y is also referred to as an X matrix, and Y is also referred to as a Y vector.

In step S14, the CALF solves the normal equation for every initial class by, for example, Cholesky decomposition or the like, and obtains the tap coefficient for every initial class, and the process proceeds to step S15.

Here, the process of obtaining the tap coefficient for every initial class as in steps S11 to S14 is the tap coefficient learning.

In step S15, the GALF performs a class merging process for merging the initial classes in order to reduce (the amount of data) of the tap coefficient, and the process proceeds to step S16.

In the class merging process, a merge pattern determination process is performed in step S21, and a process of determining the employed number of merged classes is performed in step S22.

In the merge pattern determination process, an optimum merge pattern is determined for every number of merged classes, with each value of natural numbers equal to or less than the number of initial classes being the number of merged classes. In the process of determining the employed number of merged classes, the employed number of merged classes to be employed for conversion from the initial class to the merged class when performing the filtering process using the tap coefficient is determined out of the numbers of merged classes for which the optimum merge pattern has been determined by the merge pattern determination process.

Details of the merge pattern determination process and the process of determining the employed number of merged classes will be described later.

In step S16, the GALF performs a GALF filtering process, and the process proceeds to step S17.

That is, the GALF sequentially selects the pixels of the decoded image as the pixel of interest and performs the class classification of the pixel of interest. Moreover, the GALF converts the initial class of the pixel of interest obtained by the class classification of the pixel of interest into a merged class according to the merge pattern corresponding to the employed number of merged classes. Then, the GALF performs the filtering process that applies the predictive equation using the tap coefficient of the merged class of the pixel of interest to the decoded image, that is, calculates the first-order predictive equation y=Σwᵢxᵢ using the tap coefficient wᵢ of the merged class of the pixel of interest to obtain a pixel value of the filtered image (the predicted value of the pixel value of a pixel of the original image).

Here, in the GALF filtering process, the tap coefficient of every merged class is required, but the tap coefficient of every merged class is obtained in the merge pattern determination process in step S21.

In step S17, the GALF encodes the tap coefficient of every merged class obtained by converting the initial class according to the merge pattern corresponding to the employed number of merged classes, the employed number of merged classes, and the merge pattern corresponding to the employed number of merged classes, and the process proceeds to step S18.

In step S18, the GALF makes a rate distortion (RD) determination for determining whether to perform the filtering process on the decoded image, and the process ends.

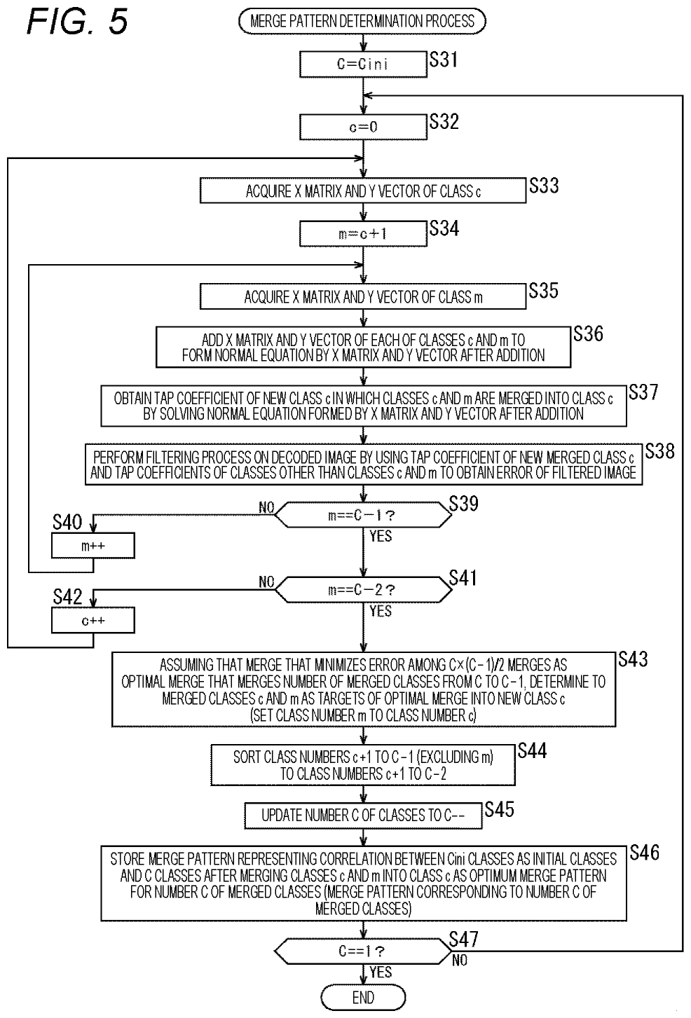

FIG. 5 is a flowchart describing the merge pattern determination process in step S21 of FIG. 4.

In step S31, the GALF sets the number Cini of initial classes (the number of classes of the initial class) as the initial value to (the variable representing) the number C of merged classes, and the process proceeds to step S32.

Here, in a case where the number C of merged classes is the number Cini of initial classes, it is a state where none of the initial classes are merged, but for convenience, it is treated as a state in which zero initial classes are merged.

Furthermore, in the GALF, the number Cini of initial classes is twenty five.

In step S32, the GALF sets the (variable representing) merged class c to 0, and the process proceeds to step S33. Here, in a case where the number C of merged classes is the number Cini of initial classes, the merged class c is the initial class c.

In step S33, the GALF acquires the X matrix and the Y vector that form the normal equation (established when obtaining the tap coefficient) of the merged class c, and the process proceeds to step S34.

Here, in a case where the number C of merged classes is the number Cini of initial classes, the merged class c is the initial class c. Thus, the normal equation of the merged class c is the normal equation of the initial class c obtained in step S13 (FIG. 4). In a case where the number C of merged classes is less than the number Cini of initial classes, the normal equation of the merged class c is the normal equation of the initial class c, the normal equation of the merged class c formed (formulated) in step S36 described later, or the normal equation of an initial class c′ or a normal equation of the merged class c′ formed in step S36, and is a normal equation whose class number is sorted by c in step S44 described later.

In step S34, the GALF sets c+1 in (a variable representing) a merged class m, and the process proceeds to step S35.

In step S35, the GALF acquires the X matrix and the Y vector that constitute the normal equation of the merged class m similarly to step S33, and the process proceeds to step S36.

In step S36, the GALF adds elements of the X matrix that constitutes the normal equation of the merged class c and the X matrix that constitutes the normal equation of the merged class m. Moreover, the GALF adds elements of the Y vector that constitutes the normal equation of the merged class c and the Y vector that constitutes the normal equation of the merged class m. Then, the GALF establishes a new normal equation of a new merged class c in which the merged classes c and m are merged, which is formed by the X matrix and the Y vector after addition, and the process proceeds from step S36 to step S37.

In step S37, the GALF obtains (calculates) the tap coefficient of the new merged class c by solving the normal equation of the new merged class c formed by the X matrix and the Y vector after addition, and the process proceeds to step S38.

In step S38, the GALF performs the filtering process on the decoded image by using the tap coefficient of the new merged class c and the tap coefficients of other than the merged classes c and m among C classes (C merged classes 1, 2, . . . , C). Then, the GALF obtains an error of the filtered image obtained by the filtering process with respect to the original image, and the process proceeds to step S39.

That is, in step S38, an error is obtained of the filtered image in a case where the filtering process is performed using the tap coefficient of C-1 merged classes obtained by merging the merged classes c and m into the new merged class c out of the C merged classes 1, 2, . . . , C.

In step S39, the GALF determines whether the merged class (class number thereof) m is equal to C-1.

In a case where it is determined in step S39 that the merged class m is not equal to C-1, that is, in a case where the merged class m is less than C-1, the process proceeds to step S40. In step S40, the GALF increments the merged class m by 1, the process returns to step S35, and a similar process is repeated thereafter.

On the other hand, in step S39, in a case where it is determined that the merged class m is equal to C-1, that is, in a case where the merged class c and each of the merged classes c+1, c+2, . . . , C are merged, and an error in the filtered image has been determined for each merge, the process proceeds to step S41.

In step S41, the GALF determines whether the merged class (class number thereof) c is equal to C−2.

In a case where it is determined in step S41 that the merged class c is not equal to C−2, that is, in a case where the merged class c is less than C−2, the process proceeds to step S42. In step S42, the GALF increments the merged class c by 1, the process returns to step S33, and a similar process is repeated thereafter.

On the other hand, in a case where it is determined in step S41 that the merged class c is equal to C−2, that is, in a case where C(C-1)/2 merges of merging any two merged classes have been performed for C merged classes 1, 2, . . . , C, and an error of the filtered image has been obtained for each of the C(C-1)/2 merges, the process proceeds to step S43.

In step S43, assuming that a merge having the minimum error of the filtered image in the C(C-1)/2 merges of merging any two merged classes of C merged classes 1, 2, . . . , C is an optimum merge that merges the number of merged classes from C to C-1, the GALF determines to merge the merged classes c and m as targets of the optimum merge into a new merged class c, and the process proceeds to step S44. That is, the GALF sets the class number m of the merged class m to the class number c of the new merged class c.

In step S44, the GALF converts the class numbers of the class numbers c+1 to C-1 excluding m into class numbers c+1 to C−2 in ascending order, and the process proceeds to step S45.

Note that because the class number m is set to the class number c in step S43, the class number m does not exist in the class numbers c+1 to C-1 when the process of step S44 is performed.

Furthermore, converting the class numbers of the class numbers c+1 to C-1 excluding m to the class numbers c+1 to C−2 in ascending order is also called series sorting.

In step S45, the GALF decrements the number C of merged classes by 1, and the process proceeds to step S46.

In step S46, assuming that a merge pattern representing the correspondence between the Cini initial classes and the C merged classes after merging the merged classes c and m into the new merged class c is an optimum merge pattern of the number C of merged classes, the GALF stores the optimum merge pattern of the number C of merged classes as a merge pattern corresponding to the number C of merged classes, and the process proceeds to step S47.

In step S47, the GALF determines whether the number C of merged classes is equal to one.

In a case where it is determined in step S47 that the number C of merged classes is not equal to one, the process returns to step S32, and a similar process is repeated thereafter.

Furthermore, in a case where it is determined in step S47 that the number C of merged classes is equal to one, the merge pattern determination process ends.

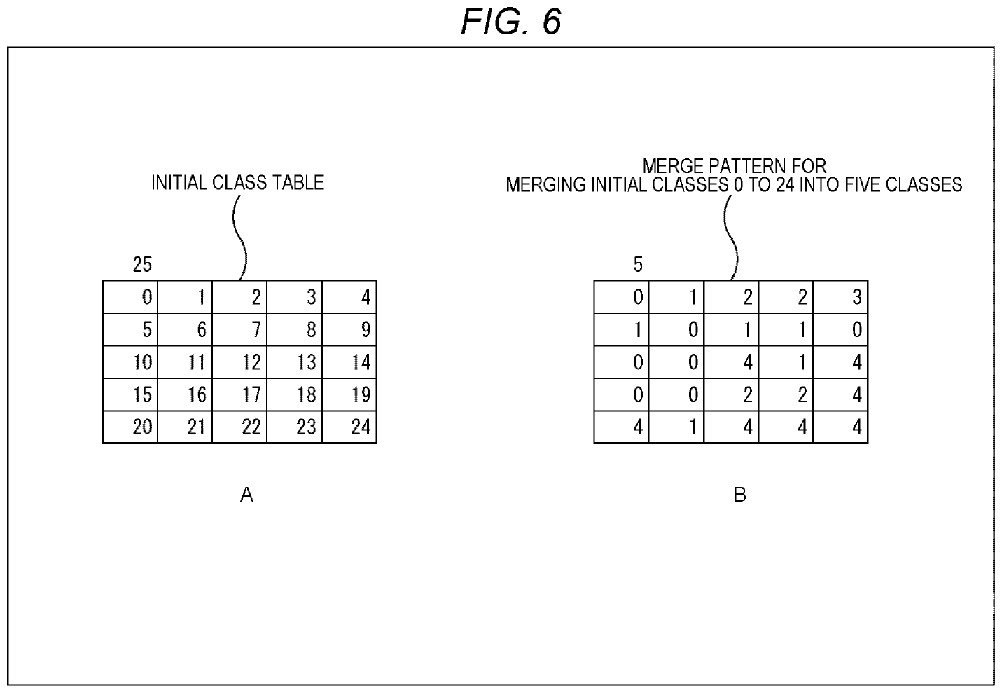

FIG. 6 is a diagram describing an example of an expression format of the merge pattern.

In the present embodiment, the merge pattern is expressed in an expression format as follows.

The merge pattern represents the correspondence between the initial classes and the merged classes in which the initial classes are merged, and is represented, for example, by arranging class numbers of the merged classes in which classes with the class numbers are merged in the order of the class numbers arranged in the initial class table.

The initial class table is a table in which the class numbers of the initial classes are arranged.

FIG. 6A illustrates the initial class table of the initial class obtained by the class classification of the GALF.

In the initial class table at A in FIG. 6, the class numbers 0 to 24 of twenty five initial classes obtained by the class classification of the GALF are arranged in ascending order.

B in FIG. 6 illustrates an example of a merge pattern.

As described above, in the merge pattern, the class numbers of the merged classes in which the classes with the class numbers are merged are arranged in the order of the class numbers arranged in the initial class table.

Therefore, the merge pattern of B in FIG. 6 represents that the initial classes 0 to 24 whose class numbers are arranged first to 25th in the initial class table are to be merged into the merged classes 0, 1, 2, 2, 3, 1, 0, 1, 1, 0, 0, 0, 4, 1, 4, 0, 0, 2, 2, 4, 4, 1, 4, 4, 4, respectively.

Note that in FIG. 6, the initial class table and the merge pattern are expressed in a 5×5 tabular format, but the expression format of the initial class table and the merge pattern is not limited to the tabular format, and may simply be an expression format such that the class numbers are arranged by separating with commas or spaces.

Further, in the present embodiment, in the drawing, the number of initial classes whose class numbers are arranged in the initial class table (number of initial classes) and the number of merged classes obtained by merging according to the merge pattern (number of merged classes) are indicated at upper parts of tables as the initial class table and the merge pattern as appropriate.

The number 25 on the upper left of the initial class table of A in FIG. 6 represents the number of initial classes, and the number 5 on the upper left of the merge pattern of B in FIG. 6 represents the number of merged classes.

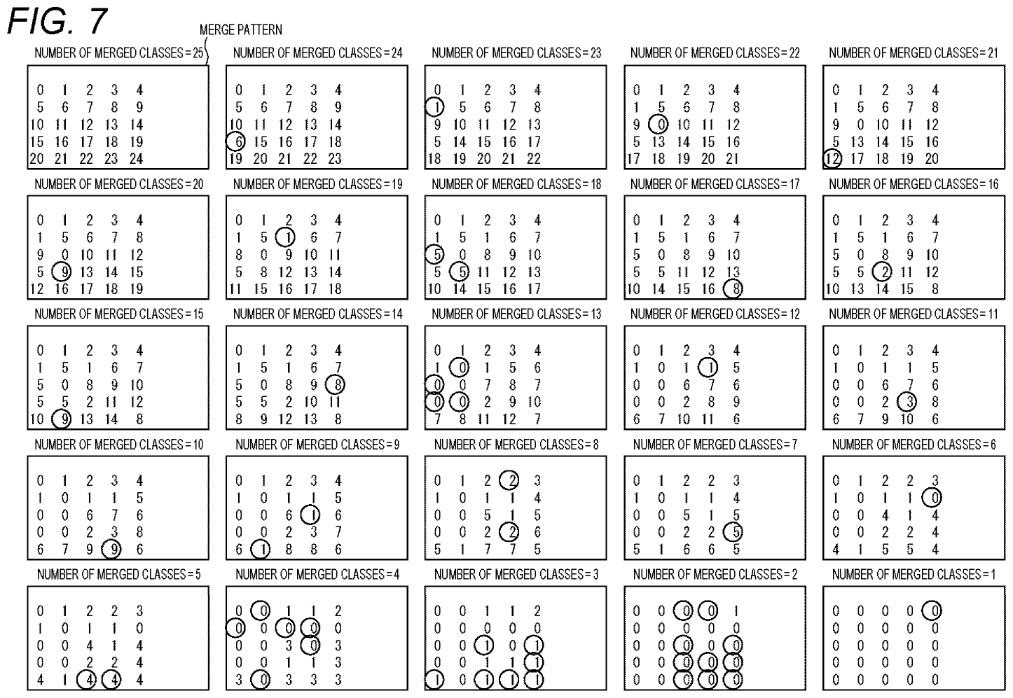

FIG. 7 is a diagram illustrating an example of a merge pattern for every number of merged classes.

That is, FIG. 7 illustrates an example of the optimum merge pattern for each number of merged classes, with each value of natural numbers equal to or less than the number of initial classes (number of initial classes) of twenty five obtained by the class classification of the GALF as the number of merged classes.

There are twenty five optimum merge patterns for respective numbers of merged classes for merging the initial classes obtained by the class classification of the GALF.

In FIG. 7, a circle attached to the merge pattern of the number C of merged classes represents a merged class that is merged into another merged class by merging the number of merged classes from C+1 to C among the merged classes obtained according to the merge pattern corresponding to the number C+1 of merged classes.

For example, in the merge pattern corresponding to the number of merged classes of twenty four, the class number 6 arranged 16th is circled. This represents that in a merge that changes the number of merged classes from twenty five to twenty four, the merged class with the class number 15 arranged 16th in the merge pattern corresponding to the number of merged classes of twenty five is merged into the merged class with the class number 6 arranged 16th in the merge pattern corresponding to the number of merged classes of twenty four (it is also the merged class with the class number 6 arranged seventh in the merge pattern corresponding to the number of merged classes of twenty four).

Note that among the merge patterns corresponding to the number of merged classes of twenty five that merge the initial classes obtained by the class classification of the GALF, none of the initial classes are merged in the merge patterns corresponding to the number of merged classes of twenty five, which is equal to the number of initial classes, but for convenience of explanation, the merge pattern corresponding to the number of merged classes of twenty five, which is equal to the number of initial classes, is treated as a merge pattern in which zero initial classes are merged. The merge pattern corresponding to the number of merged classes of twenty five is equal to the initial class table.

In the merge pattern determination process (FIG. 5), after merging the merged classes c and m into the new merged class c in step S43, series sorting of the class numbers is performed in step S44. Thus, in the merge pattern corresponding to each number of merged classes in FIG. 7, the maximum value of the class number is a value corresponding to the number C of merged classes, that is, the number C-1 of merged classes.

In the merge pattern determination process, while decrementing the number C of merged classes one by one, C(C-1)/2 merges of any two merged classes are performed for the merged class of the number C of merged classes obtained by the merge determined in the previous step S43. Then, out of the C(C-1)/2 merges, the merge that minimizes the error of the filtered image is determined as the optimum merge to the number C-1 of merged classes, and the merge pattern of the merge is determined as a merge pattern corresponding to the number C-1 of merged classes.

Note that there is one merge pattern in each of a case where the number C of merged classes is twenty five, which is the maximum in the class classification of the GALF, and a case where it is one, which is the minimum, and thus the respective one merge patterns of the case where the number C of merged classes is twenty five and the case where it is one become the merge pattern corresponding to the number of merged classes of twenty five and the merge pattern corresponding to the number of merged classes of one, respectively.

On the other hand, in a case where the number C of merged classes is either two or twenty four, as the number in a case where any two merged classes are merged among the merged classes of the number C of merged classes, there are C(C-1)/2. Thus, in the merge pattern determination process, the C(C-1)/2 merges are performed, and the filtering process is performed using the tap coefficient obtained by each merge to obtain the error of the filtered image. Then, the merge pattern of the merge that minimizes the error of the filtered image is determined by the merged class corresponding to the number C-1 of merged classes.

Therefore, in merging that changes the number C of merged classes from twenty five to twenty four, it is necessary to perform 25(25−1)/2=300 merges, and in merging that changes the number C of merged classes from twenty four to twenty three, it is necessary to perform 24(24−1)/2=276 merges. Similarly, in merging that changes the number C of merged classes from four to three, it is necessary to perform 4(4−1)/2=6 merges, and in merging that changes the number C of merged classes from three to two, it is necessary to perform 3(3−1)/2=3 merges.

In order to determine the merge pattern corresponding to each of the numbers C of merged classes of one to twenty five, it is necessary to perform a total of 2600 merges, which accordingly increases the processing amount of the merge pattern determination process.

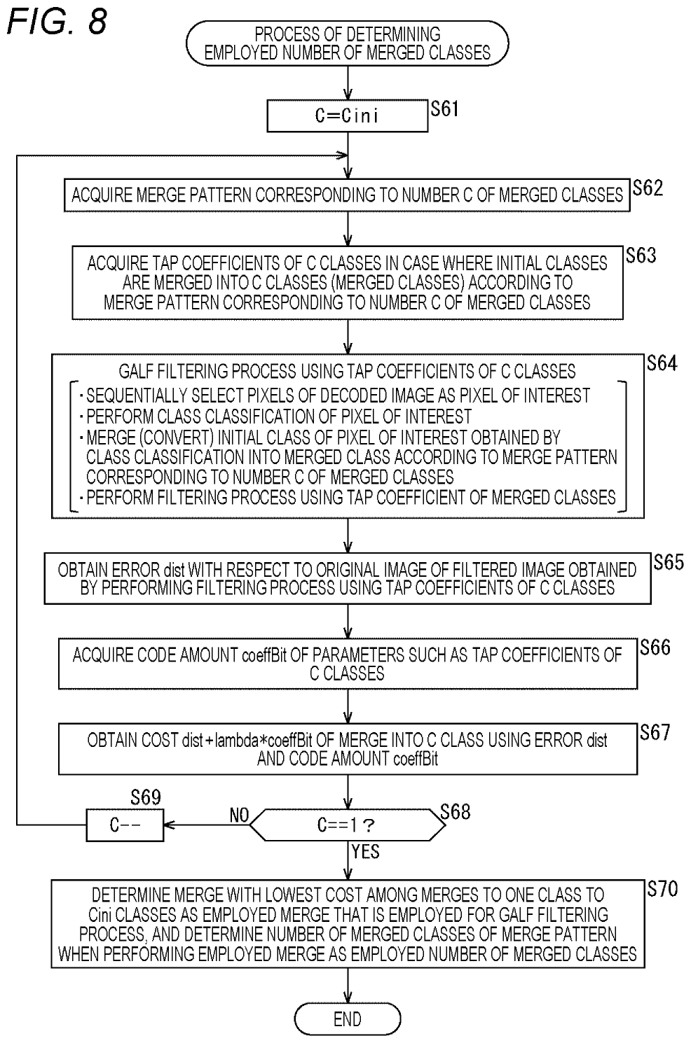

FIG. 8 is a flowchart describing the process of determining the employed number of merged classes in step S22 of FIG. 4.

In step S61, the GALF sets the number Cini of initial classes=25 to (the variable representing) the number C of merged classes, and the process proceeds to step S62.

In step S62, the GALF acquires (loads) the merge pattern corresponding to the number C of merged classes obtained in the merge pattern determination process (FIG. 5), and the process proceeds to step S63.

In step S63, the GALF acquires (loads) the tap coefficients of (the amount of) the C classes in a case where twenty five initial classes are merged into the merged classes of the C classes (C merged classes) according to the merge pattern corresponding to the number C of merged classes, and the process proceeds to step S64.

Here, the tap coefficients of the C classes (merged classes) in a case where twenty five initial classes are merged into the merged classes of the C classes according to the merge pattern corresponding to the number C of merged classes have already been determined in step S37 of the merge pattern determination process.

In step S64, the GALF performs the GALF filtering process using the tap coefficients of the C classes, and the process proceeds to step S65.

That is, the GALF sequentially selects the pixels of the decoded image as the pixel of interest, and performs the class classification of the pixel of interest (class classification with respect to the pixels of interest). Moreover, the GALF converts the initial class of the pixel of interest obtained by the class classification of the pixel of interest into a merged class according to the merge pattern corresponding to the number C of merged classes. Then, the GALF performs the filtering process using the tap coefficient of the merged class of the pixel of interest among the tap coefficients of the C classes acquired in step S63, to thereby obtain a filtered image.

In step S65, the GALF obtains an error dist with respect to the original image of the filtered image obtained by performing the filtering process using the tap coefficient of the merged class of the pixel of interest, and the process proceeds to step S66.

In step S66, the GALF obtains parameters necessary for the GALF filtering process in the decoding device, that is, the number C of merged classes, the merge pattern corresponding to the number C of merged classes, and a code amount coeffBit of the tap coefficient of the C class obtained by merging the initial classes according to the merge pattern, and the process proceeds to step S67.

In step S67, the GALF uses the error dist and the code amount coeffBit to obtain a cost of merge into C class, dist +lambda x coeffBit, for merging the initial class into the C class (the number C of merged classes), and the process proceeds to step S68. lambda is a value set according to the QP.

In step S68, the GALF determines whether the number C of merged classes is equal to one.

In a case where it is determined in step S68 that the number C of merged classes is not equal to one, the process proceeds to step S69. In step S69, the GALF decrements the number C of merged classes by one, the process returns to step S62, and a similar process is repeated thereafter.

Furthermore, in a case where it is determined in step S68 that the number C of merged classes is equal to one, the process proceeds to step S70. In step S70, the merge with the minimum cost among the merges to the one class to Cini classes is taken as an employed merge that is employed for the GALF filtering process, and the GALF determines the number of merged classes of the merge pattern when performing the employed merge as the employed number of merged classes, and the process of determining the employed number of merged classes ends.

As described above, in the process of determining the employed number of merged classes, the number of merged classes of the merge pattern that minimizes the cost among the merge patterns corresponding to each of the numbers of merged classes of one to twenty five obtained in the merge pattern determination process (FIG. 5) is determined as the employed number of merged classes.

In the GALF, in a case where the employed number of merged classes is a value other than one and twenty five, it is necessary that a merge pattern representing the correspondence between the twenty five initial classes and the merged classes of the employed number of merged classes is transmitted from the encoding device to the decoding device.

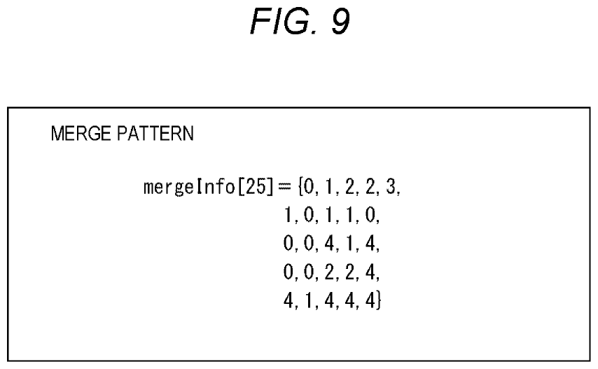

FIG. 9 is a diagram illustrating an example of the merge pattern transmitted from the encoding device to the decoding device.

In FIG. 9, the merge pattern is represented by an array variable mergelnfo[25], to which the class number of merged classes into which twenty five initial classes are merged is set.

In the array variable mergeInfo[25] in FIG. 9, the i-th number j from the beginning (left) represents that the initial class of the class number i is converted (merged) into the merged class of the class number j.

As described above, in the GALF, in the merge pattern determination process for determining the merge pattern corresponding to each of the number C of merged classes of one to twenty five, it is necessary to perform merging 2600 times, which increases the amount of processing. Moreover, in the CALF, it is necessary to transmit the merge pattern from the encoding device to the decoding device.

Accordingly, in the present technology, a merge pattern corresponding to the number of merged classes is set in advance for every number of merged classes, and the initial class is converted into a merged class according to the merge pattern set in advance.

<Example of Merge Pattern Set in Advance>

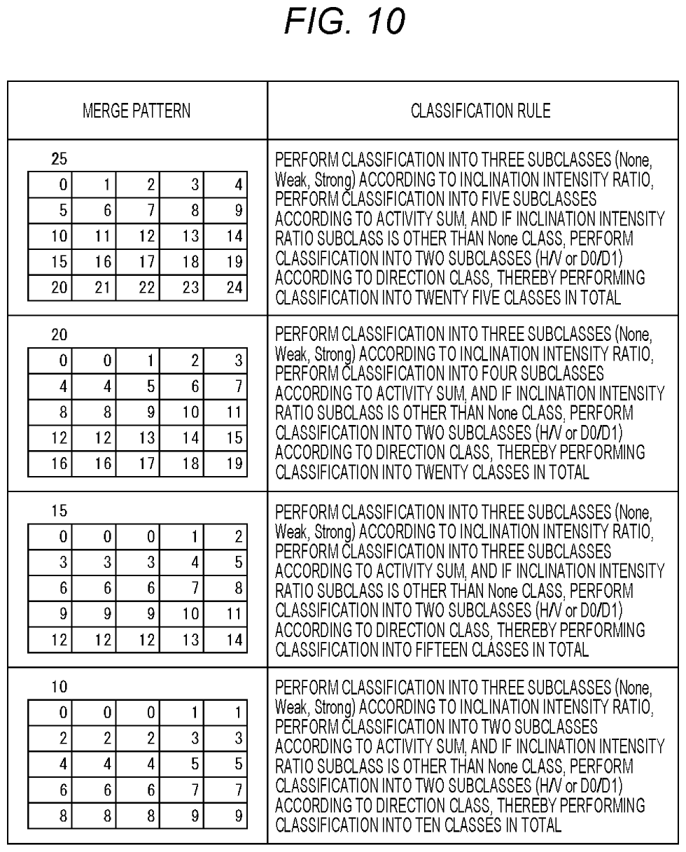

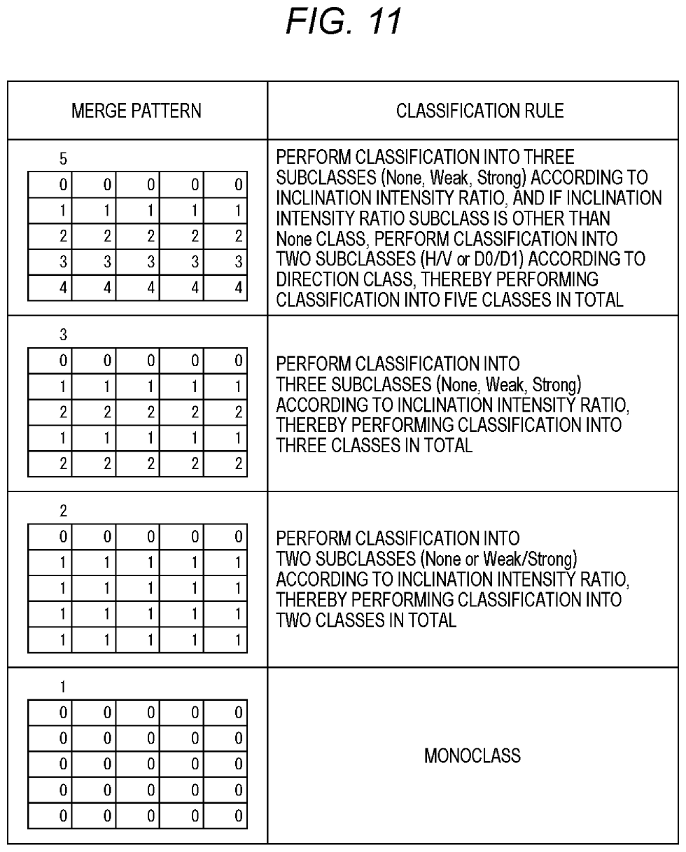

FIGS. 10 and 11 are diagrams illustrating a first example of the merge pattern set in advance.

That is, FIGS. 10 and 11 are diagrams illustrating examples of merge patterns that correspond to the numbers of merged classes of twenty five, twenty, fifteen, ten, five, three, two, and one and merge twenty five initial classes obtained by the class classification of the GALF.

In the present technology, as described above, for every number of merged classes, the merge pattern corresponding to this number of merged classes is set in advance, and the initial classes are converted into merged classes according to the merge pattern set in advance.

Therefore, it is not necessary to perform the merge pattern determination process performed by the GALF, and the processing amount can be reduced. Moreover, because the merge pattern is set in advance for every number of merged classes, if the number of merged classes is identified, the merge pattern is also uniquely identified. Therefore, by sharing the merge pattern set in advance between the encoding device and the decoding device, it is not necessary to transmit the merge pattern from the encoding device to the decoding device, and the encoding efficiency can be improved by an amount that the merge pattern does not need to be transmitted.

Note that the number of merged classes for which the merge pattern is set in advance does not have to be a continuous natural number, and may be a natural number with discrete values.

The merge pattern for every number of merged classes can be set by any method, but if the merge pattern is set by any method, performance of the filtering process may deteriorate and image quality of the filtered image may deteriorate. Here, performing predetermined class classification for classifying the pixel of interest into an initial class, and converting the initial class obtained by the predetermined class classification according to the merge pattern to obtain a merged class can be grasped as a class classification that classifies the pixel of interest into the merged class. In this case, the merge pattern that converts the initial class into the merged class can be regarded as determining classification rules (class classification method) for class classification into the merged class. Therefore, setting of the merge pattern can be performed by determining the classification rules of the class classification into the merged class.

Deterioration of performance of the filtering process can be suppressed by appropriately determining information that takes effect on the class classification into the merged class in information such as the feature amount of pixels used for the class classification to obtain the initial class, and classification rules of the class classification into the merged class, such as how to assign (a subclass of) the merged class to that information (for example, which merged class is assigned to which range of which feature quantity), and setting the merge pattern for every number of merged classes.

Accordingly, in the present technology, suppressing the deterioration of performance of the filtering process is set as a setting policy for setting the merge pattern, and the merge pattern corresponding to each number of merged classes is set by a setting rule that does not violate the setting policy.

As the setting rule for setting the merge pattern, it is possible to employ a reduction setting to set the merge pattern for every number of merged classes so that the number of classes decreases from the initial class obtained by the predetermined class classification.

Furthermore, as the setting rule, it is possible to employ a mixed setting to set the merge pattern for every number of merged classes as a mixture of a merge pattern for merging the initial classes obtained by the predetermined class classification and a merge pattern for merging initial classes obtained by another class classification.

Moreover, as the setting rule, it is possible to employ a statistical setting to set the merge pattern for every number of merged classes so that, in a case where an image for setting the merge pattern prepared in advance is encoded as an original image, one or both of the code amount of parameters required for the filtering process (the tap coefficient of every merged class and the employed number of merged classes) and errors in the filtered image with respect to the original image are statistically optimized.

In the statistical setting of the merge pattern, the image for setting the merge pattern can be used as the original image, for example, to perform the merge pattern determination process performed by the GALF offline in advance, and the merge pattern corresponding to each number of merged classes obtained in the merge pattern determination process performed offline can be set as the merge pattern for every number of merged classes.

FIGS. 10 and 11 illustrate an example of the reduction setting of the merge pattern.

In the reduction setting, the merge pattern for every number of merged classes is set so that the number of classes decreases from the initial class obtained by the predetermined class classification.

In FIGS. 10 and 11, for example, the class classification of the GALF is employed as the predetermined class classification.

In the reduction setting, a merge pattern for every number of merged classes can be set so that a merged class on which any one of pieces of information to be used for the predetermined class classification preferentially takes effect can be obtained.

In a case where the predetermined class classification is the class classification of the GALF, the information used for the class classification of the GALF includes the inclination intensity ratio, the direction class, and the activity sum (activity subclass) as described in FIGS. 1 to 3.

In the reduction setting, for example, the merge pattern for every number of merged classes can be set so that a merged class on which the inclination intensity ratio or the activity sum preferentially takes effect can be obtained. The merge patterns of FIGS. 10 and 11 are such that a merged class in which the inclination intensity ratio preferentially takes effect can be obtained.

In FIG. 10, the merge pattern corresponding to the number of merged classes of twenty five is a merge pattern for which a class is obtained as a merged class by a classification rule such that the pixel of interest is classified by the inclination intensity ratio subclass classification into one of the three subclasses, the none class, the weak class, and the strong class, according to the inclination intensity ratio, classified by the activity subclass classification into one of the five subclasses according to the activity sum and, in a case where the inclination intensity ratio subclass obtained by the inclination intensity ratio subclass classification according to the inclination intensity ratio is other than the none class, classified by the direction subclass classification into one of the two subclasses, the H/V class and the D0/D1 class, according to the direction class, and thereby classified into twenty five classes in total. That is, the merge pattern corresponding to the number of merged classes of twenty five is a merge pattern such that the same merged class as the initial class obtained by the class classification of the GALF can be obtained.

Here, the H/V class means the direction class 2 (a subclass representing that the inclination direction is the V direction or the H direction) described with reference to FIGS. 1 to 3. The D0/D1 class means the direction class 0 (a subclass representing that the inclination direction is the D0 direction or the D1 direction) described in FIGS. 1 to 3.

In FIG. 10, the merge pattern corresponding to the number of merged classes of twenty is a merge pattern for which a class is obtained as a merged class by a classification rule such that the pixel of interest is classified by the inclination intensity ratio subclass classification into one of the three subclasses, the none class, the weak class, and the strong class, according to the inclination intensity ratio, classified by the activity subclass classification into one of the four subclasses according to the activity sum and, in a case where the inclination intensity ratio subclass is other than the none class, classified by the direction subclass classification into one of the two subclasses, the H/V class and the D0/D1 class, according to the direction class, and thereby classified into twenty classes in total.

In FIG. 10, the merge pattern corresponding to the number of merged classes of fifteen is a merge pattern for which a class is obtained as a merged class by a classification rule such that the pixel of interest is classified by the inclination intensity ratio subclass classification into one of the three subclasses, the none class, the weak class, and the strong class, according to the inclination intensity ratio, classified by the activity subclass classification into one of the three subclasses according to the activity sum and, in a case where the inclination intensity ratio subclass is other than the none class, classified by the direction subclass classification into one of the two subclasses, the H/V class and the D0/D1 class, according to the direction class, and thereby classified into fifteen classes in total.

In FIG. 10, the merge pattern corresponding to the number of merged classes of ten is a merge pattern for which a class is obtained as a merged class by a classification rule such that the pixel of interest is classified by the inclination intensity ratio subclass classification into one of the three subclasses, the none class, the weak class, and the strong class, according to the inclination intensity ratio, classified by the activity subclass classification into one of the two subclasses according to the activity sum and, in a case where the inclination intensity ratio subclass is other than the none class, classified by the direction subclass classification into one of the two subclasses, the H/V class and the D0/D1 class, according to the direction class, and thereby classified into ten classes in total.

In FIG. 11, the merge pattern corresponding to the number of merged classes of five is a merge pattern for which a class is obtained as a merged class by a classification rule such that the pixel of interest is classified by the inclination intensity ratio subclass classification into one of the three subclasses, the none class, the weak class, and the strong class, according to the inclination intensity ratio and, in a case where the inclination intensity ratio subclass is other than the none class, classified by the direction subclass classification into one of the two subclasses, the H/V class and the D0/D1 class, according to the direction class, and thereby classified into five classes in total.

In FIG. 11, the merge pattern corresponding to the number of merged classes of three is a merge pattern for which a class is obtained as a merged class by a classification rule such that the pixel of interest is classified by the inclination intensity ratio subclass classification into one of the three subclasses, the none class, the weak class, and the strong class, according to the inclination intensity ratio, and thereby classified into three classes in total.

In FIG. 11, the merge pattern corresponding to the number of merged classes of two is a merge pattern for which a class is obtained as a merged class by a classification rule such that the pixel of interest is classified by the inclination intensity ratio subclass classification into one of the two subclasses, the none class and a weak-strong class, according to the inclination intensity ratio, and thereby classified into two classes in total.

Here, the weak-strong class is a class obtained by combining (merging) the weak class and the strong class in a case of performing the inclination intensity ratio subclass classification into one of the three subclasses, the none class, the weak class, and the strong class, according to the inclination intensity ratio.

In FIG. 11, the merge pattern corresponding to the number of merged classes of one is a merge pattern such that a class obtained by performing the class classification of the pixel of interest into one class can be obtained as a merged class. Here, performing the class classification of the pixel of interest into one class can be considered that the class classification is not performed, that is, there is no class. In the present embodiment, in a case of performing the class classification of the pixel of interest into one class, that one class will be also referred to as a monoclass. The merge pattern corresponding to the number of merged classes of one is a merge pattern such that the monoclass can be obtained as a merged class.

A method of setting the merge patterns of FIGS. 10 and 11 will be described by which a merged class on which the inclination intensity ratio preferentially takes effect can be obtained.

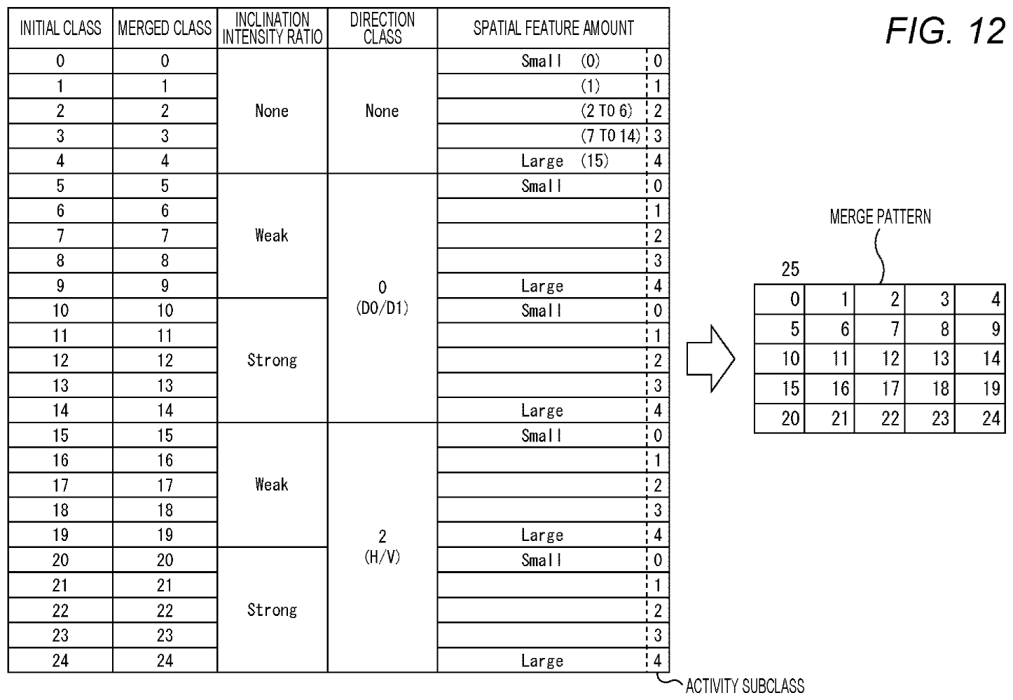

FIG. 12 is a diagram describing a method of setting the merge pattern corresponding to the number of merged classes of twenty five for merging twenty five initial classes obtained by the class classification of the GALF into twenty five merged classes

That is, FIG. 12 illustrates a classification rule for performing the class classification into merged classes obtained (by converting the initial classes) according to the merge pattern corresponding to the number of merged classes of twenty five in FIG. 10.

According to the classification rule of FIG. 12, similarly to the class classification of the GALE′ described in FIGS. 1 to 3, the pixel of interest is classified by the inclination intensity ratio subclass classification into one of the three subclasses, the none class, the weak class, and the strong class, according to the inclination intensity ratio, classified by the activity subclass classification into one of the five subclasses according to the activity sum as the spatial feature amount and, in a case where the inclination intensity ratio subclass is other than the none class, classified by the direction subclass classification into one of two subclasses, the H/V class and the D0/D1 class, according to the direction class, and thereby classified by the class classification into one of the merged classes 0 to 24.

In the classification rule in FIG. 12, in the activity subclass classification into one of the five subclasses, according to the index class_idx obtained from the activity sum as described in FIG. 3, the pixel of interest is classified into the activity subclass 0 (small class) in a case where the index class_idx is 0, classified into the activity subclass 1 in a case where the index class_idx is 1, classified into the activity subclass 2 in a case where the index class_idx is 2 to 6, classified into the activity subclass 3 in a case where the index class_idx is 7 to 14, and classified into the activity subclass 4 (large class) in a case where the index class_idx is 15.

Then, according to the classification rule of FIG. 12, in a case where the inclination intensity ratio subclass is the none class, the pixel of interest is classified into the merged class 0 when the activity subclass is 0, classified into the merged class 1 when the activity subclass is 1, classified into the merged class 2 when the activity subclass is 2, classified into the merged class 3 when the activity subclass is 3, and classified into the merged class 4 when the activity subclass is 4.

In a case where the inclination intensity ratio subclass is the weak class and the direction class is the D0/D1 class, the pixel of interest is classified into the merged class 5 when the activity subclass is 0, classified into the merged class 6 when the activity subclass is 1, classified into the merged class 7 when the activity subclass is 2, classified into the merged class 8 when the activity subclass is 3, and classified into the merged class 9 when the activity subclass is 4.

In a case where the inclination intensity ratio subclass is the strong class and the direction class is the D0/D1 class, the pixel of interest is classified into the merged class 10 when the activity subclass is 0, classified into the merged class 11 when the activity subclass is 1, classified into the merged class 12 when the activity subclass is 2, classified into the merged class 13 when the activity subclass is 3, and classified into the merged class 14 when the activity subclass is 4.

In a case where the inclination intensity ratio subclass is the weak class and the direction class is the H/V class, the pixel of interest is classified into the merged class 15 when the activity subclass is 0, classified into the merged class 16 when the activity subclass is 1, classified into the merged class 17 when the activity subclass is 2, classified into the merged class 18 when the activity subclass is 3, and classified into the merged class 19 when the activity subclass is 4.

In a case where the inclination intensity ratio subclass is the strong class and the direction class is H/V class, the pixel of interest is classified into the merged class 20 when the activity subclass is 0, classified into the merged class 21 when the activity subclass is 1, classified into the merged class 22 when the activity subclass is 2, classified into the merged class 23 when the activity subclass is 3, and classified into the merged class 24 when the activity subclass is 4.

The merged classes 0 to 24 obtained by the class classification according to the classification rule of FIG. 12 match the initial classes 0 to 24 obtained by the class classification of the GALF, respectively. Therefore, as the merge pattern corresponding to the number of merged classes of twenty five, a merge pattern that converts (merges) the initial classes 0 to 24 into the merged classes 0 to 24 can be set.

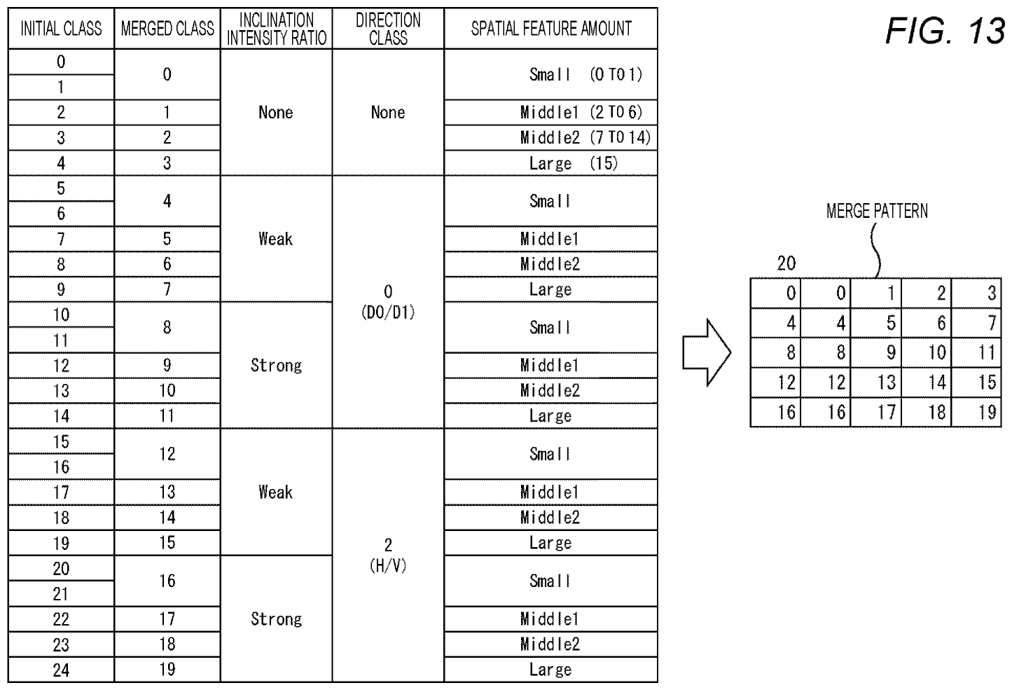

FIG. 13 is a diagram describing a method of setting the merge pattern corresponding to the number of merged classes of twenty for merging the twenty five initial classes obtained by the class classification of the GALF into twenty merged classes.

That is, FIG. 13 illustrates a classification rule for performing the class classification into merged classes obtained according to the merge pattern corresponding to the number of merged classes of twenty in FIG. 10.

According to the classification rule of FIG. 13, the pixel of interest is classified by the inclination intensity ratio subclass classification into one of the three subclasses, the none class, the weak class, and the strong class, according to the inclination intensity ratio, classified by the activity subclass classification into one of the four subclasses according to the activity sum as the spatial feature amount and, in a case where the inclination intensity ratio subclass is other than the none class, classified by the direction subclass classification into one of two subclasses, the H/V class and the D0/D1 class, according to the direction class, and thereby classified by the class classification into one of the merged classes 0 to 19. The classification rule in FIG. 13 is a rule in which the number of activity subclasses is reduced from five to four by merging the activity subclasses 0 and 1 in the classification rule in FIG. 12.

In the classification rule of FIG. 13, in the activity subclass classification into one of the four subclasses, according to the index class_idx obtained from the activity sum as described in FIG. 3, the pixel of interest is classified into a small class as an activity subclass in a case where the index class_idx is 0 or 1, classified into a middle 1 class as an activity subclass in a case where the index class_idx is 2 to 6, classified into a middle 2 class as an activity subclass in a case where the index class_idx is 7 to 14, and classified into a large class as an activity subclass in a case where the index class_idx is 15.

In the classification rule of FIG. 13, the number of activity subclasses is four, which is decreased by one from the number of activity subclasses of five in the initial class. Then, the small class matches the activity subclasses 0 and 1 in the initial class, and the middle 1 class, the middle 2 class, and the large class match the activity subclasses 2, 3, and 4 in the initial class, respectively.

In the classification rule in FIG. 13, the assignment of subclass to the activity sum is reduced by one subclass compared to the case of the class classification of the GALF, and thus the activity sum does not take effect on the class classification into the merged class by that amount. Consequently, according to the classification rule of FIG. 13, a merged class is obtained on which the inclination intensity ratio and the direction class take effect preferentially over the activity sum.

According to the classification rule of FIG. 13, in a case where the inclination intensity ratio subclass is the none class, the pixel of interest is classified into the merged class 0 when the activity subclass is the small class, classified into the merged class 1 when the activity subclass is the middle 1 class, classified into the merged class 2 when the activity subclass is the middle 2 class, and classified into the merged class 3 when the activity subclass is the large class.

In a case where the inclination intensity ratio subclass is the weak class and the direction class is the D0/D1 class, the pixel of interest is classified into the merged class 4 when the activity subclass is the small class, classified into the merged class 5 when the activity subclass is the middle 1 class, classified into the merged class 6 when the activity subclass is the middle 2 class, and classified into the merged class 7 when the activity subclass is the large class.

In a case where the inclination intensity ratio subclass is the strong class and the direction class is the D0/D1 class, the pixel of interest is classified into the merged class 8 when the activity subclass is the small class, classified into the merged class 9 when the activity subclass is the middle 1 class, classified into the merged class 10 when the activity subclass is the middle 2 class, and classified into the merged class 11 when the activity subclass is the large class.

In a case where the inclination intensity ratio subclass is the weak class and the direction class is the H/V class, the pixel of interest is classified into the merged class 12 when the activity subclass is the small class, classified into the merged class 13 when the activity subclass is the middle 1 class, classified into the merged class 14 when the activity subclass is the middle 2 class, and classified into the merged class 15 when the activity subclass is the large class.

In a case where the inclination intensity ratio subclass is the strong class and the direction class is the H/V class, the pixel of interest is classified into the merged class 16 when the activity subclass is the small class, classified into the merged class 17 when the activity subclass is the middle 1 class, classified into the merged class 18 when the activity subclass is the middle 2 class, and classified into the merged class 19 when the activity subclass is the large class.

In the classification rule of FIG. 13, the merged class 0 matches the initial classes 0 and 1 obtained by the class classification of the GALF, the merged classes 1 to 3 match the initial classes 2 to 4 obtained by the class classification of the GALF, respectively, the merged class 4 matches the initial classes 5 and 6 obtained by the class classification of the GALF, the merged classes 5 to 7 match the initial classes 7 to 9 obtained by the class classification of the GALF, respectively, the merged class 8 matches the initial classes 10 and 11 obtained by the class classification of the GALF, the merged classes 9 to 11 match the initial classes 12 to 14 obtained by the class classification of the GALF, respectively, the merged class 12 matches the initial classes 15 and 16 obtained by the class classification of the GALF, the merged classes 13 to 15 match the initial classes 17 to 19 obtained by the class classification of the GALF, respectively, the merged class 16 matches the initial classes 20 and 21 obtained by the class classification of the GALF, and the merged classes 17 to 19 match the initial classes 22 to 24 obtained by the class classification of the GALF, respectively.

Therefore, as the merge pattern corresponding to the number of merged classes of twenty, a merge pattern can be set that converts the initial classes 0 and 1 into the merged class 0, the initial classes 2 to 4 into the merged classes 1 to 3, respectively, the initial classes 5 and 6 into the merged class 4, the initial classes 7 to 9 into the merged classes 5 to 7, respectively, the initial classes 10 and 11 into the merged class 8, the initial classes 12 to 14 into the merged classes 9 to 11, respectively, the initial classes 15 and 16 into the merged class 12, the initial classes 17 to 19 into the merged classes 13 to 15, respectively, the initial classes 20 and 21 into the merged class 16, and the initial classes 22 to 24 into the merged classes 17 to 19, respectively.

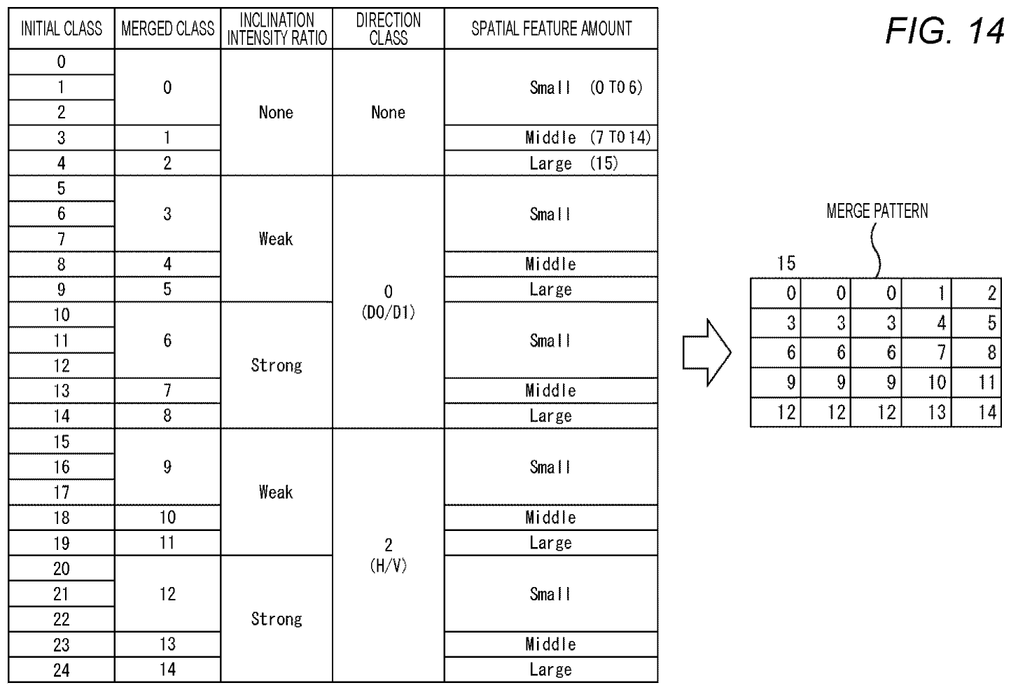

FIG. 14 is a diagram describing a method of setting the merge pattern corresponding to the number of merged classes of fifteen for merging the twenty five initial classes obtained by the class classification of the GALF into fifteen merged classes.

That is, FIG. 14 illustrates a classification rule for performing the class classification into merged classes obtained according to the merge pattern corresponding to the number of merged classes of fifteen in FIG. 10.

According to the classification rule of FIG. 14, the pixel of interest is classified by the inclination intensity ratio subclass classification into one of the three subclasses, the none class, the weak class, and the strong class, according to the inclination intensity ratio, classified by the activity subclass classification into one of the three subclasses according to the activity sum as the spatial feature amount and, in a case where the inclination intensity ratio subclass is other than the none class, classified by the direction subclass classification into one of two subclasses, the H/V class and the D0/D1 class, according to the direction class, and thereby classified by the class classification into one of the merged classes 0 to 14. The classification rule in FIG. 14 is a rule in which the number of activity subclasses is reduced from four to three by merging the small class and the middle 1 class as the activity subclass in the classification rule in FIG. 13.

In the classification rule of FIG. 14, in the activity subclass classification into one of the three subclasses, according to the index class_idx obtained from the activity sum as described in FIG. 3, the pixel of interest is classified into the small class as an activity subclass in a case where the index class_idx is 0 to 6, classified into the middle class as an activity subclass in a case where the index class_idx is 7 to 14, and classified into the large class as an activity subclass in a case where the index class_idx is 15.

In the classification rule of FIG. 14, the number of activity subclasses is three, which is decreased by two from the number of activity subclasses of five in the initial class. Then, the small class matches the activity subclasses 0 to 2 in the initial class, and the middle class and the large class match the activity subclasses of 3 and 4 in the initial class, respectively.

In the classification rule in FIG. 14, the assignment of subclass to the activity sum is reduced by two subclasses compared to the case of the class classification of the GALF, and thus the activity sum does not take effect on the class classification into the merged class by that amount. Consequently, according to the classification rule of FIG. 14, a merged class is obtained on which the inclination intensity ratio and the direction class take effect preferentially over the activity sum.

According to the classification rule of FIG. 14, in a case where the inclination intensity ratio subclass is the none class, the pixel of interest is classified into the merged class 0 when the activity subclass is the small class, classified into the merged class 1 when the activity subclass is the middle class, and classified into the merged class 2 when the activity subclass is the large class.

In a case where the inclination intensity ratio subclass is the weak class and the direction class is the D0/D1 class, the pixel of interest is classified into the merged class 3 when the activity subclass is the small class, classified into the merged class 4 when the activity subclass is the middle class, and classified into the merged class 5 when the activity subclass is the large class.

In a case where the inclination intensity ratio subclass is the strong class and the direction class is the D0/D1 class, the pixel of interest is classified into the merged class 6 when the activity subclass is the small class, classified into the merged class 7 when the activity subclass is the middle class, and classified into the merged class 8 when the activity subclass is the large class.

In a case where the inclination intensity ratio subclass is the weak class and the direction class is the H/V class, the pixel of interest is classified into the merged class 9 when the activity subclass is the small class, classified into the merged class 10 when the activity subclass is the middle class, and classified into the merged class 11 when the activity subclass is the large class.

In a case where the inclination intensity ratio subclass is the strong class and the direction class is the H/V class, the pixel of interest classified into merged class 12 when the activity subclass is the small class, classified into the merged class 13 when the activity subclass is the middle class, and classified into the merged class 14 when the activity subclass is the large class.

In the classification rule of FIG. 14, the merged class 0 matches the initial classes 0 to 2 obtained by the class classification of the CALF, the merged classes 1 and 2 match the initial classes 3 and 4 obtained by the class classification of the GALF, respectively, the merged class 3 matches the initial classes 5 to 7 obtained by the class classification of the GALF, the merged classes 4 and 5 match the initial classes 8 and 9 obtained by the class classification of the GALF, respectively, the merged class 6 matches the initial classes 10 to 12 obtained by the class classification of the CALF, the merged classes 7 to 8 match the initial classes 13 and 14 obtained by the class classification of the CALF, respectively, the merged class 9 matches the initial classes 15 to 17 obtained by the class classification of the CALF, the merged classes 10 and 11 match the initial classes 18 and 19 obtained by the class classification of the CALF, respectively, the merged class 12 matches the initial classes 20 to 22 obtained by the class classification of the CALF, and the merged classes 13 and 14 match the initial classes 23 and 24 obtained by the class classification of the CALF, respectively.

Therefore, as the merge pattern corresponding to the number of merged classes of fifteen, a merge pattern can be set that converts the initial classes 0 to 3 into the merged class 0, the initial classes 3 and 4 into the merged classes 1 and 2, respectively, the initial classes 5 to 7 into the merged class 3, the initial classes 8 and 9 into the merged classes 4 and 5, respectively, the initial classes 10 to 12 into the merged class 6, the initial classes 13 and 14 into the merged classes 7 and 8, respectively, the initial classes 15 to 17 into the merged class 9, the initial classes 18 and 19 into the merged classes 10 and 11, respectively, the initial classes 20 to 22 into the merged class 12, and the initial classes 23 and 24 into the merged classes 13 and 14, respectively.

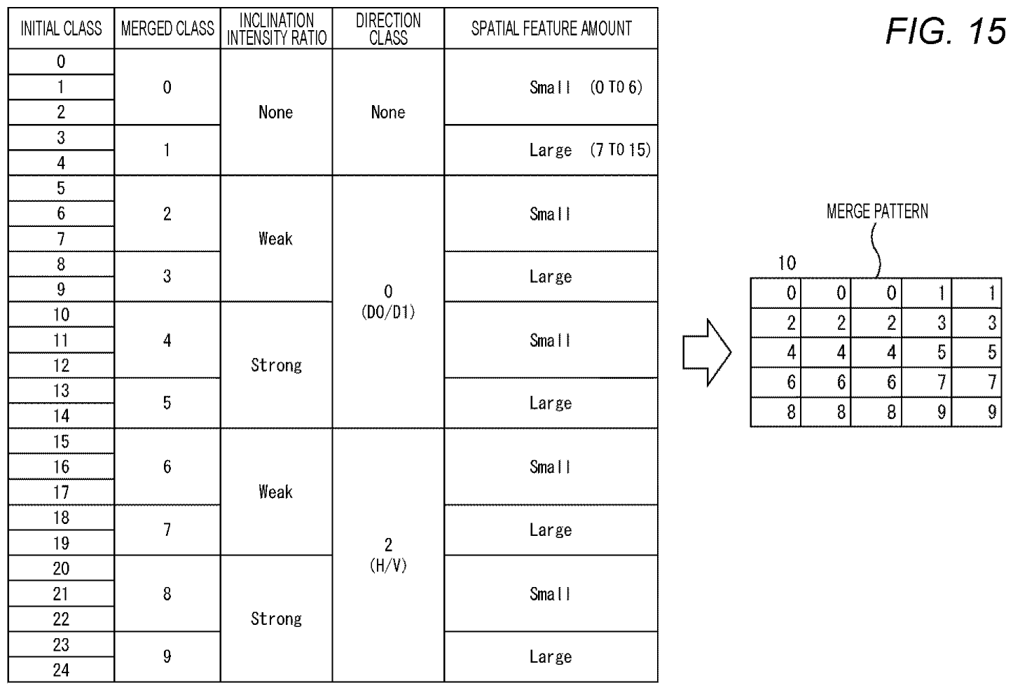

FIG. 15 is a diagram describing a method of setting the merge pattern corresponding to the number of merged classes of ten for merging the twenty five initial classes obtained by the class classification of the GALF into ten merged classes.

That is, FIG. 15 illustrates a classification rule for performing the class classification into merged classes obtained according to the merge pattern corresponding to the number of merged classes of ten in FIG. 10.

According to the classification rule of FIG. 15, the pixel of interest is classified by the inclination intensity ratio subclass classification into one of the three subclasses, the none class, the weak class, and the strong class, according to the inclination intensity ratio, classified by the activity subclass classification into one of the two subclasses according to the activity sum as the spatial feature amount and, in a case where the inclination intensity ratio subclass is other than the none class, classified by the direction subclass classification into one of two subclasses, the H/V class and the D0/D1 class, according to the direction class, and thereby classified by the class classification into one of the merged classes 0 to 14. The classification rule in FIG. 15 is a rule in which the number of activity subclasses is reduced from three to two by merging the middle class and the large class as the activity subclasses in the classification rule in FIG. 14.

In the classification rule of FIG. 15, in the activity subclass classification into one of the two subclasses, according to the index class_idx obtained from the activity sum as described in FIG. 3, the pixel of interest is classified into the small class as an activity subclass in a case where the index class_idx is 0 to 6, and classified into the large class as an activity subclass in a case where the index class_idx is 7 to 15.

In the classification rule of FIG. 15, the number of activity subclasses is two, which is decreased by three from the number of activity subclasses of five in the initial class (FIG. 3). Then, the small class matches the activity subclasses 0 to 2 in the initial class (FIG. 3), and the large class matches the activity subclasses 3 and 4 in the initial class.

In the classification rule in FIG. 15, the assignment of subclass to the activity sum is reduced by three subclasses compared to the case of the class classification of the GALF, and thus the activity sum does not take effect on the class classification into the merged class by that amount. Consequently, according to the classification rule of FIG. 15, a merged class is obtained on which the inclination intensity ratio and the direction class take effect preferentially over the activity sum.

According to the classification rule of FIG. 15, in a case where the inclination intensity ratio subclass is the none class, the pixel of interest is classified into the merged class 0 when the activity subclass is the small class, and classified into the merged class 1 when the activity subclass is the large class.

In a case where the inclination intensity ratio subclass is the weak class and the direction class is the D0/D1 class, the pixels of interest is classified into the merged class 2 when the activity subclass is the small class, and classified into the merged class 3 when the activity subclass is the large class.

In a case where the inclination intensity ratio subclass is the strong class and the direction class is the D0/D1 class, the pixel of interest is classified into the merged class 4 when the activity subclass is the small class, and classified into the merged class 5 when the activity subclass is the large class.

In a case where the inclination intensity ratio subclass is the weak class and the direction class is the H/V class, the pixel of interest is classified into the merged class 6 when the activity subclass is the small class, and classified into the merged class 7 when the activity subclass is the large class.

In a case where the inclination intensity ratio subclass is the strong class and the direction class is the H/V class, the pixel of interest is classified into the merged class 8 when the activity subclass is the small class, and classified into the merged class 9 when the activity subclass is the large class.

In the classification rule of FIG. 15, the merged class 0 matches the initial classes 0 to 2 obtained by the class classification of the GALF, the merged class 1 matches the initial classes 3 and 4 obtained by the class classification of the GALF, the merged class 2 matches the initial classes 5 to 7 obtained by the class classification of the GALF, the merged class 3 matches the initial classes 8 and 9 obtained by the class classification of the GALF, the merged class 4 matches the initial classes 10 to 12 obtained by the class classification of the GALF, the merged class 5 matches the initial classes 13 and 14 obtained by the class classification of the GALF, the merged class 6 matches the initial classes 15 to 17 obtained by the class classification of the GALF, the merged class 7 matches the initial classes 18 and 19 obtained by the class classification of the GALF, the merged class 8 matches the initial classes 20 to 22 obtained by the class classification of the GALF, and the merged class 9 matches the initial classes 23 and 24 obtained by the class classification of the GALF.

Therefore, as the merge pattern corresponding to the number of merged classes of ten, a merge pattern can be set that converts the initial classes 0 to 3 into the merged class 0, the initial classes 3 and 4 into the merged class 1, the initial classes 5 to 7 into the merged class 2, the initial classes 8 and 9 into the merged class 3, respectively, the initial classes 10 to 12 into the merged class 4, the initial classes 13 and 14 into the merged class 5, the initial classes 15 to 17 into the merged class 6, the initial classes 18 and 19 into the merged class 7, the initial classes 20 to 22 into the merged class 8, and the initial classes 23 and 24 into the merged class 9.

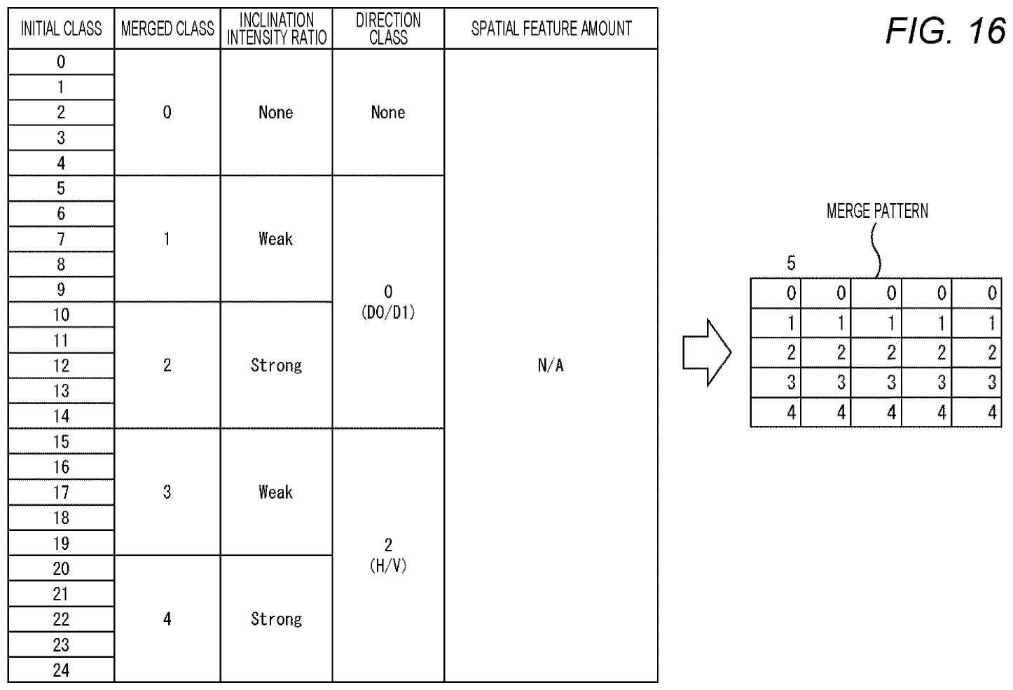

FIG. 16 is a diagram describing a method of setting the merge pattern corresponding to the number of merged classes of five for merging the twenty five initial classes obtained by the class classification of the GALF into five merged classes.

That is, FIG. 16 illustrates a classification rule for performing the class classification into merged classes obtained according to the merge pattern corresponding to the number of merged classes of ten in FIG. 11.

According to the classification rule of FIG. 16, the pixel of interest is classified into one of the three subclasses, the none class, the weak class, and the strong class by the inclination intensity ratio subclass classification, according to the inclination intensity ratio and, in a case where the inclination intensity ratio subclass is other than the none class, classified by the direction subclass classification into one of the two subclasses, the H/V class and the D0/D1 class, according to the direction class, and thereby classified by the class classification into one of the merged classes 0 to 4. The classification rule in FIG. 16 is a rule in which the number of activity subclasses is reduced from two to one by merging the small class and the large class as the activity subclasses in the classification rule of FIG. 15.

Therefore, in the classification rule of FIG. 16, the activity sum as the spatial feature amount does not take effect on the classification into the merged class. That is, in the classification rule of FIG. 16, only the inclination intensity ratio and the direction class among the inclination intensity ratio, the direction class, and the activity sum take effect on the class classification into the merged class.

According to the classification rule of FIG. 16, in a case where the inclination intensity ratio subclass is the none class, the pixel of interest is classified into the merged class 0.

In a case where the inclination intensity ratio subclass is the weak class and the direction class is the D0/D1 class, the pixel of interest is classified into the merged class 1.

In a case where the inclination intensity ratio subclass is the strong class and the direction class is the D0/D1 class, the pixel of interest is classified into the merged class 2.

In a case where the inclination intensity ratio subclass is the weak class and the direction class is the H/V class, the pixel of interest is classified into the merged class 3.

In a case where the inclination intensity ratio subclass is the strong class and the direction class is the H/V class, the pixel of interest is classified into the merged class 4.

In the classification rule of FIG. 16, the merged class 0 matches the initial classes 0 to 4 obtained by the class classification of the GALF, the merged class 1 matches the initial classes 5 to 9 obtained by the class classification of the GALF, the merged class 2 matches the initial classes 10 to 14 obtained by the class classification of the GALF, the merged class 3 matches the initial classes 15 to 19 obtained by the class classification of the GALF, and the merged class 4 matches the initial classes 20 to 24 obtained by the class classification of the GALF.

Therefore, as the merge pattern corresponding to the number of merged classes of five, a merge pattern can be set that separately converts the initial classes 0 to 4 into the merged class 0, the initial classes 5 to 9 into the merged class 1, the initial classes 10 to 14 into the merged class 2, the initial classes 15 to 19 into the merged class 3, respectively, and the initial classes 20 to 24 into the merged class 4.

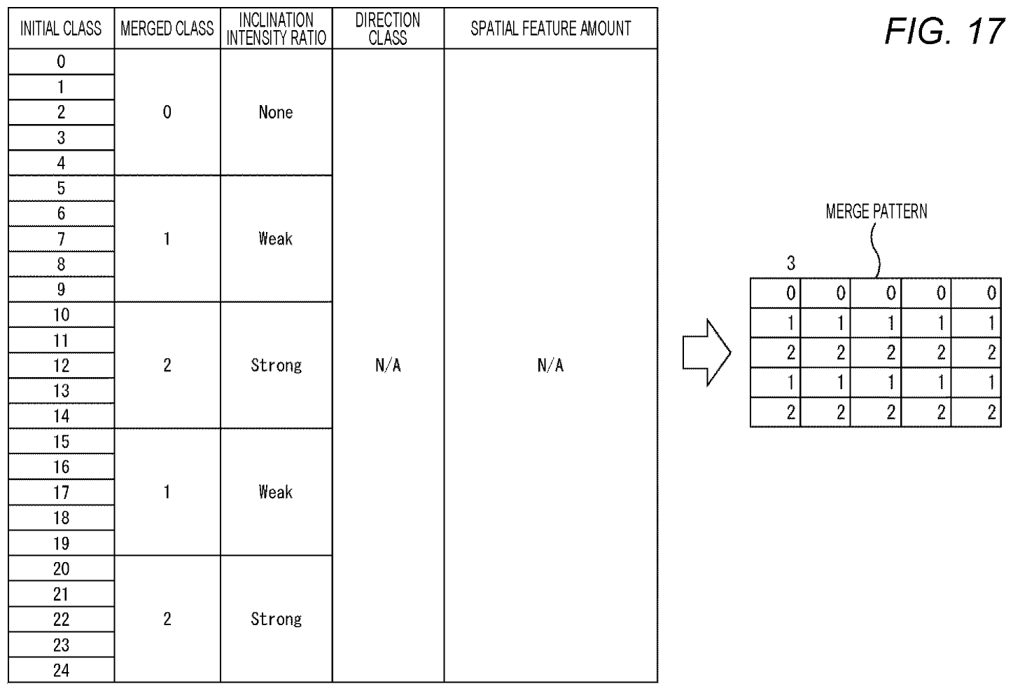

FIG. 17 is a diagram describing a method of setting the merge pattern corresponding to the number of merged classes of three for merging the twenty five initial classes obtained by the class classification of the GALF into three merged classes.

That is, FIG. 17 illustrates a classification rule for performing the class classification into merged classes obtained according to the merge pattern corresponding to the number of merged classes of three in FIG. 11.

According to the classification rule of FIG. 17, the pixel of interest is classified by the inclination intensity ratio subclass classification into one of the three subclasses, the none class, the weak class, and the strong class, according to the inclination intensity ratio, and thereby classified by the class classification into one of the merged classes 0 to 2. The classification rule of FIG. 17 is a rule in which the number of direction classes is reduced from 2 to 1 by merging the D0/D1 class and the H/V class as the direction classes in the classification rule of FIG. 16.

Therefore, in the classification rule of FIG. 17, the activity sum as the direction class and the spatial feature amount does not take effect on the class classification into the merged class. That is, in the classification rule of FIG. 17, only the inclination intensity ratio among the inclination intensity ratio, the direction class, and the activity sum takes effect on the class classification into the merged class.

According to the classification rule of FIG. 17, in a case where the inclination intensity ratio subclass is the none class, the pixel of interest is classified into the merged class 0.

In a case where the inclination intensity ratio subclass is the weak class, the pixel of interest is classified into the merged class 1, and in a case where the inclination intensity ratio subclass is the strong class, the pixel of interest is classified into the merged class 2.

In the classification rule of FIG. 17, the merged class 0 matches the initial classes 0 to 4 obtained by the class classification of the GALF, the merged class 1 matches the initial classes 5 to 9 and 15 to 19 obtained by the class classification of the GALF, and the merged class 2 matches the initial classes 10 to 14 and 20 to 24 obtained by the class classification of the GALF.

Therefore, as the merge pattern corresponding to the number of merged classes of three, a merge pattern can be set that converts the initial classes 0 to 4 into the merged class 0, the initial classes 5 to 9 and 15 to 19 into the merged class 1, and the initial classes 10 to 14 and 20 to 24 into the merged class 2.

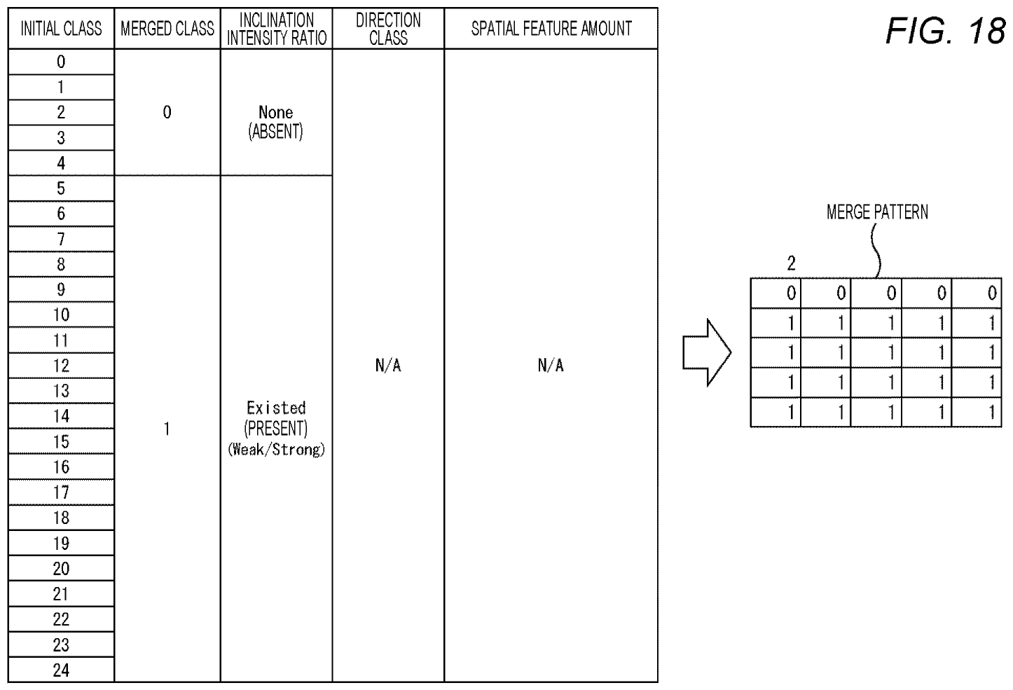

FIG. 18 is a diagram describing a method of setting the merge pattern corresponding to the number of merged classes of two for merging the twenty five initial classes obtained by the class classification of the GALF into two merged classes.

That is, FIG. 18 illustrates a classification rule for performing the class classification into merged classes obtained according to the merge pattern corresponding to the number of merged classes of two in FIG. 11.

According to the classification rule of FIG. 18, the pixel of interest is classified by the inclination intensity ratio subclass classification into one of the two subclasses, the none class and the weak-strong class, according to the inclination intensity ratio, and thereby classified by the class classification into one of the merged classes 0 and 1. The classification rule of FIG. 18 is a rule in which the number of inclination intensity ratio subclasses is reduced from three to two by merging the weak class and the strong class as the inclination intensity ratio subclasses in the classification rule of FIG. 17.

In the classification rule of FIG. 18, the number of inclination intensity ratio subclasses obtained by the inclination intensity ratio subclass classification is two, which is decreased from the number of inclination intensity ratio subclasses in the initial class of three. The none class in the classification rule of FIG. 18 matches the none class in the initial class, and the weak-strong class matches the weak class and the strong class in the initial class.

Therefore, in the classification rule of FIG. 18, the activity sum as the direction class and the spatial feature amount does not take effect on the class classification into the merged class, similarly to the classification rule of FIG. 17. That is, in the classification rule of FIG. 18, only the inclination intensity ratio among the inclination intensity ratio, the direction class, and the activity sum takes effect on the class classification into the merged class.

According to the classification rule of FIG. 18, in a case where the inclination intensity ratio subclass is the none class, the pixel of interest is classified into the merged class 0, and in a case where the inclination intensity ratio subclass is the weak-strong class, the pixel of interest is classified into the merged class 1. In this case, the pixel of interest is classified into a texture pixel and a non-texture pixel.

In the classification rule of FIG. 18, the merged class 0 matches the initial classes 0 to 4 obtained by the class classification of the GALF, and the merged class 1 matches the initial classes 5 to 24 obtained by the class classification of the CALF.

Therefore, as the merge pattern corresponding to the number of merged classes of two, a merge pattern can be set that converts the initial classes 0 to 4 into the merged class 0 and the initial classes 5 to 24 into the merged class 1.

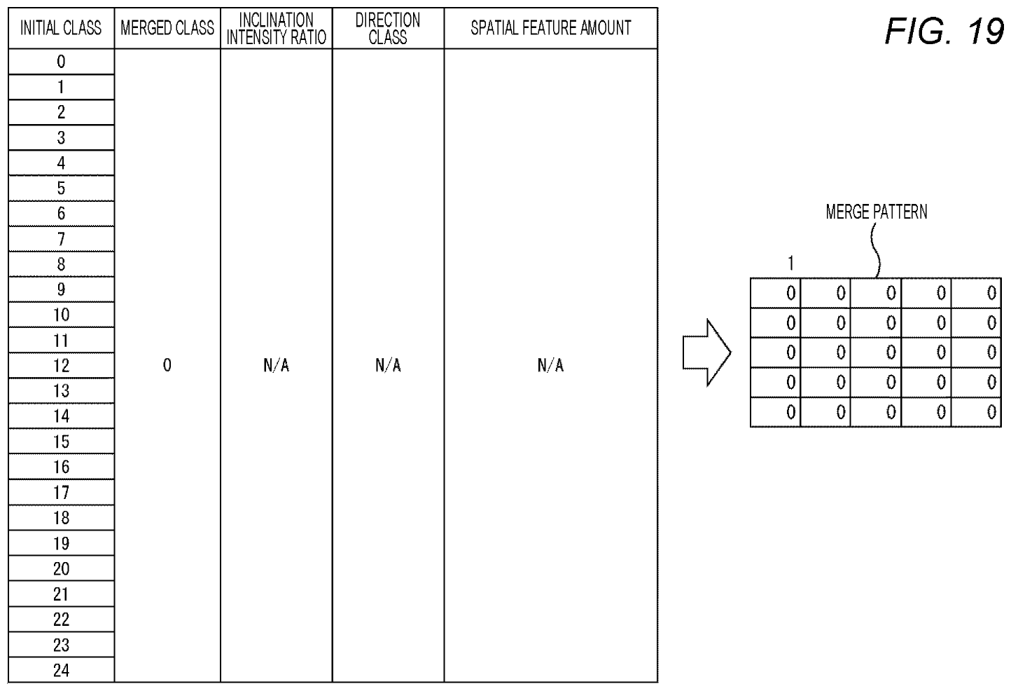

FIG. 19 is a diagram describing a method of setting the merge pattern corresponding to the number of merged classes of one for merging the twenty five initial classes obtained by the class classification of the GALF into one merged class.

That is, FIG. 19 illustrates a classification rule for performing the class classification into merged classes obtained according to the merge pattern corresponding to the number of merged classes of one in FIG. 11.

According to the classification rule of FIG. 19, the pixel of interest is always classified into the merged class 0 as the monoclass. The classification rule in FIG. 19 is a rule in which the number of inclination intensity ratio subclasses is reduced from two to one by merging the none class and the weak-strong class as the inclination intensity ratio subclass in the classification rule in FIG. 18.

In the classification rule of FIG. 19, the merged class 0 matches the initial classes 0 to 24 obtained by the class classification of the GALF.

Therefore, as the merge pattern corresponding to the number of merged classes of one, a merge pattern that converts the initial classes 0 to 24 to the merged class 0 can be set.

In the merge pattern settings corresponding to the numbers of merged classes of twenty five, twenty, fifteen, ten, five, three, two, and one illustrated in FIGS. 10 to 19, the inclination intensity ratio subclasses in the class classification of the GALF are not merged as much as possible, and thus according to such a merge pattern, a merged class on which the inclination intensity ratio preferentially takes effect can be obtained.

In the merge pattern setting, as described above, besides the merge pattern such that the merged class on which the inclination intensity ratio takes effect preferentially can be obtained, it is possible to set the merge pattern such that the merged class on which a feature amount other than the inclination intensity ratio, for example, the activity sum preferentially takes effect can be obtained.

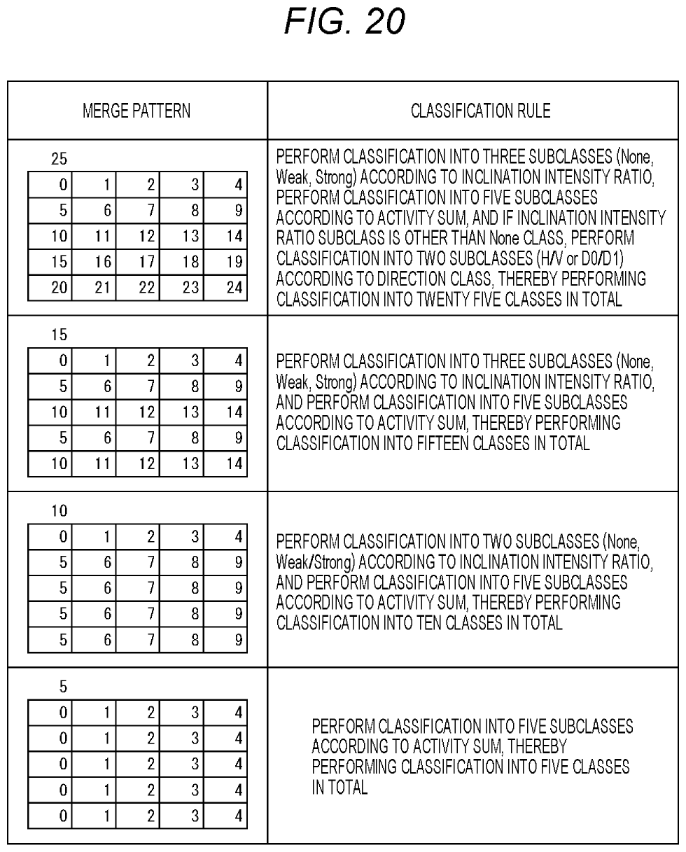

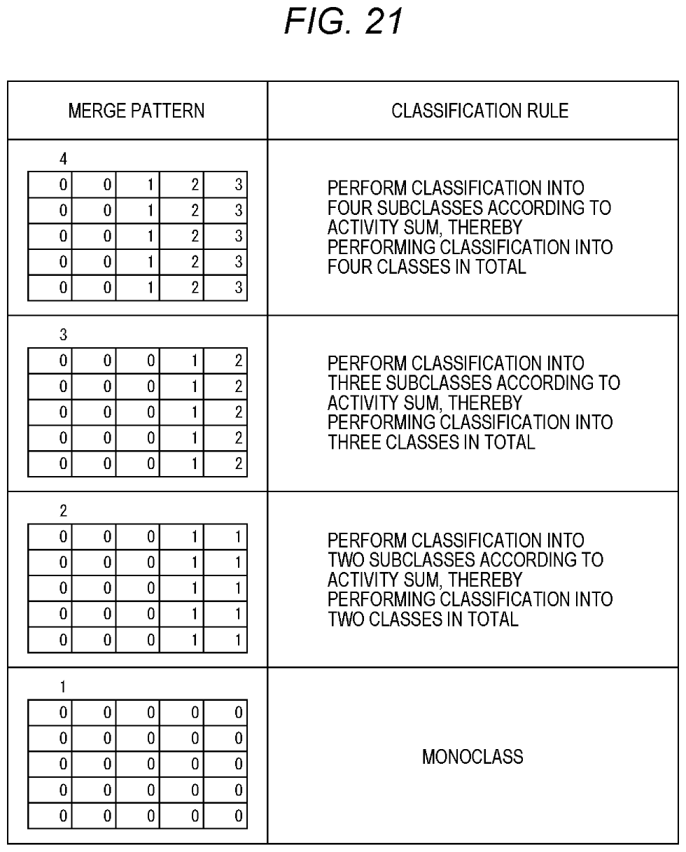

FIGS. 20 and 21 are diagrams illustrating a second example of the merge pattern set in advance.

That is, FIGS. 20 and 21 are diagrams illustrating examples of merge patterns corresponding to the numbers of merged classes of twenty five, fifteen, ten, five, four, three, two, and one for merging twenty five initial classes obtained by the class classification of the GALF.

The merge patterns of FIGS. 20 and 21 are set by the reduction setting similarly to the merge pattern of FIGS. 10 and 11. However, the merge patterns of FIGS. 10 and 11 are merge patterns such that the merged class on which the inclination intensity ratio preferentially takes effect can be obtained, whereas the merge patterns of FIGS. 20 and 21 are merge patterns such that the merged class on which the activity sum preferentially takes effect can be obtained.

In FIG. 20, the merge pattern corresponding to the number of merged classes of twenty five is a merge pattern for which a class is obtained as a merged class by a classification rule such that the pixel of interest is classified by the inclination intensity ratio subclass classification into one of the three subclasses, the none class, the weak class, and the strong class, according to the inclination intensity ratio, classified by the activity subclass classification into one of the five subclasses (activity subclasses 0 to 4) according to the activity sum and, in a case where the inclination intensity ratio subclass obtained by the inclination intensity ratio subclass classification according to the inclination intensity ratio is other than the none class, classified by the direction subclass classification into one of the two subclasses, the H/V class and the D0/D1 class, according to the direction class, and thereby classified into twenty five classes in total. That is, the merge pattern corresponding to the number of merged classes of twenty five is a merge pattern such that the same merged class as the initial class obtained by the class classification of the GALF can be obtained.

In FIG. 20, the merge pattern corresponding to the number of merged classes of fifteen is a merge pattern such that the pixel of interest is classified by the inclination intensity ratio subclass classification into one of the three subclasses, the none class, the weak class, and the strong class, according to the inclination intensity ratio, and classified by the activity subclass classification into one of the five subclasses according to the activity sum, and thereby the class obtained by the classification rule for performing classification into fifteen classes in total can be obtained as a merged class.

The direction class does not take effect on the class classification into the merged class because the direction class is not used in the classification rule for performing the class classification into merged classes obtained according to the merge pattern corresponding to the number of merged classes of fifteen. Note that the same applies to the merge patterns with the numbers of merged classes of ten, five, four, three, two, and one in FIGS. 20 and 21 described below.

In FIG. 20, the merge pattern corresponding to the number of merged classes of ten is a merge pattern for which a class is obtained as a merged class by a classification rule such that the pixel of interest is classified by the inclination intensity ratio subclass classification into one of the two subclasses, the none class and the weak-strong class, according to the inclination intensity ratio, and classified by the activity subclass classification into one of the five subclasses according to the activity sum, and thereby classified into ten classes in total.

In the classification rule for performing the class classification into merged classes obtained according to the merge pattern corresponding to the number of merged classes of ten, the assignment of subclass to the inclination intensity ratio is reduced by one subclass compared to the case of the class classification of the GALF, and thus the inclination intensity ratio does not take effect on the class classification into the merged class by that amount. Consequently, according to the merge pattern corresponding to the number of merged classes of ten, a merged class on which the activity sum takes effect preferentially over the inclination intensity ratio is obtained. Note that the same applies to the merge patterns with the numbers of merged classes of five, four, three, and two in FIGS. 20 and 21 described below.

In FIG. 20, the merge pattern corresponding to the number of merged classes of five is a merge pattern for which a class is obtained as a merged class by a classification rule such that the pixel of interest is classified by the activity subclass classification into one of the five subclasses according to the activity sum, and thereby classified into five classes in total.

In FIG. 21, the merge pattern corresponding to the number of merged classes of four is a merge pattern for which a class is obtained as a merged class by a classification rule such that the pixel of interest is classified by the activity subclass classification into one of the four subclasses according to the activity sum, and thereby classified into four classes in total.

Note that as the four subclasses obtained by the activity subclass classification here, the small class, the middle 1 class, the middle 2 class, and the large class described in FIG. 13 can be employed.

In FIG. 21, the merge pattern corresponding to the number of merged classes of three is a merge pattern for which a class is obtained as a merged class by a classification rule such that the pixel of interest is classified by the activity subclass classification into one of the three subclasses according to the activity sum, and thereby classified into three classes in total.

Note that as the three subclasses obtained by the activity subclass classification here, the small class, the middle class, and the large class described in FIG. 14 can be employed.

In FIG. 21, the merge pattern corresponding to the number of merged classes of two is a merge pattern for which a class is obtained as a merged class by a classification rule such that the pixel of interest is classified by the activity subclass classification into one of the two subclasses according to the activity sum, and thereby classified into two classes in total.

Note that as the two subclasses obtained by the activity subclass classification here, the small class and the large class described in FIG. 15 can be employed.

In FIG. 21, the merge pattern corresponding to the number of merged classes of one is always a merge pattern in which the merged class 0 as a monoclass can be obtained.

In the above, it is decided to employ the class classification of the GALF as the class classification for obtaining the initial class (hereinafter, also referred to as the initial class classification), but as the initial class classification, a class classification other than the class classification of the GALF may be employed.

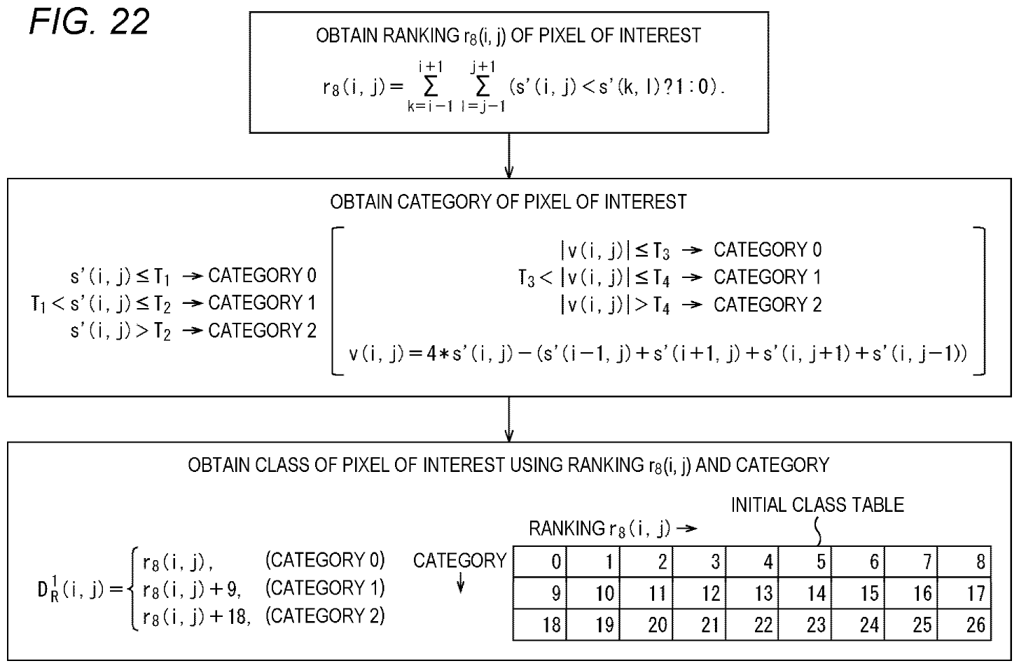

FIG. 22 is a diagram describing class classification using ranking as the feature amount of the pixel of interest, that is, the class classification of JVET-J0014.

In the classification using ranking, ranking r₈(i, j) of the pixel of interest is obtained according to an equation r₈(i, j)=ΣΣ(s′(i, j)<s′(k, 1)? 1:0).

Here, in the equation r₈(i, j)=ΣΣ(s¹(i, j)<s′(k, 1)?1:0), (i, j) is the position of the pixel of interest (for example, the i-th position from the left and the j-th position from the top). s′(i, j) represents a pixel value (for example, luminance) of the pixel at the position (i, j). A first summation (Σ) on the right side represents a summation in which k is changed to an integer from i−1 to i+1, and a second summation represents a summation in which 1 is changed to an integer from j−1 to j+1. (X?1:0) means to take 1 in a case where X is true and take 0 in a case where X is false.

According to the equation r₈(i, j)=ΣΣ(s′(i, j)<s′(k, 1)?1:0), the more the pixels with a pixel value larger than the pixel of interest exist around the pixel of interest, the larger the ranking r₈(i, j) of the pixel of interest. r₈(i, j) takes an integer value in the range 0 to 8.

In the classification using the ranking, the category of the pixel of interest is obtained. For example, in a case where an equation s′(i, j)<=T₁ is satisfied, the category of the pixel of interest is (category) 0. In a case where an expression T₁<s′(i, j)<=T₂ is satisfied, the category of the pixel of interest is 1, and in a case where an expression T₂<s′(i, j) is satisfied, the category of the pixel of interest is 2.

Note that the category of the pixel of interest can be obtained as follows.

That is, in a case where an expression |v(i, j)|<=T₃ is satisfied, the category of the pixel of interest can be (category) 0, in a case where the expression T₃<|v(i, j)|<=T₄ is satisfied, the category of the pixel of interest can be 1, and in a case where the expression |v(i, j)|>T₄ is satisfied, the category of the pixel of interest can be 2.

Here, T₁, T₂, T₃, and T₄ are thresholds set in advance. T₁ and T₂ have the relation of an expression T₁<T₂, and T₃ and T₄ have the relation of an expression T₃<T₄. Furthermore, v(i, j) is expressed as v(i, j)=4×s′(i, j)−(s′(i−1, j)+s′(i+1, j)+s′(i, j+1)+s′(i, j−1)).

In the class classification using the ranking, a class D¹_{R}(i, j) of the pixel of interest is obtained by using the ranking r₈(i, j) of the pixel of interest and the category. In a case where the category of the pixel of interest is 0, the class of class number D¹R(i, j)=r₈(i, j) is obtained as the class of the pixel of interest. In a case where the category of the pixel of interest is 1, the class of class number D¹_{R}(i, j)=re(i, j)+9 is obtained as the class of the pixel of interest. In a case where the category of the pixel of interest is 2, the class of class number D¹_{R}(i, j)=r₈(i,j)+18 is obtained as the class of the pixel of interest.

As described above, in the classification using the ranking, the pixel of interest is classified by the class classification into one of twenty-seven classes of classes 0 to 26.

FIG. 22 illustrates an example of an initial class table in which the class obtained by the class classification using the ranking is the initial class. The initial class table in FIG. 22 is a table in which the horizontal axis is r₈(i, j) and the vertical axis is a category.

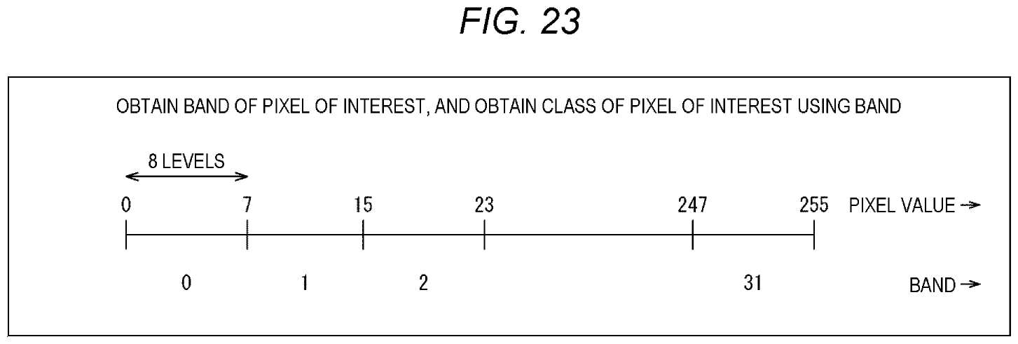

FIG. 23 is a diagram describing a class classification using a pixel value as the feature amount of the pixel of interest, that is, the class classification of JVET-J0018.

In the class classification using a pixel value, a dynamic range of pixel values is divided into bands of the same size, for example. The pixel of interest is classified according to which band the pixel value of the pixel of interest belongs to.

In FIG. 23, the dynamic range of pixel values is 256=2⁸ levels, and is divided into thirty two bands by bands with sizes of eight levels. Then, the class number from 0 is assigned from the band with the smallest pixel value. In the class classification using the pixel value, the pixel of interest is classified into the class of a class number assigned to a band to which the pixel value of the pixel of interest belongs.

In this case, the pixel of interest is classified by the class classification into one of thirty two classes of classes 0 to 31.

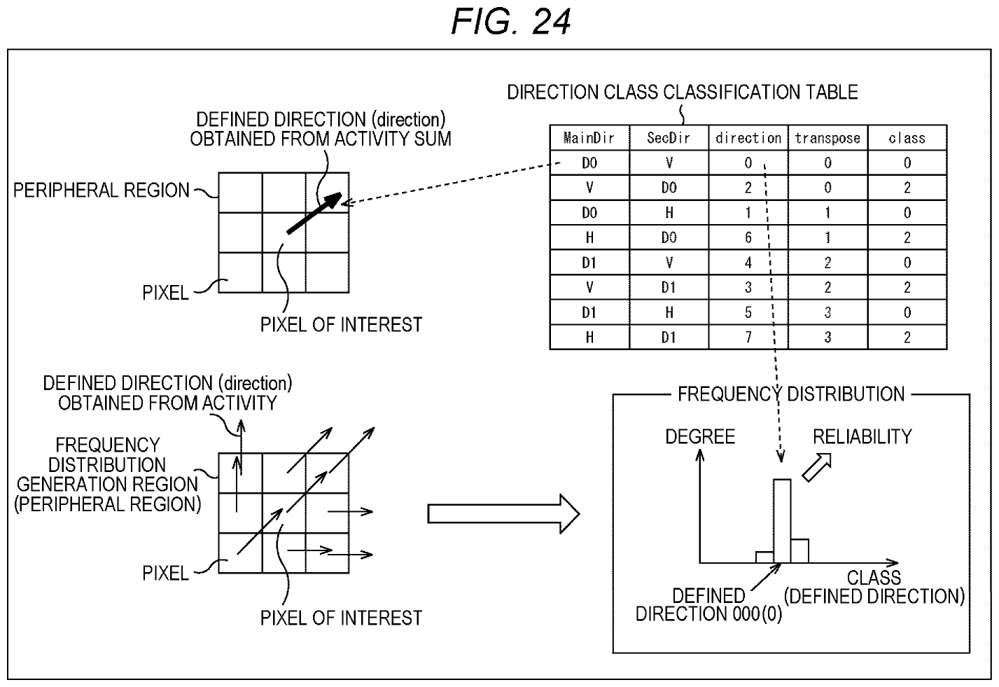

FIG. 24 is a diagram describing class classification using reliability of the inclination direction as a feature amount of the pixel of interest.

In the class classification using the reliability, for example, the direction as the defined direction of the pixel of interest is obtained (set) similarly to the GALF.

That is, in the class classification using the reliability, by applying the Laplacian filter to a decoded image, for example, respective activities A(V), A(H), A(D0), and A(D1) in four directions of the V direction, the H direction, the D0 direction, and the D1 direction of each of 3×3 pixels horizontal x vertical as a peripheral region, which are centered on the pixel of interest, are obtained.

Moreover, in the class classification using reliability, respective activity sums sumA(H), sumA(D0), and sumA(D1) in the four directions are obtained by adding activities A(D) of the 3×3 pixels as a peripheral region in each of the four directions, with respect to the pixel of interest.

Then, in the class classification using the reliability, for the respective activity sums sumA(H), sumA(D0), and sumA(D1) in the four directions with respect to the pixel of interest, MainDir and SecDir are obtained (set) as explained in FIG. 2, and the direction assigned to the MainDir and SecDir in the direction class classification table is obtained (set) as the defined direction of the pixel of interest.

Furthermore, in the class classification using the reliability, a frequency distribution in the inclination direction (defined direction) is generated for the pixel of interest.

That is, in the class classification using the reliability, by applying the Laplacian filter to the decoded image, the frequency distribution generation region including the pixel of interest, for example, the respective activities A(V), A(H), A(D0), and A(D1) in the four directions of the V direction, the H direction, the D0 direction, and the D1 direction of each of the 3×3 pixels horizontal x vertical, which are centered on the pixel of interest, are obtained.

Here, the frequency distribution generation region is a pixel region used to generate the frequency distribution in a defined direction. Here, for simplicity of description, the frequency distribution generation region is assumed as a region that coincides with the peripheral region. In a case where the frequency distribution generation region matches the peripheral region, as the respective activities A(V), A(H), A(D0), and A(D1) in the four directions of each of the 3×3 pixels in the frequency distribution generation region, the respective activities A(V), A(H), A(D0), and A(D1) in the four directions of each of the 3×3 pixels in the peripheral region obtained when obtaining the direction as the defined direction of the pixel of interest can be used as they are.

In the class classification using the reliability, for example, the eight directions of the GALF described in FIG. 1 are used as defining directions representing the class of the frequency distribution, with respect to the pixel of interest, for a defined direction as a target that is represented by the direction of the GALF obtained (set) for the respective activities A(V), A(H), A(D0), and A(D1) in the four directions of each of 3×3 pixels in the frequency distribution generation region, a frequency distribution in the defined direction is generated by counting the frequency in the defined direction.

That is, in the class classification using the reliability, instead of the respective activity sums sumA(H), sumA(D0), and sumA(D1) in the four directions, the respective activities A(V), A(H), A(D0), and A(D1) in the four directions are used to obtain the MainDir and SecDir for each of the 3×3 pixels in the frequency distribution generation region, as described in FIG. 2. Moreover, in the class classification using the reliability, the directions assigned to the MainDir and SecDir are obtained as the defined directions of pixels for each of the 3×3 pixels in the frequency distribution generation region, as described in FIG. 2.

Then, in the class classification using the reliability, the frequency distribution in the defined direction with respect to the pixel of interest is generated by counting the frequency in the defined direction obtained (set) for each of the 3×3 pixels in the frequency distribution generation region as described above.

Thereafter, in the class classification using the reliability, in the frequency distribution in the defined direction with respect to the pixel of interest, the value corresponding to the frequency of (the class of) the direction as the defined direction of the pixel of interest is obtained (set) as reliability in the defined direction of the pixel of interest.

In FIG. 24, the defined direction of the pixel of interest is a defined direction 000 (defined direction to which 0 in decimal number (000 in binary number) is assigned) among the defined directions as the directions of the eight directions of the GALF, and a value corresponding to the frequency in the defined direction 000 is obtained (set) as the reliability in the defined direction of the pixel of interest in the frequency distribution in the defined direction with respect to the pixel of interest.

In the class classification using the reliability, for example, the reliability in the defined direction of the pixel of interest is used and, for example, using the class classification of the GALF, the pixel of interest is classified in one of twenty five classes of final classes 0 to 24 similar to those of the class classification of the GALF.

Note that, here, the reliability in the defined direction as the inclination direction of the pixel of interest is obtained by using the frequency distribution in the inclination direction of the pixels in the frequency distribution generation region, but as the reliability in the inclination direction of the pixel of interest besides that, for example, it is possible to employ a value or the like representing a likelihood of the inclination direction of the pixel of interest of a value or the like corresponding to the sum total of absolute value or squares of an inner product of a vector representing the inclination direction of the pixel of interest and each of vectors representing the inclination directions of the plurality of pixels around the pixel of interest, or the like.

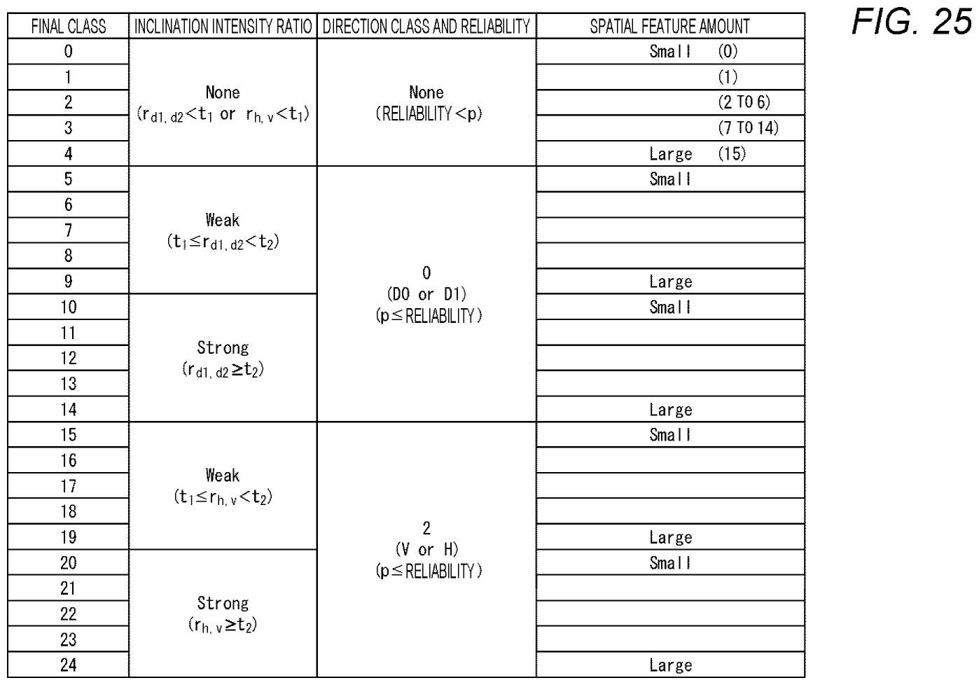

FIG. 25 is a diagram describing the final classes obtained by the class classification using the reliability.

In the class classification using the reliability, the direction subclass classification is performed similarly to the class classification of the GALF. However, in the class classification using the reliability, the direction subclass classification is performed also according to the reliability of the defined direction besides the direction as the defined direction of the pixel of interest.

Therefore, in FIG. 25, as the direction class, besides the direction classes 0 (D0/D1 class) and 2 (H/V class), none class indicating that the reliability is low is prepared.

In a case where the reliability of the pixel of interest in the defined direction is less than a threshold p, the pixel of interest is classified by the direction subclass classification into the direction class of the none class in the class classification using the reliability. Then, in the classification using the reliability, the pixel of interest is classified by the class classification into one of the final classes 0 to 4 similarly to the class classification of the GALF according to the activity sums sumA(V), sumA(H), sumA(D0), and sumA(D1) in the V direction, the H direction, the D0 direction, and the D1 direction as the spatial feature amounts of the pixel of interest.

In a case where the reliability of the pixel of interest in the defined direction is equal to or greater than the threshold p, in the class classification using the reliability, the image of interest is classified by the direction subclass classification into the direction class 0 or 2 according to the direction as the defined direction of the pixel of interest, similarly to the class classification of the GALF.

In the direction subclass classification, in a case where the pixel of interest is classified into the direction class 0 or 2, in the class classification using the reliability, the inclination intensity ratio of equation (2) or equation (3) is obtained similarly to the class classification of the GALF. Then, the inclination intensity ratio subclass classification for obtaining the class representing the inclination intensity ratio of the pixel of interest is performed according to the inclination intensity ratio.

Thereafter, similarly to the class classification of the GALF described in FIG. 3, the pixel of interest is classified by the class classification into one of the final classes 0 to 24 according to the direction class 0 or 2, the none class, weak class, or strong class obtained as a result of the inclination intensity ratio subclass classification, and the activity sums sumA(V), sumA(H), sumA(D0), and sumA(D1) in the V direction, H direction, D0 direction, and D1 direction as the spatial feature amounts of the pixel of interest.

Note that the threshold p of the reliability in the defined direction can be set according to the number of pixels in the frequency distribution generation region. For example, in a case where the frequency itself of the frequency distribution in the defined direction is employed as the reliability in the defined direction, when the frequency distribution generation region is a region of 6×6 pixels, the threshold p can be set to, for example, ¼ or ⅛ of the number the pixels (36 pixels for example) of the frequency distribution generation region.

It can be said that the class classification in FIG. 25 is a class classification in which the reliability in the inclination direction (defined direction) is introduced into the class classification of the GALF in FIG. 3. According to the class classification in FIG. 25, by classifying the pixels according to the reliability in the inclination direction, in a case where the reliability of the inclination direction is low, that is, the reliability of the direction indicating the inclination direction is low, it is possible to prevent classifying the pixels into the direction class 0 or 2 by the direction subclass classification according to such a direction, and thus classifying the pixels into a direction class that does not correspond to the inclination direction. Consequently, the pixels can be classified into an appropriate class (final class), and the tap coefficient of that class can be used to perform the filtering process as an appropriate prediction process. Therefore, performance of the filtering process can be improved.

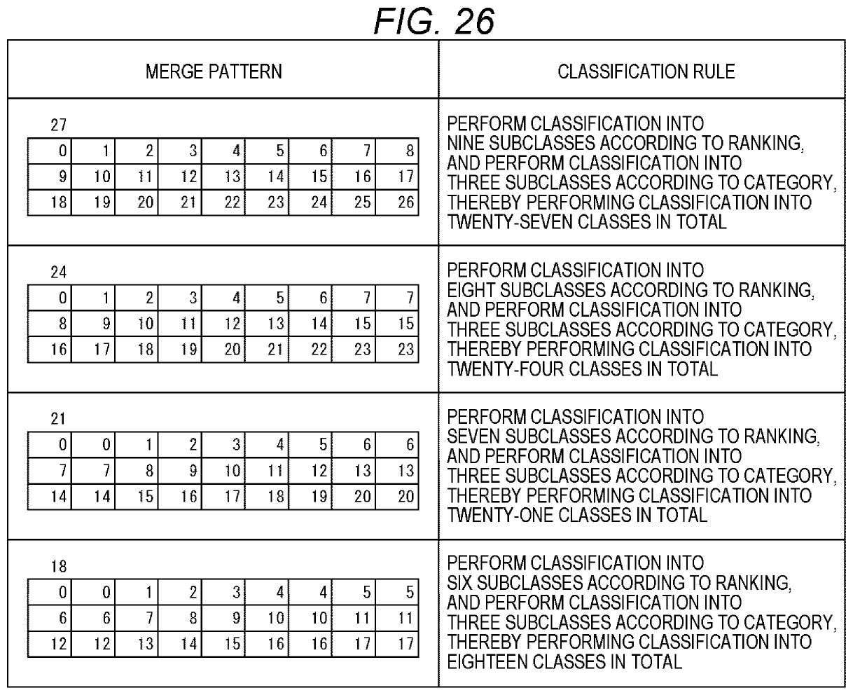

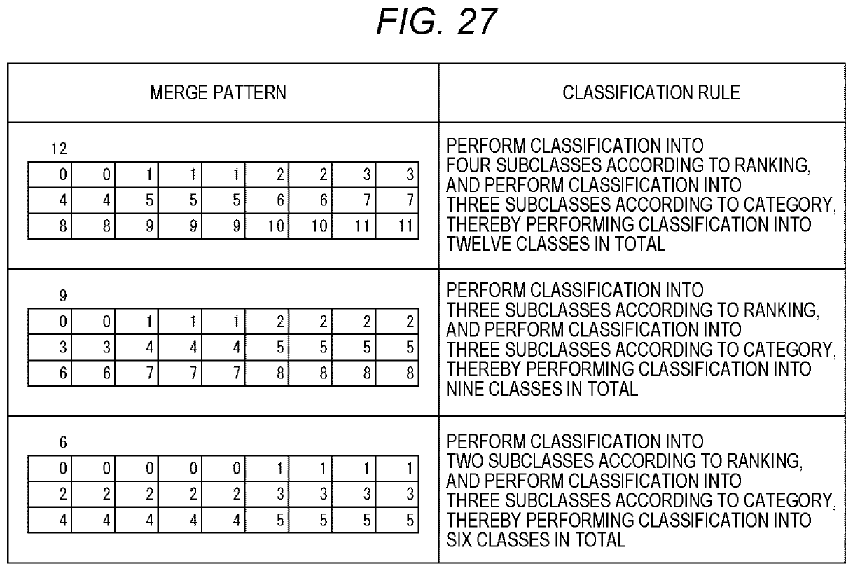

FIGS. 26 and 27 are diagrams illustrating a third example of the merge pattern set in advance.

That is, FIGS. 26 and 27 are diagrams illustrating examples of merge patterns corresponding to the numbers of merged classes of twenty-seven, twenty four, twenty one, eighteen, twelve, nine, and six that merge twenty-seven initial classes obtained by the class classification using the ranking described in FIG. 22.

The merge patterns of FIGS. 26 and 27 are set by the reduction setting similarly to the merge patterns of FIGS. 10 and 11 and 20 and 21.

Here, in the class classification using the ranking, it can be said that there is employed a classification rule for performing classification into twenty-seven classes in total by classifying the pixel of interest by the subclass classification into one of the nine subclasses representing that the ranking r₈(i, j) is 0 to 9 according to the ranking, and classifying the pixel of interest by the subclass classification into one of the three subclasses representing that the category is 0 or 2 according to the category.

In FIGS. 26 and 27, the merge pattern corresponding to the number of merged classes of twenty-seven is a merge pattern for which a class is obtained as a merged class by a classification rule such that the pixels of interest is classified by the subclass classification into the nine subclasses according to the ranking, classified by the subclass classification into the three subclasses according to the category, and thereby classified into twenty-seven classes in total. That is, the merge pattern corresponding to the number of merged classes of twenty seven is a merge pattern such that the same merged class as the initial class obtained by the class classification using the ranking can be obtained.

In FIGS. 26 and 27, each of the merge patterns corresponding to the numbers of merged classes of twenty four, twenty one, eighteen, twelve, nine, and six is a merge pattern for which a class is obtained as a merged class by a classification rule such that the pixel of interest is classified by the subclass classification into eight, seven, six, four, three, and two subclasses according to the ranking, and classified by the subclass classification into one of three subclasses according to the category, and thereby classified into twenty four, twenty one, eighteen, twelve, nine, and six classes in total.

Note that as the number of merged classes of the merge pattern for merging twenty-seven initial classes obtained by the class classification using the ranking, besides twenty-seven, twenty four, twenty one, eighteen, twelve, nine, and six, for example, fifteen, three, and one can be employed.

As the merge pattern corresponding to the number of merged classes of fifteen, a merge pattern can be employed for which a class is obtained as a merged class by a classification rule such that the pixels of interest is classified by the subclass classification into the five subclasses according to the ranking, and classified by the subclass classification into the three subclasses according to the category, and thereby classified into fifteen classes in total.

As the merge pattern corresponding to the number of merged classes of three, a merge pattern can be employed for which a class is obtained as a merged class by a classification rule such that the pixel of interest is classified by the subclass classification into one of the three subclasses according to the category, and thereby classified into three classes in total.

The merge pattern corresponding to the number of merged classes of one is always a merge pattern by which the merged class 0 as a monoclass is obtained.

According to the merge pattern corresponding to the numbers of merged classes of twenty four, twenty one, eighteen, fifteen, twelve, nine, six, and three merged classes on which the category takes effect preferentially over the ranking are obtained.

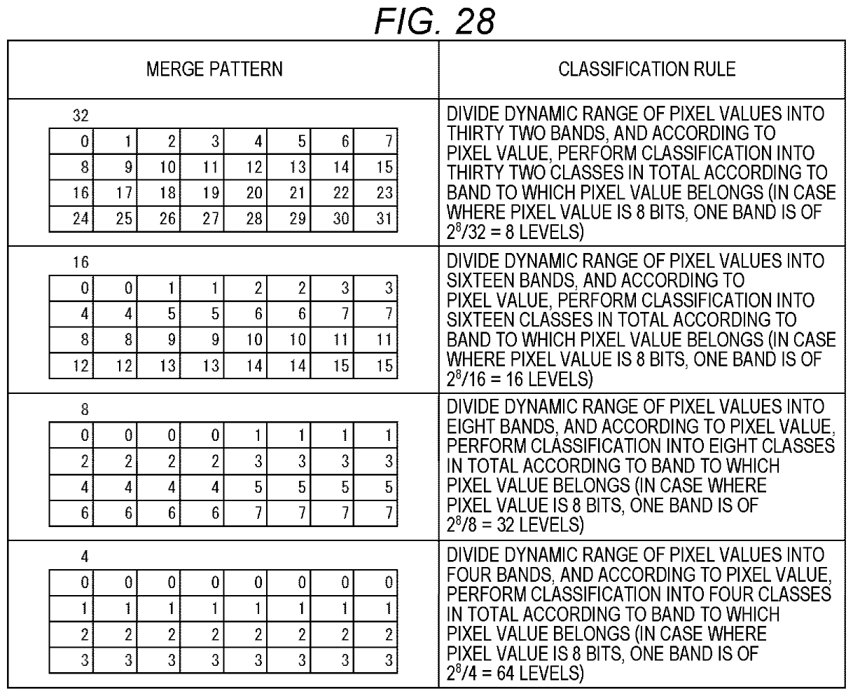

FIG. 28 is a diagram illustrating a fourth example of the merge pattern set in advance.

That is, FIG. 28 is a diagram illustrating an example of a merge pattern corresponding to the numbers of merged classes of thirty two, sixteen, eight, and four that merges thirty two initial classes obtained by the class classification using the pixel values described in FIG. 23.

The merge patterns of FIG. 28 are set by the reduction setting similarly to the merge patterns of FIGS. 10 and 11 and 20 and 21.

Here, in the class classification using the pixel values in FIG. 23, it can be said that there is employed a classification rule such that two hundred fifty six levels as the dynamic range of the pixel values are divided into thirty two bands, and the pixel of interest is classified, according to a pixel value of the pixel of interest, into the class assigned to a band to which the pixel value belongs, and thereby classified into thirty two classes in total.

In FIG. 28, the merge pattern corresponding to the number of merged classes of thirty two is a merge pattern for which a class is obtained as a merged class by a classification rule such that two hundred fifty six levels as the dynamic range of the pixel values are divided into thirty two bands, and the pixel of interest is classified, according to a pixel value of the pixel of interest, into the class assigned to a band to which the pixel value belongs, and thereby classified into thirty two classes in total. That is, the merge pattern corresponding to the number of merged classes of thirty two is a merge pattern such that the same merged class as the initial class obtained by the class classification using the pixel values can be obtained.

In FIG. 28, each of the merge patterns corresponding to the numbers of merged classes of sixteen, eight, and four is a merge pattern for which a class is obtained as a merged class by a classification rule such that two hundred fifty six levels as the dynamic range of the pixel values are divided into sixteen, eight, and four bands, and the pixel of interest is classified, according to a pixel value of the pixel of interest, into the class assigned to a band to which the pixel value belongs, and thereby classified into sixteen, eight, and four classes in total.

Note that in a case where the two hundred fifty six levels as the dynamic range of the pixel value are divided into thirty two, sixteen, eight, and four bands, the band sizes are eight, sixteen, thirty two, and sixty four levels, respectively.

Further, as the number of merged classes of the merge pattern for merging thirty two initial classes obtained by the class classification using the pixel values, in addition to thirty two, sixteen, eight, and four, for example, two or one can be employed.

As the merge pattern corresponding to the number of merged classes of two, there can be obtained a merge pattern for which a class is obtained as a merged class by a classification rule such that two hundred fifty six levels as the dynamic range of the pixel values are divided into two bands, and the pixel of interest is classified, according to a pixel value of the pixel of interest, into the class assigned to a band to which the pixel value belongs, and thereby classified into two classes in total.

The merge pattern corresponding to the number of merged classes of one is always a merge pattern by which the merged class 0 as a monoclass is obtained.

As described above, as the merge pattern corresponding to each number of merged classes, a merge pattern can be employed that merges the initial classes obtained by the class classification of various classification methods such as the class classification of the GALF, the class classification using the ranking, the class classification using the pixel values, the class classification using the reliability of the inclination direction, and the like.

Moreover, the merge pattern corresponding to each number of merged classes can be set in a mixed setting, that is, set so that a merge pattern for merging the initial classes obtained by predetermined class classification and a merge pattern for merging the initial classes obtained by another class classification are mixed.

For example, the merge pattern corresponding to each number of merged classes can be set so that a merge pattern for merging the initial classes obtained by the class classification of the GALF and a merge pattern for merging the initial classes obtained by the class classification using ranking are mixed.

As the merge pattern for merging the initial classes obtained by the class classification of the GALF, for example, the merge patterns corresponding to the numbers of merged classes of twenty five, twenty, fifteen, ten, five, three, two, and one illustrated in FIGS. 10 and 11 can be employed.

As the merge pattern for merging the initial classes obtained by the class classification using the ranking, the merge patterns corresponding to the numbers of merged classes of twenty seven, twenty four, twenty one, eighteen, fifteen, twelve, nine, six, three, and one described in FIGS. 26 and 27 can be employed.

However, in a case where the merge patterns corresponding to the number of merged classes twenty five, twenty, fifteen, ten, five, three, two, and one as the merge pattern for merging the initial classes obtained by the class classification of the GALF (hereinafter also referred to as GALF merge pattern) and the merge patterns corresponding to the numbers of merged classes of twenty seven, twenty four, twenty one, eighteen, fifteen, twelve, nine, six, three, and one as the merge patterns for merging the initial classes obtained by the class classification using the ranking (hereinafter also referred to as ranking merge pattern) are mixed, the numbers of merged classes of fifteen, three, and one overlap between the GALF merge pattern and the ranking merge pattern.

In a case where the numbers of merged classes overlap between the GALF merge pattern and the ranking merge pattern, it is possible to set in advance which of the CALF merge pattern and the ranking merge pattern has priority. For example, in a case where the CALF merge pattern has priority, the GALF merge pattern is employed as the merge patterns corresponding to the numbers of merged classes of twenty five, twenty, fifteen, ten, five, three, two, and one and the ranking merge pattern is employed as the merge patterns corresponding to the numbers of merged classes of twenty seven, twenty four, twenty one, eighteen, twelve, nine, and six.

Furthermore, the merge pattern corresponding to each number of merged classes can be set so that merge patterns for merging the initial classes obtained by each class classification of any two or more types of the class classification methods are mixed, besides the class classification using the class classification of the GALF and the ranking.

For example, the merge pattern corresponding to each number of merged classes can be set so that a merge pattern for merging the initial classes obtained by the class classification of the CALF and a merge pattern for merging the initial classes obtained by the class classification using the pixel values are mixed.

As the merge pattern for merging the initial classes obtained by the class classification of the GALF, for example, the merge patterns corresponding to the numbers of merged classes of twenty five, twenty, fifteen, ten, five, three, two, and one illustrated in FIGS. 10 and 11 can be employed.

As a merge pattern for merging the initial classes obtained by class classification using the pixel values, the merge pattern corresponding to the numbers of merged classes of thirty two, sixteen, eight, four, two, one described in FIG. 28 can be employed.

However, in a case where the GALF merge patterns corresponding to the numbers of merged classes of twenty five, twenty, fifteen, ten, five, three, two, and one as the merge pattern for merging the initial classes obtained by the class classification of the GALF and the merge pattern corresponding to the numbers of merged classes of thirty two, sixteen, eight, four, two, one as the merge pattern for merging the initial classes obtained by the class classification using the pixel values (hereinafter also referred to as a pixel value merge pattern) are mixed, the numbers of merged classes of two and one overlap between the GALF merge pattern and the pixel value merge pattern.

Now, if between the GALF merge pattern and the pixel value merge pattern, for example, the GALF merge pattern is given priority, the GALF merge pattern is employed as the merge patterns corresponding to the numbers of merged classes of twenty five, twenty, fifteen, ten, five, three, two, and one, and the ranking merge pattern is employed as the merge pattern corresponding to the numbers of merged classes of thirty two, sixteen, eight, four.

Here, as described above, setting the merge pattern in a mixed setting so that the merge pattern for merging the initial classes obtained by predetermined class classification and the merge pattern for merging the initial classes obtained by another class classification are mixed can be said as setting a merge pattern so that the number of merged classes other than the number of merged classes in the merge pattern for merging the initial classes obtained by the predetermined class classification is interpolated by the number of merged classes in the merge pattern for merging the initial classes obtained by another class classification.

For example, it can be said that in a case where the GALF merge pattern and the pixel value merge pattern are mixed, the numbers of merged classes of thirty two, sixteen, eight, and four that do not exist as the numbers of merged classes of the GALF merge pattern is interpolated by the numbers of merged classes of thirty two, sixteen, eight, and four of the pixel value merge pattern.

Note that in a case where the merge pattern for every number of merged classes is set in the mixed setting, (the class classification method of) the initial class classification differs depending on the (employed) number of merged classes.

<Class Classification of GALF>

The class classification of the GALF will be described again.

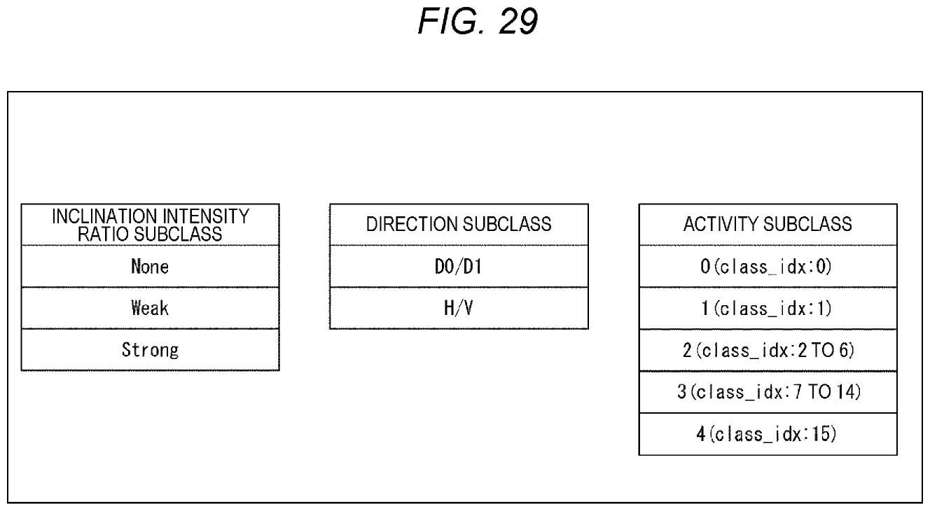

FIG. 29 is a diagram describing the class classification of the GALF.

From the description made with FIGS. 1 to 3, it can be said that the class classification of the GALF is performed using the inclination intensity ratio, the direction (defined direction), and the activity sum (spatial feature amount) as a plurality of feature amounts of the pixel of interest.

Moreover, it can be said that the class classification of the GALF is performed by the inclination intensity ratio subclass classification of the inclination intensity ratio (using the inclination intensity ratio), the direction subclass classification of the direction (using the direction), and the activity subclass classification of the activity sum (using the activity thumb). Here, the subclass obtained by the direction subclass classification will be also referred to as a direction subclass (equal to the direction class described in FIG. 2).

In the inclination intensity ratio subclass classification, by threshold process of the inclination intensity ratio, the pixel of interest is classified into one of three subclasses (inclination intensity ratio subclass) of the none class, the weak class, and the strong class, as illustrated in FIG. 29. In the direction subclass classification, the pixel of interest is classified into one of two subclasses (direction subclasses) of the D0/D1 class and the H/V class, as illustrated in FIG. 29, according to the direction. In the activity subclass classification, the pixel of interest is classified into one of the five subclasses of the activity subclasses 0 to 4 by the index class_idx in the range of 0 to 15 obtained from the activity sum.

It can be said that the class classification of the GALF is performed by the inclination intensity ratio, direction, and activity sum subclass classification (inclination intensity ratio subclass classification, direction subclass classification, and activity subclass classification) as a plurality of feature amounts as described above.

Here, for example, it can be said that the class classification using the reliability described in FIGS.

24 and 25 is performed by the subclass classification of the inclination intensity ratio, the direction, the activity sum, and the reliability. Therefore, it can be said that the class classification using the reliability is also performed by the subclass classification of each of the plurality of feature amounts, similarly to the class classification of the GALF.

In a case where the class classification performed by the subclass classification of each of the plurality of feature amounts is employed as the class classification (initial class classification) for obtaining the initial class and setting a the merge pattern by the reduction setting, it is possible to set the merge pattern for converting into the merged class in which the initial class is merged by merging the subclasses of the feature amount. That is, the merge pattern can be set by merging the subclasses of the feature amounts.

For example, in a case where the class classification of the GALF is employed as the initial class classification, the merge pattern can be set by merging the inclination intensity ratio subclass of the inclination intensity ratio, the direction subclass of the direction, and the activity subclass of the activity sum.

Here, merging of the subclasses will be also referred to as subclass merging.

<Subclass Merging>

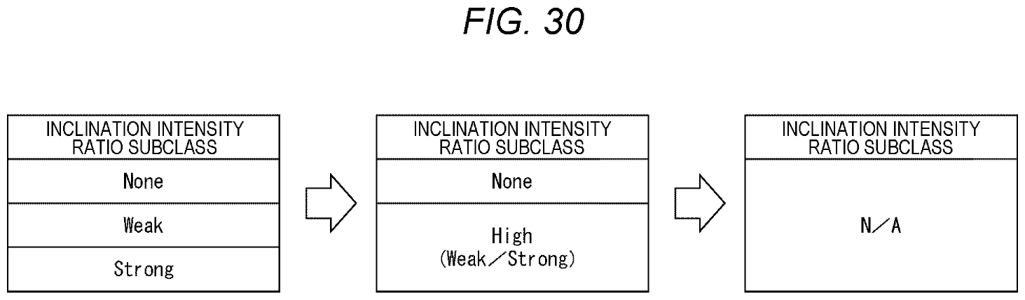

FIG. 30 is a diagram describing the subclass merging of inclination intensity ratio subclasses.

The inclination intensity ratio subclass can be made as two subclasses of none class and high class as a whole by subclass-merging the weak class and the strong class among the original three subclasses of the none class, the weak class, and the strong class into the high class. Moreover, the inclination intensity ratio subclass can be made as one subclass of only N/A (Not Available) class as a whole by subclass-merging the none class and the high class into the N/A class. Merging the inclination intensity ratio subclass to one subclass of only the N/A class is equivalent to not performing the inclination intensity ratio subclass classification.

Note that as mentioned above, the N/A class as the inclination intensity ratio subclass can be said to be a subclass obtained by merging two subclasses, the none class and the high class, and can also be said to be a subclass obtained by merging three subclasses, the original none class, weak class, and strong class.

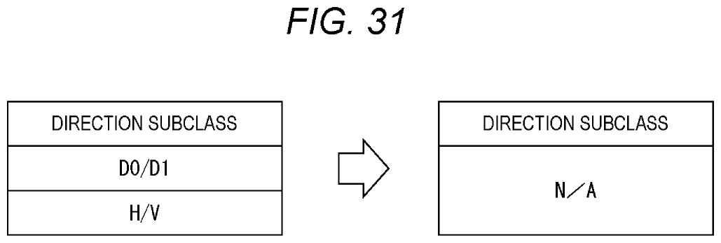

FIG. 31 is a diagram describing the subclass merging of direction subclasses.

The direction subclass can be made as one subclass of only the N/A class as a whole by subclass merging the original two subclasses of the D0/D1 class and the H/V class into the N/A class. Merging the direction subclasses into one subclass of only the N/A class is equivalent to not performing the direction subclass classification.

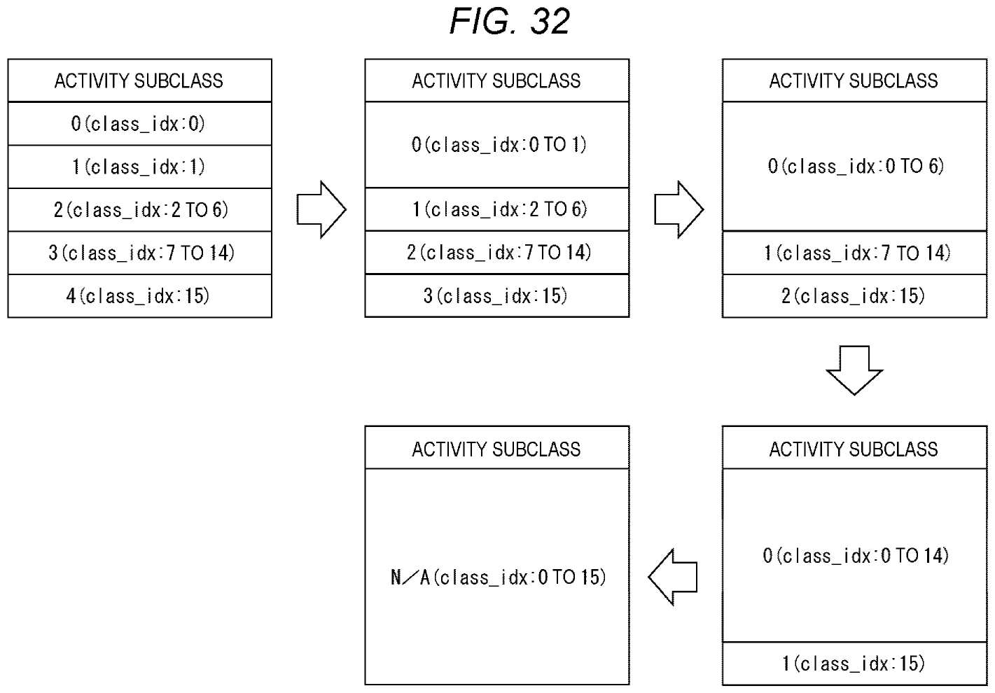

FIG. 32 is a diagram describing subclass merging of activity subclasses.

The activity subclass can be merged such that among five subclasses of activity subclass 0 corresponding to the original index class_idx of (value) 0, activity subclass 1 corresponding to the index class_idx of 1, activity subclass 2 corresponding to the index class_idx of 2 to 6, activity subclass 3 corresponding to the index class_idx of 7 to 14, and activity subclass 4 corresponding to the index class_idx of 15, for example, the activity subclasses 0 and 1 can be subclass merged into activity subclass 0 corresponding to the index class_idx of 0 and 1, thereby merging into four subclasses of activity subclass 0 corresponding to the index class_idx of 0 and 1, activity subclass 1 corresponding to the index class_idx of 2 to 6, activity subclass 2 corresponding to the index class_idx of 7 to 14, and activity subclass 3 corresponding to the index class_idx of 15 as a whole.

Moreover, the activity subclasses can be merged such that among activity subclass 0 corresponding to the index class_idx of 0 and 1, activity subclass 1 corresponding to the index class_idx of 2 to 6, activity subclass 2 corresponding to the index class_idx of 7 to 14, and activity subclass 3 corresponding to the index class_idx of 15, for example, the activity subclasses 0 and 1 can be subclass merged into activity subclass 0 corresponding to the index class_idx of 0 to 6, thereby merging into three subclasses of activity subclass 0 corresponding to the index class_idx of 0 to 6, activity subclass 1 corresponding to the index class_idx of 7 to 14, and activity subclass 2 corresponding to the index class_idx of 15 as a whole.

Furthermore, the activity subclasses can be merged such that among activity subclass 0 corresponding to the index class_idx of 0 to 6, activity subclass 1 corresponding to the index class_idx of 7 to 14, and activity subclass 2 corresponding to the index class_idx of 15, for example, the activity subclass 0 corresponding to the index class_idx of 0 and 6 and the activity subclass 1 corresponding to the index class_idx of 7 and 14 can be subclass merged into the activity subclass 0 corresponding to the index class_idx of 0 and 14, thereby merging into two subclasses of activity subclass 0 corresponding to the index class_idx of 0 and 14 and activity subclass 1 corresponding to the index class_idx of 15 as a whole.

Moreover, the activity subclass can be merged such that activity subclass 0 corresponding to the index class_idx of 0 to 14 and activity subclass 1 corresponding to the index class_idx of 15 can be subclass merged into the N/A class (activity subclass 0) corresponding to the index class_idx of 0 to 15, thereby merging into one subclass of only the N/A class corresponding to the index class_idx of 0 to 15. Merging the activity subclasses into one subclass with only the N/A class is equivalent to not performing the activity subclass classification.

Note that for activity subclasses merged into three subclasses, it can be said that the activity subclass 0 corresponding to the index class_idx of 0 to 6, as described above, is a subclass obtained by merging the original activity subclasses 0 to 2, besides that it is a subclass obtained by merging activity subclass 0 corresponding to the index class_idx of 0 and 1, and activity subclass 1 corresponding to the index class_idx of 2 to 6. The same applies to the activity subclass merged into two subclasses and the activity subclass merged into one subclass.

Furthermore, here, the activity subclasses are merged (subclass merged) towards activity subclass 4 which represents a large activity from activity subclass 0 that represents a small activity with a small number of index class_idx assignments, but the order of subclass merging of activity subclasses is not limited to this. For example, the subclass merging of the activity subclasses can be performed in an order of merging activity subclasses 0 and 1, then merging the activity subclass 2, thereafter merging activity subclasses 3 and 4, and finally merging into the N/A class, or the like.

In the merge pattern reduction setting that converts the initial class obtained by the class classification of the GALF into the merged class, the initial class can be merged and the merge pattern can be set (generated) by the subclass merging as described above.

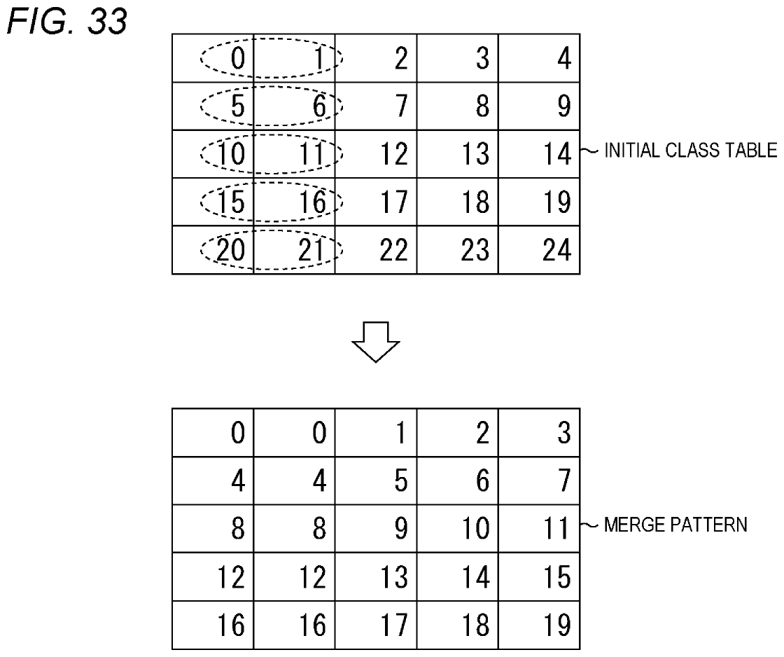

FIG. 33 is a diagram illustrating an example of merge of initial classes by subclass merging of the activity subclasses.

According to the subclass merging of activity subclasses, for example, a plurality of horizontal initial classes of each row is merged in the initial class table, as illustrated by dotted lines in FIG. 33.

In FIG. 33, by subclass merging of activity subclass 0 corresponding to the index class_idx of 0 and activity subclass 1 corresponding to the index class_idx of 1, the initial class in the first column and the initial class in the second column of each row are merged.

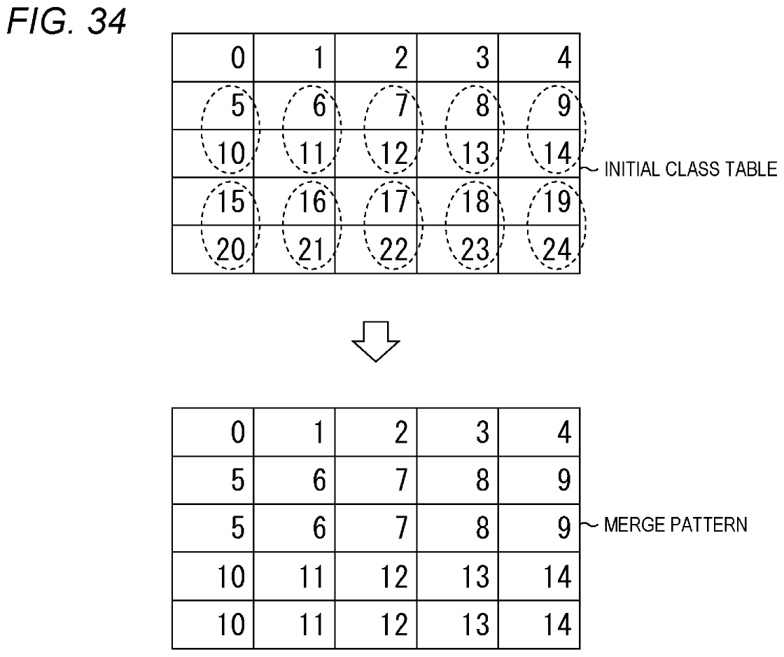

FIG. 34 is a diagram illustrating an example of merging the initial class by subclass merging of the inclination intensity ratio subclass.

According to the subclass merging of the inclination intensity ratio subclass, for example, as illustrated by the dotted line in FIG. 34, the initial classes in the second and third rows of each column are merged, and a fourth row and a fifth row are merged in the initial class table.

In FIG. 34, by the subclass merging of the weak class and the strong class, the initial classes in the second and third rows of each column are merged, and the initial classes in the fourth and fifth rows are merged.

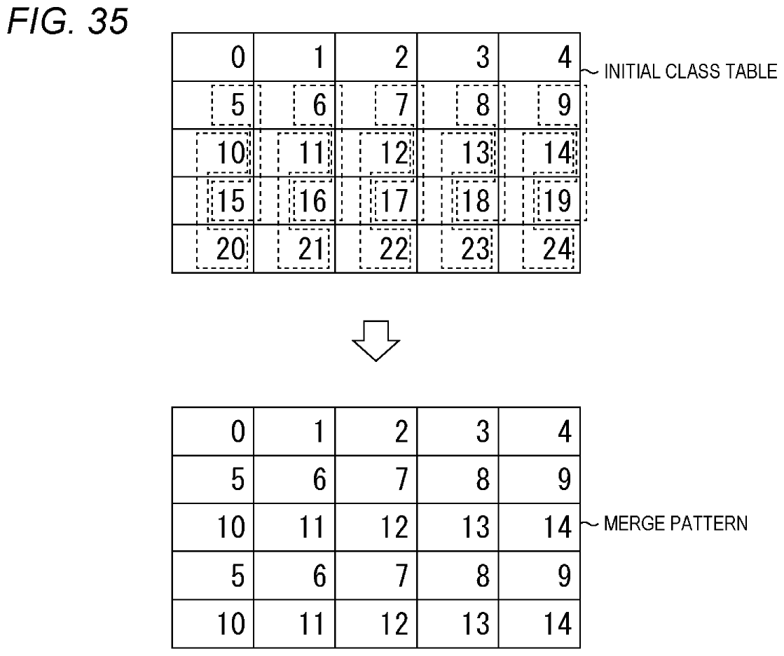

FIG. 35 is a diagram illustrating an example of merging of initial classes by subclass merging of direction subclasses.

According to the subclass merging of direction subclasses, for example, the initial classes in second and fourth rows of each column are merged and the initial classes in third and fifth rows are merged, in the initial class table as illustrated by dotted lines in FIG. 35.

In FIG. 35, by the subclass merging of the D0/D1 class and the H/V class, the initial classes in the second row and the fourth row of each column are merged, and the initial classes in the third and fifth rows are merged.

<Number of Subclasses and Number of Merged Classes after Subclass Merging>

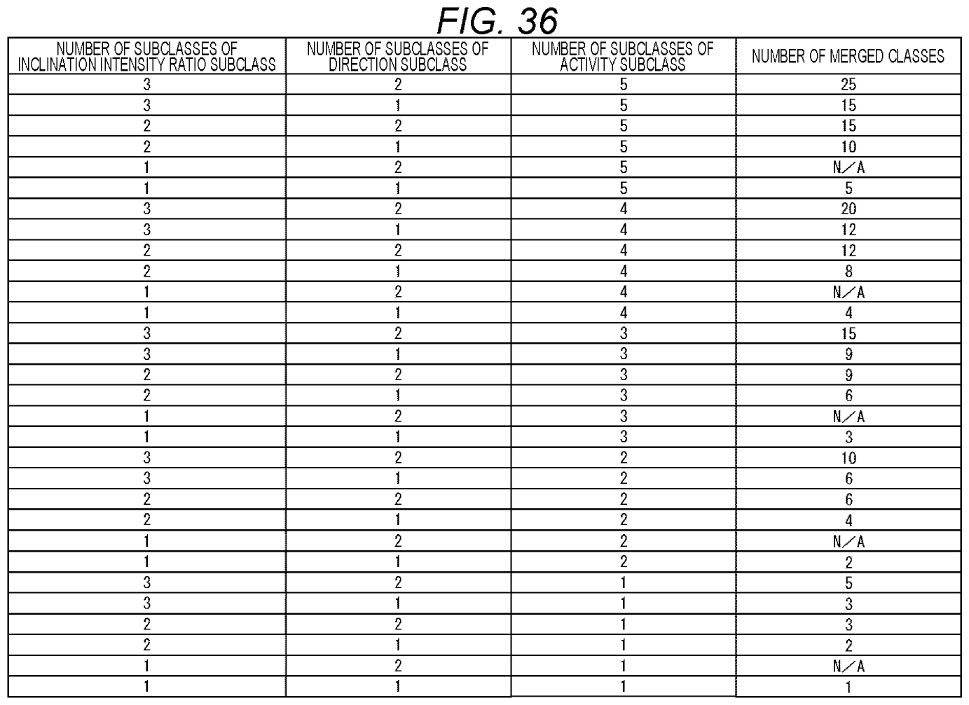

FIG. 36 is a diagram illustrating a relationship between the number of subclasses after the subclass merging of the inclination intensity ratio subclass, the direction subclass, and the activity subclass, and the number of merged classes.

That is, FIG. 36 illustrates the relationship between the number of subclasses after the subclass merging and the number of merged classes in a case where the inclination intensity ratio subclass is subclass merged as one of one to three subclasses, the direction subclass as one of one and two subclasses, and the activity subclass as one of one to five subclasses, as described in FIGS. 30 to 32.

Here, for example, the number of subclasses of the inclination intensity ratio subclass after the subclass merging being three is equivalent to that the subclass merging of the inclination intensity ratio subclass is not performed. However, in the present technology, not performing the subclass merging is regarded as subclass merging that merges each subclass into this subclass. The same applies to merging of the initial classes.

In the class classification of the GALF, as described in FIGS. 1 to 3, in a case where the inclination intensity ratio subclass is the none class, the direction subclass is invalid and the class classification is performed without considering the direction subclass (regardless of the direction subclass).

Accordingly, assuming that the numbers of subclasses of the inclination intensity ratio subclass, the direction subclass, and the activity subclass after the subclass merging are Na, Nb, and Nc, respectively, the number of merged classes is represented by an expression Nc×(Nb×(Na−1)+1).

As described in FIGS. 30 to 32, the merge patterns that can be obtained in a case where the inclination intensity ratio subclass is subclass-merged into one of the one to three subclasses, the direction subclass is subclass-merged into one of one and two subclasses, and the activity subclass is subclass-merged into in one of one to five subclasses, the number of subclasses after subclass merging is 30 patterns by calculation as illustrated in FIG. 36.

However, in a case where the inclination intensity ratio subclass is subclass merged into one subclass, the class classification into the merged class is performed regardless of the inclination intensity ratio (subclass). Then, if the direction is made to contribute to the class classification into the merged class even though whether the inclination intensity ratio is large or small is not known, in a case where the inclination intensity ratio is small, the class classification is performed in consideration of the direction as an inclination direction of a pixel value of a pixel of a flat image. Pixel values are not (mostly) inclined for the flat image, and if the class classification into the merged class is performed in consideration of the inclination direction of the pixel values for such a flat image, the pixel of interest may not be classified into an appropriate class, that is, pixels having similar characteristics may be classified into different classes instead of the same class (merged class) due to slight noise, for example.

Accordingly, in a case where the inclination intensity ratio subclass is merged into one subclass, the direction subclass classification is classified into the D0/D1 class or the H/V class, and by extension, the merge pattern to be the class classification performed by such direction subclass classification, that is, any merge pattern whose number of subclasses of the inclination intensity ratio subclass is one and whose number of subclasses of the direction subclass corresponds to the number of subclasses of two (or more) is assumed as invalid and is not used (N/A).

In FIG. 36, a column where the number of merged classes is N/A indicates that the merge pattern corresponding to this number of merged classes is invalid. There are five invalid merge patterns.

Therefore, the merge pattern obtained by the subclass merging of the inclination intensity ratio subclass, the direction subclass, and the activity subclass described with reference to FIGS. 30 to 32, that is, the valid merge patterns that can be obtained in a case where the inclination intensity ratio subclass is subclass-merged into one of one to three subclasses, the direction subclasses is subclass-merged into one of one and two subclasses, and the activity subclass is subclass-merged into one of one to five subclasses are twenty five merge patterns, which is obtained by subtracting five invalid merge patterns from 30 calculated patterns.

From the above, it is possible to set twenty five (valid) merge patterns by the subclass merging.

As the twenty five patterns of merge patterns that can be obtained by the subclass merging, there are merge patterns with the numbers of subclasses of one, two, three, four, five, six, eight, nine, ten, twelve, fifteen, twenty, and twenty five subclasses, and there are merge patterns with the same number of merged classes.

Now, merge patterns obtained in a case where the numbers of subclasses of the inclination intensity ratio subclass, the direction subclass, and the activity subclass are subclass merged into Na, Nb, and Nc, respectively, are represented as merge patterns (Na, Nb, Nc).

In FIG. 36, for example, the merge patterns (3, 1, 5) and (2, 2, 5) and the like have the same number of merged classes (of fifteen).

In the present technology, because the merge pattern is set for every number of merged classes, for a plurality of merge patterns with the same number of merged classes, merge pattern selection is performed that obtains a cost using various images, and selects the merge pattern with the minimum cost as the merged class corresponding to the number of merged classes.

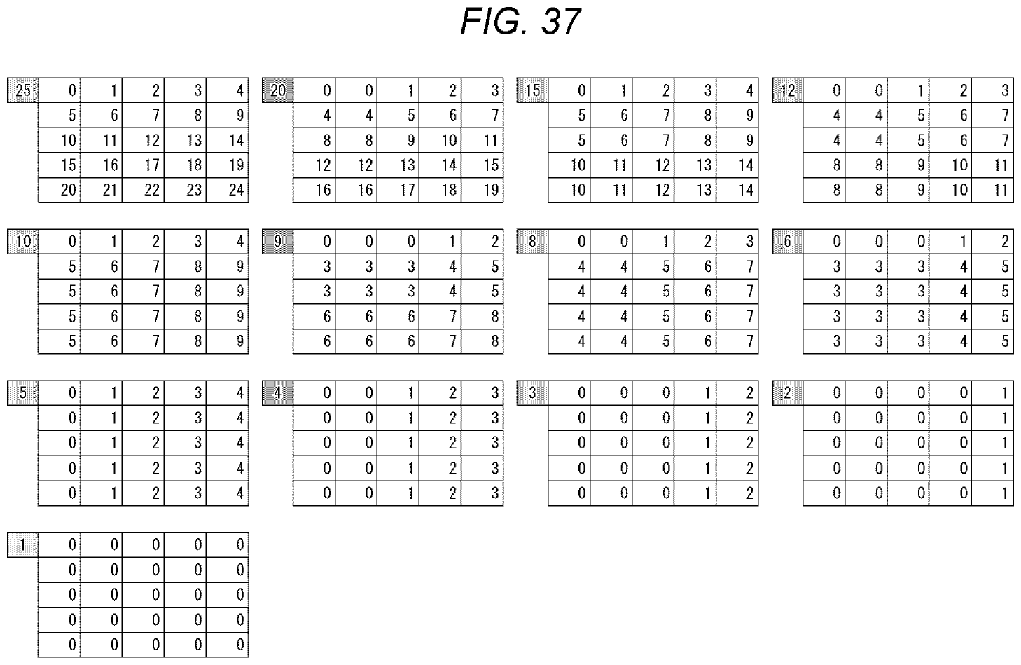

FIG. 37 is a diagram illustrating an example of a merge pattern obtained by performing the subclass merging and the merge pattern selection.

By the subclass merging and the merge pastern selection, thirteen merge patterns, that is, merge patterns corresponding to the numbers of subclasses of one, two, three, four, five, six, eight, nine, ten, twelve, fifteen, twenty, and twenty five, respectively, as illustrated in FIG. 37 can be set.

Incidentally, in a case where the merge pattern is set in advance, it is desirable to set a certain number of patterns of the merge patterns from the viewpoint of improving performance of the filtering process, that is, image quality and encoding efficiency of the filtered image.

In a case of employing the class classification of the GALF as the initial class classification, the number of classes of the initial class classification is twenty five, and thus in a case of setting the merge pattern for every number of subclasses in the reduction setting, twenty five merge patterns at the maximum with the numbers of merged classes of one to twenty five can be set.

However, as illustrated in FIG. 37, the merge patterns that can be set by the subclass merging and the merge pattern selection are thirteen merge patterns corresponding to the numbers of subclasses of one, two, three, four, five, six, eight, nine, ten, twelve, fifteen, twenty, and twenty five, respectively, and in particular, merge patterns corresponding to the numbers of merge patterns between twenty five and twenty, between twenty and fifteen, or between fifteen and twelve are missing.

As described above, the merge patterns of the number of merge patterns missing in the subclass merging and the merge pattern selection can be interpolated by performing partial merging of the subclasses. By the partial merging of subclasses, a merge pattern can be set that correspond to the number of merged classes that interpolates between twenty five and twenty, between twenty and fifteen, between fifteen and twelve, and the like of the numbers of merged classes in the merge pattern set by the subclass merging and the merge pattern selection.

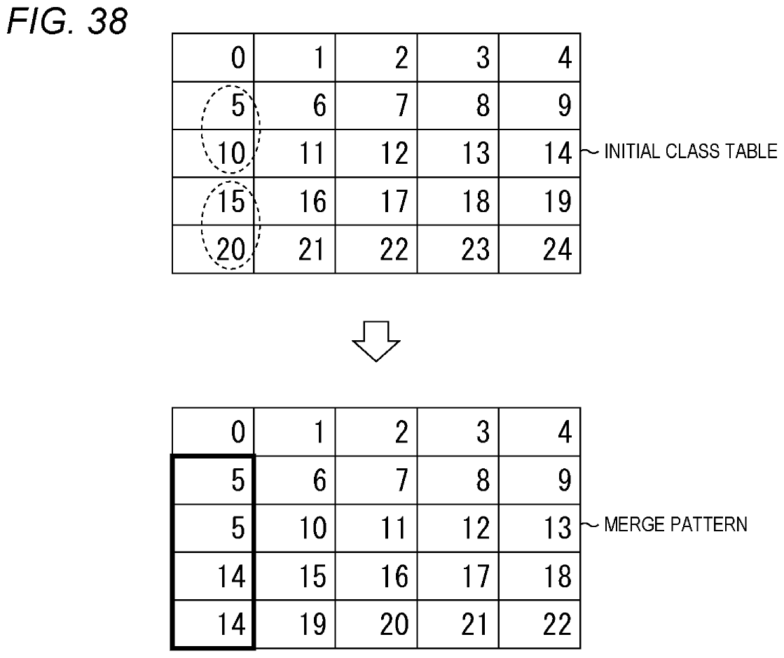

FIG. 38 is a diagram describing the partial merging of subclasses.

The partial merging means that in a case where the subclass of one feature amount to be used for the initial class classification is a particular subclass, the subclass of another feature amount is merged.

FIG. 38 illustrates a merge pattern obtained by the partial merging that merges the inclination intensity ratio subclass in a case where the activity subclass is the activity subclass 0 corresponding to the index class_idx of 0.

In the subclass merging of the inclination intensity ratio subclass, as described in FIG. 34, in the initial class table, initial classes in the second and third rows of each column are merged, and initial classes in the fourth and fifth rows are merged.

On the other hand, by the partial merging that merges the inclination intensity ratio subclasses in a case where the activity subclass is the activity subclass 0 corresponding to the index class_idx of 0, as illustrated in FIG. 38, the initial classes 5 and 10 on the second and third rows of only the first column are merged, and the initial classes 15 and 20 on the fourth and fifth rows are merged in the initial class table.

Consequently, a merge pattern corresponding to the number of merged classes of twenty three can be obtained.

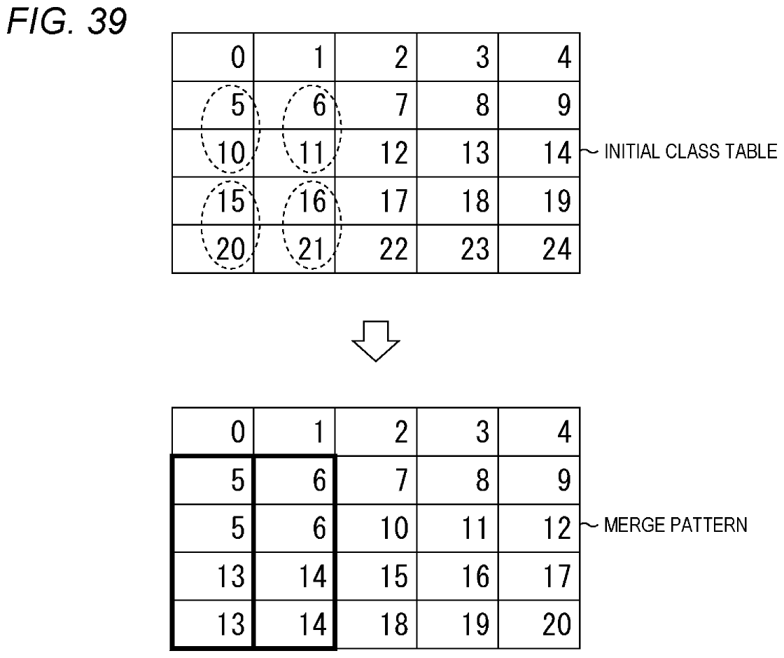

FIG. 39 is a diagram describing the partial merging of subclasses.

That is, FIG. 39 illustrates merge patterns obtained by the partial merging that merges the inclination intensity ratio subclasses in a case where the activity subclass is the activity subclass 0 corresponding to the index class_idx of 0, and merges the inclination intensity ratio subclasses in a case where the activity subclass is the activity subclass 1 corresponding to the index class_idx of 1.

By the partial merging that merges the inclination intensity ratio subclasses in a case where the activity subclass is the activity subclass 0 corresponding to the index class_idx of 0, as described in FIG. 38, the initial classes 5 and 10 on the second and third rows of only the first column are merged, and the initial classes 15 and 20 on the fourth and fifth rows are merged in the initial class table.

Furthermore, by the partial merging that merges the inclination intensity ratio subclasses in a case where the activity subclass is the activity subclass 1 corresponding to the index class_idx of 1, as illustrated in FIG. 39, the initial classes 6 and 11 on the second and third rows of only the second column are merged, and the initial classes 16 and 21 on the fourth and fifth rows are merged in the initial class table.

Consequently, a merge pattern corresponding to the number of merged classes of twenty one can be obtained.

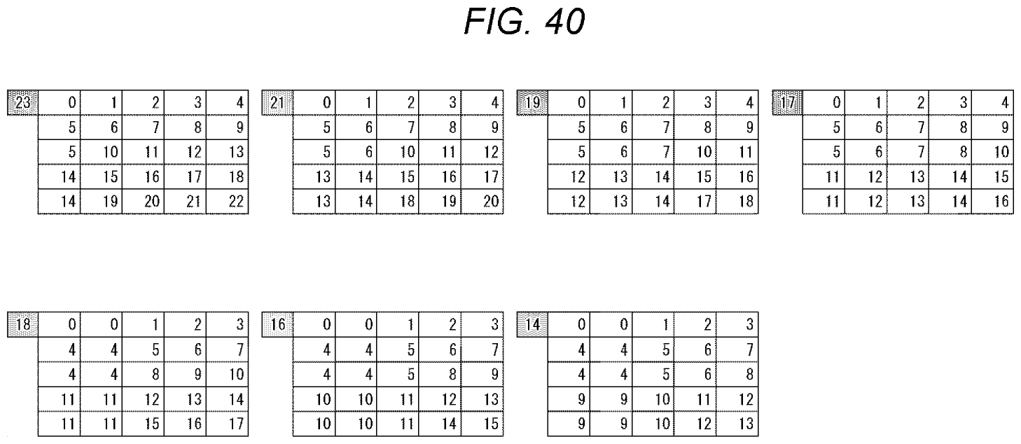

FIG. 40 is a diagram illustrating an example of a merge pattern obtained by the partial merging of subclasses.

For example, a merge pattern corresponding to the number of merged classes of twenty three can be obtained by the partial merging described in FIG. 38.

Furthermore, for example, a merge pattern corresponding to the number of merged classes of twenty one can be obtained by the partial merging described in FIG. 39.

A merge pattern corresponding to the number of merged classes of nineteen can be obtained by performing the partial merging that merges the inclination intensity ratio subclasses in a case where the activity subclass is the activity subclass 2 corresponding to the index class_idx of 2 to 6, in addition to the partial merging described in FIG. 39.

Moreover, in addition, a merge pattern corresponding to the number of merged classes of seventeen can be obtained by performing the partial merging that merges the inclination intensity ratio subclasses in a case where the activity subclass is the activity subclass 3 corresponding to the index class_idx of 7 to 14.

Furthermore, a merge pattern corresponding to the number of merged classes of eighteen can be obtained by merging the activity subclasses into four subclasses of the activity subclass 0 corresponding to the index class_idx of 0 and 1, the activity subclass 1 corresponding to the index class_idx of 2 to 6, the activity subclass 2 corresponding to the index class_idx of 7 to 14, and the activity subclass 3 corresponding to the index class_idx of 15 by the subclass merging, and thereafter performing the partial merging that merges the inclination intensity ratio subclasses in a case where the activity subclass is the activity subclass 0 corresponding to the index class_idx of 0 and 1.

Moreover, a merge pattern corresponding to the number of merged classes of sixteen can be obtained by performing the partial merging that merges the inclination intensity ratio subclasses in a case where the activity subclass is the activity subclass 1 corresponding to the index class_idx of 2 to 6.

Moreover, in addition, a merge pattern corresponding to the number of merged classes of fourteen can be obtained by performing the partial merging that merges the inclination intensity ratio subclasses in a case where the activity subclass is the activity subclass 2 corresponding to the index class_idx of 7 to 14.

Note that in the present embodiment, in the subclass merging of the activity subclass, as illustrated in FIG. 32, a merge pattern is obtained by merging the activity subclass in order from the activity subclass 0 representing that the activity is small to the activity subclass 4 representing that the activity is large from among the activity subclass 0 corresponding to the index class_idx of 0, the activity subclass 1 corresoonding to the index class_idx of 1, the activity subclass 2 corresponding to the index class_idx of 2 to 6, the activity subclass 3 corresponding to the index class_idx of 7 to 14, and the activity subclass 4 corresoonding to the index class_idx of 15.

In order to give a correlation with such subclass merging to the partial merging, in the partial merging, the merge patterns corresponding to the numbers of merged classes of twenty three, twenty one, nineteen, and seventeen are obtained by merging the inclination intensity ratio subclasses in order from a case where the activity subclass is the activity subclass 0 that represents that the activity is small to a case where it is the activity subclass 3 that represents that the activity is large.

However, the merge pattern corresponding to each of the numbers of merged classes of twenty three, twenty one, nineteen, and seventeen can be obtained by performing the partial merging that merges the inclination intensity ratio subclasses in order from a case where the activity subclass is the activity subclass 4 that represents that the activity is large to a case where it is the activity subclass 1 that represents that the activity is small. The same applies to the merge patterns corresponding respectively to the numbers of merged classes eighteen, sixteen, and fourteen.

Furthermore, regarding the partial merging, partial merging to merge the subclass of another feature amount in a case where a subclass other than the activity subclass is a specific subclass can be performed, so as to obtain a merge pattern corresponding to the number of other merged classes that interpolate between the number of merged classes of the merge pattern set by the subclass merging and the merge pattern selection.

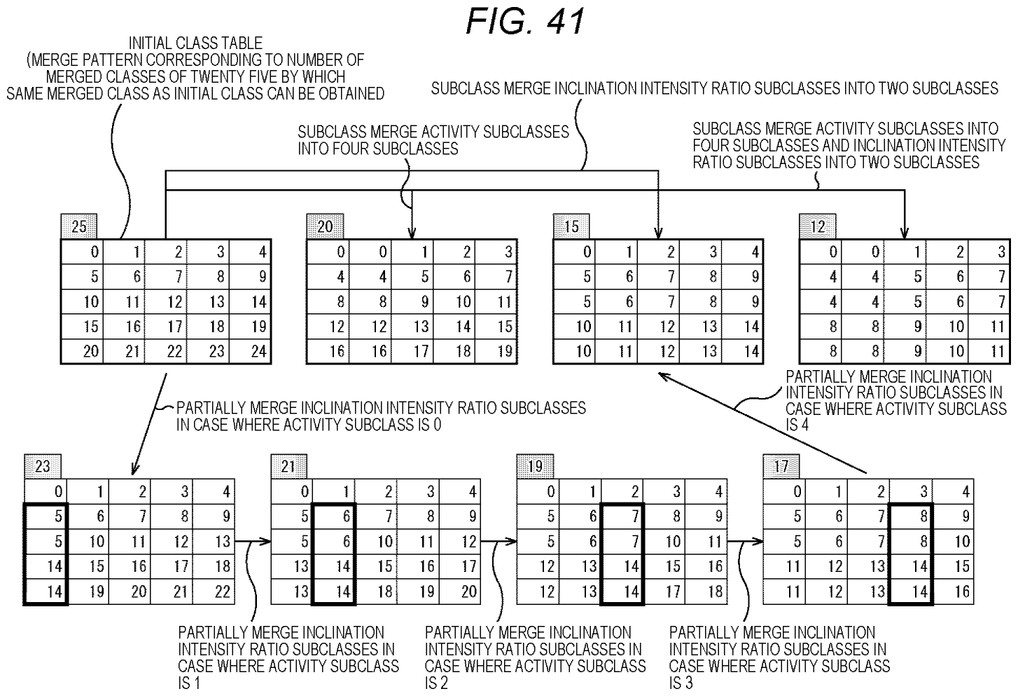

FIG. 41 is a diagram illustrating an example of a relationship between the merge pattern obtained by the subclass merging (and the merge pattern selection) and the merge pattern obtained by the partial merging.

By the subclass merging that causes the numbers of inclination intensity ratio subclasses, direction subclasses, and activity subclasses to be three, two, and five, respectively, that is, by the subclass merging that causes the numbers of inclination intensity ratio subclasses, direction subclasses, and activity subclasses to remain to be those of the original class classification of the GALF without change, a merge pattern corresponding to the number of merged classes of twenty five can be obtained.

Furthermore, for example, a merge pattern corresponding to the number of merged classes of twenty can be obtained by the subclass merging that changes the number of subclasses of the activity subclass from the original five to four among the inclination intensity ratio subclass, the direction subclass, and the activity subclass.

Moreover, for example, a merge pattern corresponding to the number of merged classes of fifteen can be obtained by the subclass merging that changes the number of subclasses of the inclination intensity ratio subclass from the original three to two among the inclination intensity ratio subclass, the direction subclass, and the activity subclass.

Furthermore, for example, a merge pattern corresponding to the number of merged classes of twelve can be obtained by the subclass merging that changes the number of subclasses of the activity subclass from the original five to four, and the number of subclasses of the inclination intensity ratio subclass from the original three to two among the inclination intensity ratio subclass, the direction subclass, and the activity subclass.

On the other hand, for example, a merge pattern corresponding to the number of merged classes of twenty three can be obtained by the partial merging described with reference to FIG. 38.

Further, for example, a merge pattern corresponding to the number of merged classes of twenty one can be obtained by the partial merging described with reference to FIG. 39.

A merge pattern corresponding to the number of merged classes of nineteen can be obtained by performing the partial merging that merges the inclination intensity ratio subclasses in a case where the activity subclass is the activity subclass 2 corresponding to the index class_idx of 2 to 6, in addition to the partial merging described in FIG. 39.

Moreover, in addition, a merge pattern corresponding to the number of merged classes of seventeen can be obtained by performing the partial merging that merges the inclination intensity ratio subclasses in a case where the activity subclass is the activity subclass 3 corresponding to the index class_idx of 7 to 14.

Moreover, in addition, a merge pattern corresponding to the number of merged classes of fifteen can be obtained by performing the partial merging that merges the inclination intensity ratio subclasses in a case where the activity subclass is the activity subclass 4 corresponding to the index class_idx of 15. The merge pattern corresponding to the number of merged classes of fifteen matches the merge pattern corresponding to the number of merged classes of fifteen obtained by the subclass merging that changes the number of subclasses of the inclination intensity ratio subclass from the original three to two.

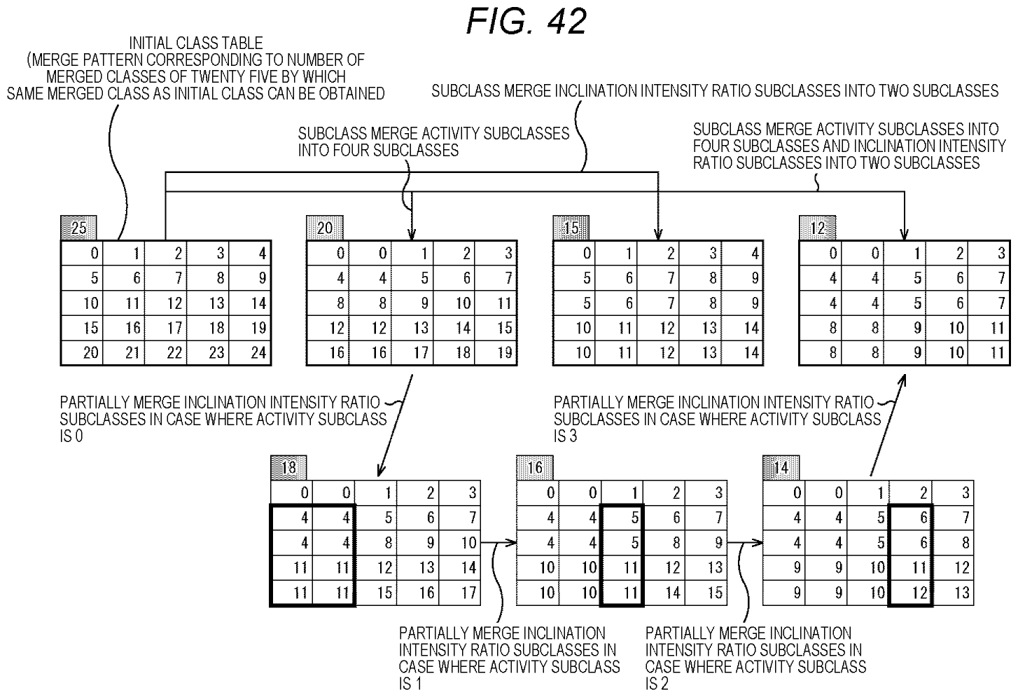

FIG. 42 is a diagram illustrating another example of the relationship between the merge pattern obtained by the subclass merging and the merge pattern obtained by the partial merging.

In FIG. 42, the merge pattern corresponding to the numbers of merged classes of twenty five, twenty, fifteen, and twelve can be obtained by the subclass merging described in FIG. 41.

Then, a merge pattern corresponding to the number of merged classes of eighteen can be obtained by performing the subclass merging to obtain the merge pattern corresponding to the number of merged classes of twenty, that is, the subclass merging that merges into four subclasses of the activity subclass 0 corresponding to the index class_idx of 0 and 1, the activity subclass 1 corresponding to the index class_idx of 2 to 6, the activity subclass 2 corresponding to the index class_idx of 7 to 14, and the activity subclass 3 corresponding to the index class_idx of 15, and thereafter performing the partial merging that merges the inclination intensity ratio subclasses in a case where the activity subclass is the activity subclass 0 corresponding to the index class_idx of 0 and 1.

Moreover, a merge pattern corresponding to the number of merged classes of sixteen can be obtained by performing the partial merging that merges the inclination intensity ratio subclasses in a case where the activity subclass is the activity subclass 1 corresponding to the index class_idx of 2 to 6.

Moreover, in addition, a merge pattern corresponding to the number of merged classes of fourteen can be obtained by performing the partial merging that merges the inclination intensity ratio subclasses in a case where the activity subclass is the activity subclass 2 corresponding to the index class_idx of 7 to 14.

Moreover, in addition, a merge pattern corresponding to the number of merged classes of twelve can be obtained by performing the partial merging that merges the inclination intensity ratio subclasses in a case where the activity subclass is the activity subclass 3 corresponding to the index class_idx of 15. The merge pattern corresponding to the number of merged classes of twelve matches the merge pattern corresponding to the number of merged classes of twelve obtained by the subclass merging that changes the number of subclasses of the activity subclass from the original five to four and the number of subclasses of the inclination intensity ratio subclass from the original three to two.

Merge patterns for every number of merged classes set by the subclass merging (and the merge pattern selection), that is, merge patterns of thirteenth patterns corresponding to each of one, two, three, four, five, six, eight, nine, ten, twelve, fifteen, twenty, and twenty five will be described again below.

<Merge Patterns for Every Number of Merged Classes Set by Subclass Merging>

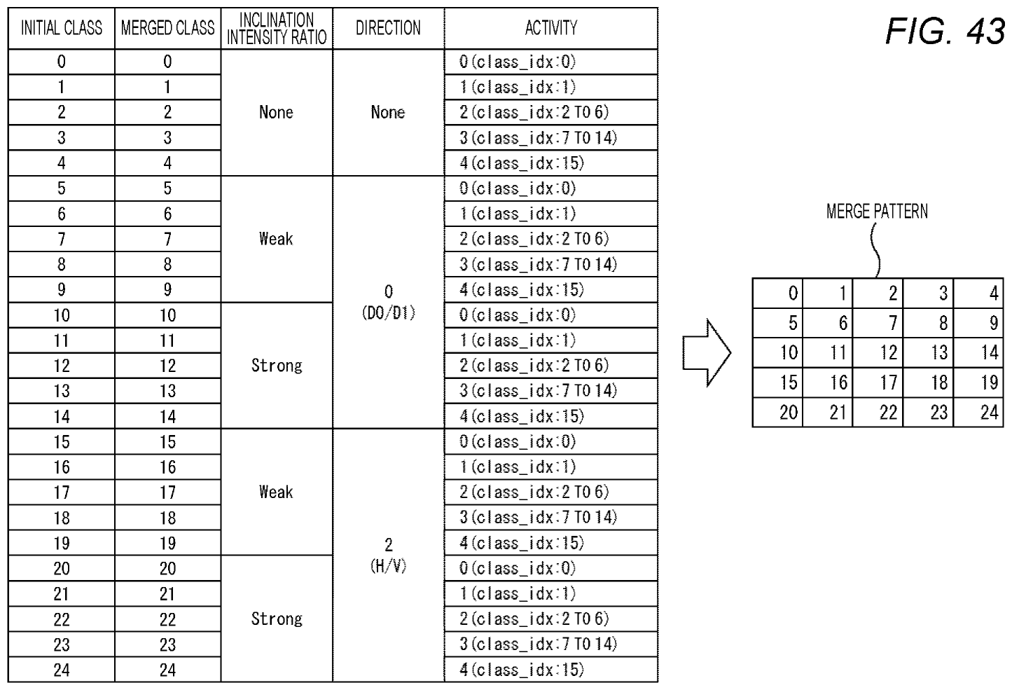

FIG. 43 is a diagram illustrating a merge pattern corresponding to the number of merged classes of twenty five obtained by the subclass merging, and the subclass merging by which the merge pattern is obtained.

A merge pattern corresponding to the number of merged classes of twenty five can be obtained by subclass merging the inclination intensity ratio subclass into three subclasses of the none class, the weak class, and the strong class, subclass merging the direction subclass into two subclasses of the D0/D1 class and the H/V class, and subclass merging the activity subclass into five subclasses of the activity subclass 0 corresponding to the index class_idx of 0, the activity subclass 1 corresponding to the index class_idx of 1, the activity subclass 2 corresponding to the index class_idx of 2 to 6, the activity subclass 3 corresponding to the index class_idx of 7 to 14, and the activity subclass 4 corresponding to the index class_idx of 15.

That is, a merge pattern with the number of merged classes of twenty five can be obtained by leaving the three subclasses of the inclination intensity ratio subclasses, the two subclasses of the direction subclasses, and the five subclasses of the activity subclasses as they are.

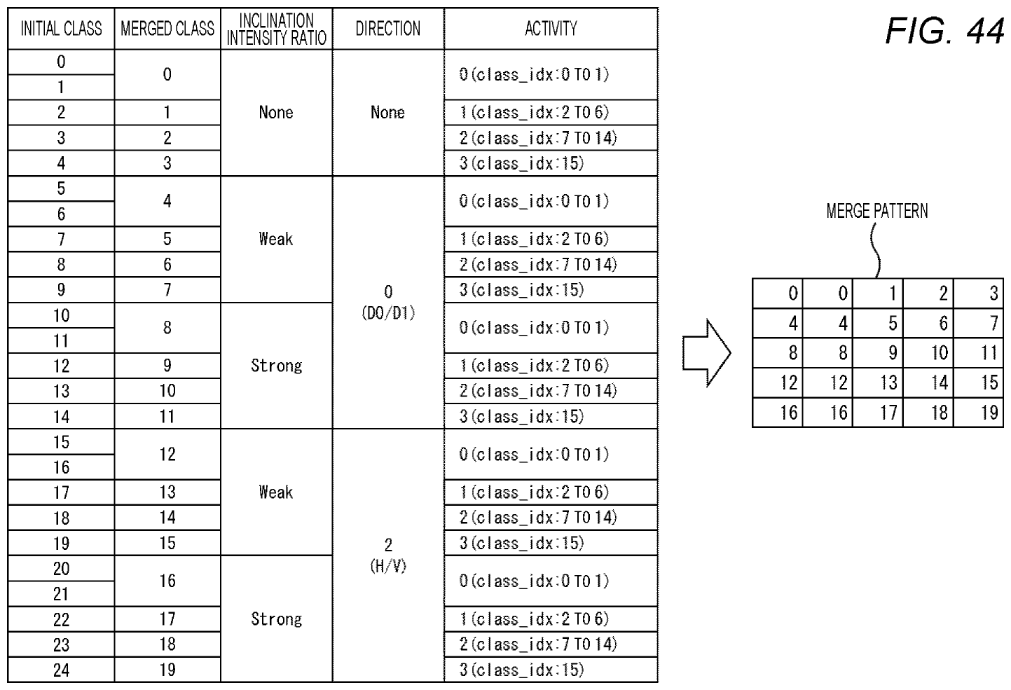

FIG. 44 is a diagram illustrating a merge pattern corresponding to the number of merged classes of twenty obtained by the subclass merging and the subclass merging by which this merge pattern is obtained.

A merge pattern corresponding to the number of merged classes of twenty can be obtained by subclass merging the inclination intensity ratio subclass into three subclasses of the none class, the weak class, and the strong class, subclass merging the direction subclass into two subclasses of the D0/D1 class and the H/V class, and subclass merging the activity subclass into four subclasses of the activity subclass 0 corresponding to the index class_idx of 0 and 1, the activity subclass 1 corresponding to the index class_idx of 2 to 6, the activity subclass 2 corresponding to the index class_idx of 7 to 14, and the activity subclass 3 corresponding to the index class_idx of 15.

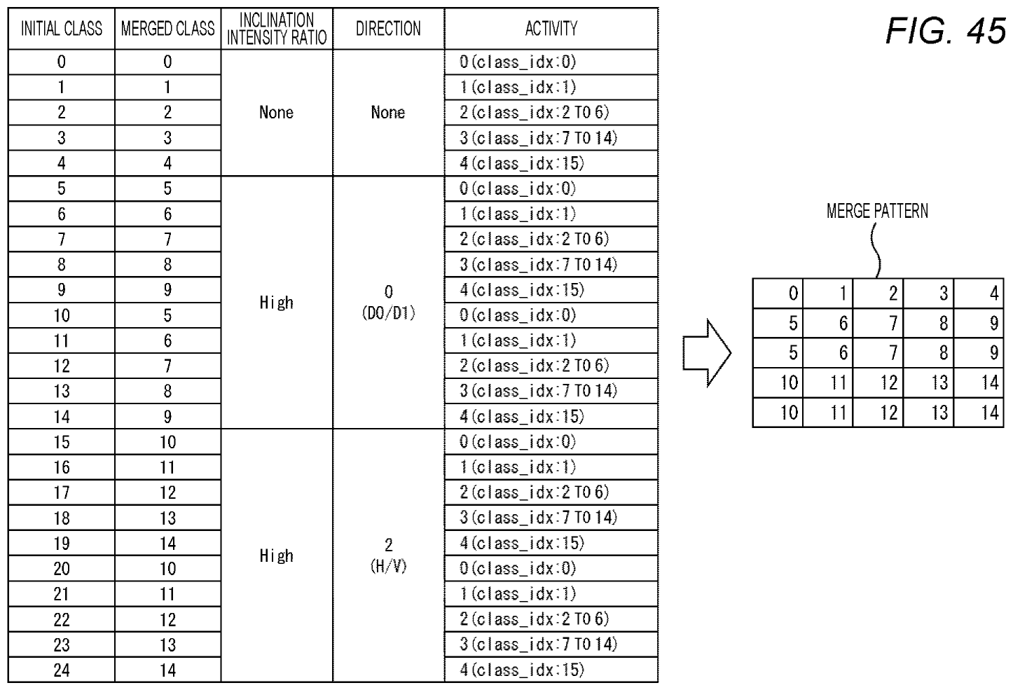

FIG. 45 is a diagram illustrating a merge pattern corresponding to the number of merged classes of fifteen obtained by the subclass merging and the subclass merging by which this merge pattern is obtained.

A merge pattern corresponding to the number of merged classes of fifteen can be obtained by subclass merging the inclination intensity ratio subclass into two subclasses of the none class and the high class, subclass merging the direction subclass into two subclasses of the D0/D1 class and the H/V class, and subclass merging the activity subclass into five subclasses of the activity subclass 0 corresponding to the index class_idx of 0, the activity subclass 1 corresponding to the index class_idx of 1, the activity subclass 2 corresponding to the index class_idx of 2 to 6, the activity subclass 3 corresponding to the index class_idx of 7 to 14, and the activity subclass 4 corresponding to the index class_idx of 15.

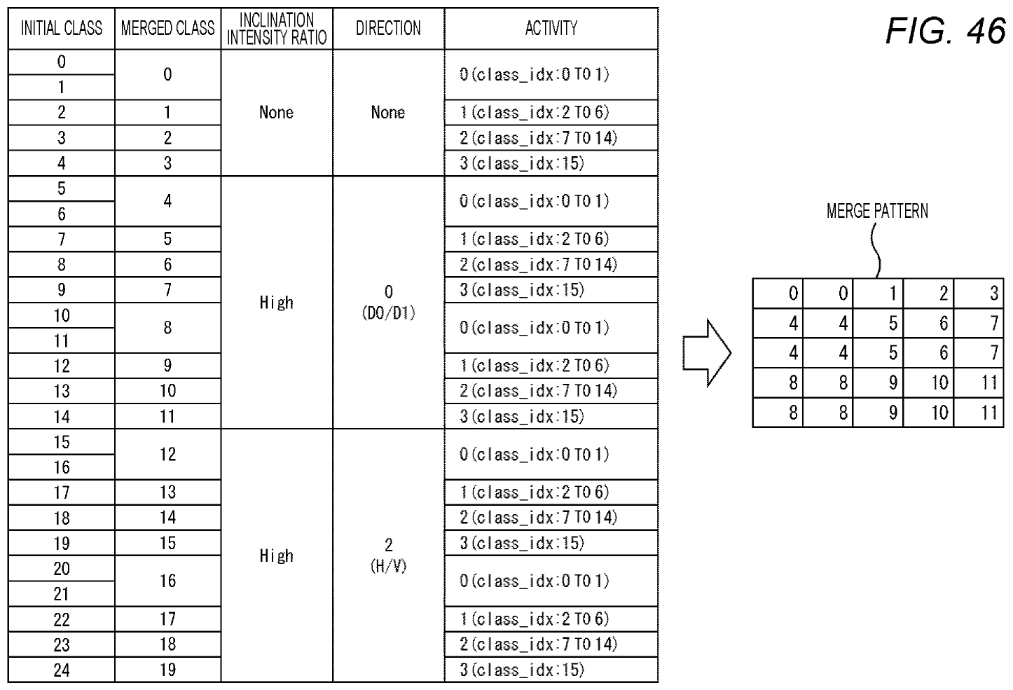

FIG. 46 is a diagram illustrating a merge pattern corresponding to the number of merged classes of twelve obtained by the subclass merging and the subclass merging by which this merge pattern is obtained.

A merge pattern corresponding to the number of merged classes of twelve can be obtained by subclass merging the inclination intensity ratio subclass into two subclasses of the none class and the high class, subclass merging the direction subclass into two subclasses of the D0/D1 class and the H/V class, and subclass merging the activity subclass into four subclasses of the activity subclass 0 corresponding to the index class_idx of 0 and 1, the activity subclass 1 corresponding to the index class_idx of 2 to 6, the activity subclass 2 corresponding to the index class_idx of 7 to 14, and the activity subclass 3 corresponding to the index class_idx of 15.

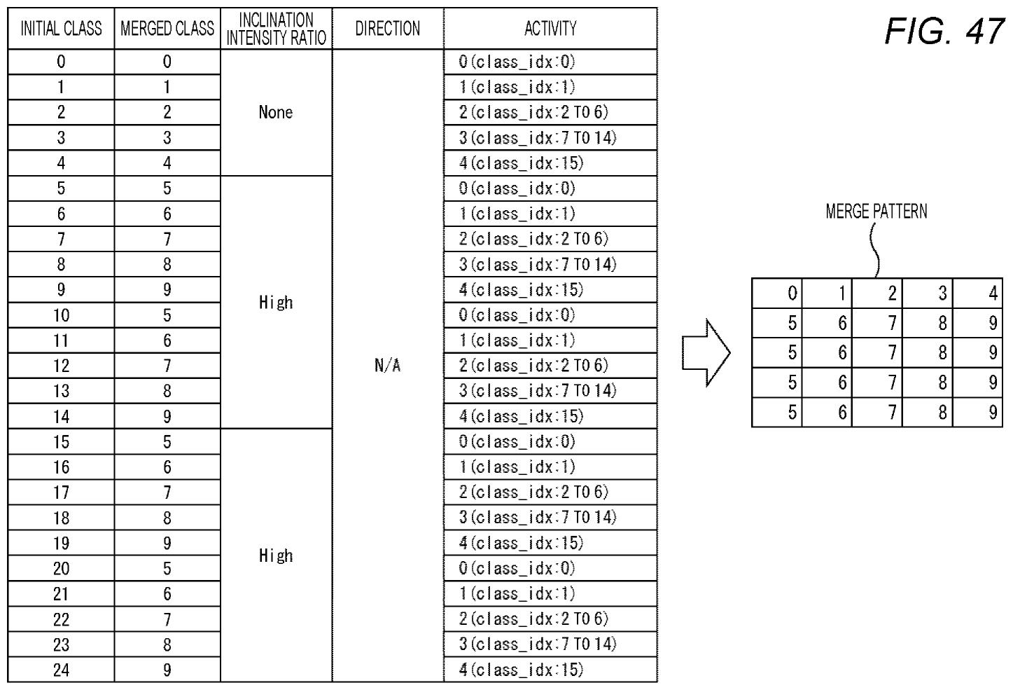

FIG. 47 is a diagram illustrating a merge pattern corresponding to the number of merged classes of ten obtained by the subclass merging and the subclass merging by which this merge pattern is obtained.

A merge pattern corresponding to the number of merged classes of ten can be obtained by subclass merging the inclination intensity ratio subclass into two subclasses of the none class and the high class, subclass merging the direction subclass into one subclass of the N/A class, and subclass merging the activity subclass into five subclasses of the activity subclass 0 corresponding to the index class_idx of 0, the activity subclass 1 corresponding to the index class_idx of 1, the activity subclass 2 corresponding to the index class_idx of 2 to 6, the activity subclass 3 corresponding to the index class_idx of 7 to 14, and the activity subclass 4 corresponding to the index class_idx of 15.

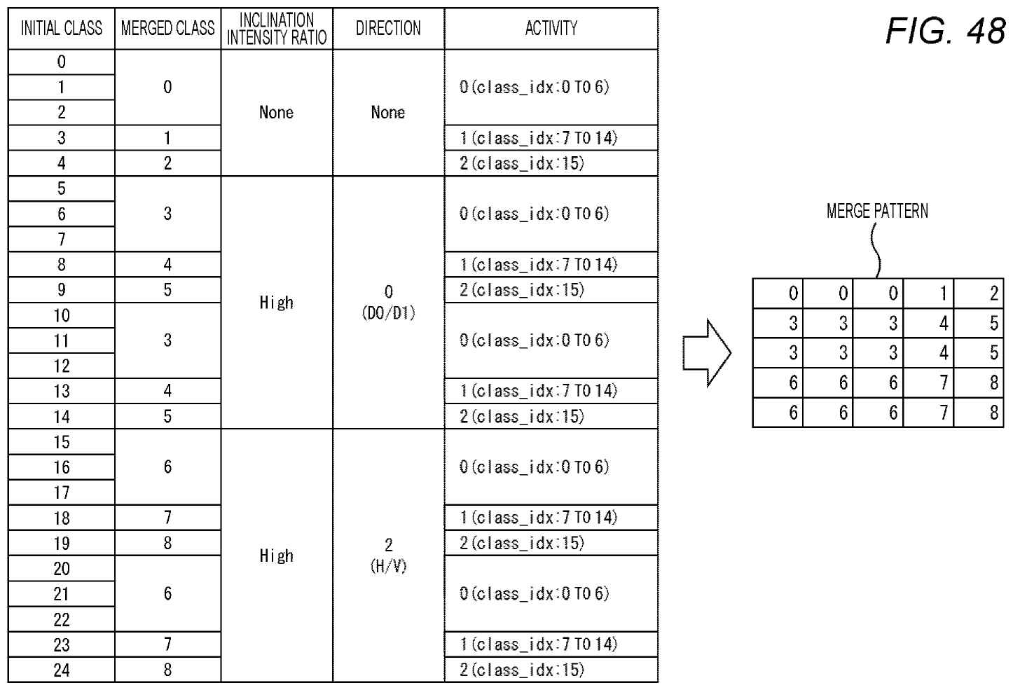

FIG. 48 is a diagram illustrating a merge pattern corresponding to the number of merged classes of nine obtained by the subclass merging and the subclass merging by which this merge pattern is obtained.

A merge pattern corresponding to the number of merged classes of nine can be obtained by subclass merging the inclination intensity ratio subclass into two subclasses of the none class and the high class, subclass merging the direction subclass into two subclasses of the D0/D1 class and the H/V class, and subclass merging the activity subclass into three subclasses of the activity subclass 0 corresponding to the index class_idx of 0 to 6, the activity subclass 1 corresponding to the index class_idx of 7 to 14, and the activity subclass 2 corresponding to the index class_idx of 15.

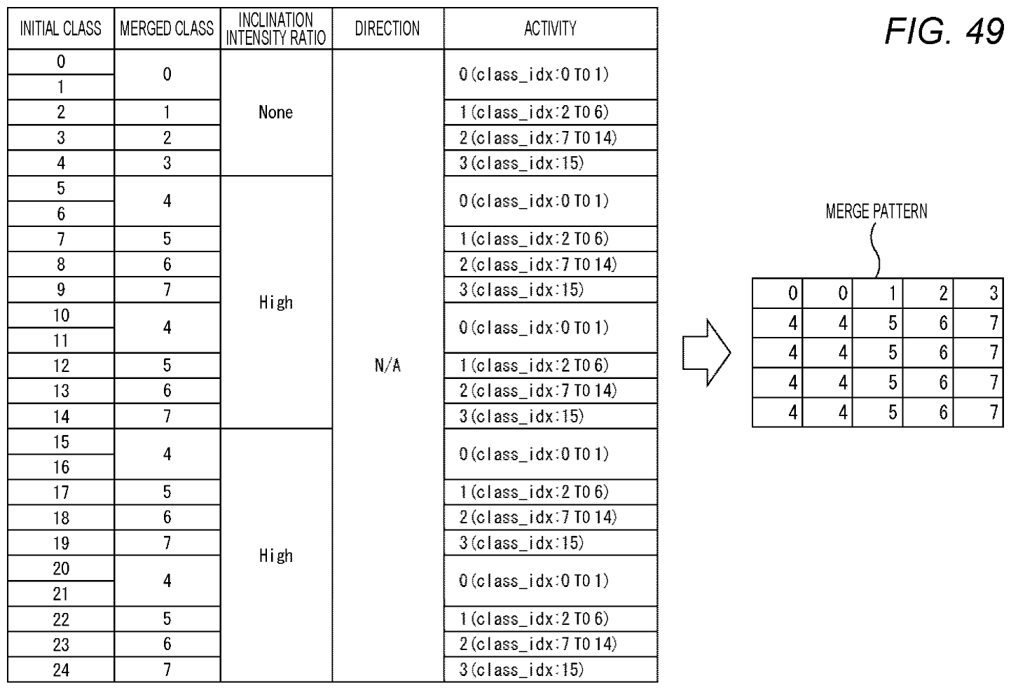

FIG. 49 is a diagram illustrating a merge pattern corresponding to the number of merged classes of eight obtained by the subclass merging and the subclass merging by which this merge pattern is obtained.

A merge pattern corresponding to the number of merged classes of eight can be obtained by subclass merging the inclination intensity ratio subclass into two subclasses of the none class and the high class, subclass merging the direction subclass into one subclass of the N/A class, and subclass merging the activity subclass into four subclasses of the activity subclass 0 corresponding to the index class_idx of 0 and 1, the activity subclass 1 corresponding to the index class_idx of 2 to 6, the activity subclass 2 corresponding to the index class_idx of 7 to 14, and the activity subclass 3 corresponding to the index class_idx of 15.

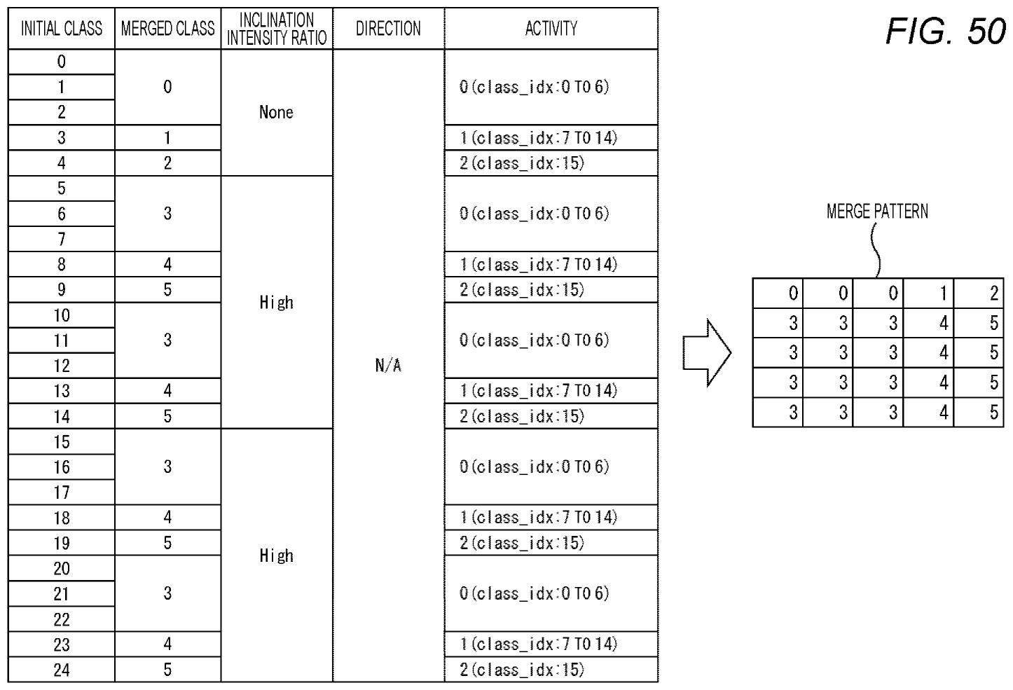

FIG. 50 is a diagram illustrating a merge pattern corresponding to the number of merged classes of six obtained by the subclass merging and the subclass merging by which this merge pattern is obtained.

A merge pattern corresponding to the number of merged classes of six can be obtained by subclass merging the inclination intensity ratio subclass into two subclasses of the none class and the high class, subclass merging the direction subclass into one subclass of the N/A class, and subclass merging the activity subclass into three subclasses of the activity subclass 0 corresponding to the index class_idx of 0 to 6, the activity subclass 1 corresponding to the index class_idx of 7 to 14, and the activity subclass 2 corresponding to the index class_idx of 15.

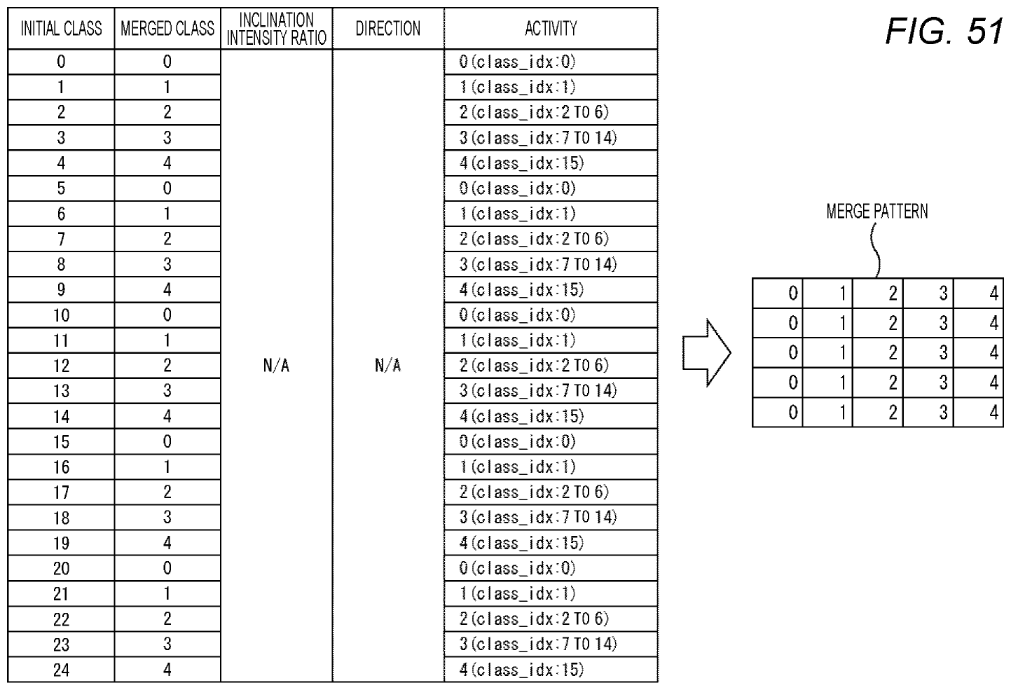

FIG. 51 is a diagram illustrating a merge pattern corresponding to the number of merged classes of five obtained by the subclass merging and the subclass merging by which this merge pattern is obtained.

A merge pattern corresponding to the number of merged classes of five can be obtained by subclass merging the inclination intensity ratio subclass into one subclass of the N/A class, subclass merging the direction subclass into one subclass of the N/A class, and subclass merging the activity subclass into five subclasses of the activity subclass 0 corresponding to the index class_idx of 0, the activity subclass 1 corresponding to the index class_idx of 1, the activity subclass 2 corresponding to the index class_idx of 2 to 6, the activity subclass 3 corresponding to the index class_idx of 7 to 14, and the activity subclass 4 corresponding to the index class_idx of 15.

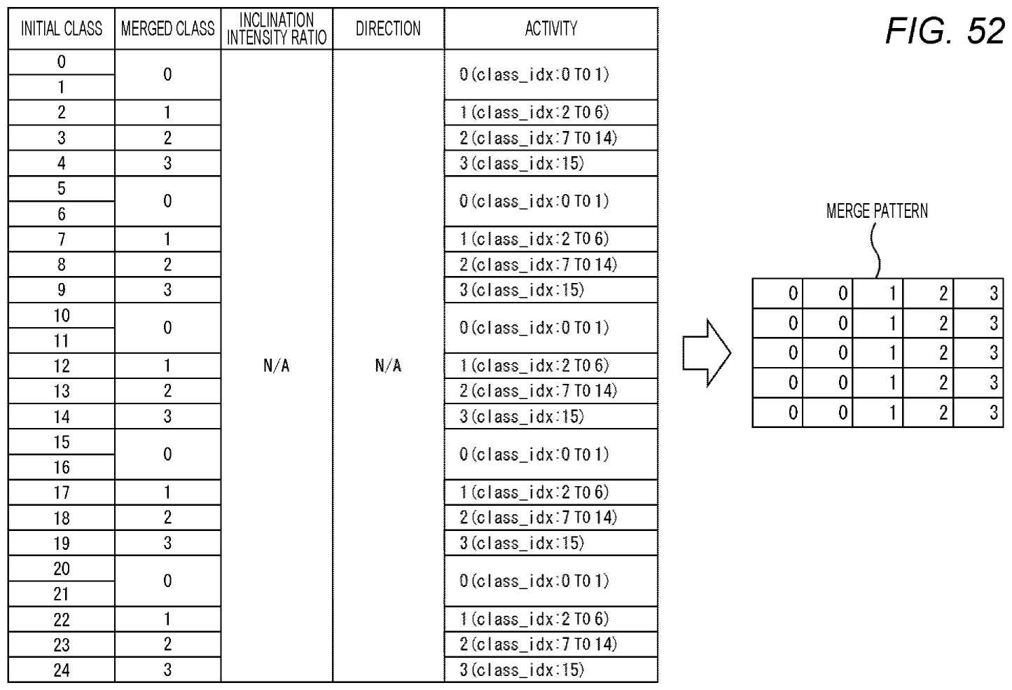

FIG. 52 is a diagram illustrating a merge pattern corresponding to the number of merged classes of four obtained by the subclass merging and the subclass merging by which this merge pattern is obtained.

A merge pattern corresponding to the number of merged classes of four can be obtained by subclass merging the inclination intensity ratio subclass into one subclass of the N/A class, subclass merging the direction subclass into one subclass of the N/A class, and subclass merging the activity subclass into four subclasses of the activity subclass 0 corresponding to the index class_idx of 0 and 1, the activity subclass 1 corresponding to the index class_idx of 2 to 6, the activity subclass 2 corresponding to the index class_idx of 7 to 14, and the activity subclass 3 corresponding to the index class_idx of 15.

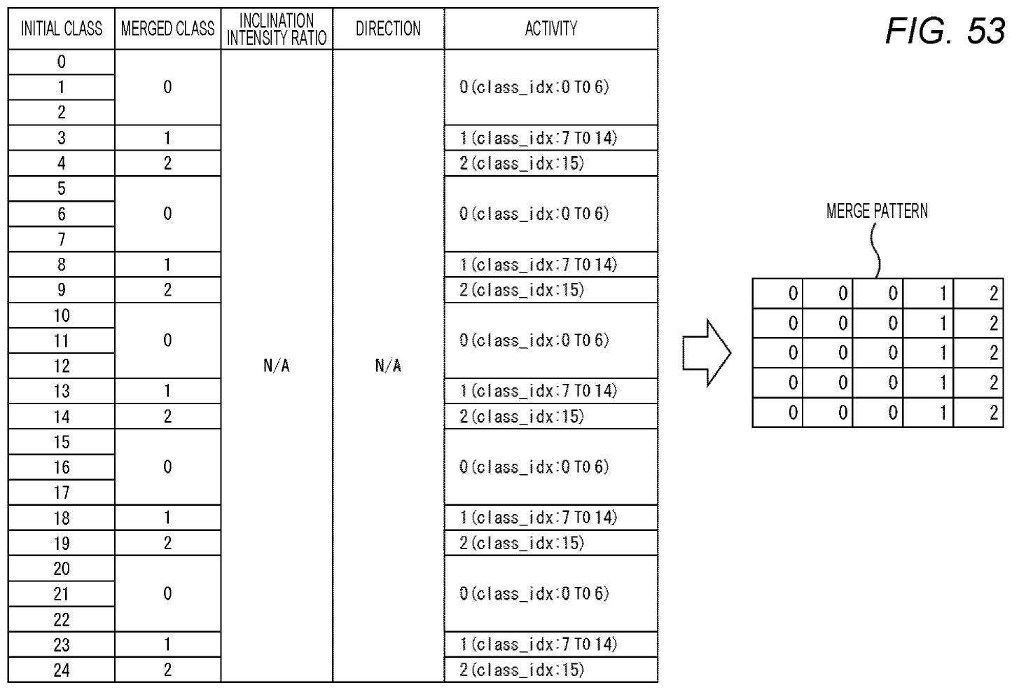

FIG. 53 is a diagram illustrating a merge pattern corresponding to the number of merged classes of three obtained by the subclass merging and the subclass merging by which this merge pattern is obtained.

A merge pattern corresponding to the number of merged classes of three can be obtained by subclass merging the inclination intensity ratio subclass into one subclass of the N/A class, subclass merging the direction subclass into one subclass of the N/A class, and subclass merging the activity subclass into three subclasses of the activity subclass 0 corresponding to the index class_idx of 0 to 6, the activity subclass 1 corresponding to the index class_idx of 7 to 14, and the activity subclass 2 corresponding to the index class_idx of 15.

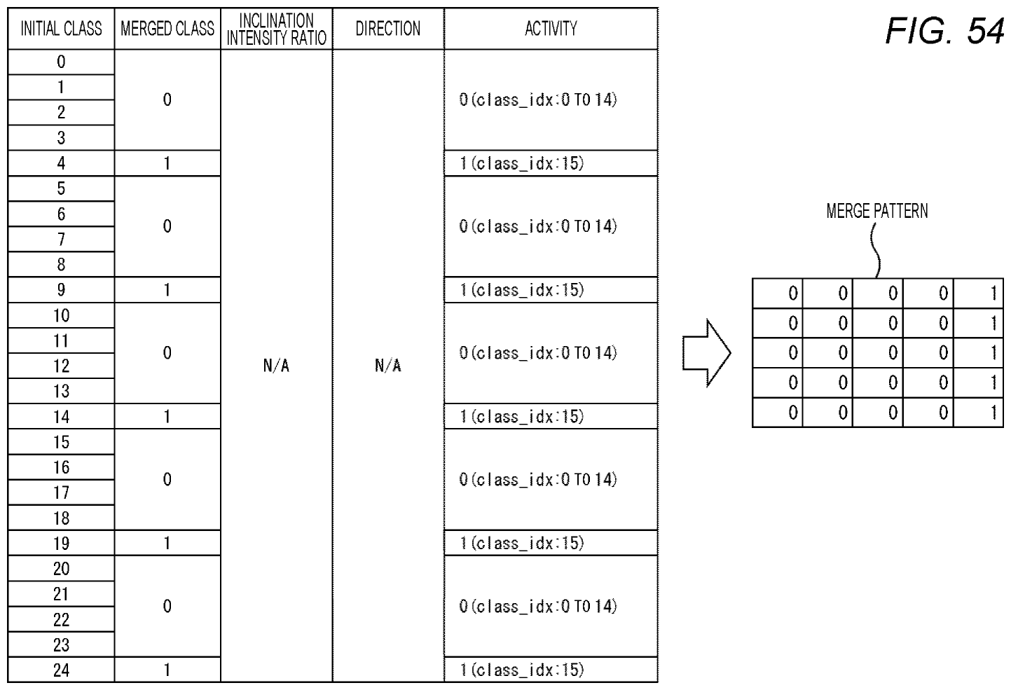

FIG. 54 is a diagram illustrating a merge pattern corresponding to the number of merged classes of two obtained by the subclass merging and the subclass merging by which this merge pattern is obtained.

A merge pattern corresponding to the number of merged classes of two can be obtained by subclass merging the inclination intensity ratio subclass into one subclass of the N/A class, subclass merging the direction subclass into one subclass of the N/A class, and subclass merging the activity subclass into two subclasses of the activity subclass 0 corresponding to the index class_idx of 0 to 14, and the activity subclass 1 corresponding to the index class_idx of 15.

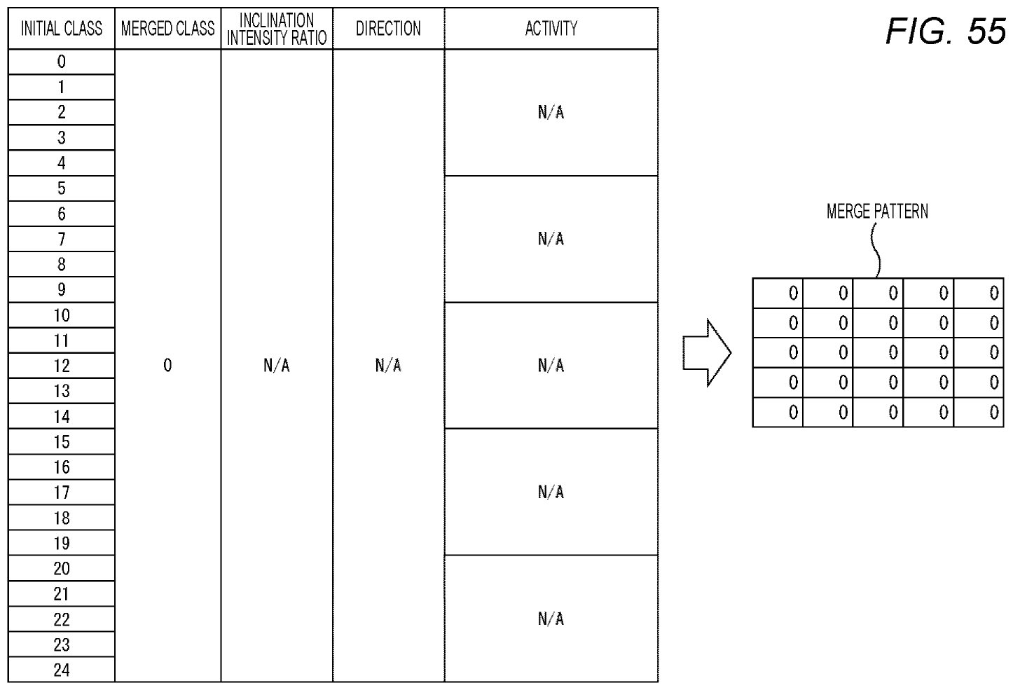

FIG. 55 is a diagram illustrating a merge pattern corresponding to the number of merged classes of one obtained by the subclass merging and the subclass merging by which this merge pattern is obtained.

A merge pattern corresponding to the number of merged classes of one can be obtained by subclass merging the inclination intensity ratio subclass into cne subclass of the N/A class, subclass merging the direction subclass into one subclass of the N/A class, and subclass merging the activity subclass into one subclass of the N/A class (activity subclass corresponding to the index class_idx of 0 to 15).

<Configuration Example of Class Classification Prediction Filter to which Present Technology is Applied>

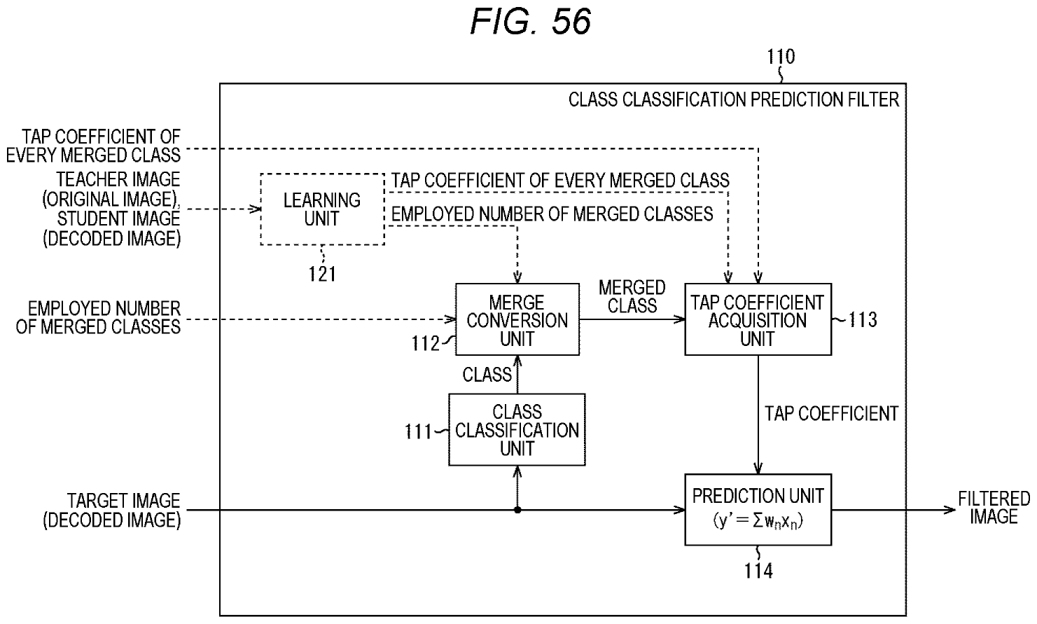

FIG. 56 is a block diagram illustrating a configuration example of a class classification prediction filter to which the present technology is applied.

In a class classification prediction filter 110, a class classification prediction process is performed. In the class classification prediction process, predetermined class classification is performed, and the initial class obtained by the predetermined class classification is converted into a merged class. Then, a filtering process is performed as a prediction process that applies a predictive equation using the tap coefficient of the merged class.

In FIG. 56, the class classification prediction filter 110 has a class classification unit 111, a merge conversion unit 112, a tap coefficient acquisition unit 113, and a prediction unit 114.

A target image (for example, a decoded image) as a target of the filtering process is supplied to the class classification unit 111 and the prediction unit 114.

The class classification unit 111 sequentially selects pixels of the target image as the pixel of interest. The class classification unit 111 obtains the initial class of the pixel of interest by performing, for example, the class classification of the GALF as an initial class classification performed by the subclass classification or the like of each of the plurality of feature amounts on the pixel of interest, and supplies the initial class to the merge conversion unit 112.

The merge conversion unit 112 converts the initial class of the pixel of interest from the class classification unit 111 into a merged class obtained by merging the initial class by merging subclasses of the subclass classification (subclass merging) according to a merge pattern set in advance for every number of merged classes. That is, the merge conversion unit 112 stores merge patterns set in advance for every number of merged classes by, for example, subclass merging of the inclination intensity ratio subclass, the direction subclass, and the activity subclass, and necessary partial merging. Then, the merge conversion unit 112 converts the initial class of the pixel of interest into the merged class according to the merge pattern corresponding to the employed number of merged classes among the merge patterns set in advance for every number of merged classes. The merge conversion unit 112 supplies the merged class of the pixel of interest to the tap coefficient acquisition unit 113.

The tap coefficient acquisition unit 113 stores the tap coefficients of every merged class, and acquires the tap coefficient to be used for the filtering process as a prediction process of the pixel of interest according to the merged class of the pixel of interest from the merge conversion unit 112.

That is, the tap coefficient acquisition unit 113 selects the tap coefficient of the merged class of the pixel of interest from the merge conversion unit 112 from among the tap coefficients of every merged class (tap coefficients for the employed number of merged classes), and supplies the tap coefficient to the prediction unit 114.

The prediction unit 114 performs on the target image the filtering process as a prediction process that applies a predictive equation using the tap coefficient of the merged class of the pixel of interest from the tap coefficient acquisition unit 113, and outputs a filtered image generated by the filtering process.

That is, the prediction unit 114 selects, for example, a plurality of pixels near the pixel of interest among the pixels of the target image as the prediction tap of the pixel of interest. Moreover, the prediction unit 114 performs the prediction process of applying the predictive equation formed by the tap coefficient of the class of the pixel of interest to the target image, that is, calculates a predictive equation y′=Σwₙxₙ formed by (the pixel value of) a pixel xₙ as the prediction tap of the pixel of interest and a tap coefficient wₙ of the merged class of the pixel of interest, thereby obtaining a predicted value y′ of (the pixel value of) the pixel of the predetermined image (image corresponding to the teacher image) (for example, the original image with respect to the decoded image) for the pixel of interest. Then, the prediction unit 114 generates the image having the predicted value y′ as a pixel value and outputs the image as a filtered image.

In the class classification prediction filter 110, the employed number of merged classes and the tap coefficient of every merged class stored in the tap coefficient acquisition unit 113 can be supplied to the class classification prediction filter 110 from the outside.

Further, the class classification prediction filter 110 can incorporate a learning unit 121 that performs the tap coefficient learning. Assuming that the function of performing the tap coefficient learning is a learning function, it can be said that the class classification prediction filter 110 having the learning unit 121 is the class classification prediction filter 110 with the learning function.

In the learning unit 121, the tap coefficient of every merged class can be obtained by using the teacher image and the student image, and can be stored in the tap coefficient acquisition unit 113. Moreover, the learning unit 121 can determine the employed number of merged classes and supply the employed number of merged classes to the merge conversion unit 112.

In a case where the class classification prediction filter 110 is applied to the encoding device, an original image as an encoding target can be employed as the teacher image, and a decoded image obtained by encoding and locally decoding the original image can be employed as the student image.

The learning unit 121 performs class classification similarly to the class classification unit 111 using the decoded image as the student image, and performs for every initial class obtained by the class classification the tap coefficient learning to obtain, by the least squares method, the tap coefficient that statistically minimizes a prediction error of a predicted value of the teacher image obtained by the predictive equation formed by the tap coefficient and the prediction tap.

Furthermore, the learning unit 121 stores the merge pattern corresponding to each of a plurality of numbers of merged classes as the same merge pattern as the merge pattern for every number of merged classes set in advance that is stored in the merge conversion unit 112. The learning unit 121 determines the number of merged classes that minimizes a cost (for example, cost dist+lambda×coeffBit obtained in step S67 in FIG. 8) as the employed number of merged classes among the plurality of numbers of merged classes for which the merge pattern is set in advance, by performing a process similar to the process of determining the employed number of merged classes (FIG. 8) using each of the merge patterns corresponding to the plurality of merged classes set in advance.

Moreover, the learning unit 121 obtains the tap coefficient of every merged class by performing a process similar to steps S36 and S37 in the merge pattern determination process (FIG. 5) in step S63 before the process of step S64, which is the filtering process for obtaining the cost for determining the employed number of merged classes in the process of determining the employed number of merged classes (FIG. 8).

The learning unit 121 supplies the employed number of merged classes to the merge conversion unit 112, and supplies the tap coefficient of every merged class of the employed number of merged classes to the tap coefficient acquisition unit 113.

The merge conversion unit 112 converts the initial class of the pixel of interests from the class classification unit 111 into a merged class according to the merge pattern corresponding to the employed number of merged classes supplied thereto among the merge patterns respectively corresponding to the plurality of numbers of merged classes set in advance.

Because the merge pattern corresponding to each of the plurality of merged classes stored in the merge conversion unit 112 and the learning unit 121 is a merge pattern set for every number of merged classes, the merge pattern can be uniquely identified by the number of merged classes.

the class classification prediction filter 110 is premised on associating the number of merged classes with a merge pattern set in advance as a merge pattern corresponding to the number of merged classes.

Now, information in which the number of merged classes is associated with the merge pattern set in advance as the merge pattern corresponding to the number of merged classes will be referred to as merge information.

The encoding device and the decoding device to which the present technology is applied share the merge information. Then, the encoding device determines the employed number of merged classes from the plurality of numbers of merged classes and transmits the employed number of merged classes to the decoding device. The decoding device identifies the merge pattern with the employed number of merged classes from the encoding device. Then, the decoding device performs the initial class classification, and converts the initial class obtained by the initial class classification into a merged class according to the merge pattern (merge pattern corresponding to the employed number of merged classes) identified with the employed number of merged classes.

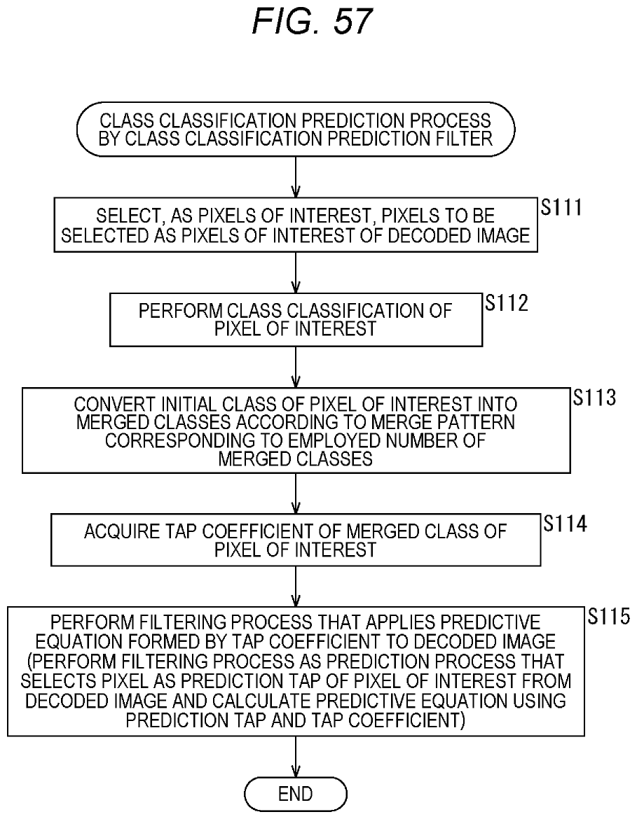

FIG. 57 is a flowchart describing an example of the class classification prediction process performed by the class classification prediction filter 110 of FIG. 56.

In step S111, the class classification unit 111 sequentially selects, as the pixel of interest, the pixels to be selected as the pixel of interest of the decoded image as the target image, and the process proceeds to step S112.

In step S112, the class classification unit 111 performs the initial class classification of the pixel of interest and obtains the initial class of the pixel of interest. The class classification unit 111 supplies the initial class of the pixel of interest to the merge conversion unit 112, and the process proceeds from step S112 to step S113.

In step S113, the merge conversion unit 112 converts the initial class of the pixel of interest from the class classification unit 111 into a merged class according to the merge pattern corresponding to the employed number of merged classes. The merge conversion unit 112 supplies the merged class of the pixel of interest to the tap coefficient acquisition unit 113, and the process proceeds from step S113 to step S114.

In step S114, the tap coefficient acquisition unit 113 acquires the tap coefficient of the merged class of the pixel of interest from the merge conversion unit 112 from the tap coefficients of every merged class, and the process proceeds to step S115.

In step S115, the prediction unit 114 performs the filtering process as a prediction process that applies to the decoded image the predictive equation formed by the tap coefficient of the merged class of the pixel of interest from the tap coefficient acquisition unit 113.

That is, the prediction unit 114 selects a pixel to be the prediction tap of the pixel of interest from the decoded image, and calculates a first-order predictive equation formed by using this prediction tap and the tap coefficient of the merged class of the pixel of interest, to thereby obtain a predicted value of (pixel value of) a pixel of the original image with respect to the pixel of interest. Then, the prediction unit 114 generates an image using the predicted value as a pixel value, outputs the image as a filtered image, and ends the class classification prediction process.

<One Embodiment of Image Processing System to which Present Technology is Applied>

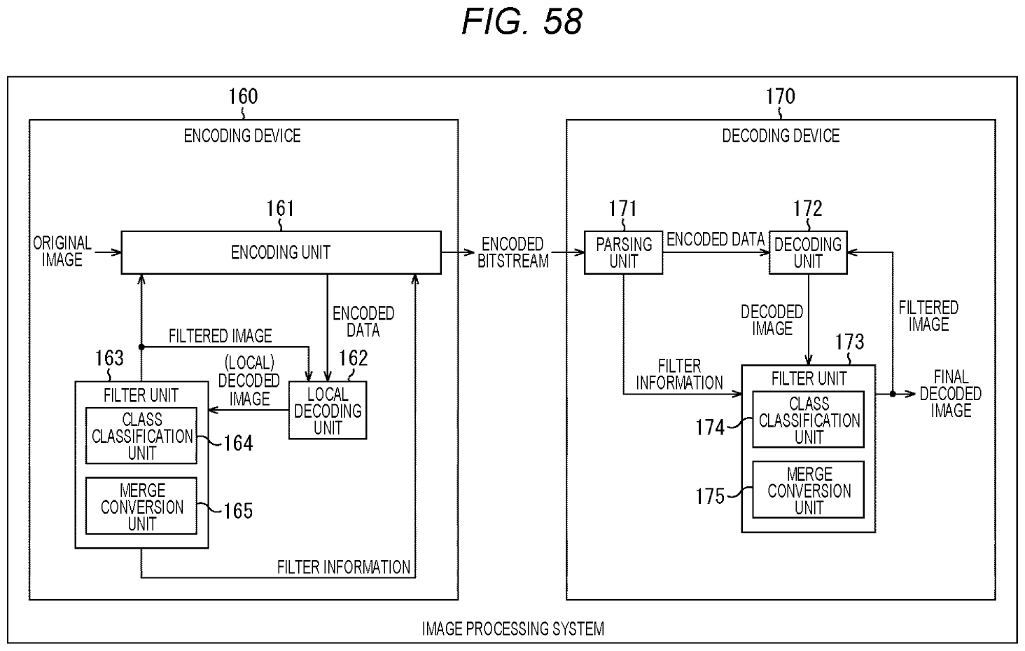

FIG. 58 is a block diagram illustrating an outline of one embodiment of an image processing system to which the present technology is applied.

In FIG. 58, the image processing system has an encoding device 160 and a decoding device 170.

The encoding device 160 has an encoding unit 161, a local decoding unit 162, and a filter unit 163.

The encoding unit 161 is supplied with an original image (data), which is an image as an encoding target, and with a filtered image from the filter unit 163.

The encoding unit 161 (prediction) encodes the original image in, for example, predetermined block units, such as CU of a quad-tree block structure or a quad tree plus binary tree (QTBT) block structure, by using the filtered image from the filter unit 163, and supplies encoded data obtained by the encoding to the local decoding unit 162.

That is, the encoding unit 161 subtracts from the original image a predicted image of the original image obtained by performing motion compensation of the filtered image from the filter unit 163, and encodes a residual obtained as a result.

Filter information is supplied to the encoding unit 161 from the filter unit 163.

The encoding unit 161 generates and transmits (sends) an encoded bitstream including the encoded data and the filter information from the filter unit 163.

The local decoding unit 162 is supplied with the encoded data from the encoding unit 161, and with the filtered image from the filter unit 163.

The local decoding unit 162 performs local decoding of the encoded data from the encoding unit 161 by using the filtered image from the filter unit 163, and supplies a (local) decoded image obtained as a result to the filter unit 163.

That is, the local decoding unit 162 decodes the encoded data from the encoding unit 161 into a residual, and adds a predicted image of the original image obtained by performing motion compensation of the filtered image from the filter unit 163 to the residual, to thereby generate a decoded image (locally decoded image) obtained by decoding the original image.

The filter unit 163 is configured similarly to, for example, the class classification prediction filter 110 (FIG. 56) with the learning function, and includes a class classification unit 164 and a merge conversion unit 165.

The filter unit 163 uses the decoded image from the local decoding unit 162 and the original image for the decoded image as the student image and the teacher image to perform the tap coefficient learning, and obtains a tap coefficient of every class.

Furthermore, by performing a process similar to the process of determining the employed number of merged classes (FIG. 8) using the merge pattern set in advance for each of the plurality of numbers of merged classes, the filter unit 163 determines the number of merged classes that minimizes the cost as the employed number of merged classes, among the plurality of numbers of merged classes for which the merge pattern is set in advance.

Moreover, upon determining the employed number of merged classes, the filter unit 163 performs a process similar to steps S36 and S37 of the merge pattern determination process (FIG. 5) using (X matrix and Y vector of) a normal equation obtained by the tap coefficient learning, to thereby obtain the tap coefficient of every merged class of the employed number of merged classes.

Then, the filter unit 163 performs, in the class classification unit 164, for example, the class classification of the GALF or the like as the initial class classification performed by the subclass classification of a plurality of feature amounts using the decoded image from the local decoding unit 162, so as to obtain the initial class of the pixel of interest. Moreover, the filter unit 163 converts, in the merge conversion unit 165, the initial class of the pixel of interest into a merged class obtained by merging the initial class by merging the subclasses of the subclass classification according to the merge pattern corresponding to the employed number of merged classes. Then, the filter unit 163 performs the filtering process as the prediction process that applies to the decoded image a predictive equation that performs a product-sum operation of the tap coefficient of the merged class of the pixel of interest obtained by conversion by the merge conversion unit 165 and pixels of the decoded image.

The filter unit 163 supplies the filtered image obtained by the filtering process to the encoding unit 161 and the local decoding unit 162. Moreover, the filter unit 163 supplies the employed number of merged classes and the tap coefficient of every merged class of this employed number of merged classes to the encoding unit 161 as the filter information.

Note that, here, although the number of merged classes that minimizes the cost among the plurality of numbers of merged classes for which the merge pattern is set in advance is determined as the employed number of merged classes in the encoding device 160, for the employed number of merged classes, the number of merged classes of a specific merge pattern among the plurality of numbers of merged classes for which the merge pattern is set in advance can be determined in advance as the employed number of merged classes. In this case, it is not necessary to obtain the cost for determining the employed number of merged classes, the processing amount of the encoding device 160 can be reduced.

As described above, determining the employed number of merged classes in advance is effective, for example, particularly in a case where the performance of the encoding device 160 is not high.

The decoding device 170 has a parsing unit 171, a decoding unit 172, and a filter unit 173.

The parsing unit 171 receives the encoded bitstream transmitted by the encoding device 160, performs parsing, and supplies filter information obtained by the parsing to the filter unit 173. Moreover, the parsing unit 171 supplies the encoded data included in the encoded bitstream to the decoding unit 172.

The decoding unit 172 is supplied with the encoded data from the parsing unit 171, and with a filtered image from the filter unit 173.

The decoding unit 172 decodes the encoded data from the parsing unit 171 using the filtered image from the filter unit 173 in units of predetermined blocks such as CU, similarly to the encoding unit 161 for example, and supplies a decoded image obtained as a result to the filter unit 173.

That is, the decoding unit 172, similarly to the local decoding unit 162, decodes the encoded data from the parsing unit 171 into a residual, and adds a predicted image of the original image obtained by performing motion compensation of the filtered image from the filter unit 173 to the residual, to thereby generate a decoded image obtained by decoding the original image.

The filter unit 173 is configured similarly to, for example, the class classification prediction filter 110 (FIG. 56) without the learning function, and includes a class classification unit 174 and a merge conversion unit 175.

The filter unit 173 performs a filtering process similar to that of the filter unit 163 on the decoded image from the decoding unit 172 to generate a filtered image, and supplies the filtered image to the decoding unit 172.

That is, the filter unit 173 performs, in the class classification unit 174, the same initial class classification as the class classification unit 164 using the decoded image from the decoding unit 172, and obtains the initial class of the pixel of interest. Moreover, the filter unit 173 converts, in the merge conversion unit 175, the initial class of the pixel of interest into a merged class in which the initial class is merged by merging (subclass merging) the subclass of the subclass classification, according to the merge pattern corresponding to the employed number of merged classes included in the filter information from the parsing unit 171. Then, the filter unit 173 performs the filtering process as the prediction process that applies to the decoded image the predictive equation that performs the product-sum operation of the tap coefficient of the merged class of the pixel of interest obtained by conversion by the merge conversion unit 175 and the pixels of the decoded image. The tap coefficient of the merged class of the pixel of interest used in the filtering process is acquired from the tap coefficient of every merged class included in the filter information from the parsing unit 171.

The filter unit 173 supplies the filtered image obtained by the filtering process to the decoding unit 172, and outputs the filtered image as a final decoded image obtained by decoding the original image.

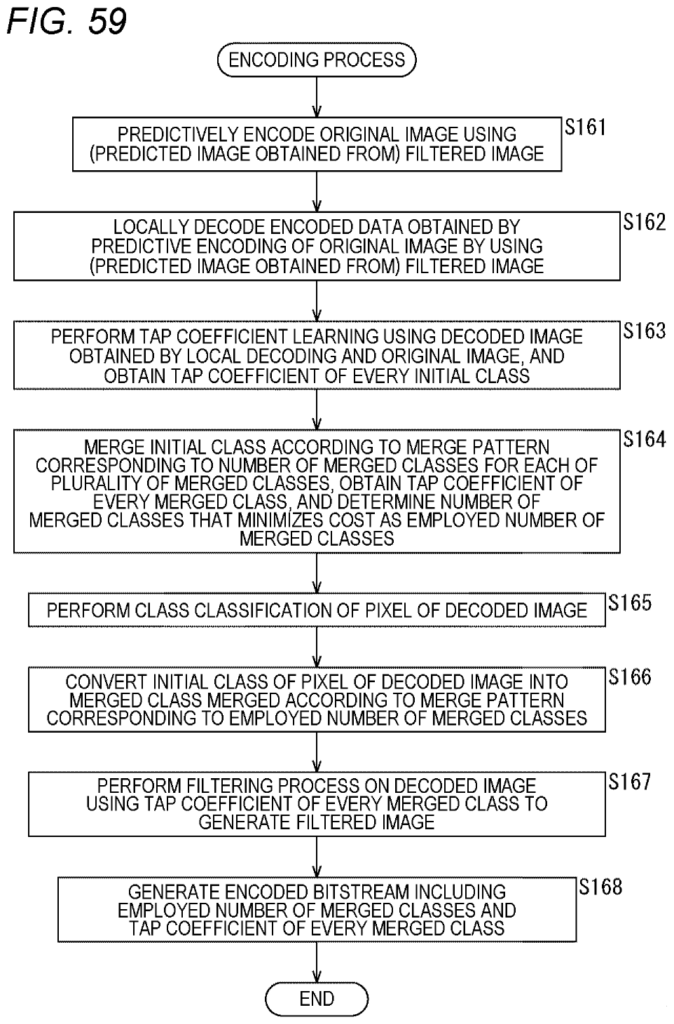

FIG. 59 is a flowchart describing an outline of an encoding process of the encoding device 160 of FIG. 58.

The process according to the flowchart of FIG. 59 is performed, for example, in frame (picture) units.

In step S161, the encoding unit 161 (FIG. 58) (predictively) encodes the original image using the filtered image from the filter unit 163, and supplies encoded data obtained by the encoding to the local decoding unit 162, and the process proceeds to step S162.

In step S162, the local decoding unit 162 performs local decoding of the encoded data from the encoding unit 161 by using the filtered image from the filter unit 163, and supplies a (local) decoded image obtained as a result to the filter unit 163, and the process proceeds to step S163.

In step S163, the filter unit 163 performs the tap coefficient learning using the decoded image from the local decoding unit 162 and the original image for the decoded image as the student image and the teacher image, and obtains the tap coefficient for every initial class, and the process proceeds to step S164.

In step S164, the filter unit 163 merges the initial class according to the merge pattern corresponding to the number of merged classes for each of the plurality of numbers of merged classes for which the merge pattern is set in advance, and obtains, using (X matrix and Y vector of) the normal equation obtained by the tap coefficient learning to obtain the tap coefficient of every initial class, the tap coefficient of every merged class in which the initial class is merged according to the merge pattern corresponding to the number of merged classes, as described in steps S36 and S37 of FIG. 5. Moreover, the filter unit 163 determines the number of merged classes that minimizes the cost as the employed number of merged classes by using the tap coefficient of every merged class, and the process proceeds from step S164 to step S165.

In step S165, the class classification unit 164 of the filter unit 163 performs the initial class classification of the pixel of interest of the decoded image from the local decoding unit 162, and the process proceeds to step S166.

In step S166, the merge conversion unit 165 of the filter unit 163 converts the initial class of the pixel of interest obtained by the class classification of the class classification unit 164 into a merged class according to the merge pattern corresponding to the employed number of merged classes, and the process proceeds to step S167.

In step S167, the filter unit 163 performs the filtering process as the prediction process that applies to the decoded image the predictive equation that performs the product-sum operation of the tap coefficient of the merged class of the pixel of interest among the tap coefficients of every merged class obtained in step S164 and the pixels of the decoded image, so as to generate a filtered image. The filtered image is supplied from the filter unit 163 to the encoding unit 161 and the local decoding unit 162. The filtered image supplied from the filter unit 163 to the encoding unit 161 and the local decoding unit 162 is used in the process of steps S161 and S162 performed for the next frame.

Furthermore, the filter unit 163 supplies the employed number of merged classes and the tap coefficient of every merged class to the encoding unit 161 as the filter information.

Thereafter, the process proceeds from step S167 to step S168, and the encoding unit 161 generates and transmits an encoded bitstream including the encoded data obtained in step S161 and the employed number of merged classes and the tap coefficient of every merged class as the filter information obtained by the filter unit 163.

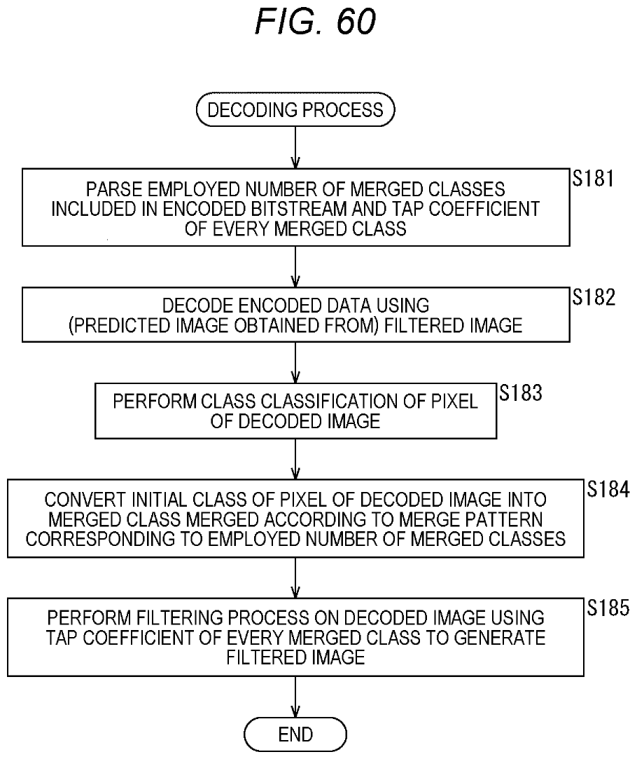

FIG. 60 is a flowchart describing an outline of a decoding process of the decoding device 170 of FIG. 58.

The process according to the flowchart of FIG. 60 is performed, for example, in frame units similarly to the encoding process of FIG. 59.

In step S181, the parsing unit 171 (FIG. 58) receives the encoded bitstream transmitted from the encoding device 160, parses the employed number of merged classes and the tap coefficient of every merged class as the filter information included in the encoded bitstream, and supplies them to the filter unit 173. Moreover, the parsing unit 171 supplies the encoded data included in the encoded bitstream to the decoding unit 172, and the process proceeds from step S181 to step S182.

In step S182, the decoding unit 172 decodes the encoded data from the parsing unit 171 by using the filtered image from the filter unit 173, and supplies a decoded image obtained as a result to the filter unit 173, and the process proceeds to step S183.

In step S183, the class classification unit 174 of the filter unit 173 performs the initial class classification on the pixel of interest of the decoded image from the decoding unit 172, and the process proceeds to step S184.

In step S184, the merge conversion unit 175 of the filter unit 173 converts the initial class of the pixel of interest obtained by the class classification of the class classification unit 174 into a merged class according to the merge pattern corresponding to the employed number of merged classes from the parsing unit 171, and the process proceeds to step S185.

In step S185, the filter unit 173 performs the filtering process as the class classification prediction process on the decoded image from the decoding unit 172 by using the tap coefficient of every merged class from the parsing unit 171, so as to generate a filtered image.

That is, the filter unit 173 performs the filtering process as the prediction process that applies to the decoded image the predictive equation that performs the product-sum operation of the tap coefficient of the merged class of the pixel of interest among the tap coefficients of every merged class from the parsing unit 171 and the pixels of the decoded image, so as to generate a filtered image.

The filtered image is supplied from the filter unit 173 to the decoding unit 172, and is output as a final decoded image obtained by decoding the original image.

The filtered image supplied from the filter unit 173 to the decoding unit 172 is used in the process of step S182 performed for the next frame of the decoded image.

Note that, here, as a method of signaling the merge pattern (employed merge pattern) that converts the initial class into the merged class, a method of transmitting the employed number of merged classes by including in the encoded bitstream is employed, but as the method of signaling the employed merge pattern, it is possible to employ a method of transmitting the employed merge pattern by including in the encoded bitstream together with the employed number of merged classes similarly to the case of the GALF or instead of the employed number of merged classes. However, overhead can be reduced by transmitting the employed number of merged classes as compared with the case of transmitting the employed merge pattern. On the other hand, in the case of transmitting the employed merge pattern, a syntax similar to the class classification of the GALF can be employed.

<Configuration Example of Encoding Device 160>

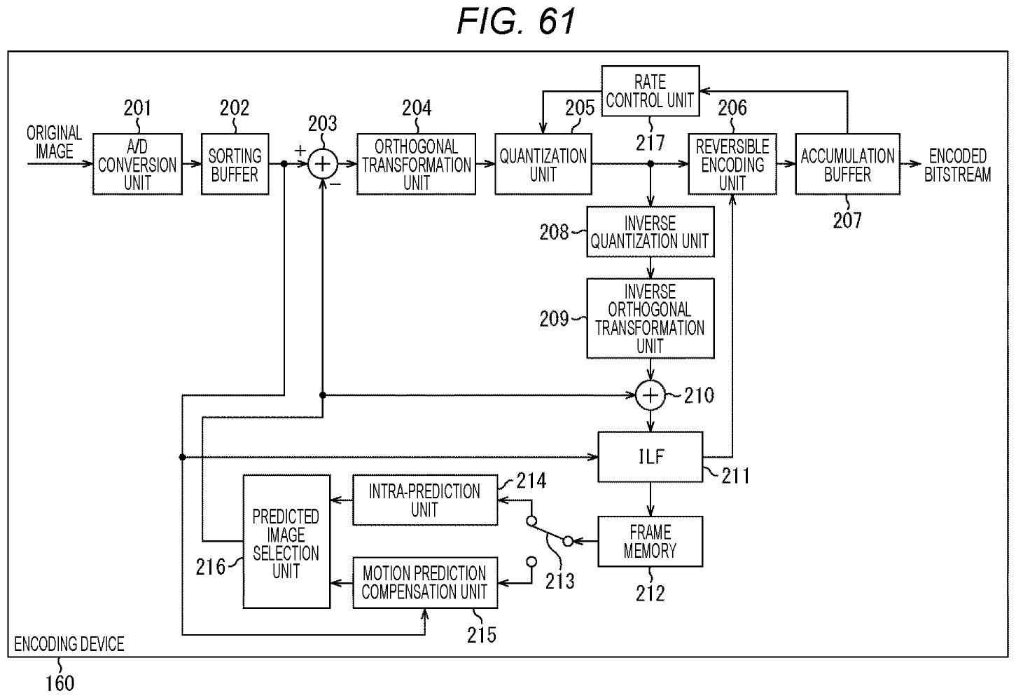

FIG. 61 is a block diagram illustrating a detailed configuration example of the encoding device 160 of FIG. 58.

Note that in the block diagram described below, a description of a line that supplies information (data) required for processing of each block is omitted as appropriate in order to avoid complicating the diagram.

In FIG. 61, the encoding device 160 includes an A/D conversion unit 201, a sorting buffer 202, a calculation unit 203, an orthogonal transformation unit 204, a quantization unit 205, a reversible encoding unit 206, and an accumulation buffer 207. Moreover, the encoding device 160 includes an inverse quantization unit 208, an inverse orthogonal transformation unit 209, a calculation unit 210, an ILF 211, a frame memory 212, a selection unit 213, an intra-prediction unit 214, a motion prediction compensation unit 215, a predicted image selection unit 216, and a rate control unit 217.

The A/D conversion unit 201 performs A/D conversion of the original image of an analog signal into the original image of a digital signal, and supplies the original image to the sorting buffer 202 for storage.

The sorting buffer 202 sorts frames of the original image in an order of encoding (decoding) from a display order according to a group of picture (GOP), and supplies it to the calculation unit 203, the intra-prediction unit 214, the motion prediction compensation unit 215, and the ILF 211.

The calculation unit 203 subtracts the predicted image supplied from the intra-prediction unit 214 or the motion prediction compensation unit 215 via the predicted image selection unit 216 from the original image from the sorting buffer 202, and supplies a residual obtained by the subtraction (predicted residual) to the orthogonal transformation unit 204.

For example, in a case of an image to be intercoded, the calculation unit 203 subtracts the predicted image supplied from the motion prediction compensation unit 215 from the original image read from the sorting buffer 202.

The orthogonal transformation unit 204 performs orthogonal transformation such as discrete cosine transformation and Karhunen-Loeve transformation on the residual supplied from the calculation unit 203. Note that the method of this orthogonal transformation is arbitrary. The orthogonal transformation unit 204 supplies an orthogonal transformation coefficient obtained by orthogonal exchange to the quantization unit 205.

The quantization unit 205 quantizes the orthogonal transformation coefficient supplied from the orthogonal transformation unit 204. The quantization unit 205 sets the quantization parameter QP on the basis of a target value of a code amount (code amount target value) supplied from the rate control unit 217, and performs quantization of the orthogonal transformation coefficient. Note that a method for this quantization is arbitrary. The quantization unit 205 supplies the encoded data, which is the quantized orthogonal transformation coefficient, to the reversible encoding unit 206.

The reversible encoding unit 206 encodes the quantized orthogonal transformation coefficient as the encoded data from the quantization unit 205 by a predetermined reversible encoding method. Because the orthogonal transformation coefficient is quantized under the control of the rate control unit 217, the code amount of the encoded bitstream obtained by reversible encoding of the reversible encoding unit 206 becomes a code amount target value (or approximates the code amount target value) set by the rate control unit 217.

Furthermore, the reversible encoding unit 206 acquires the encoding information necessary for decoding by the decoding device 170 from each block among the encoding information related to the predictive encoding in the encoding device 160.

Here, as the encoding information, for example, there is information such as a prediction mode of intra-prediction or inter-prediction, motion information such as motion vector, code amount target value, quantization parameter QP, picture type (I, P, B), coding unit (CU), and coding tree unit (CTU), and the like.

For example, the prediction mode can be acquired from the intra-prediction unit 214 or the motion prediction compensation unit 215. Furthermore, for example, the motion information can be acquired from the motion prediction compensation unit 215.

In addition to acquiring the encoding information, the reversible encoding unit 206 also acquires the tap coefficient for every class from the ILF 211 as the filter information related to the filtering process in the ILF 211.

The reversible encoding unit 206 encodes the encoding information and the filter information by variable length encoding, for example, context-adaptive variable length coding (CAVLC), context-adaptive binary arithmetic coding (CABAC), or the like, or arithmetic encoding or other reversible encoding to generate an encoded bitstream including the encoding information and the filter information after encoding and the encoded data from the quantization unit 205 and supplies the encoded bit stream to the accumulation buffer 207.

The accumulation buffer 207 temporarily accumulates the encoded bitstream supplied from the reversible encoding unit 206. The encoded bitstream accumulated in the accumulation buffer 207 is read out and transmitted at a predetermined timing.

The encoded data, which is the orthogonal transformation coefficient quantized in the quantization unit 205, is supplied to the reversible encoding unit 206 and also to the inverse quantization unit 208. The inverse quantization unit 208 inversely quantizes the quantized orthogonal transformation coefficient by a method corresponding to the quantization by the quantization unit 205, and supplies the orthogonal transformation coefficient obtained by the inverse quantization to the inverse orthogonal transformation unit 209.

The inverse orthogonal transformation unit 209 performs inverse orthogonal transformation of the orthogonal transformation coefficient supplied from the inverse quantization unit 208 by a method corresponding to the orthogonal transformation process by the orthogonal transformation unit 204, and supplies a residual obtained as a result of the inverse orthogonal transformation to the calculation unit 210.

The calculation unit 210 adds the predicted image supplied from the intra-prediction unit 214 or the motion prediction compensation unit 215 via the predicted image selection unit 216 to the residual supplied from the inverse orthogonal transformation unit 209, and thereby obtains (a part of) a decoded image obtained by decoding the original image and outputs the decoded image.

The decoded image output by the calculation unit 210 is supplied to the ILF 211.

The ILF 211 is configured similarly to the class classification prediction filter 110 with the learning function (FIG. 56), for example, and functions as one or two or more filters of a deblocking filter, an adaptive offset filter, a bilateral filter, and an ALF by performing the filtering process as the class classification prediction process. In a case where the ILF 211 is configured to function as two or more filters of a deblocking filter, an adaptive offset filter, a bilateral filter, and an ALF, the arrangement order of the two or more filters is arbitrary.

The decoded image is supplied to the ILF 211 from the calculation unit 210, and the original image for the decoded image is supplied from the sorting buffer 202.

The ILF 211 stores the merge information in which a plurality of merged classes is associated with a merge pattern set in advance for every number of merged classes.

The ILF 211 uses, for example, the decoded image from the calculation unit 210 and the original image from the sorting buffer 202 as the student image and the teacher image, respectively, to perform the tap coefficient learning, and obtains the tap coefficient for every initial class. In the tap coefficient learning, the initial class classification is performed using the decoded image as the student image, and the tap coefficient is obtained by the least squares method, the tap coefficient statistically minimizing the prediction error of the predicted value of the original image as the teacher image obtained by the predictive equation formed by the tap coefficient and the prediction tap for every initial class obtained by the initial class classification.

The ILF 211 performs a process similar to the process of determining the employed number of merged classes (FIG. 8) by using the merge pattern corresponding to each of the plurality of merged classes included in the merge information, so as to determine as the employed number of merged classes the number of merged classes that minimizes the cost (for example, the cost dist+lambda×coeffBit obtained in step S67 in FIG. 8) among the plurality of merged classes included in the merge information.

Note that in the ILF 211, in step S63 before the process of step S64, which is the filtering process for obtaining the cost of determining the employed number of merged classes in the process of determining the employed number of merged classes (FIG. 8), similarly to steps S36 and S37 in the merge pattern determination process (FIG. 5), the tap coefficient of every merged class is obtained for each of the plurality of numbers of merged classes included in the merge information by using (X matrix and Y vector of) the normal equation that is formulated when obtaining the tap coefficient for every initial class in the tap coefficient learning.

The ILF 211 supplies the employed number of merged classes and the tap coefficient of every merged class of the employed number of merged classes to the reversible encoding unit 206 as the filter information.

Furthermore, the ILF 211 sequentially selects, for example, pixels of the decoded image from the calculation unit 210 as the pixel of interest. The ILF 211 performs the initial class classification on the pixel of interest and obtains the initial class of the pixel of interest.

Moreover, the ILF 211 converts the initial class of the pixel of interest into the merged class according to the merge pattern corresponding to the employed number of merged classes. The ILF 211 acquires (reads) the tap coefficient of the merged class of the pixel of interest among the tap coefficients of every merged class obtained by conversion according to the merge pattern corresponding to the employed number of merged classes. Then, the ILF 211 selects a pixel near the pixel of interest as the prediction tap from the decoded image, and performs the filtering process as the prediction process that applies to the decoded image the predictive equation that performs the product-sum operation of the tap coefficient of the merged class of the pixel of interest and the pixels of the decoded image as the prediction tap, so as to generate a filtered image. Note that in the class classification in the ILF 211, for example, the class obtained by the class classification of an upper left pixel of 2×2 pixels of the decoded image can be employed as the class of each of the 2×2 pixels.

The filtered image generated by ILF 211 is supplied to the frame memory 212.

The frame memory 212 temporarily stores the filtered image supplied from the ILF 211. The filtered image stored in the frame memory 212 is supplied to the selection unit 213 as a reference image used for generating the predicted image at a necessary timing.

The selection unit 213 selects a supply destination of the reference image supplied from the frame memory 212. For example, in a case where the intra-prediction unit 214 performs intra-prediction, the selection unit 213 supplies the reference image supplied from the frame memory 212 to the intra-prediction unit 214. Furthermore, for example, in a case where the motion prediction compensation unit 215 performs inter-prediction, the selection unit 213 supplies the reference image supplied from the frame memory 212 to the motion prediction compensation unit 215.

The intra-prediction unit 214 performs intra-prediction (in-screen prediction) using the original image supplied from the sorting buffer 202 and the reference image supplied from the frame memory 212 via the selection unit 213 and, for example, using the prediction unit (PU) as a processing unit. The intra-prediction unit 214 selects an optimum intra-prediction mode on the basis of a predetermined cost function (for example, RD cost or the like), and supplies the predicted image generated in the optimum intra-prediction mode to the predicted image selection unit 216. Furthermore, as described above, the intra-prediction unit 214 appropriately supplies the reversible encoding unit 206 and the like with a prediction mode indicating the intra-prediction mode selected on the basis of the cost function.

The motion prediction compensation unit 215 performs the motion prediction (inter-prediction) using the original image supplied from the sorting buffer 202 and the reference image supplied from the frame memory 212 via the selection unit 213 and using, for example, the PU as a processing unit. Moreover, the motion prediction compensation unit 215 performs motion compensation according to the motion vector detected by the motion prediction, and generates a predicted image. The motion prediction compensation unit 215 performs inter-prediction in a plurality of inter-prediction modes prepared in advance and generates a predicted image.

The motion prediction compensation unit 215 selects an optimum inter-prediction mode on the basis of a predetermined cost function of the predicted image obtained for each of the plurality of inter-prediction modes. Moreover, the motion prediction compensation unit 215 supplies the predicted image generated in the optimum inter-prediction mode to the predicted image selection unit 216.

Furthermore, the motion prediction compensation unit 215 supplies the prediction mode indicating the inter-prediction mode selected on the basis of the cost function, and motion information such as a motion vector needed for decoding encoded data encoded in this inter-prediction mode, and the like to the reversible encoding unit 206.

The predicted image selection unit 216 selects a supply source of the predicted image (intra-prediction unit 214 or motion prediction compensation unit 215) to be supplied to the calculation unit 203 and the calculation unit 210, and supplies the prediction image supplied from the selected supply source to the calculation unit 203 and the calculation unit 210.

The rate control unit 217 controls the rate of quantization operation of the quantization unit 205 on the basis of the code amount of the encoded bitstream accumulated in the accumulation buffer 207 so that overflow or underflow does not occur. That is, the rate control unit 217 sets a target code amount of the encoded bitstream and supplies the target code amount to the quantization unit 205 so that overflow and underflow of the accumulation buffer 207 do not occur.

Note that in FIG. 61, the calculation unit 203 to the reversible encoding unit 206 correspond to the encoding unit 161 of FIG. 58, the inverse quantization unit 208 to the calculation unit 210 correspond to the local decoding unit 162 of FIG. 58, and the ILF 211 correspond to the filter unit 163 of FIG. 58.

<Encoding Process>

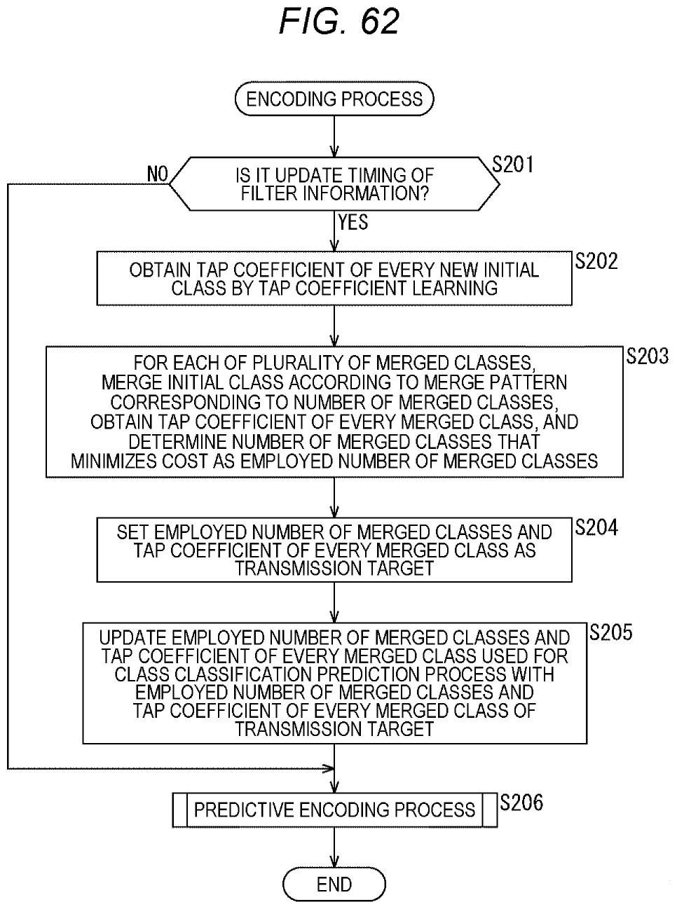

FIG. 62 is a flowchart describing an example of the encoding process of the encoding device 160 of FIG. 61.

Note that the order of respective steps of the encoding process illustrated in FIG. 62 and the like is an order for convenience of explanation, and each step of the actual encoding process is performed in a necessary order in parallel as appropriate. The same applies to processes described later.

In the encoding device 160, the ILF 211 temporarily stores the decoded image supplied from the calculation unit 210, and temporarily stores the original image, which is supplied from the sorting buffer 202, for the decoded image from the calculation unit 210.

Then, the encoding device 160 (control unit that is not illustrated) determines in step S201 whether or not the current timing is an update timing for updating the filter information.

Here, the update timing of the filter information can be decided in advance, for example, for every one or more frames (picture), for every one or more sequences, for every one or more slices, for every one or more lines of a predetermined block such as CTU, and the like.

Furthermore, as the update timing of the filter information, in addition to the periodic (fixed) timing such as a timing for every one or more frames (picture), it is possible to employ what is called a dynamic timing such as a timing when S/N of the filtered image becomes equal to or less than a threshold (timing when an error of the filtered image with respect to the original image becomes equal to or greater than a threshold) or a timing when (the sum of absolute value or the like of) a residual becomes equal to or greater than the threshold.

Here, for example, it is assumed that the ILF 211 performs the tap coefficient learning using one frame of the decoded image and the original image, and the timing for every frame is the update timing of the filter information.

In a case where it is determined in step S201 that the current timing is not the update timing of the filter information, the process skips steps S202 to 5205 and proceeds to step S206.

Furthermore, in a case where it is determined in step S201 that the current timing is the update timing of the filter information, the process proceeds to step S202, and the ILF 211 performs the tap coefficient learning for obtaining the tap coefficient for every initial class.

That is, the ILF 211 uses, for example, the decoded image and the original image (here, the decoded image and the original image of the latest one-frame supplied to the ILF 211) stored between the previous update timing and the current update timing, so as to perform the tap coefficient learning to obtain the tap coefficient for every initial class.

In step S203, the ILF 211 converts each of the plurality of merged classes included in the merge information into a merged class by merging the initial class according to the merge pattern corresponding to the number of merged classes, and similarly to steps S36 and S37 in FIG. 5, the tap coefficient of every merged class is obtained by using the normal equation formulated by the tap coefficient learning.

Moreover, the ILF 211 obtains the cost (for example, the cost dist +lambda x coeffBit obtained in step S67 in FIG. 8) by performing the filtering process for each of the plurality of numbers of merged classes by using the tap coefficient of every merged class. Then, the ILF 211 determines the number of merged classes that minimizes the cost among the plurality of merged classes as the employed number of merged classes, and the process proceeds from step S203 to step S204.

In step S204, the ILF 211 supplies the employed number of merged classes and the tap coefficient of every merged class of the employed number of merged classes to the reversible encoding unit 206 as the filter information. The reversible encoding unit 206 sets the filter information from the ILF 211 as a transmission target, and the process proceeds from step S204 to step S205. The filter information set as the transmission target is included in the encoded bitstream and transmitted in the predictive encoding process performed in step S206 described later.

In step S205, the ILF 211 updates the employed number of merged classes and the tap coefficient used for the class classification prediction process with the employed number of merged classes and the tap coefficient of every merged class of the employed number of merged classes determined in the latest step S203, and the process proceeds to step S206.

In step S206, the predictive encoding process of the original image is performed, and the encoding process ends.

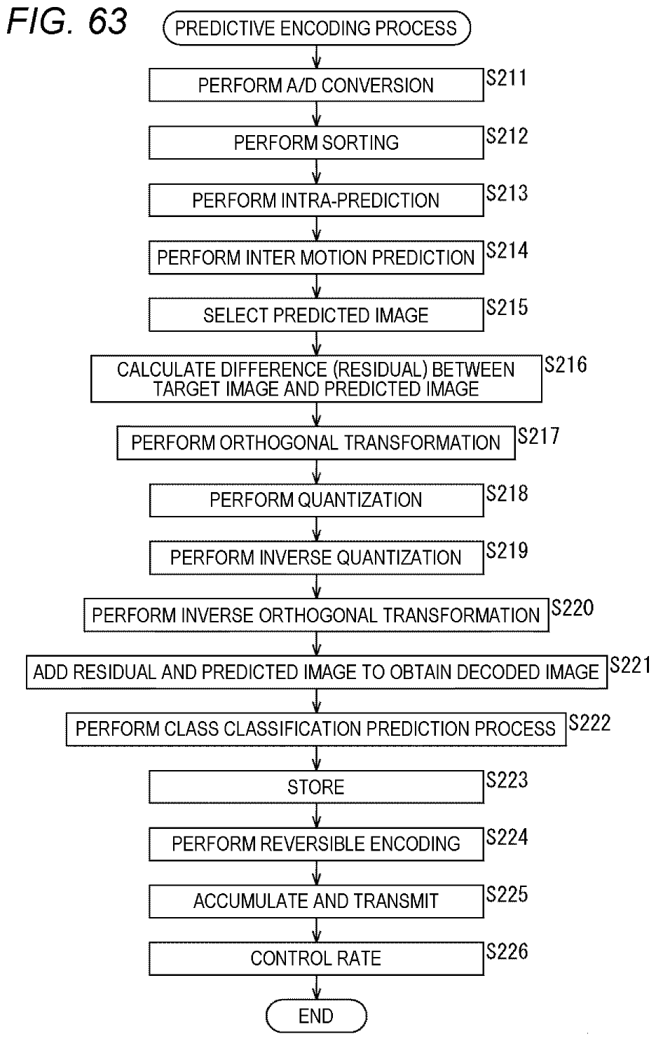

FIG. 63 is a flowchart describing an example of the predictive encoding process in step S206 of FIG. 62.

In the predictive encoding process, in step S211, the A/D conversion unit 201 performs A/D conversion of the original image and supplies the original image to the sorting buffer 202, and the process proceeds to step S212.

In step S212, the sorting buffer 202 stores the original image from the A/D conversion unit 201, sorts and outputs the original image in the encoding order, and the process proceeds to step S213.

In step S213, the intra-prediction unit 214 performs the intra-prediction process in the intra-prediction mode, and the process proceeds to step S214. In step S214, the motion prediction compensation unit 215 performs an inter-motion prediction process for performing motion prediction and motion compensation in the inter-prediction mode, and the process proceeds to step S215.

In the intra-prediction process of the intra-prediction unit 214 and the inter-motion prediction process of the motion prediction compensation unit 215, cost functions of various prediction modes are calculated and predicted images are generated.

In step S215, the predicted image selection unit 216 determines an optimum prediction mode on the basis of respective cost functions obtained by the intra-prediction unit 214 and the motion prediction compensation unit 215. Then, the predicted image selection unit 216 selects and outputs the predicted image of the optimum prediction mode from the predicted images generated by the intra-prediction unit 214 and the predicted image generated by the motion prediction compensation unit 215, and the process proceeds from step S215 to step S216.

In step S216, the calculation unit 203 calculates a residual between the target image of the encoding target, which is the original image output by the sorting buffer 202, and the predicted image output by the predicted image selection unit 216, supplies the residual to the orthogonal transformation unit 204, and the process proceeds to step S217.

In step S217, the orthogonal transformation unit 204 orthogonally converts the residual from the calculation unit 203, supplies the orthogonal transformation coefficient obtained as a result to the quantization unit 205, and the process proceeds to step S218.

In step S218, the quantization unit 205 quantizes the orthogonal transformation coefficient from the orthogonal transformation unit 204, and supplies a quantization coefficient obtained by the quantization to the reversible encoding unit 206 and the inverse quantization unit 208, and the process proceeds to step S219.

In step S219, the inverse quantization unit 208 inversely quantizes the quantization coefficient from the quantization unit 205, supplies an orthogonal transformation coefficient obtained as a result to the inverse orthogonal transformation unit 209, and the process proceeds to step S220. In step S220, the inverse orthogonal transformation unit 209 performs inverse orthogonal transformation of the orthogonal transformation coefficient from the inverse quantization unit 208, supplies a residual obtained as a result to the calculation unit 210, and the process proceeds to step 5221.

In step S221, the calculation unit 210 adds the residual from the inverse orthogonal transformation unit 209 and the predicted image output by the predicted image selection unit 216, and generates a decoded image corresponding to the original image that is the target of residual calculation in the calculation unit 203. The calculation unit 210 supplies the decoded image to the ILF 211, and the process proceeds from step S221 to step 5222.

In step S222, the ILF 211 applies the filtering process as the class classification prediction process to the decoded image from the calculation unit 210, supplies a filtered image obtained by the filtering process to the frame memory 212, and the process proceeds from step S222 to step S223.

In the class classification prediction process of step S222, a process similar to that of the class classification prediction filter 110 (FIG. 56) is performed.

That is, the ILF 211 performs the initial class classification on the pixel of interest of the decoded image from the calculation unit 210, and obtains the initial class of the pixel of interest. Moreover, the ILF 211 converts the initial class of the pixel of interest into a merged class according to the merge pattern corresponding to the employed number of merged classes updated in step S205 of FIG. 62. The ILF 211 acquires the tap coefficient of the merged class of the pixel of interest from the tap coefficient of every merged class updated in step S205 of FIG. 62. Thereafter, the ILF 211 performs on the decoded image the filtering process as the prediction process that applies the predictive equation formed by using the tap coefficient of the merged class of the pixel of interest, so as to generate a filtered image. The filtered image is supplied from the ILF 211 to the frame memory 212.

In step S223, the frame memory 212 stores the filtered image supplied from the ILF 211 and the process proceeds to step S224. The filtered image stored in the frame memory 212 is used as the reference image from which the predicted image is generated in steps S213 and S114.

In step S224, the reversible encoding unit 206 encodes the encoded data, which is the quantization coefficient from the quantization unit 205, and generates an encoded bitstream including the encoded data. Moreover, the reversible encoding unit 206 encodes the encoding information such as the quantization parameter QP used for the quantization in the quantization unit 205, the prediction mode obtained in the intra-prediction process by the intra-prediction unit 214, and, the prediction mode and motion information and the like obtained in the inter-motion prediction process by the motion prediction compensation unit 215 as necessary, and includes the encoding information in the encoded bitstream.

Furthermore, the reversible encoding unit 206 encodes the filter information set as the transmission target in step S203 of FIG. 62 as necessary, and includes the filter information in the encoded bitstream. Then, the reversible encoding unit 206 supplies the encoded bitstream to the accumulation buffer 207, and the process proceeds from step S224 to step S225.

In step S225, the accumulation buffer 207 accumulates the encoded bitstream from the reversible encoding unit 206, and the process proceeds to step S226. The encoded bitstream accumulated in the accumulation buffer 207 is appropriately read and transmitted.

In step S226, the rate control unit 217 controls the rate of quantization operation of the quantization unit 205 so that overflow or underflow does not occur on the basis of the code amount (generated code amount) of the encoded bitstream accumulated in the accumulation buffer 207, and the encoding process ends.

<Configuration Example of Decoding Device 170>

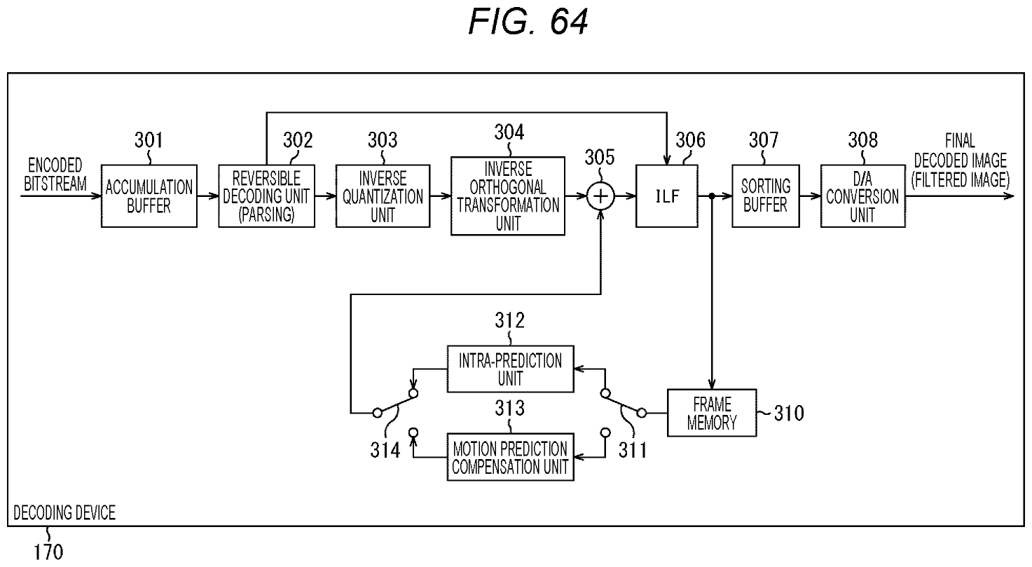

FIG. 64 is a block diagram illustrating a detailed configuration example of the decoding device 170 of FIG. 58.

In FIG. 64, the decoding device 170 has an accumulation buffer 301, a reversible decoding unit 302, an inverse quantization unit 303, an inverse orthogonal transformation unit 304, a calculation unit 305, an ILF 306, a sorting buffer 307, and a D/A conversion unit 308. Further, the decoding device 170 has a frame memory 310, a selection unit 311, an intra-prediction unit 312, a motion prediction compensation unit 313, and a selection unit 314.

The accumulation buffer 301 temporarily accumulates the encoded bitstream transmitted from the encoding device 160, and supplies the encoded bitstream to the reversible decoding unit 302 at a predetermined timing.

The reversible decoding unit 302 receives the encoded bitstream from the accumulation buffer 301 and decodes the encoded bitstream by a method corresponding to the encoding method of the reversible encoding unit 206 of FIG. 61.

Then, the reversible decoding unit 302 supplies the quantization coefficient as the encoded data included in a decoding result of the encoded bitstream to the inverse quantization unit 303.

Furthermore, the reversible decoding unit 302 has a function of performing parsing. The reversible decoding unit 302 parses necessary encoding information and filter information included in the decoding result of the encoded bitstream, and supplies the encoding information to the intra-prediction unit 312, the motion prediction compensation unit 313, and other necessary blocks. Moreover, the reversible decoding unit 302 supplies the filter information to the ILF 306.

The inverse quantization unit 303 inversely quantizes the quantization coefficient as the encoded data from the reversible decoding unit 302 by a method corresponding to the quantization method of the quantization unit 205 in FIG. 61, and supplies the orthogonal transformation coefficient obtained by the inverse-quantization to the inverse orthogonal transformation unit 304.

The inverse orthogonal transformation unit 304 performs inverse orthogonal transformation of the orthogonal transformation coefficient supplied from the inverse quantization unit 303 by a method corresponding to the orthogonal transformation method of the orthogonal transformation unit 204 of FIG. 61, and supplies a residual obtained as a result to the calculation unit 305.

Besides that the residual is supplied from the inverse orthogonal transformation unit 304, the calculation unit 305 is supplied with the predicted image from the intra-prediction unit 312 or the motion prediction compensation unit 313 via the selection unit 314.

The calculation unit 305 adds the residual from the inverse orthogonal transformation unit 304 and the predicted image from the selection unit 314 to generate a decoded image, and supplies the decoded image to the ILF 306.

The IFL306 stores merge information similar to that in the ILF 211 (FIG. 61).

The ILF 306 is configured similarly to, for example, the class classification prediction filter 110 (FIG. 56) without the learning function, and functions as one or two or more filters of the deblocking filter, the adaptive offset filter, the bilateral filter, and the ALF similarly to the ILF 211 in FIG. 61 by performing the filtering process as the class classification prediction process.

The ILF 306 sequentially selects pixels of the decoded image from the calculation unit 305 as the pixel of interest. The ILF 306 performs the initial class classification on the pixel of interest and obtains the initial class of the pixel of interest. Moreover, the ILF 211 converts the initial class of the pixel of interest into a merged class according to the merge pattern corresponding to the employed number of merged classes included in the filter information supplied from the reversible decoding unit 302 among the merge patterns included in the merge information. The ILF 306 acquires the tap coefficient of the merged class of the pixel of interest among the tap coefficients of every merged class included in the filter information supplied from the reversible decoding unit 302. Then, the ILF 306 selects a pixel near the pixel of interest as the prediction tap from the decoded image, and performs the filtering process as the prediction process that applies to the filtered image the predictive equation that performs the product-sum operation of the tap coefficient of the class of the pixel of interest and the pixels of the decoded image as the prediction tap, so as to generate and output a filtered image. Note that in the class classification in the ILF 306, for example, the class obtained by the class classification of an upper left pixel of 2×2 pixels can be employed as the class of each of the 2×2 pixels, similarly to the ILF 211.

The filtered image output by the ILF 306 is an image similar to the filtered image output by the ILF 211 in FIG. 61, and is supplied to the sorting buffer 307 and the frame memory 310.

The sorting buffer 307 temporarily stores the filtered image supplied from the ILF 306, sorts an arrangement of frames (pictures) of the filtered image from the order of encoding (decoding) to a display order, and supplies the filtered image to the D/A conversion unit 308.

The D/A conversion unit 308 D/A-converts the filtered image supplied from the sorting buffer 307 and outputs the filtered image to a display (not illustrated) for display.

The frame memory 310 temporarily stores the filtered image supplied from the ILF 306. Moreover, the frame memory 310 supplies the filtered image as the reference image to be used for generating the predicted image to the selection unit 311, at a predetermined timing or on the basis of an external request such as the intra-prediction unit 312 or the motion prediction compensation unit 313.

The selection unit 311 selects the supply destination of the reference image supplied from the frame memory 310. In a case of decoding the intra-encoded image, the selection unit 311 supplies the reference image supplied from the frame memory 310 to the intra-prediction unit 312. Furthermore, in a case of decoding the inter-encoded image, the selection unit 311 supplies the reference image supplied from the frame memory 310 to the motion prediction compensation unit 313.

The intra-prediction unit 312 performs the intra-prediction using the reference image supplied from the frame memory 310 via the selection unit 311 in the intra-prediction mode used in the intra-prediction unit 214 of FIG. 61, according to the prediction mode included in the encoding information supplied from the reversible decoding unit 302. Then, the intra-prediction unit 312 supplies a predicted image obtained by the intra-prediction to the selection unit 314.

The motion prediction compensation unit 313 performs the inter-prediction using the reference image supplied from the frame memory 310 via the selection unit 311 in the inter-prediction mode used in the motion prediction compensation unit 215 of FIG. 61, according to the prediction mode included in the encoding information supplied from the reversible decoding unit 302. Inter-prediction is performed by using the motion information or the like included in the encoding information supplied from the reversible decoding unit 302 as necessary.

The motion prediction compensation unit 313 supplies the predicted image obtained by the inter-prediction to the selection unit 314.

The selection unit 314 selects the predicted image supplied from the intra-prediction unit 312 or the predicted image supplied from the motion prediction compensation unit 313, and supplies the predicted image to the calculation unit 305.

Note that in FIG. 64, the reversible decoding unit 302 corresponds to the parsing unit 171 of FIG. 58, the inverse quantization unit 303 to the calculation unit 305 correspond to the decoding unit 172 of FIG. 58, and the ILF 306 corresponds to the filter unit 173 of FIG. 58.

<Decoding Process>

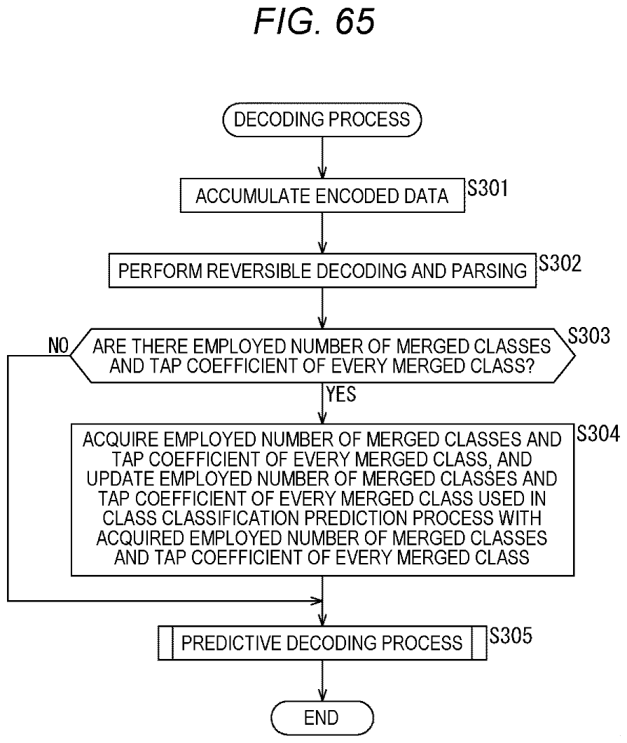

FIG. 65 is a flowchart describing an example of the decoding process of the decoding device 170 of FIG. 64.

In the decoding process, in step S301, the accumulation buffer 301 temporarily accumulates the encoded bitstream transmitted from the encoding device 160 and supplies the encoded bitstream to the reversible decoding unit 302 as appropriate, and the process proceeds to step S302.

In step S302, the reversible decoding unit 302 receives and decodes the encoded bitstream supplied from the accumulation buffer 301, and supplies a quantization coefficient as encoded data included in a decoding result of the encoded bitstream to the inverse quantization unit 303.

Furthermore, in a case where the decoding result of the encoded bitstream includes filter information and encoding information, the reversible decoding unit 302 parses the filter information and the encoding information. Then, the reversible decoding unit 302 supplies necessary encoding information to the intra-prediction unit 312, the motion prediction compensation unit 313, and other necessary blocks. Furthermore, the reversible decoding unit 302 supplies the filter information to the ILF 306.

Thereafter, the process proceeds from step S302 to step S303, and the ILF 306 determines whether or not the filter information including the employed number of merged classes and the tap coefficient of every merged class of the employed number of merged classes has been supplied from the reversible decoding unit 302.

In a case where it is determined in step S303 that the filter information has not been supplied, the process skips step S304 and proceeds to step S305.

Furthermore, in a case where it is determined in step S303 that the filter information has been supplied, the process proceeds to step S304, and the ILF 306 acquires the employed number of merged classes and the tap coefficient of every merged class of the employed number of merged classes included in the filter information from the reversible decoding unit 302. Moreover, the ILF 306 updates the employed number of merged classes and the tap coefficient used in the class classification prediction process by the employed number of merged classes and the tap coefficient of every merged class of the employed number of merged classes acquired from the filter information from the reversible decoding unit 302.

Then, the process proceeds from step S304 to step S305, the predictive decoding process is performed, and the decoding process ends.

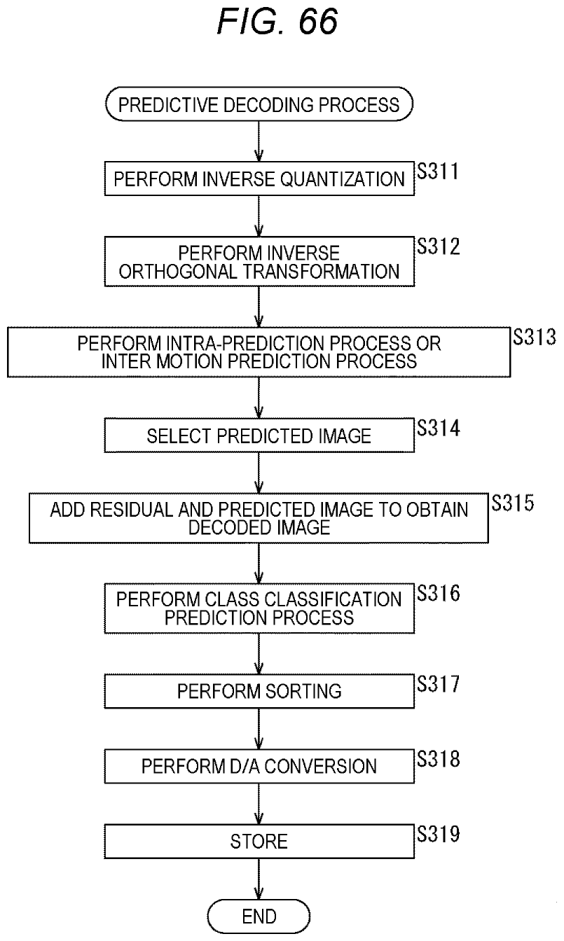

FIG. 66 is a flowchart describing an example of the predictive decoding process of step S305 of FIG. 65.

In step S311, the inverse quantization unit 303 inversely quantizes the quantization coefficient from the reversible decoding unit 302, supplies an orthogonal transformation coefficient obtained as a result to the inverse orthogonal transformation unit 304, and the process proceeds to step S312.

In step S312, the inverse orthogonal transformation unit 304 performs inverse orthogonal transformation of the orthogonal transformation coefficient from the inverse quantization unit 303, supplies a residual obtained as a result to the calculation unit 305, and the process proceeds to step S313.

In step S313, the intra-prediction unit 312 or the motion prediction compensation unit 313 performs the intra-prediction process or inter-motion prediction process for generating a predicted image by using the reference image supplied from the frame memory 310 via the selection unit 311 and the encoding information supplied from the reversible decoding unit 302. Then, the intra-prediction unit 312 or the motion prediction compensation unit 313 supplies a predicted image obtained by the intra-prediction process or the inter-motion prediction process to the selection unit 314, and the process proceeds from step S313 to step S314.

In step S314, the selection unit 314 selects the predicted image supplied from the intra-prediction unit 312 or the motion prediction compensation unit 313, and supplies the predicted image to the calculation unit 305, and the process proceeds to step S315.

In step S315, the calculation unit 305 generates a decoded image by adding the residual from the inverse orthogonal transformation unit 304 and the predicted image from the selection unit 314. Then, the calculation unit 305 supplies the decoded image to the ILF 306, and the process proceeds from step S315 to step S316.

In step S316, the ILF 306 applies the filtering process as the class classification prediction process to the decoded image from the calculation unit 305, and supplies a filtered image obtained by the filtering process to the sorting buffer 307 and the frame memory 310, and the process proceeds from step S316 to step S317.

In the class classification prediction process of step S316, a process similar to that of the class classification prediction filter 110 (FIG. 56) is performed.

That is, the ILF 306 performs the same initial class classification as the ILF 211 on the pixel of interest of the decoded image from the calculation unit 305, and obtains the initial class of the pixel of interest. Moreover, the ILF 306 converts the initial class of the pixel of interest into a merged class according to the merge pattern corresponding to the employed number of merged classes updated in step S304 of FIG. 65 among the merge patterns included in the merge information. The ILF 306 acquires the tap coefficient of the merged class of the pixel of interest among the tap coefficient of every merged class updated in step S304 of FIG. 65. Thereafter, the ILF 306 performs the filtering process as the prediction process that applies the predictive equation formed by the tap coefficient of the merged class of the pixel of interest to the decoded image, so as to generate a filtered image. The filtered image is supplied from the ILF 306 to the sorting buffer 307 and the frame memory 310.

In step S317, the sorting buffer 307 temporarily stores the filtered image supplied from the ILF 306. Moreover, the sorting buffer 307 sorts the stored filtered image in the display order and supplies the stored filtered image to the D/A conversion unit 308, and the process proceeds from step S317 to step S318.

In step S318, the D/A conversion unit 308 performs D/A conversion of the filtered image from the sorting buffer 307, and the process proceeds to step S319. The filtered image after the D/A conversion is output and displayed on a display (not illustrated).

In step S319, the frame memory 310 stores the filtered image supplied from the ILF 306, and the decoding process ends. The filtered image stored in the frame memory 310 is used as the reference image from which the predicted image is generated in the intra-prediction process or the inter-motion prediction process in step S313.

<Other Example of Merge Pattern Set in Advance>

In a case where a merge pattern is set for every number of merged classes, even in a case where there is a plurality of merge patterns for a predetermined (value of the) number of merged classes, one merge pattern of a plurality of merge patterns is selected (and set) as the merge pattern corresponding to the predetermined number of merged classes by the merge pattern selection. Here, in a case where a plurality of merge patterns exists for a predetermined number of merged classes, the merge patterns are called candidate patterns, and among the plurality of candidate patterns, a merge pattern selected as a merge pattern corresponding to the predetermined number of merged classes will be referred to as a selected pattern.

Depending on the original image, there are cases where a filtered image having a smaller error from the original image is obtained by the class classification that classifies into a class obtained according to the candidate pattern other than the selected pattern than by the class classification that classifies into a class obtained according to the selected pattern (merged class). Therefore, if a plurality of selected patterns is set for a predetermined number of merged classes, errors of the filtered image can be reduced, and moreover, encoding efficiency and image quality of the decoded image can be improved. However, in a case where the plurality of selected patterns is set for the predetermined number of merged classes, the employed merge pattern has to be included in the encoded bitstream and transmitted, for example, similarly to the GALF in order to signal the employed pattern. Then, in a case where the (employed) merge pattern is transmitted, overhead becomes large and encoding efficiency deteriorates as compared with the case where the (employed) number of merged classes is transmitted.

Accordingly, the present technology employs a method to identify, in a case where a plurality of merge patterns is set for a predetermined number of merged classes, the merge pattern used for merging classes (employed merge pattern) with smaller overhead than in the case where the merge pattern is transmitted.

In a case where the subclass merging is employed as the initial class merging and the subclass merging is performed according to a certain rule, that is, for example, in a case where the subclass merging of the inclination intensity ratio subclass, the direction subclass, and the activity subclass is performed as described in FIGS. 30 to 32, a merge pattern (Na, Nb, Nc) is uniquely determined by a combination (Na, Nb, Nc) of the numbers of subclasses of Na, Nb, and Nc of each of the inclination intensity ratio subclass, the direction subclass, and the activity subclass. Therefore, the merge pattern (Na, Nb, Nc) can be identified by the combination (Na, Nb, Nc) of the numbers of subclasses of Na, Nb, and Nc of each of the inclination intensity ratio subclass, the direction subclass, and the activity subclass after subclass merging. A method of identifying the merge pattern (Na, Nb, Nc) by the combination (Na, Nb, Nc) of the numbers of subclasses Na, Nb, and Nc of each of the inclination intensity ratio subclass, the direction subclass, and the activity subclass after the subclass merging in this manner is also called an identification method by the numbers of subclasses.

According to the identification method by the number of subclasses, it is possible to identify each of a plurality of merge patterns having the same number of merged classes. Therefore, the employed merge pattern can be determined from a larger number of merge patterns as compared with the case where the merge pattern is set for every number of merged classes. Consequently, the initial classes can be merged by the merge pattern in which the class classification more suitable for the original image is performed, and encoding efficiency and image quality of the decoded image can be improved.

Furthermore, the numbers of subclasses of Na, Nb, and Nc of the inclination intensity ratio subclass, the direction subclass, and the activity subclass after the subclass merging are one to three subclasses, one or two subclasses, and one to five subclasses, respectively, and thus the amount of data is small compared to the merge pattern of the GALF (FIG. 9) that is a series of twenty five numbers. Therefore, by the identification method by the number of subclasses that identifies the employed merge pattern (Na, Nb, Nc) by the combination (Na, Nb, Nc) of the numbers of subclasses Na, Nb, and Nc of each of the inclination intensity ratio subclass, the direction subclass, and the activity subclass after the subclass merging, overhead can be reduced and encoding efficiency can be improved as compared with the case of the GALF.

The merge pattern (Na, Nb, Nc) corresponding to the combination (Na, Nb, Nc) will be described below, which is determined for each of the thirty combinations (Na, Nb, Nc) illustrated in FIG. 36 of the numbers of subclasses Na, Nb, and Nc of each of the inclination intensity ratio subclass, the direction subclass, and the activity subclass after the subclass merging.

A merge pattern (3, 2, 5) corresponding to a combination (3, 2, 5) in which the respective numbers of subclasses of the inclination intensity ratio subclass, the direction subclass, and the activity subclass after the subclass merging are three, two, and five and the subclass merging by which this merge pattern (3, 2, 5) is obtained are as illustrated in FIG. 43.

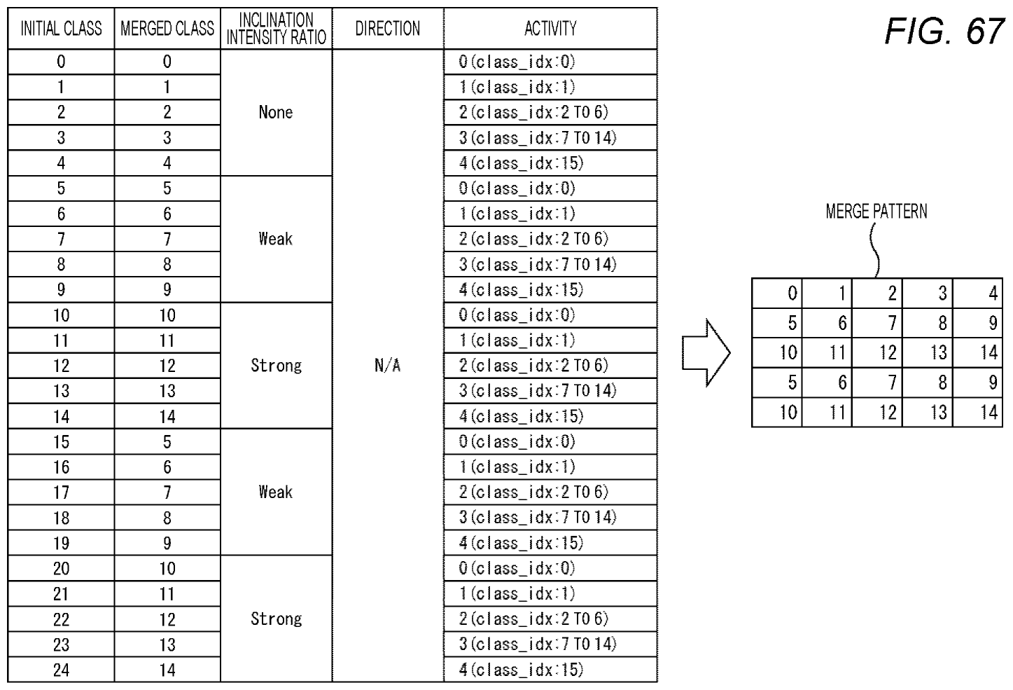

FIG. 67 is a diagram illustrating a merge pattern (3, 1, 5) corresponding to a combination (3, 1, 5) in which the respective numbers of subclasses of the inclination intensity ratio subclass, the direction subclass, and the activity subclass after the subclass merging are three, one, and five and the subclass merging by which the merge pattern (3, 1, 5) is obtained.

The merge pattern (3, 1, 5) can be obtained by subclass merging the inclination intensity ratio subclass into three subclasses of the none class, the weak class, and the strong class, subclass merging the direction subclass into one subclass of the N/A class, and subclass merging the activity subclass into five subclasses of the activity subclass 0 corresponding to the index class_idx of 0, the activity subclass 1 corresponding to the index class_idx of 1, the activity subclass 2 corresponding to the index class_idx of 2 to 6, the activity subclass 3 corresponding to the index class_idx of 7 to 14, and the activity subclass 4 corresponding to the index class_idx of 15.

The number of merged classes in the merge pattern (3, 1, 5) can be obtained as 5×(1×(3−1)+1)=15 from the respective numbers of subclasses of three, one, and five of the inclination intensity ratio subclass, the direction subclass, and the activity subclass after the subclass merging as described in FIG. 36.

A merge pattern (2, 2, 5) corresponding to a combination (2, 2, 5) in which the respective numbers of subclasses of the inclination intensity ratio subclass, the direction subclass, and the activity subclass after the subclass merging are two, two, and five and the subclass merging by which this merge pattern (2, 2, 5) is obtained are as illustrated in FIG. 45.

A merge pattern (2, 1, 5) corresponding to a combination (2, 1, 5) in which the respective numbers of subclasses of the inclination intensity ratio subclass, the direction subclass, and the activity subclass after the subclass merging are two, one, and five and the subclass merging by which this merge pattern (2, 1, 5) is obtained are as illustrated in FIG. 47.

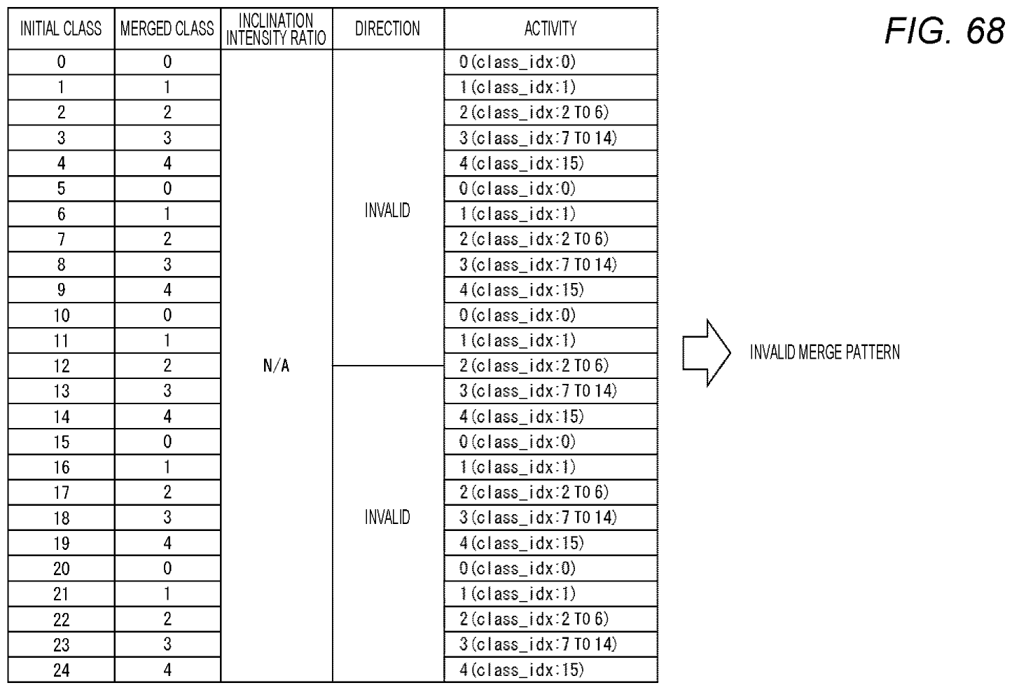

FIG. 68 is a diagram illustrating a merge pattern (1, 2, 5) corresponding to a combination (1, 2, 5) in which the respective numbers of subclasses of the inclination intensity ratio subclass, the direction subclass, and the activity subclass after the subclass merging are one, two, and five and the subclass merging by which the merge pattern (1, 2, 5) is obtained.

A case where the respective numbers of subclasses of the inclination intensity ratio subclass, the direction subclass, and the activity subclass after the subclass merging are one, two, and five corresponds to a case where the inclination intensity ratio subclass is merged into one subclass (N/A class) and the direction subclass classification that classifies into the D0/D1 class or the H/V class is performed. In a case where the inclination intensity ratio subclass is merged into one subclass and direction subclass classification that classifies into the D0/D1 class or the H/V class is performed, as described in FIG. 36, the direction subclass classification is invalid, and the merge pattern that is class classification performed by such direction subclass classification is also invalid. The present technology does not use invalid merge patterns.

A merge pattern (1, 1, 5) corresponding to a combination (1, 1, 5) in which the respective numbers of subclasses of the inclination intensity ratio subclass, the direction subclass, and the activity subclass after the subclass merging are one, one, and five and the subclass merging by which this merge pattern (1, 1, 5) is obtained are as illustrated in FIG. 51.

A merge pattern (3, 2, 4) corresponding to a combination (3, 2, 4) in which the respective numbers of subclasses of the inclination intensity ratio subclass, the direction subclass, and the activity subclass after the subclass merging are three, two, and four and the subclass merging by which this merge pattern (3, 2, 4) is obtained are as illustrated in FIG. 44.

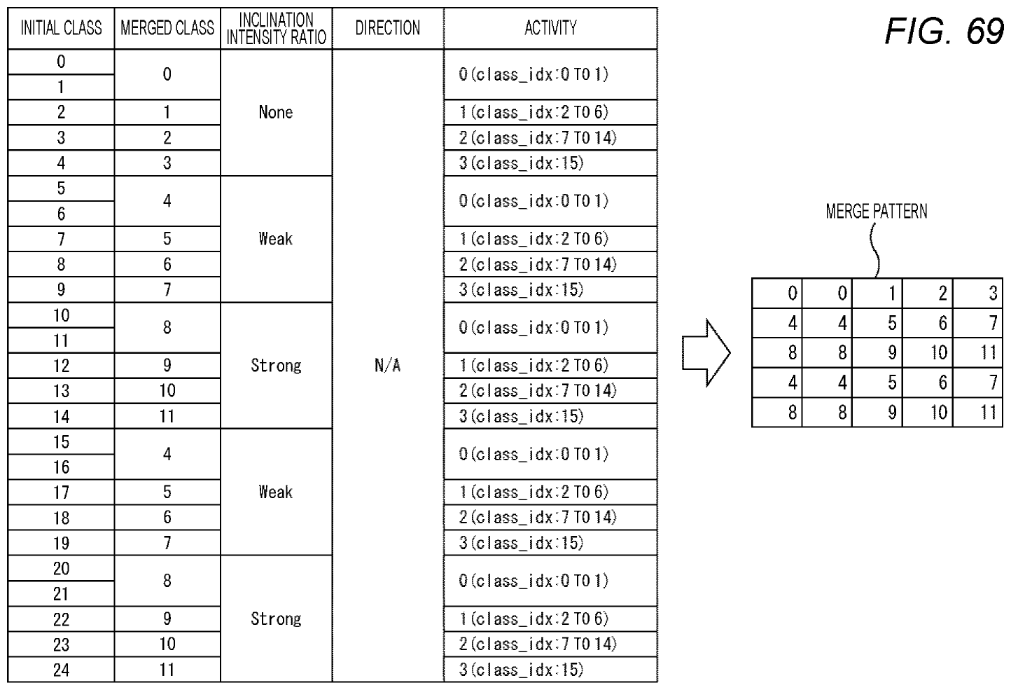

FIG. 69 is a diagram illustrating a merge pattern (3, 1, 4) corresponding to a combination (3, 1, 4) in which the respective numbers of subclasses of the inclination intensity ratio subclass, the direction subclass, and the activity subclass after the subclass merging are three, one, and four and the subclass merging by which the merge pattern (3, 1, 4) is obtained.

The merge pattern (3, 1, 4) can be obtained by subclass merging the inclination intensity ratio subclass into three subclasses of the none class, the weak class, and the strong class, subclass merging the direction subclass into one subclass of the N/A class, and subclass merging the activity subclass into four subclasses of the activity subclass 0 corresponding to the index class_idx of 0 and 1, the activity subclass 1 corresponding to the index class_idx of 2 to 6, the activity subclass 2 corresponding to the index class_idx of 7 to 14, and the activity subclass 3 corresponding to the index class_idx of 15.

The number of merged classes in the merge pattern (3, 1, 4) can be obtained as 4×(1×(3−1)+1)=12 from the respective numbers of subclasses of three, one, and four of the inclination intensity ratio subclass, the direction subclass, and the activity subclass after the subclass merging.

A merge pattern (2, 2, 4) corresponding to a combination (2, 2, 4) in which the respective numbers of subclasses of the inclination intensity ratio subclass, the direction subclass, and the activity subclass after the subclass merging are two, two, and four and the subclass merging by which this merge pattern (2, 2, 4) is obtained are as illustrated in FIG. 46.

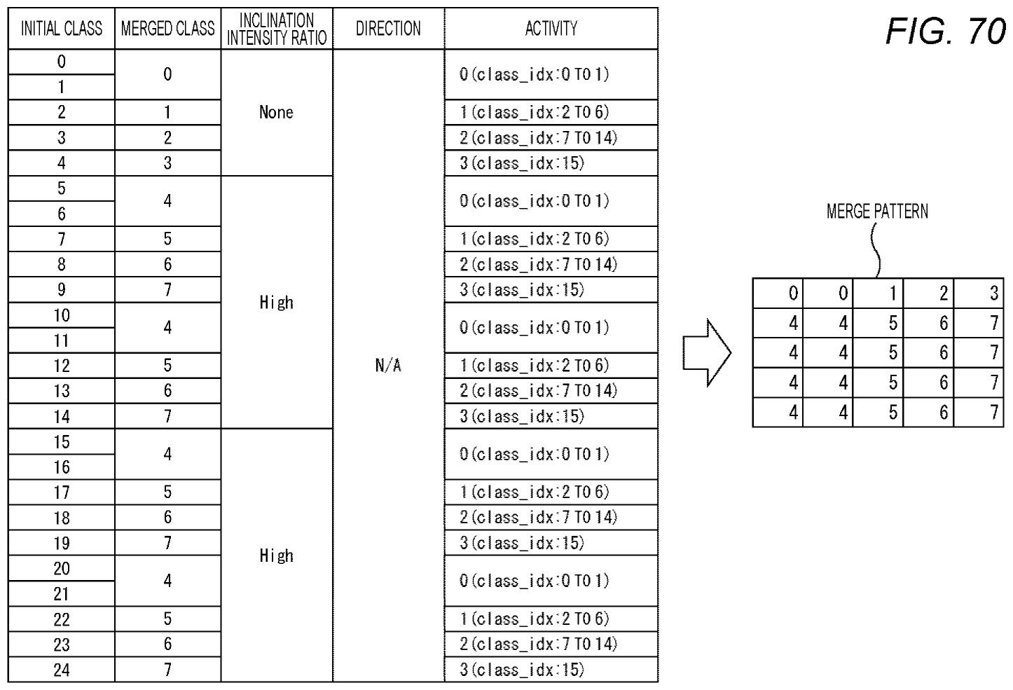

FIG. 70 is a diagram illustrating a merge pattern (2, 1, 4) corresponding to a combination (2, 1, 4) in which the respective numbers of subclasses of the inclination intensity ratio subclass, the direction subclass, and the activity subclass after the subclass merging are two, one, and four and the subclass merging by which the merge pattern (2, 1, 4) is obtained.

The merge pattern (2, 1, 4) can be obtained by subclass merging the inclination intensity ratio subclass into two subclasses of the none class and the high class, subclass merging the direction subclass into one subclass of the N/A class, and subclass merging the activity subclass into four subclasses of the activity subclass 0 corresponding to the index class_idx of 0 and 1, the activity subclass 1 corresponding to the index class_idx of 2 to 6, the activity subclass 2 corresponding to the index class_idx of 7 to 14, and the activity subclass 3 corresponding to the index class_idx of 15.

The number of merged classes in the merge pattern (2, 1, 4) can be obtained as 4×(1×(2−1)+1)=8 from the respective numbers of subclasses of two, one, and four of the inclination intensity ratio subclass, the direction subclass, and the activity subclass after the subclass merging.

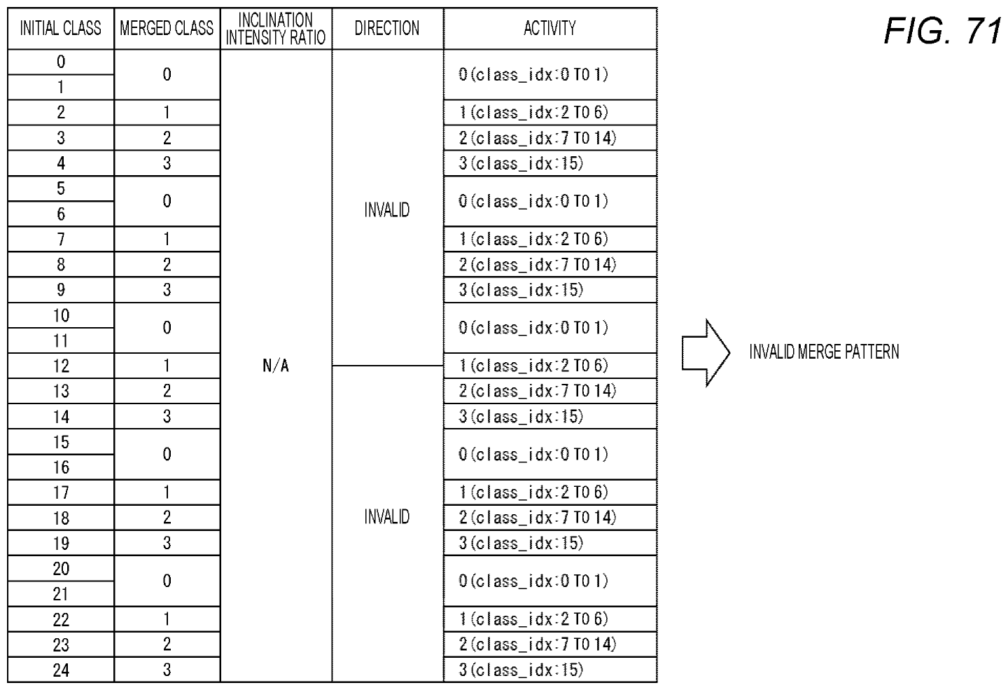

FIG. 71 is a diagram illustrating a merge pattern (1, 2, 4) corresponding to a combination (1, 2, 4) in which the respective numbers of subclasses of the inclination intensity ratio subclass, the direction subclass, and the activity subclass after the subclass merging are one, two, and four and the subclass merging by which the merge pattern (1, 2, 4) is obtained.

A case where the respective numbers of subclasses of the inclination intensity ratio subclass, the direction subclass, and the activity subclass after the subclass merging are one, two, and four corresponds to a case where the inclination intensity ratio subclass is merged into one subclass (N/A class) and the direction subclass classification that classifies into the D0/D1 class or the H/V class is performed. In a case where the inclination intensity ratio subclass is merged into one subclass and direction subclass classification that classifies into the D0/D1 class or the H/V class is performed, as described in FIG. 36, the direction subclass classification is invalid, and the merge pattern that is class classification performed by such direction subclass classification is also invalid. The present technology does not use invalid merge patterns.

A merge pattern (1, 1, 4) corresponding to a combination (1, 1, 4) in which the respective numbers of subclasses of the inclination intensity ratio subclass, the direction subclass, and the activity subclass after the subclass merging are one, one, and four and the subclass merging by which this merge pattern (1, 1, 4) is obtained are as illustrated in FIG. 52.

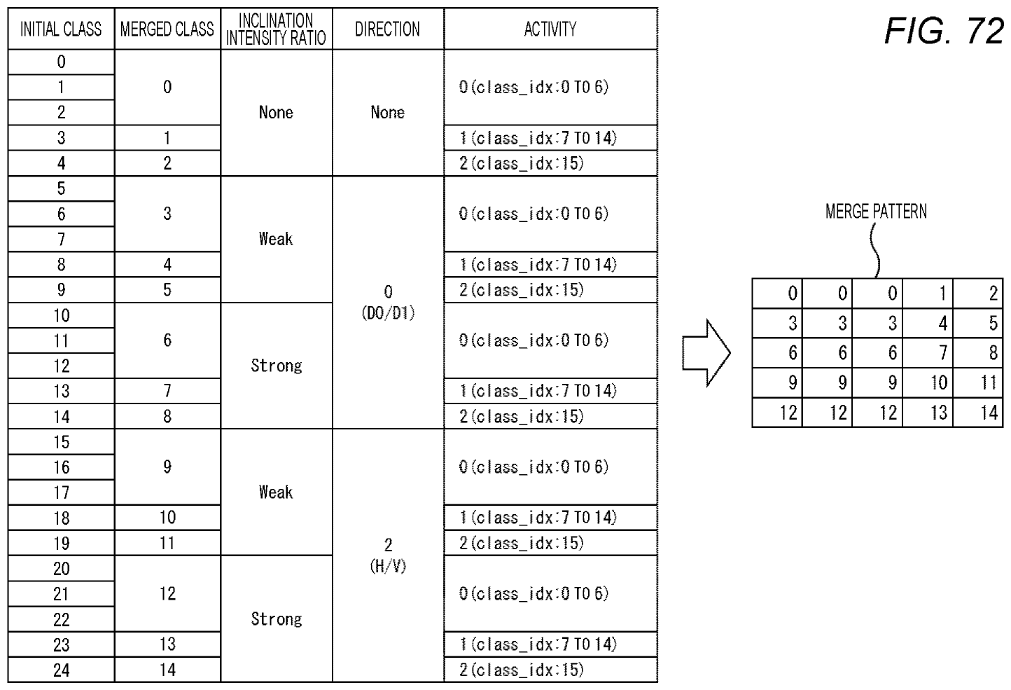

FIG. 72 is a diagram illustrating a merge pattern (3, 2, 3) corresponding to a combination (3, 2, 3) in which the respective numbers of subclasses of the inclination intensity ratio subclass, the direction subclass, and the activity subclass after the subclass merging are three, two, and three and the subclass merging by which the merge pattern (3, 2, 3) is obtained.

The merge pattern (3, 2, 3) can be obtained by subclass merging the inclination intensity ratio subclass into three subclasses of the none class, the weak class, and the strong class, subclass merging the direction subclass into two subclasses of the D0/D1 class and the H/V class, and subclass merging the activity subclass into three subclasses of the activity subclass 0 corresponding to the index class_idx of 0 to 6, the activity subclass 1 corresponding to the index class_idx of 7 to 14, and the activity subclass 2 corresponding to the index class_idx of 15.

The number of merged classes in the merge pattern (3, 2, 3) can be obtained as 3×(2×(3−1)+1)=15 from the respective numbers of subclasses of three, two, and three of the inclination intensity ratio subclass, the direction subclass, and the activity subclass after the subclass merging.

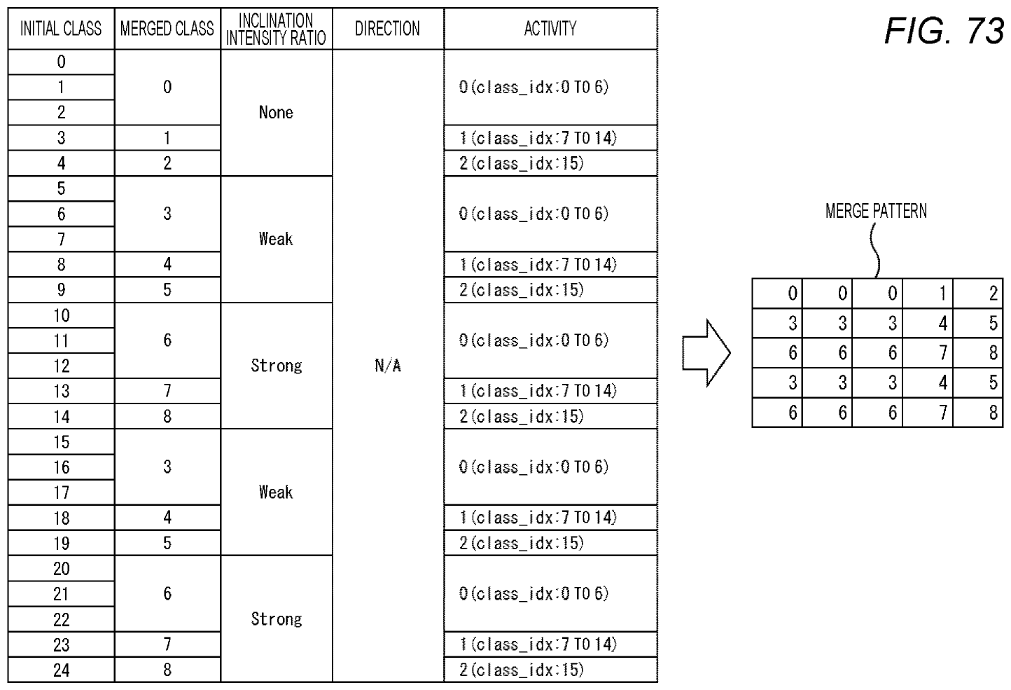

FIG. 73 is a diagram illustrating a merge pattern (3, 1, 3) corresponding to a combination (3, 1, 3) in which the respective numbers of subclasses of the inclination intensity ratio subclass, the direction subclass, and the activity subclass after the subclass merging are three, one, and three and the subclass merging by which the merge pattern (3, 1, 3) is obtained.

The merge pattern (3, 1, 3) can be obtained by subclass merging the inclination intensity ratio subclass into three subclasses of the none class, the weak class, and the strong class, subclass merging the direction subclass into one subclasses of the N/A class, and subclass merging the activity subclass into three subclasses of the activity subclass 0 corresponding to the index class_idx of 0 to 6, the activity subclass 1 corresponding to the index class_idx of 7 to 14, and the activity subclass 2 corresponding to the index class_idx of 15.

The number of merged classes in the merge pattern (3, 1, 3) can be obtained as 3×(1×(3−1)+1)=9 from the respective numbers of subclasses of three, one, and three of the inclination intensity ratio subclass, the direction subclass, and the activity subclass after the subclass merging.

A merge pattern (2, 2, 3) corresponding to a combination (2, 2, 3) in which the respective numbers of subclasses of the inclination intensity ratio subclass, the direction subclass, and the activity subclass after the subclass merging are two, two, and three and the subclass merging by which this merge pattern (2, 2, 3) is obtained are as illustrated in FIG. 48.

A merge pattern (2, 1, 3) corresponding to a combination (2, 1, 3) in which the respective numbers of subclasses of the inclination intensity ratio subclass, the direction subclass, and the activity subclass after the subclass merging are two, one, and three and the subclass merging by which this merge pattern (2, 1, 3) is obtained are as illustrated in FIG. 50.

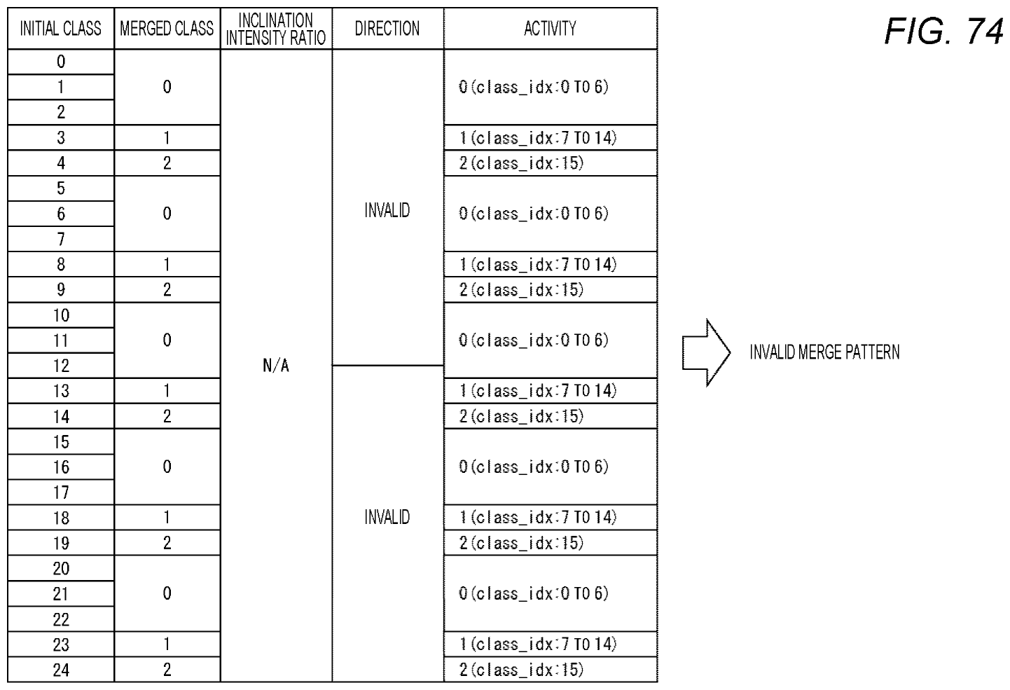

FIG. 74 is a diagram illustrating a merge pattern (1, 2, 3) corresponding to a combination (1, 2, 3) in which the respective numbers of subclasses of the inclination intensity ratio subclass, the direction subclass, and the activity subclass after the subclass merging are one, two, and three and the subclass merging by which the merge pattern (1, 2, 3) is obtained.

A case where the respective numbers of subclasses of the inclination intensity ratio subclass, the direction subclass, and the activity subclass after the subclass merging are one, two, and three corresponds to a case where the inclination intensity ratio subclass is merged into one subclass (N/A class) and the direction subclass classification that classifies into the D0/D1 class or the H/V class is performed. In a case where the inclination intensity ratio subclass is merged into one subclass and direction subclass classification that classifies into the D0/D1 class or the H/V class is performed, as described in FIG. 36, the direction subclass classification is invalid, and the merge pattern that is class classification performed by such direction subclass classification is also invalid. The present technology does not use invalid merge patterns.

A merge pattern (1, 1, 3) corresponding to a combination (1, 1, 3) in which the respective numbers of subclasses of the inclination intensity ratio subclass, the direction subclass, and the activity subclass after the subclass merging are one, one, and three and the subclass merging by which this merge pattern (1, 1, 3) is obtained are as illustrated in FIG. 53.

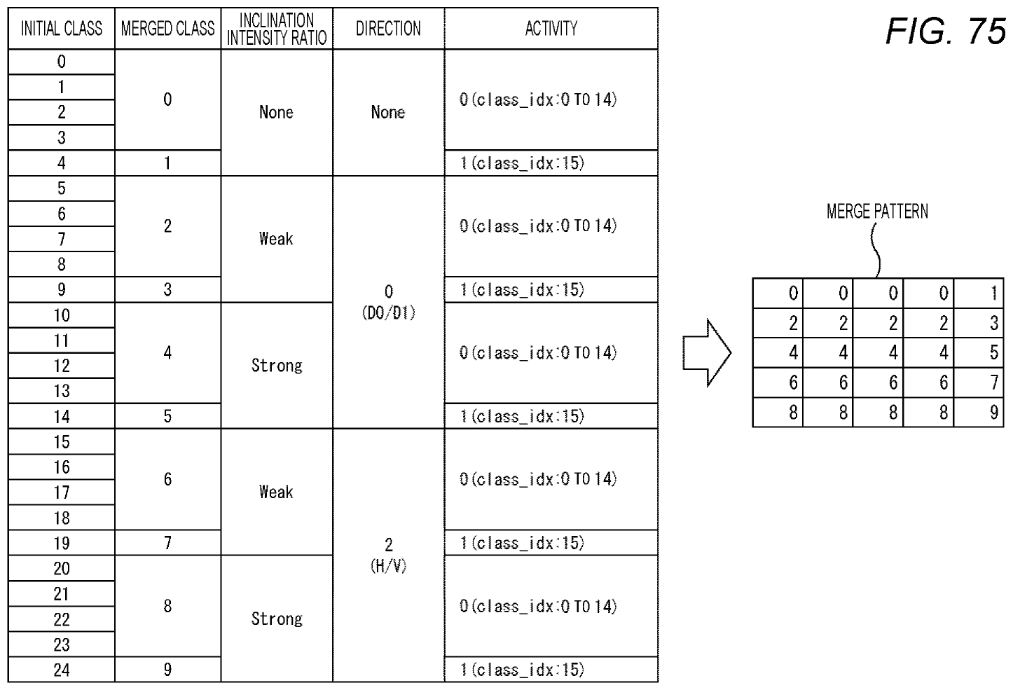

FIG. 75 is a diagram illustrating a merge pattern (3, 2, 2) corresponding to a combination (3, 2, 2) in which the respective numbers of subclasses of the inclination intensity ratio subclass, the direction subclass, and the activity subclass after the subclass merging are three, two, and two and the subclass merging by which the merge pattern (3, 2, 2) is obtained.

The merge pattern (3, 2, 2) can be obtained by subclass merging the inclination intensity ratio subclass into three subclasses of the none class, the weak class, and the strong class, subclass merging the direction subclass into two subclasses of the D0/D1 class and the H/V class, and subclass merging the activity subclass into two subclasses of the activity subclass 0 corresponding to the index class_idx of 0 to 14, and the activity subclass 1 corresponding to the index class_idx of 15.

The number of merged classes in the merge pattern (3, 2, 2) can be obtained as 2×(2×(3−1)+1)=10 from the respective numbers of subclasses of three, two, and two of the inclination intensity ratio subclass, the direction subclass, and the activity subclass after the subclass merging.

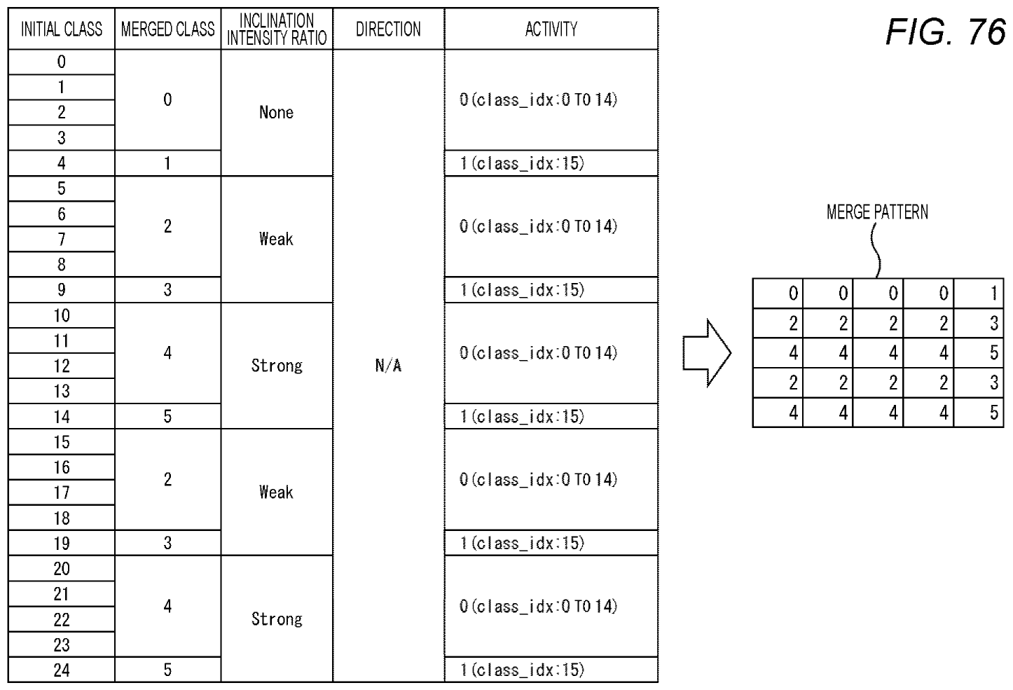

FIG. 76 is a diagram illustrating a merge pattern (3, 1, 2) corresponding to a combination (3, 1, 2) in which the respective numbers of subclasses of the inclination intensity ratio subclass, the direction subclass, and the activity subclass after the subclass merging are three, one, and two and the subclass merging by which the merge pattern (3, 1, 2) is obtained.

The merge pattern (3, 1, 2) can be obtained by subclass merging the inclination intensity ratio subclass into three subclasses of the none class, the weak class, and the strong class, subclass merging the direction subclass into one subclass of the N/A class, and subclass merging the activity subclass into two subclasses of the activity subclass 0 corresponding to the index class_idx of 0 to 14, and the activity subclass 1 corresponding to the index class_idx of 15.

The number of merged classes in the merge pattern (3, 1, 2) can be obtained as 2×(1×(3−1)+1)=6 from the respective numbers of subclasses of three, one, and two of the inclination intensity ratio subclass, the direction subclass, and the activity subclass after the subclass merging.

A merge pattern (2, 2, 2) corresponding to a combination (2, 2, 2) in which the respective numbers of subclasses of the inclination intensity ratio subclass, the direction subclass, and the activity subclass after the subclass merging are two, two, and two and the subclass merging by which this merge pattern (2, 2, 2) is obtained are as illustrated in FIG. 49.

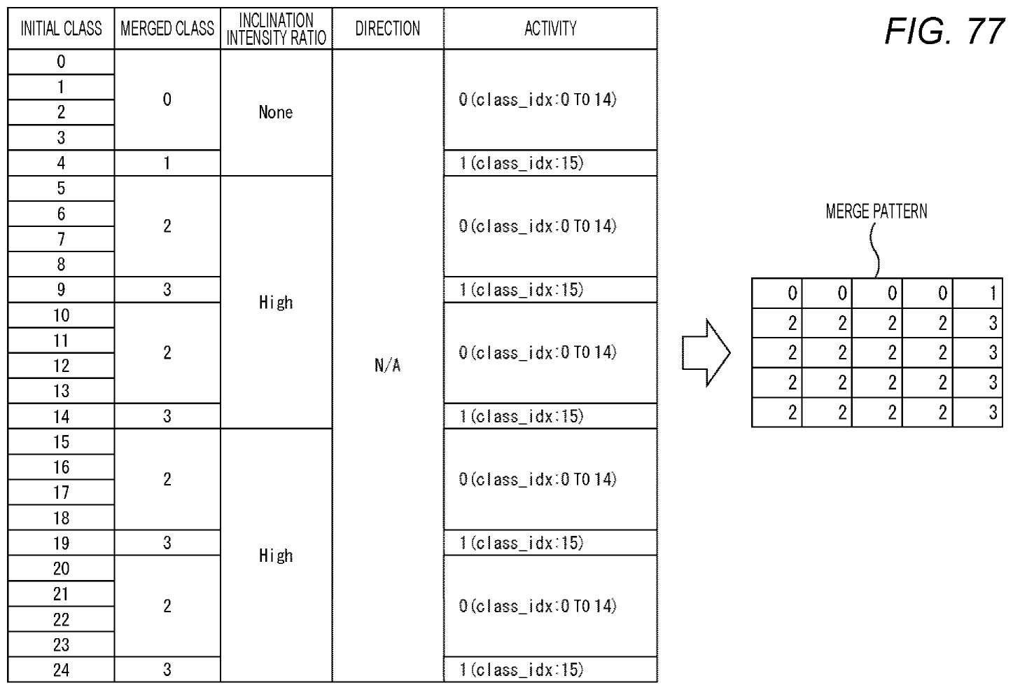

FIG. 77 is a diagram illustrating a merge pattern (2, 1, 2) corresponding to a combination (2, 1, 2) in which the respective numbers of subclasses of the inclination intensity ratio subclass, the direction subclass, and the activity subclass after the subclass merging are two, one, and two and the subclass merging by which the merge pattern (2, 1, 2) is obtained.

The merge pattern (2, 1, 2) can be obtained by subclass merging the inclination intensity ratio subclass into two subclasses of the none class and the high class, subclass merging the direction subclass into one subclass of the N/A class, and subclass merging the activity subclass into two subclasses of the activity subclass 0 corresponding to the index class_idx of 0 to 14, and the activity subclass 1 corresponding to the index class_idx of 15.

The number of merged classes in the merge pattern (2, 1, 2) can be obtained as 2×(1×(2−1)+1)=4 from the respective numbers of subclasses of two, one, and two of the inclination intensity ratio subclass, the direction subclass, and the activity subclass after the subclass merging.

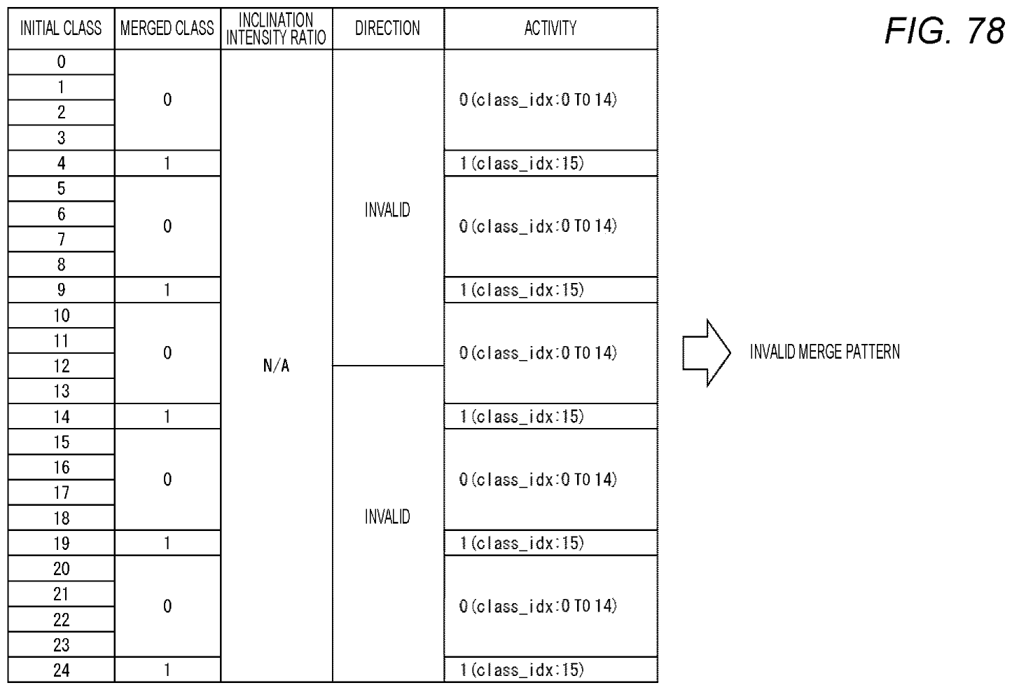

FIG. 78 is a diagram illustrating a merge pattern (1, 2, 2) corresponding to a combination (1, 2, 2) in which the respective numbers of subclasses of the inclination intensity ratio subclass, the direction subclass, and the activity subclass after the subclass merging are one, two, and two and the subclass merging by which the merge pattern (1, 2, 2) is obtained.

A case where the respective numbers of subclasses of the inclination intensity ratio subclass, the direction subclass, and the activity subclass after the subclass merging are one, two, and two corresponds to a case where the inclination intensity ratio subclass is merged into one subclass (N/A class) and the direction subclass classification that classifies into the D0/D1 class or the H/V class is performed. In a case where the inclination intensity ratio subclass is merged into one subclass and direction subclass classification that classifies into the D0/D1 class or the H/V class is performed, as described in FIG. 36, the direction subclass classification is invalid, and the merge pattern that is class classification performed by such direction subclass classification is also invalid. The present technology does not use invalid merge patterns.

A merge pattern (1, 1, 2) corresponding to a combination (1, 1, 2) in which the respective numbers of subclasses of the inclination intensity ratio subclass, the direction subclass, and the activity subclass after the subclass merging are one, one, and two and the subclass merging by which this merge pattern (1, 1, 2) is obtained are as illustrated in FIG. 54.

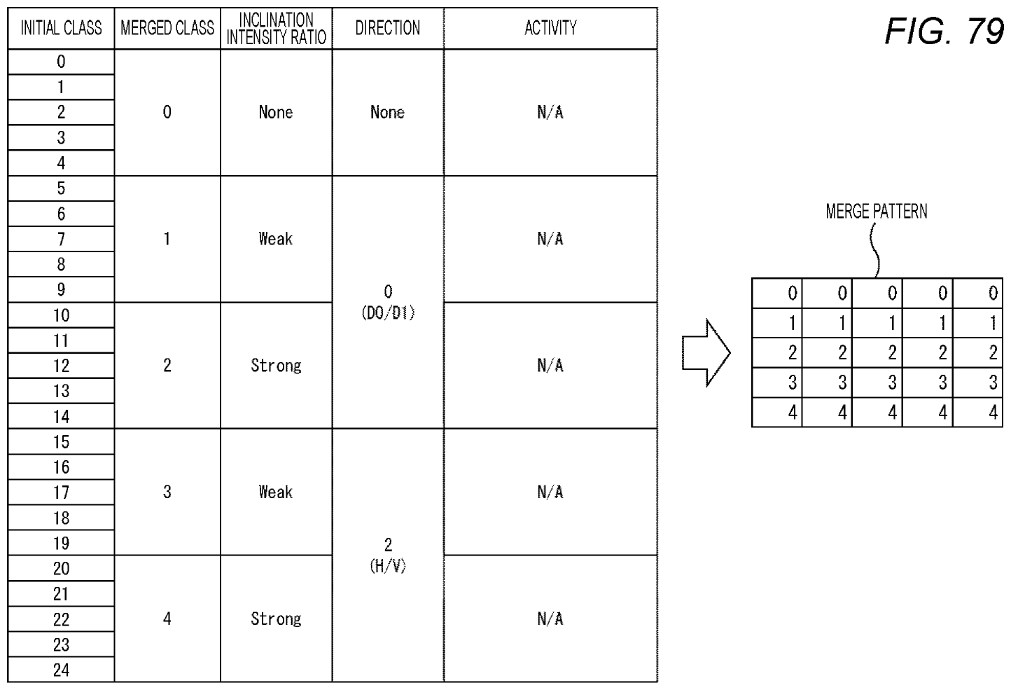

FIG. 79 is a diagram illustrating a merge pattern (3, 2, 1) corresponding to a combination (3, 2, 1) in which the respective numbers of subclasses of the inclination intensity ratio subclass, the direction subclass, and the activity subclass after the subclass merging are three, two, and one and the subclass merging by which the merge pattern (3, 2, 1) is obtained.

The merge pattern (3, 2, 1) can be obtained by subclass merging the inclination intensity ratio subclass into three subclasses of the none class, the weak class, and the strong class, subclass merging the direction subclass into two subclasses of the D0/D1 class and the H/V class, and subclass merging the activity subclass into one subclass of the N/A class.

The number of merged classes in the merge pattern (3, 2, 1) can be obtained as 1×(2×(3−1)+1)=5 from the respective numbers of subclasses of three, two, and one of the inclination intensity ratio subclass, the direction subclass, and the activity subclass after the subclass merging.

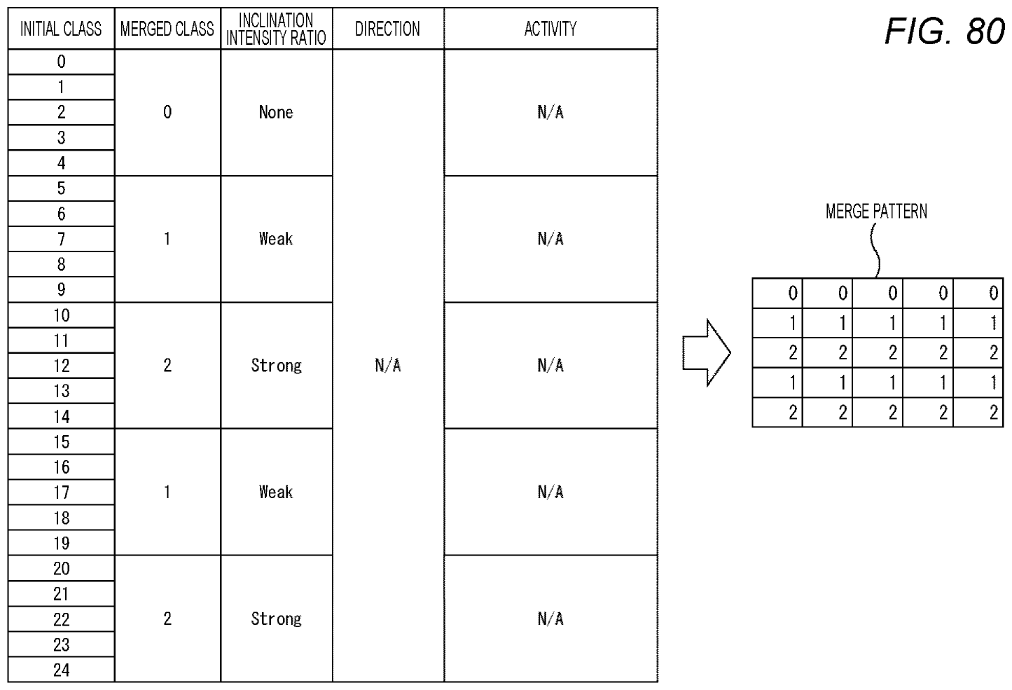

FIG. 80 is a diagram illustrating a merge pattern (3, 1, 1) corresponding to a combination (3, 1, 1) in which the respective numbers of subclasses of the inclination intensity ratio subclass, the direction subclass, and the activity subclass after the subclass merging are three, one, and one and the subclass merging by which the merge pattern (3, 1, 1) is obtained.

The merge pattern (3, 1, 1) can be obtained by subclass merging the inclination intensity ratio subclass into three subclasses of the none class, the weak class, and the strong class, subclass merging the direction subclass into one subclass of the N/A class, and subclass merging the activity subclass into one subclass of the N/A class.

The number of merged classes in the merge pattern (3, 1, 1) can be obtained as 1×(1×(3−1)+1)=3 from the respective numbers of subclasses of three, one, and one of the inclination intensity ratio subclass, the direction subclass, and the activity subclass after the subclass merging.

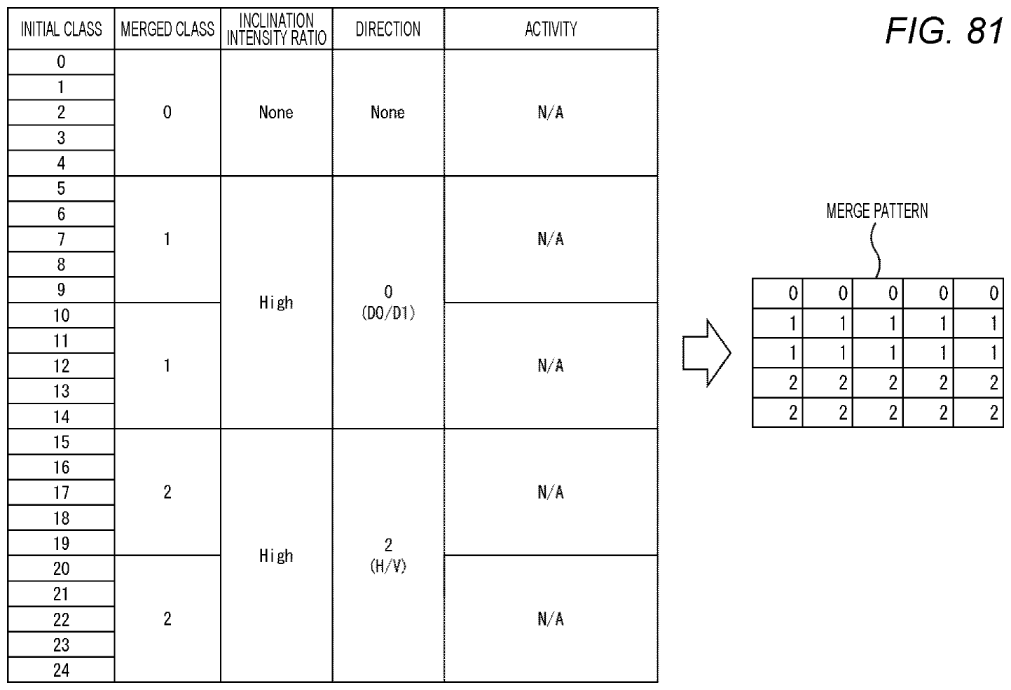

FIG. 81 is a diagram illustrating a merge pattern (2, 2, 1) corresponding to a combination (2, 2, 1) in which the respective numbers of subclasses of the inclination intensity ratio subclass, the direction subclass, and the activity subclass after the subclass merging are two, two, and one and the subclass merging by which the merge pattern (2, 2, 1) is obtained.

The merge pattern (2, 2, 1) can be obtained by subclass merging the inclination intensity ratio subclass into two subclasses of the none class and the high class, subclass merging the direction subclass into two subclasses of the D0/D1 class and the H/V class, and subclass merging the activity subclass into one subclass of the N/A class.

The number of merged classes in the merge pattern (2, 2, 1) can be obtained as 1×(2×(2−1)+1)=3 from the respective numbers of subclasses of two, two, and one of the inclination intensity ratio subclass, the direction subclass, and the activity subclass after the subclass merging.

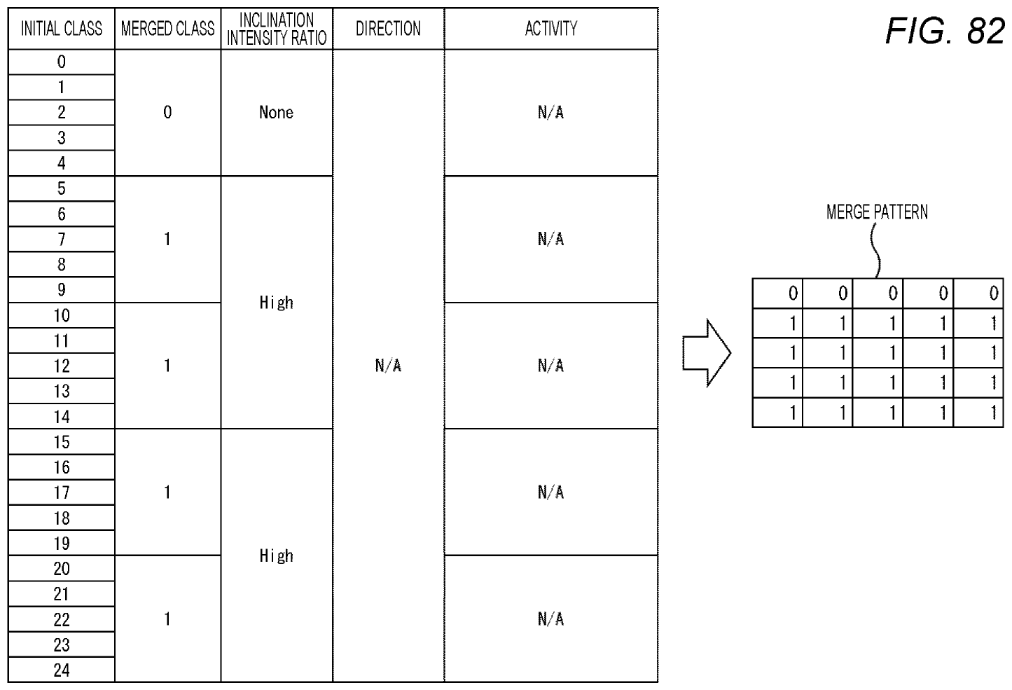

FIG. 82 is a diagram illustrating a merge pattern (2, 1, 1) corresponding to a combination (2, 1, 1) in which the respective numbers of subclasses of the inclination intensity ratio subclass, the direction subclass, and the activity subclass after the subclass merging are two, one, and one and the subclass merging by which the merge pattern (2, 1, 1) is obtained.

The merge pattern (2, 1, 1) can be obtained by subclass merging the inclination intensity ratio subclass into two subclasses of the none class and the high class, subclass merging the direction subclass into one subclass of the N/A class, and subclass merging the activity subclass into one subclass of the N/A class.

The number of merged classes in the merge pattern (2, 1, 1) can be obtained as 1×(1×(2−1)+1)=2 from the respective numbers of subclasses of two, one, and one of the inclination intensity ratio subclass, the direction subclass, and the activity subclass after the subclass merging.

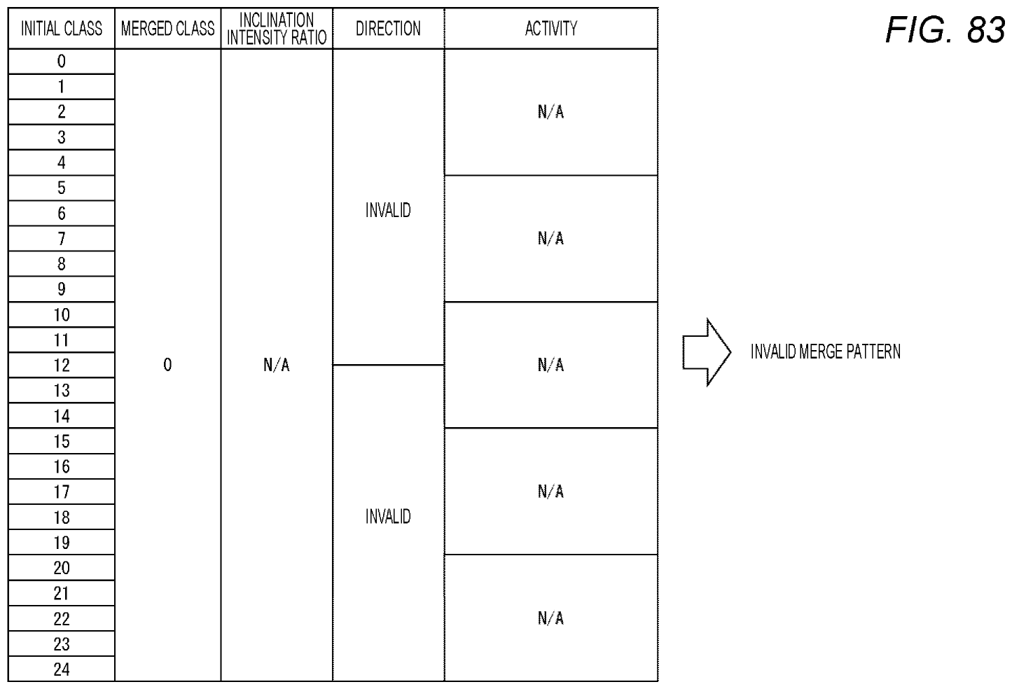

FIG. 83 is a diagram illustrating a merge pattern (1, 2, 1) corresponding to a combination (1, 2, 1) in which the respective numbers of subclasses of the inclination intensity ratio subclass, the direction subclass, and the activity subclass after the subclass merging are one, two, and one and the subclass merging by which the merge pattern (1, 2, 1) is obtained.

A case where the respective numbers of subclasses of the inclination intensity ratio subclass, the direction subclass, and the activity subclass after the subclass merging are one, two, and one corresponds to a case where the inclination intensity ratio subclass is merged into one subclass (N/A class) and the direction subclass classification that classifies into the D0/D1 class or the H/V class is performed. In a case where the inclination intensity ratio subclass is merged into one subclass and direction subclass classification that classifies into the D0/D1 class or the H/V class is performed, as described in FIG. 36, the direction subclass classification is invalid, and the merge pattern that is class classification performed by such direction subclass classification is also invalid. The present technology does not use invalid merge patterns.

A merge pattern (1, 1, 1) corresponding to a combination (1, 1, 1) in which the respective numbers of subclasses of the inclination intensity ratio subclass, the direction subclass, and the activity subclass after the subclass merging are one, one, and one and the subclass merging by which this merge pattern (1, 1, 1) is obtained are as illustrated in FIG. 55.

<Syntax for Transmitting Combination of Numbers of Subclasses>

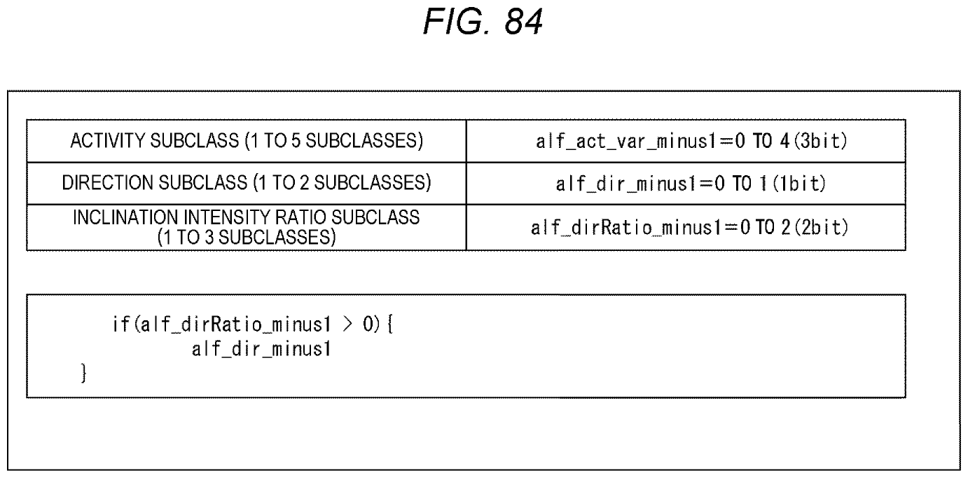

FIG. 84 is a diagram illustrating an example of a syntax for transmitting a combination of the numbers of subclasses.

In a case where the employed merge pattern (Na, Nb, Nc) is identified by the identification method by the number of subclasses, a combination of the numbers of subclasses that identifies the employed merge pattern (Na, Nb, Nc) (hereinafter, also referred to as an employed combination) (Na, Nb, Nc) has to be transmitted from the encoding device to the decoding device.

In FIG. 84, alf_dirRatio_minus1, alf_dir_minus1, alf_act_var_minus1 represents the number of subclasses Na, Nb, and Nc of the inclination intensity ratio subclass, the direction subclass, and the activity subclass after subclass merging for which the employed merge pattern is obtained.

That is, alf_dirRatio_minus1 is set to the number Na-1 of subclasses of the inclination intensity ratio subclass after the subclass merged for which the employed merge pattern is obtained. In alf_dir_minus1, the number Nb-1 of subclasses of the direction subclass after subclass merging from which the employed merge pattern is obtained. In alf_act_var_minus1, the number Nc-1 of subclasses of the activity subclass after subclass merging for which the employed merge pattern is obtained.

The number of subclasses of the inclination intensity ratio subclass is one of one to three, the number of subclasses of the direction subclass is one or two, and the number of subclasses of the activity subclass is one of one to five. Therefore, 2-bit, 1-bit, and 3-bit (or more) variables are employed as alf_dirRatio_minus1, alf_dir_minus1, and alf_act_var_minus1 that represent the numbers of inclination intensity ratio subclasses, direction subclasses, and activity subclasses, respectively.

According to the syntax of FIG. 84, alf_dir_minus1 representing the number of subclasses Nb of the direction subclass is transmitted only in a case where alf_dirRatio_minus1 representing the number of subclasses Na of the inclination intensity ratio subclass is larger than zero.

That is, as described in FIG. 36 and the like, in a case where the inclination intensity ratio subclass is merged into one subclass of the N/A class, the direction subclass classification is classified into the D0/D1 class or the H/V class, and by extension, the merge pattern to be the class classification performed by such direction subclass classification, that is, any merge pattern whose number Na of subclasses of the inclination intensity ratio subclass is one and whose number Nb of subclasses of the direction subclass corresponds to the number of subclasses of two is assumed as invalid and is not used.

Therefore, the combination of the numbers of subclasses to be the employed combination does not include any combination in which the number of subclasses of the inclination intensity ratio subclass (number of subclasses of the subclass classification of the inclination intensity ratio) is one, and the number of subclasses of the direction subclass (number of subclasses of the subclass of the direction subclass classification) is a number equal to or greater than two.

Consequently, in the employed combination (Na, Nb, Nc), in a case where the number Na of subclasses of the inclination intensity ratio subclass is one, the number Nb of subclasses of the direction subclass is not two but inevitably one.

As described above, in a case where the number of subclasses Na of the inclination intensity ratio subclass is one, the number of subclasses Nb of the direction subclass is determined to be one, and thus it is not necessary to transmit the number of subclasses Nb of the direction subclass. Then, in a case where it is necessary to transmit the number of subclasses Nb of the direction subclass, it means that the number of subclasses Na of the inclination intensity ratio subclass is two or more.

Therefore, in the syntax of FIG. 84, it is defined that the number of subclasses Nb (representing alf_dir_minus1) of the direction subclass is transmitted only in a case where the number of subclasses Na of the inclination intensity ratio subclass is two or more (in a case where alf_dirRatio_minus1 is larger than 0).

Therefore, the employed combination transmitted by the syntax of FIG. 84 includes the number of subclasses Nb of the direction subclass in a case where the number of subclasses Na of the inclination intensity ratio subclass is two or more.

According to the syntax of FIG. 84, in a case where the number of subclasses Na of the inclination intensity ratio subclass is one, it is not necessary to transmit the number of subclasses Nb of the direction subclass. Therefore, as compared with a case where the number of subclasses Nb of the direction subclass is always transmitted, encoding efficiency can be increased (improved).

<Configuration Example of Class Classification Prediction Filter to which Present Technology is Applied>

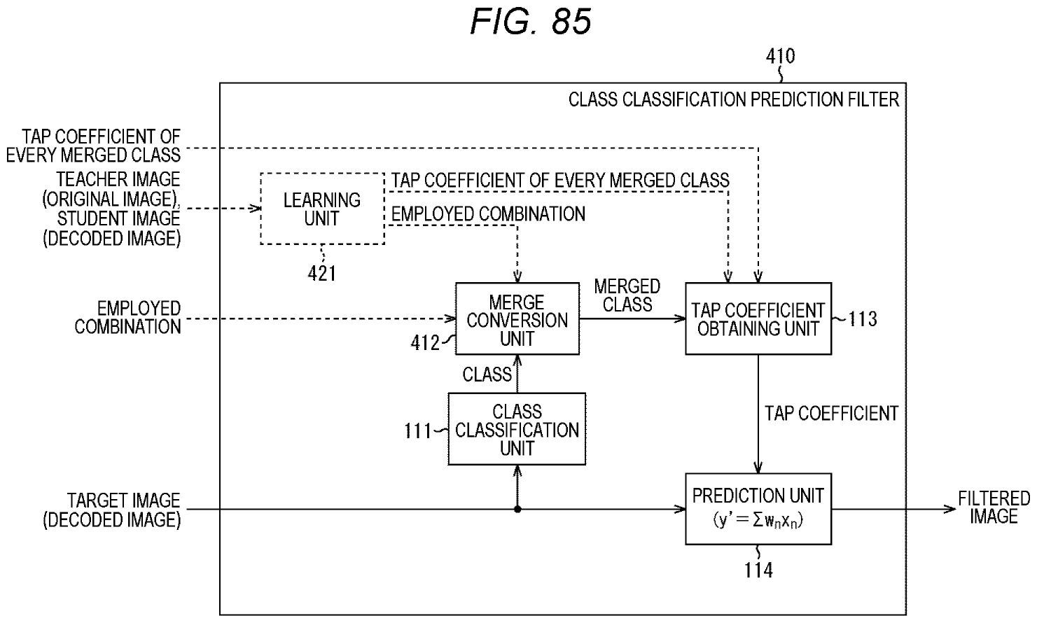

FIG. 85 is a block diagram illustrating a configuration example of a class classification prediction filter to which the present technology is applied.

That is, FIG. 85 illustrates a configuration example of the class classification prediction filter 410 that identifies the employed merge pattern by the identification method based on the number of subclasses.

Note that in the diagram, parts corresponding to those of the class classification prediction filter 110 of FIG. 56 are designated by the same reference numerals, and the description thereof will be omitted as appropriate below.

In FIG. 85, the class classification prediction filter 410 includes the class classification unit 111, the tap coefficient acquisition unit 113, the prediction unit 114, and a merge conversion unit 412.

Therefore, the class classification prediction filter 410 is common to the class classification prediction filter 110 in that it has a class classification unit 111, a tap coefficient acquisition unit 113, and a prediction unit 114. However, the class classification prediction filter 410 differs from the class classification prediction filter 110 in that it has the merge conversion unit 412 instead of the merge conversion unit 112.

The merge conversion unit 412 converts the initial class of the pixel of interest from the class classification unit 111 into a merged class according to a merge pattern determined for every combination of subclasses (hereinafter, also simply referred to as a merge pattern determined for every combination of the numbers of subclasses) in the subclass classification of the number of subclasses of the inclination intensity ratio subclass, the direction subclass, and the activity subclass after subclass merging (the number of subclasses of the respective subclasses of the inclination intensity ratio, the direction, and the activity sum of the subclass classification). That is, for example, the merge conversion unit 412 converts the initial class of the pixel of interest into a merged class according to the merge pattern corresponding to the employed combination among the (valid) twenty five patterns of merge patterns determined for every combination of the number of subclasses described in FIG. 36. The merge conversion unit 412 supplies the merged class of the pixel of interest to the tap coefficient acquisition unit 113.

In the tap coefficient acquisition unit 113, the tap coefficient of the merged class of the pixel of interest from the merge conversion unit 412 is selected from the tap coefficients of every merged class and supplied to the prediction unit 114. Then, the prediction unit 114 performs the filtering process as the prediction process that applies the predictive equation using the tap coefficient of the merged class of the pixel of interest from the tap coefficient acquisition unit 113 on the target image, and outputs a filtered image generated by the filtering process.

In the class classification prediction filter 410, the employed combination and the tap coefficient of every merged class can be supplied to the class classification prediction filter 410 from the outside.

Furthermore, the class classification prediction filter 410 can incorporate a learning unit 421 that performs the tap coefficient learning. It can be said that the class classification prediction filter 410 having the learning unit 421 is a class classification prediction filter 410 with a learning function.

In the learning unit 421, the tap coefficient of every merged class can be obtained by using the teacher image and the student image, and can be stored in the tap coefficient acquisition unit 113. Moreover, the learning unit 421 can determine the employed combination and supply the employed combination to the merge conversion unit 412.

In a case where the class classification prediction filter 410 is applied to the encoding device, the original image of the encoding target can be employed as the teacher image, and the decoded image obtained by encoding and locally decoding the original image can be employed as the student image.

The learning unit 421 performs class classification similar to that of the class classification unit 111 using the decoded image as the student image, and the tap coefficient learning is performed to obtain the tap coefficient by the least squares method that statistically minimizes prediction errors of the predicted value of the teacher image obtained by the predictive equation formed by the tap coefficient and the prediction tap for every initial class obtained by the class classification.

Furthermore, the learning unit 421 determines the number of subclasses that identifies the merge pattern that minimizes a cost (for example, the cost dist+lambda×coeffBit obtained in step S67 in FIG. 8) as the employed combination among the merge patterns corresponding to a plurality of combinations of the number of subclasses, by performing a process similar to a process of determining the number of employed merge patterns (FIG. 8) by using each merge pattern corresponding to each of a plurality of combinations of the number of subclasses as the merge pattern determined for every combination of the number of subclasses.

Moreover, the learning unit 421 performs a process similar to steps S36 and S37 of the merge pattern determination process (FIG. 5) in step S63 before the process of step S64, which is the filtering process for obtaining the cost of determining the process of determining the number of employed merge patterns (FIG. 8), to thereby obtain the tap coefficient of every merged class obtained according to the merge pattern corresponding to the employed combination.

The learning unit 421 supplies the employed combination to the merge conversion unit 412, and supplies the tap coefficient of every merged class obtained according to the merge pattern corresponding to the employed combination to the tap coefficient acquisition unit 113.

The encoding device and the decoding device to which the present technology is applied share that the initial class merge is performed by the subclass merging of FIGS. 30 to 32. Then, the encoding device determines the employed combination from a plurality of combinations of the numbers of subclasses that identify the merge pattern obtained by the subclass merging, and transmits the combination to the decoding device. The decoding device identifies the merge pattern from the employed combination from the encoding device. Then, the decoding device performs the initial class classification, and converts the initial class obtained by the initial class classification into a merged class according to the merge pattern (merge pattern corresponding to the employed combination) identified from the employed combination.

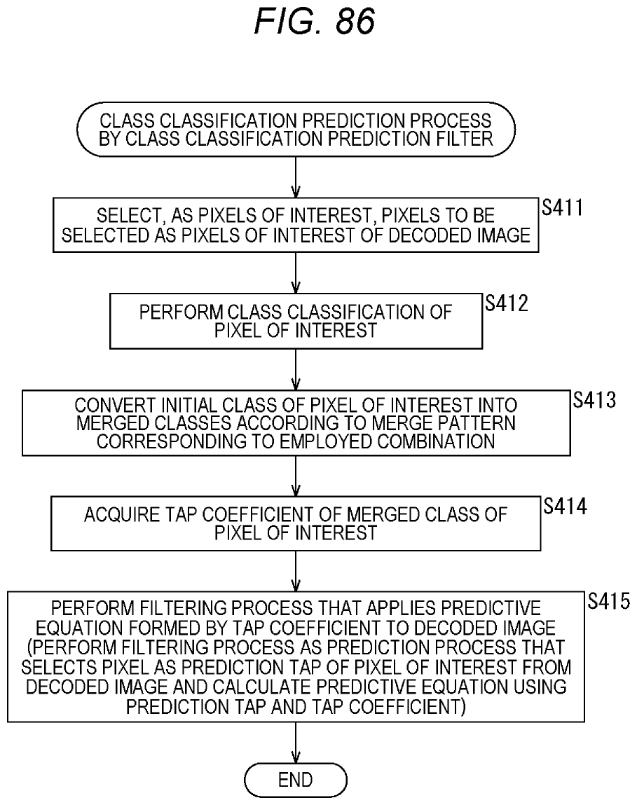

FIG. 86 is a flowchart describing an example of the class classification prediction process performed by the class classification prediction filter 410 of FIG. 85.

In step S411, the class classification unit 111 sequentially selects, as the pixel of interest, the pixels to be selected as the pixel of interest of the decoded image as the target image, and the process proceeds to step S412.

In step S412, the class classification unit 111 performs the initial class classification of the pixel of interest and obtains the initial class of the pixel of interest. The class classification unit 111 supplies the initial class of the pixel of interest to the merge conversion unit 412, and the process proceeds from step S412 to step S413.

In step S413, the merge conversion unit 412 converts the initial class of the pixel of interest from the class classification unit 111 into a merged class according to the merge pattern corresponding to the employed combination. The merge conversion unit 412 supplies the merged class of the pixel of interest to the tap coefficient acquisition unit 113, and the process proceeds from step S413 to step S414.

In step S414, the tap coefficient acquisition unit 113 acquires the tap coefficient of the merged class of the pixel of interest from the merge conversion unit 412 from the tap coefficients of every merged class, and the process proceeds to step S415.

In step S415, the prediction unit 114 performs the filtering process as a prediction process that applies to the decoded image the predictive equation formed by the tap coefficients of the merged class of the pixel of interest from the tap coefficient acquisition unit 113.

That is, the prediction unit 114 selects a pixel to be the prediction tap of the pixel of interest from the decoded image, and calculates a first-order predictive equation formed by using this prediction tap and the tap coefficient of the merged class of the pixel of interest, to thereby obtain a predicted value of (pixel value of) a pixel of the original image with respect to the pixel of interest. Then, the prediction unit 114 generates an image using the predicted value as a pixel value, outputs the image as a filtered image, and ends the class classification prediction process.

<One Embodiment of Image Processing System to which Present Technology is Applied>

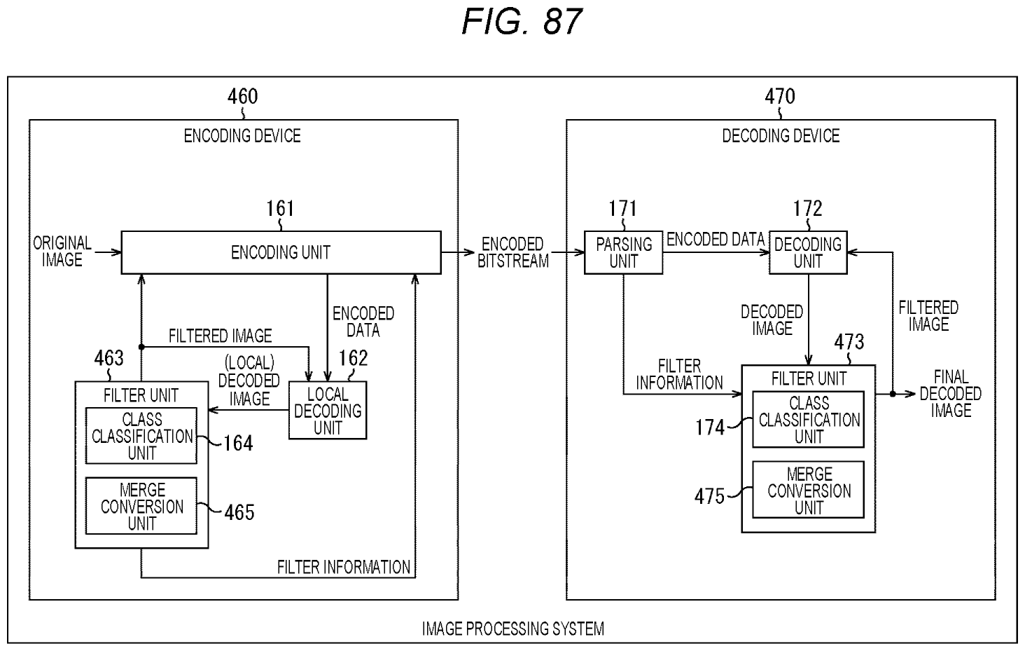

FIG. 87 is a block diagram illustrating an outline of one embodiment of an image processing system to which the present technology is applied.

Note that in the diagram, parts corresponding to those in the case of FIG. 58 are designated by the same reference numerals, and the description thereof will be omitted as appropriate below.

In FIG. 87, the image processing system has an encoding device 460 and a decoding device 470.

The encoding device 460 includes the encoding unit 161, the local decoding unit 162, and a filter unit 463.

Therefore, the encoding device 460 is common to the encoding device 160 of FIG. 58 in that it has the encoding unit 161 and the local decoding unit 162, and is different from the encoding device 160 in that it has the filter unit 463 instead of the filter unit 163.

The filter unit 463 is configured similarly to, for example, the class classification prediction filter 410 (FIG. 85) with the learning function, and includes the class classification unit 164 and a merge conversion unit 465. Therefore, the filter unit 463 is common to the filter unit 163 in FIG. 58 in that it has the class classification unit 164, and differs from the filter unit 163 in that it has the merge conversion unit 465 instead of the merge conversion unit 165.

The filter unit 463 uses the decoded image from the local decoding unit 162 and the original image for the decoded image as the student image and the teacher image to perform the tap coefficient learning, and obtains a tap coefficient of every class.

Furthermore, the filter unit 463 determines the combination of the number of subclasses that identifies the merge pattern that minimizes the cost as the employed combination among the combinations of the numbers of subclasses obtained by the subclass merging, by performing a process similar to the process of determining the number of employed merge patterns (FIG. 8) by using (a plurality of) merge patterns determined for every combination of the numbers of subclasses obtained by the subclass merging.

Moreover, upon determining the employed combination, the filter unit 463 performs a process similar to steps S36 and S37 of the merge pattern determination process (FIG. 5) using (X matrix and Y vector of) the normal equation obtained by the tap coefficient learning, to thereby obtain the tap coefficient of every merged class obtained by the merge pattern corresponding to the employed combination.

Then, the filter unit 463 performs, in the class classification unit 164, for example, the class classification of the GALF or the like as the initial class classification performed by the subclass classification of a plurality of feature amounts using the decoded image from the local decoding unit 162, so as to obtain the initial class of the pixel of interest. Moreover, the filter unit 463 converts the initial class of the pixel of interest into the merged class according to the merge pattern corresponding to the employed combination in the merge conversion unit 465. Then, the filter unit 463 performs the filtering process as the prediction process that applies to the decoded image the predictive equation that performs the product-sum operation of the tap coefficient of the merged class of the pixel of interest obtained by conversion by the merge conversion unit 465 and the pixels of the decoded image.

The filter unit 463 supplies the filtered image obtained by the filtering process to the encoding unit 161 and the local decoding unit 162. Moreover, the filter unit 463 supplies the employed combination and the tap coefficient of every merged class obtained by the conversion of the initial class according to the merge pattern corresponding to the employed combination to the encoding unit 161 as the filter information.

Note that, here, in the encoding device 460, the combination of the numbers of subclasses that identifies the merge pattern that minimizes the cost is determined as the employed combination among the merge patterns obtained by the subclass merging (valid merge patterns of twenty five patterns among the merge patterns corresponding to the thirty types of combinations of the numbers of subclasses in FIG. 36), but the employed combination can be determined in advance as the employed combination among the merge patterns obtained by the subclass merging, the combination of the numbers of subclasses that identifies a specific merge pattern. In this case, it is not necessary to obtain the cost in order to determine the combination to be employed, and thus the processing amount of the encoding device 460 can be reduced.

As described above, it is effective to determine the combination to be employed in advance, for example, especially in a case where performance of the encoding device 460 is not high.

The decoding device 470 includes the parsing unit 171, the decoding unit 172, and a filter unit 473. Therefore, the decoding device 470 is common to the decoding device 170 of FIG. 58 in that it has the parsing unit 171 and the decoding unit 172, and differs from the decoding device 170 in that it has the filter unit 473 instead of the filter unit 173.

The filter unit 473 is configured similarly to, for example, the class classification prediction filter 410 (FIG. 85) without the learning function, and includes a class classification unit 174 and a merge conversion unit 475. Therefore, the filter unit 473 is common to the filter unit 173 in FIG. 58 in that it has the class classification unit 174, and differs from the filter unit 173 in that it has the merge conversion unit 475 instead of the merge conversion unit 175.

The filter unit 473 performs a filtering process similar to that of the filter unit 463 on the decoded image from the decoding unit 172 to generate a filtered image, and supplies the filtered image to the decoding unit 172.

That is, the filter unit 473 performs, in the class classification unit 174, the same initial class classification as the class classification unit 164 using the decoded image from the decoding unit 172, and obtains the initial class of the pixel of interest. Moreover, the filter unit 473 converts, in the merge conversion unit 475, the initial class of the pixel of interest into a merged class in which the initial class is merged by merging the subclass of the subclass classification, according to the merge pattern corresponding to the employed combination included in the filter information from the parsing unit 171. Then, the filter unit 473 performs the filtering process as the prediction process that applies to the decoded image the predictive equation that performs the product-sum operation of the tap coefficient of the merged class of the pixel of interest obtained by conversion by the merge conversion unit 475 and the pixels of the decoded image. The tap coefficient of the merged class of the pixel of interest used in the filtering process is acquired from the tap coefficient of every merged class included in the filter information from the parsing unit 171.

The filter unit 473 supplies the filtered image obtained by the filtering process to the decoding unit 172, and outputs the filtered image as a final decoded image obtained by decoding the original image.

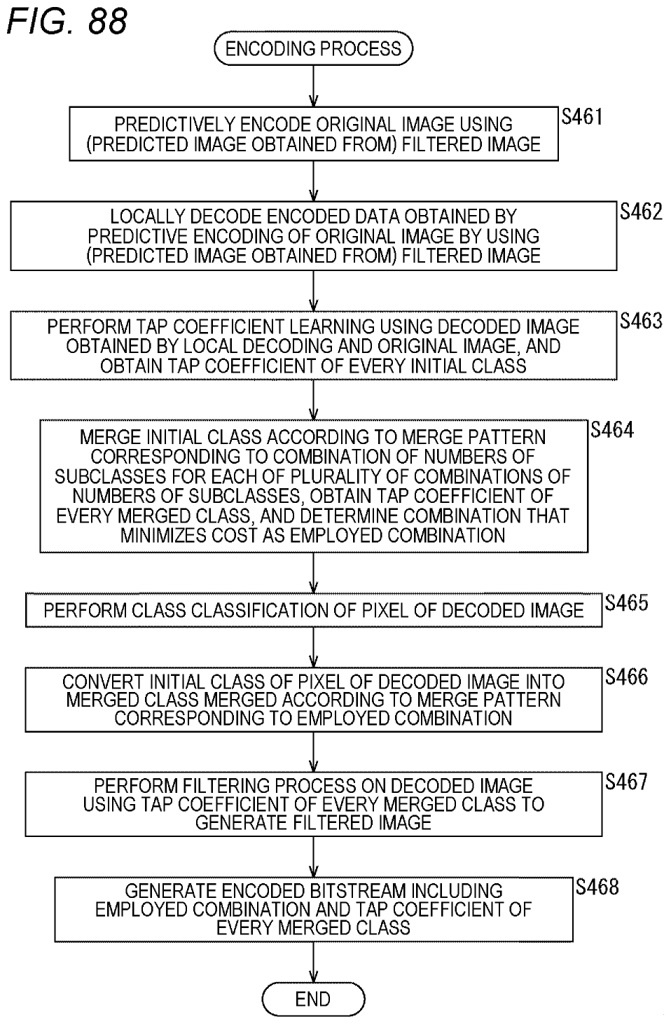

FIG. 88 is a flowchart describing an outline of the encoding process of the encoding device 460 of FIG. 87.

The process according to the flowchart of FIG. 88 is performed, for example, in frame (picture) units.

Processes similar to steps S161 to S163 of FIG. 59 are performed in steps S461 to S463, respectively. Then, in step S463, after the tap coefficient of every initial class is obtained, the process proceeds to step S464.

In step S464, the filter unit 463 merges the initial class according to the merge pattern corresponding to the combination of the number of subclasses for each of the plurality of combinations (for example, the combination of twenty five effective merge patterns described in FIG. 36) of the numbers of subclasses for which the merge pattern obtained by the subclass merging is identified, and obtains, using (X matrix and Y vector of) the normal equations obtained by tap coefficient learning to obtain the tap coefficient of every initial class, the tap coefficient of every merged class in which the initial class is merged according to the merge pattern corresponding to the combination, as described in steps S36 and S37 of FIG. 5. Moreover, the filter unit 463 determines the combination of the number of subclasses that identifies the merge pattern that minimizes the cost as the employed combination by using the tap coefficient of every merged class, and the process proceeds from step S464 to step S465.

In step S465, the class classification unit 164 of the filter unit 463 performs the initial class classification of the pixel of interest of the decoded image from the local decoding unit 162, and the process proceeds to step S466.

In step S466, the merge conversion unit 465 of the filter unit 463 converts the initial class of the pixel of interest obtained by the class classification of the class classification unit 164 into a merged class according to the merge pattern corresponding to the employed combination, and the process proceeds to step S467.

In step S467, the filter unit 463 performs the filtering process as the prediction process that applies to the decoded image the predictive equation that performs the product-sum operation of the tap coefficient of the merged class of the pixel of interest among the tap coefficients of every merged class obtained in step S464 and the pixels of the decoded image, so as to generate a filtered image. The filtered image is supplied from the filter unit 463 to the encoding unit 161 and the local decoding unit 162. The filtered image supplied from the filter unit 463 to the encoding unit 161 and the local decoding unit 162 is used in the processes of steps S461 and 5462 performed for the next frame.

Furthermore, the filter unit 463 supplies the employed combination and the tap coefficient of every merged class to the encoding unit 161 as the filter information.

Thereafter, the process proceeds from step S467 to step S468, and the encoding unit 161 generates and transmits an encoded bitstream including the encoded data obtained in step S461 and the employed combination as the filter information obtained in the filter unit 463, and the tap coefficient of every merged class.

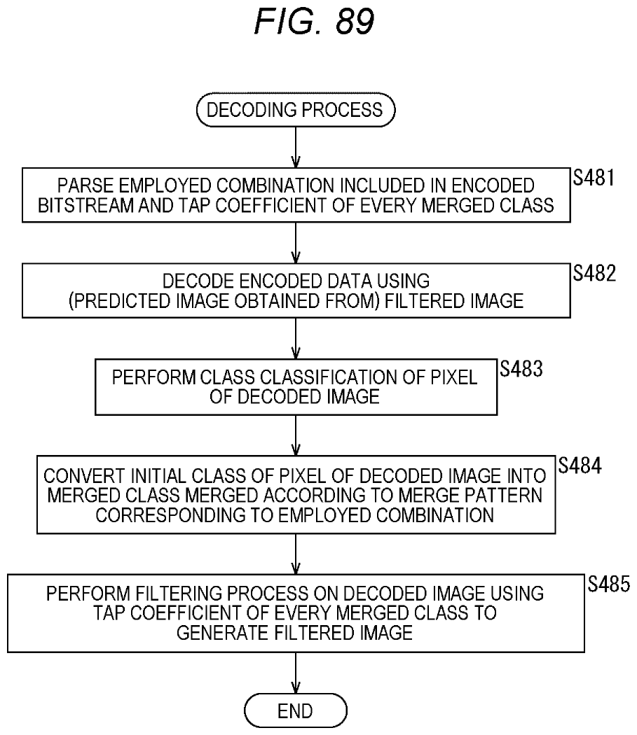

FIG. 89 is a flowchart describing an outline of a decoding process of the decoding device 470 of FIG. 87.

The process according to the flowchart of FIG. 89 is performed in frame units, similarly to the encoding process of FIG. 88, for example.

In step S481, the parsing unit 171 (FIG. 87) receives the encoded bitstream transmitted from the encoding device 460, parses the employed combination and the tap coefficient of every merged class as the filter information included in the encoded bitstream, and supplies them to the filter unit 473. Moreover, the parsing unit 171 supplies the encoded data included in the encoded bitstream to the decoding unit 172, and the process proceeds from step S481 to step S482.

In step S482, the decoding unit 172 decodes the encoded data from the parsing unit 171 by using the filtered image from the filter unit 473, and supplies a decoded image obtained as a result to the filter unit 473, and the process proceeds to step S483.

In step S483, the class classification unit 174 of the filter unit 473 performs the initial class classification on the pixel of interest of the decoded image from the decoding unit 172, and the process proceeds to step S484.

In step S484, the merge conversion unit 475 of the filter unit 473 converts the initial class of the pixel of interest obtained by the class classification of the class classification unit 174 into a merged class according to the merge pattern corresponding to the employed number of merged classes from the parsing unit 171, and the process proceeds to step S485.

In step S485, the filter unit 473 performs the filtering process as the class classification prediction process on the decoded image from the decoding unit 172 by using the tap coefficient of every merged class from the parsing unit 171, so as to generate a filtered image.

The filtered image is supplied from the filter unit 473 to the decoding unit 172, and is output as a final decoded image obtained by decoding the original image.

The filtered image supplied from the filter unit 473 to the decoding unit 172 is used in the process of step S482 performed for the next frame of the decoded image.

Note that, here, as a method of signaling the merge pattern (employed merge pattern) that converts the initial class into the merged class, a method of transmitting the employed combination by including in the encoded bitstream is employed, but as the method of signaling the employed merge pattern, it is possible to employ a method of transmitting the employed merge pattern by including in the encoded bitstream together with the employed number of merged classes similarly to the case of the GALF or instead of the employed number of merged classes. However, overhead can be reduced by transmitting the employed combination as compared with the case of transmitting the employed merge pattern. On the other hand, in the case of transmitting the employed merge pattern, a syntax similar to the class classification of the GALF can be employed.

<Configuration Example of Encoding Device 460>

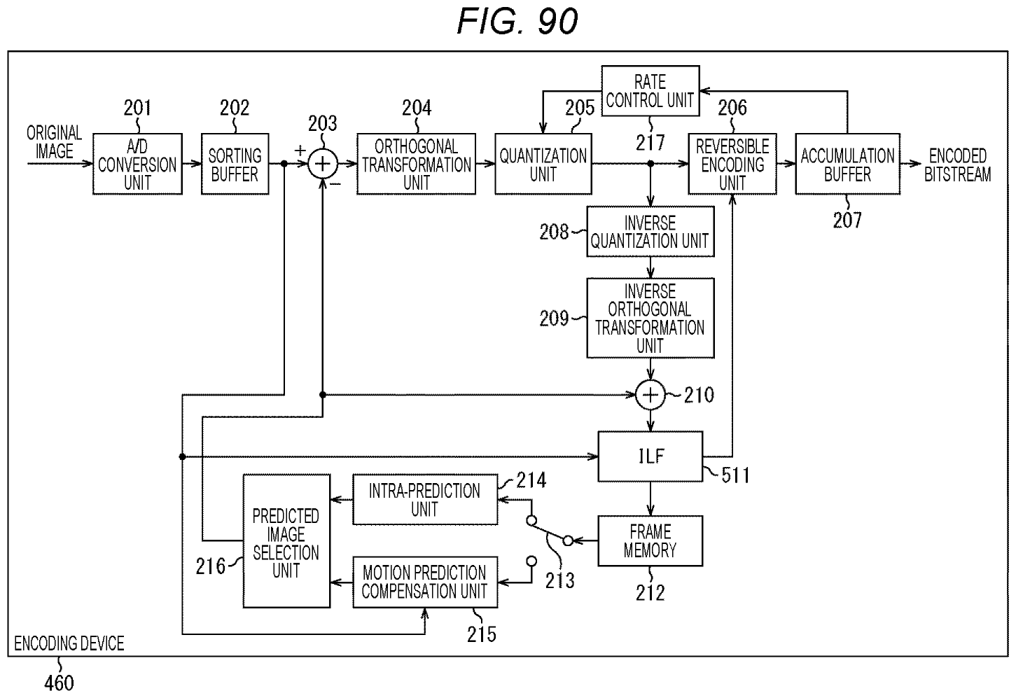

FIG. 90 is a block diagram illustrating a detailed configuration example of the encoding device 460 of Fig. 87.

Note that in the diagram, parts corresponding to those of the encoding device 160 of FIG. 61 are designated by the same reference numerals, and the description thereof will be omitted as appropriate below.

In FIG. 90, the encoding device 460 includes the A/D conversion unit 201, the sorting buffer 202, the calculation unit 203, the orthogonal transformation unit 204, the quantization unit 205, the reversible encoding unit 206, and the accumulation buffer 207. Moreover, the encoding device 460 includes the inverse quantization unit 208, the inverse orthogonal transformation unit 209, the calculation unit 210, the frame memory 212, the selection unit 213, the intra-prediction unit 214, the motion prediction compensation unit 215, the predicted image selection unit 216, the rate control unit 217, and an ILF 511.

Therefore, the encoding device 460 is common to the encoding device 160 of FIG. 61 in that it has the A/D conversion unit 201 to the calculation unit 210, and the frame memory 212 to the rate control unit 217. However, the encoding device 460 differs from the encoding device 160 in that it has the ILF 511 instead of the ILF 211.

The ILF 511 is configured similarly to the class classification prediction filter 410 with the learning function (FIG. 85), for example, and functions as one or two or more filters of a deblocking filter, an adaptive offset filter, a bilateral filter, and an ALF by performing the filtering process as the class classification prediction process. In a case where the ILF 511 is configured to function as two or more filters of a deblocking filter, an adaptive offset filter, a bilateral filter, and an ALF, the arrangement order of the two or more filters is arbitrary.

The decoded image is supplied to the ILF 511 from the calculation unit 210, and the original image for the decoded image is supplied from the sorting buffer 202.

The ILF 511 uses, for example, the decoded image from the calculation unit 210 and the original image from the sorting buffer 202 as the student image and the teacher image, respectively, to perform the tap coefficient learning, and obtains the tap coefficient for every initial class. In the tap coefficient learning, the initial class classification is performed using the decoded image as the student image, and the tap coefficient is obtained by the least squares method, the tap coefficient statistically minimizing the prediction error of the predicted value of the original image as the teacher image obtained by the predictive equation formed by the tap coefficient and the prediction tap for every initial class obtained by the initial class classification.

The ILF 511 determines the combination of subclasses that identifies the merge pattern that minimizes the cost (for example, the cost dist +lambda x coeffBit obtained in step S67 in FIG. 8) as the employed combination among the plurality of merge patterns obtained by the subclass merging, by performing a process similar to the process of determining the number of employed merge patterns (FIG. 8) by using each of the plurality of merge patterns obtained by the subclass merging (for example, a combination of the numbers of subclasses that identifies each of the twenty five valid merge patterns described in FIG. 36).

Note that in the ILF 511, in step S63 before the process of step S64, which is the filtering process for obtaining the cost of determining the employed combination in the process of determining the number of employed merge patterns (FIG. 8), similarly to steps S36 and S37 in the merge pattern determination process (FIG. 5), the tap coefficient of every merged class is obtained for each of the plurality of merge patterns obtained by the subclass merging by using (X matrix and Y vector of) the normal equation that is formulated when obtaining the tap coefficient of every initial class in the tap coefficient learning.

The ILF 511 supplies the employed combination and the tap coefficient of every merged class obtained by the conversion of the initial class according to the merge pattern corresponding to the employed combination to the reversible encoding unit 206 as filter information.

Moreover, the ILF 511 sequentially selects, for example, pixels of the decoded image from the calculation unit 210 as the pixel of interest. The ILF 511 performs the initial class classification on the pixel of interest and obtains the initial class of the pixel of interest.

Moreover, the ILF 511 converts the initial class of the pixel of interest into a merged class according to the merge pattern corresponding to the employed combination. The ILF 511 acquires (reads) the tap coefficient of the merged class of the pixel of interest among the tap coefficients for every merged class obtained by conversion according to the merge pattern corresponding to the employed combination. Then, the ILF 511 selects a pixel near the pixel of interest as the prediction tap from the decoded image, and performs the filtering process as the prediction process that applies to the decoded image the predictive equation that performs the product-sum operation of the tap coefficient of the merged class of the pixel of interest and the pixels of the decoded image as the prediction tap, so as to generate a filtered image. Note that in the class classification in the ILF 511, for example, the class obtained by the class classification of an upper left pixel of 2×2 pixels of the decoded image can be employed as the class of each of the 2×2 pixels.

The filtered image generated by the ILF 511 is supplied to the frame memory 212.

Note that in FIG. 90, the calculation unit 203 to the reversible encoding unit 206 correspond to the encoding unit 161 of FIG. 87, the inverse quantization unit 208 to the calculation unit 210 correspond to the local decoding unit 162 of FIG. 87, and the ILF 511 correspond to the filter unit 463 of FIG. 87.

<Encoding Process>

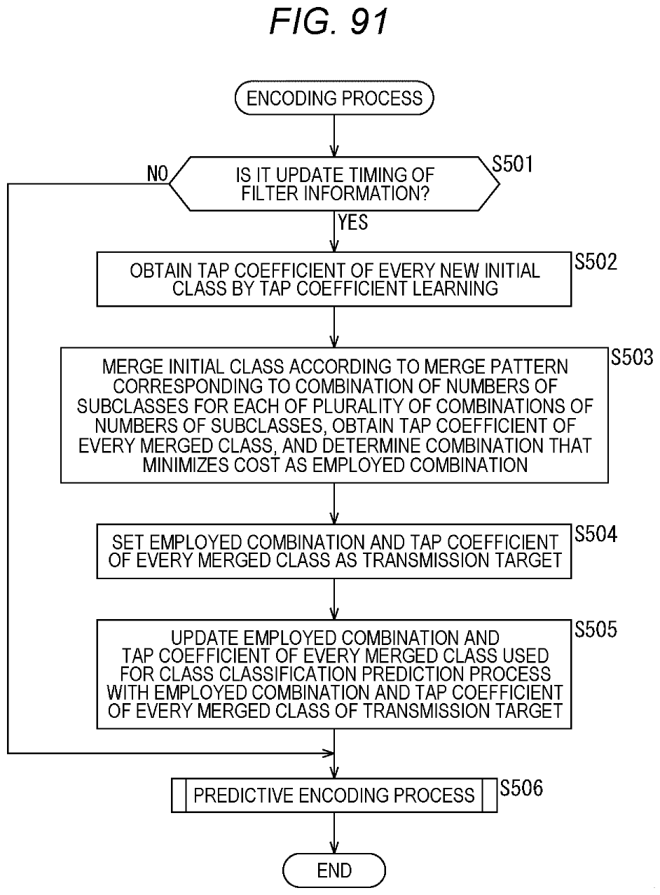

FIG. 91 is a flowchart describing an example of the encoding process of the encoding device 460 of FIG. 90.

In the encoding device 460, the ILF 511 temporarily stores the decoded image supplied from the calculation unit 210, and temporarily stores the original image for the decoded image supplied from the sorting buffer 202 from the calculation unit 210.

Then, in steps S501 and S502, processes similar to steps S201 and 5202 of FIG. 62 are performed, respectively.

Thereafter, in step S503, the ILF 511 converts each of the plurality of combinations of the numbers of subclasses that identify the plurality of merge patterns, respectively, obtained by the subclass merging into a merged class by merging the initial class according to the merge pattern corresponding to the combination of the number of subclasses, and obtains the tap coefficient of every merged class by using the normal equation formulated by the tap coefficient learning similarly to steps S36 and S37 of FIG. 5.

Moreover, the ILF 511 obtains the cost by performing the filtering process for each of the plurality of combinations of the number of subclasses using the tap coefficient of every merged class. Then, the ILF 511 determines the combination of the numbers of subclasses that minimizes the cost among the plurality of combinations of the number of subclasses as the employed combination, and the process proceeds from step S503 to step S504.

In step S504, the ILF 511 supplies the employed combination and the tap coefficient of every merged class obtained by the conversion of the initial class according to the merge pattern corresponding to the employed combination to the reversible encoding unit 206 as filter information. The reversible encoding unit 206 sets the filter information from the ILF 511 as the transmission target, and the process proceeds from step S504 to step S505. The filter information set as the transmission target is included in the encoded bitstream and transmitted in the predictive encoding process performed in step S506 described later.

In step S505, the ILF 511 updates the employed combination and the tap coefficient used for the class classification prediction process by the employed combination determined in the latest step S503 and the tap coefficient of every merged class obtained by the conversion of the initial class according to the merge pattern corresponding to the employed combination, and the process proceeds to step S506.

In step S506, the predictive encoding process of the original image is performed, and the encoding process ends.

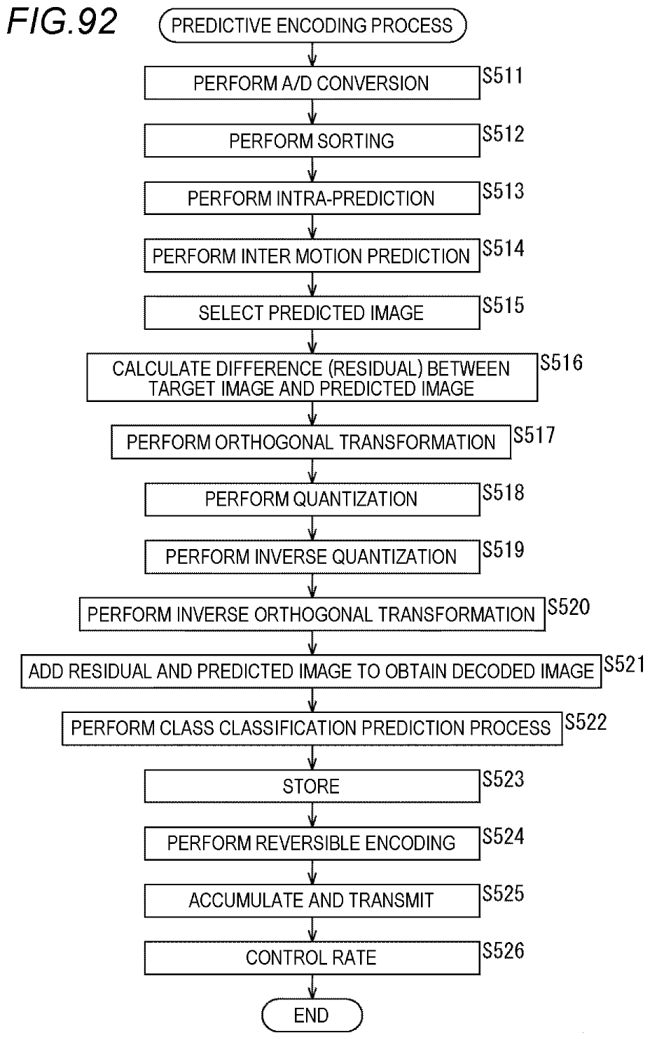

FIG. 92 is a flowchart describing an example of the predictive encoding process of step S506 of FIG. 91.

In the predictive encoding process, processes similar to steps S211 to S221 of FIG. 63 are performed in steps S511 to S521, respectively.

Then, in step S522, the ILF 511 applies the filtering process as the class classification prediction process to the decoded image from the calculation unit 210, supplies a filtered image obtained by the filtering process to the frame memory 212, and the process proceeds from step S522 to step S523.

In the class classification prediction processing of step S522, a process similar to that of the class classification prediction filter 410 (FIG. 85) is performed.

That is, the ILF 511 performs the initial class classification on the pixel of interest of the decoded image from the calculation unit 210, and obtains the initial class of the pixel of interest. Moreover, the ILF 511 converts the initial class of the pixel of interest into a merged class according to the merge pattern corresponding to the employed combination updated in step S505 of FIG. 91. The ILF 511 acquires the tap coefficient of the merged class of the pixel of interest from the tap coefficient of every merged class updated in step S505 of FIG. 91. Thereafter, the ILF 511 performs on the decoded image the filtering process as the prediction process that applies the predictive equation formed by using the tap coefficient of the merged class of the pixel of interest, so as to generate a filtered image. The filtered image is supplied from ILF 511 to the frame memory 212.

Thereafter, processes similar to steps S223 to 5226 of FIG. 63 are performed in steps S523 to 5526, respectively.

<Configuration Example of Decoding Device 470>

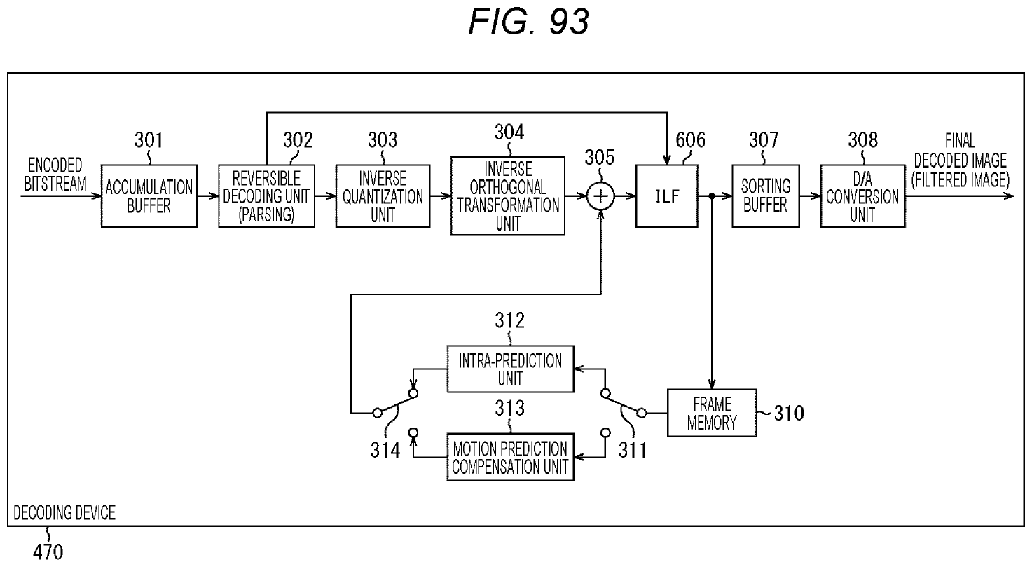

FIG. 93 is a block diagram illustrating a detailed configuration example of the decoding device 470 of FIG. 87.

Note that in the diagram, parts corresponding to those of the decoding device 170 of FIG. 64 are designated by the same reference numerals, and the description thereof will be omitted as appropriate below.

In FIG. 93, the decoding device 470 includes the accumulation buffer 301, the reversible decoding unit 302, the inverse quantization unit 303, the inverse orthogonal transformation unit 304, the calculation unit 305, the sorting buffer 307, the D/A conversion unit 308, an ILF 606. Furthermore, the decoding device 470 has the frame memory 310, the selection unit 311, the intra-prediction unit 312, the motion prediction compensation unit 313, and the selection unit 314.

Therefore, the decoding device 470 is common to the decoding device 170 of FIG. 64 in that it has the accumulation buffer 301 to the calculation unit 305, the sorting buffer 307, the D/A conversion unit 308, and the frame memory 310 to the selection unit 314. However, the decoding device 470 differs from the decoding device 170 in that it has the ILF 606 instead of the ILF 306.

The ILF 606 is configured similarly to, for example, the class classification prediction filter 410 (FIG. 85) without the learning function, and functions as one or two or more filters of the deblocking filter, the adaptive offset filter, the bilateral filter, and the ALF similarly to the ILF 511 in FIG. 90 by performing the filtering process as the class classification prediction process.

The ILF 606 sequentially selects pixels of the decoded image from the calculation unit 305 as the pixel of interest. The ILF 606 performs the initial class classification on the pixel of interest and obtains the initial class of the pixel of interest. Moreover, the ILF 511 converts the initial class of the pixel of interest into a merged class according to the merge pattern corresponding to the employed combination included in the filter information supplied from the reversible decoding unit 302 among the merge patterns determined for every combination of the numbers of subclasses. The ILF 606 acquires the tap coefficient of the merged class of the pixel of interest among the tap coefficients of every merged class included in the filter information supplied from the reversible decoding unit 302. Then, the ILF 606 selects a pixel near the pixel of interest as the prediction tap from the decoded image, and performs the filtering process as the prediction process that applies to the filtered image the predictive equation that performs the product-sum operation of the tap coefficient of the class of the pixel of interest and the pixels of the decoded image as the prediction tap, so as to generate and output a filtered image. Note that in the class classification in the ILF 606, for example, the class obtained by the class classification of an upper left pixel of 2×2 pixels can be employed as the class of each of the 2×2 pixels, similarly to the ILF 511.

The filtered image output by the ILF 606 is an image similar to the filtered image output by the ILF 511 of FIG. 90, and is supplied to the sorting buffer 307 and the frame memory 310.

Note that in FIG. 93, the reversible decoding unit 302 corresponds to the parsing unit 171 of FIG. 87, the inverse quantization unit 303 to the calculation unit 305 correspond to the decoding unit 172 of FIG. 87, and the ILF 606 corresponds to the filter unit 473 of FIG. 87.

<Decoding Process>

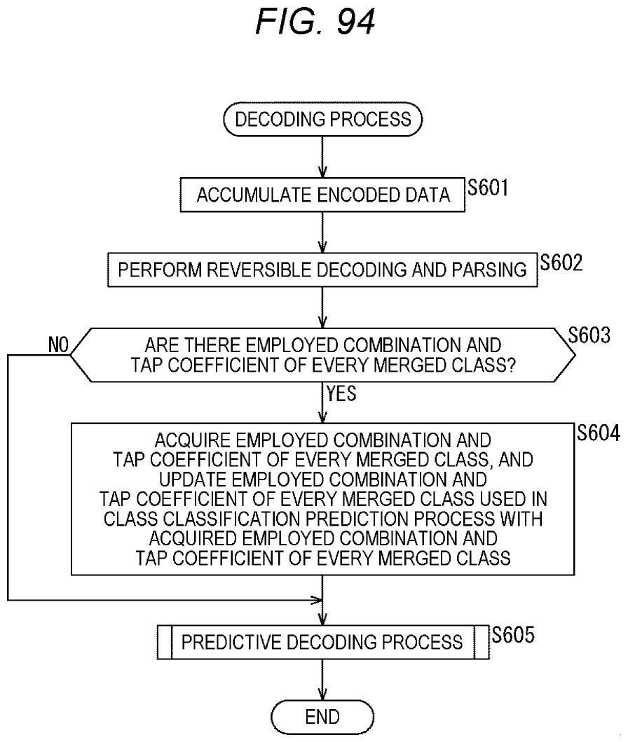

FIG. 94 is a flowchart describing an example of the decoding process of the decoding device 470 of FIG. 93.

In the decoding process, in step S601, the accumulation buffer 301 temporarily accumulates the encoded bitstream transmitted from the encoding device 460 and supplies the encoded bitstream to the reversible decoding unit 302 as appropriate, and the process proceeds to step S602.

In step S602, the reversible decoding unit 302 receives and decodes the encoded bitstream supplied from the accumulation buffer 301, and supplies a quantization coefficient as encoded data included in a decoding result of the encoded bitstream to the inverse quantization unit 303.

Furthermore, in a case where the decoding result of the encoded bitstream includes filter information and encoding information, the reversible decoding unit 302 parses the filter information and the encoding information. Then, the reversible decoding unit 302 supplies necessary encoding information to the intra-prediction unit 312, the motion prediction compensation unit 313, and other necessary blocks. Further, the reversible decoding unit 302 supplies the filter information to the ILF 606.

Thereafter, the process proceeds from step S602 to step S603, and the ILF 606 determines whether or not the filter information including the employed combination and the tap coefficient of every merged class obtained by conversion of the initial class according to the merge pattern corresponding to the employed combination has been supplied from the reversible decoding unit 302.

In a case where it is determined in step S603 that the filter information has not been supplied, the process skips step S604 and proceeds to step S605.

Furthermore, in a case where it is determined in step S603 that the filter information has been supplied, the process proceeds to step S604, and the ILF 606 acquires the employed combination and the tap coefficient of every merged class, which is obtained by conversion of the initial class according to the merge pattern corresponding to the employed combination, included in the filter information from the reversible decoding unit 302. Moreover, the ILF 606 updates the employed combination and the tap coefficient used for the class classification prediction processing by the employed combination and the tap coefficient of every merged class, which is obtained by conversion of the initial class according to the merge pattern corresponding to the employed combination, acquired from the filter information from the reversible decoding unit 302.

Then, the process proceeds from step S604 to step S605, the predictive decoding process is performed, and the decoding process ends.

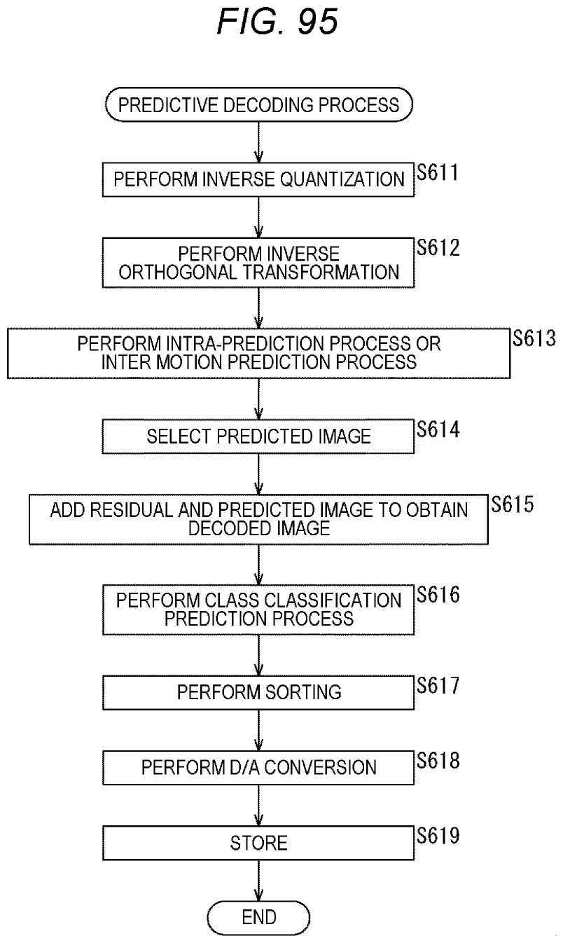

FIG. 95 is a flowchart describing an example of the predictive decoding process of step S605 of FIG. 94.

Processes similar to steps S311 to S315 of FIG. 66 are performed in steps S611 to S615, respectively.

Then, in step S616, the ILF 606 applies the filtering process as the class classification prediction process to the decoded image from the calculation unit 305, and supplies a filtered image obtained by the filtering process to the sorting buffer 307 and the frame memory 310, and the process proceeds from step S616 to step S617.

In the class classification prediction processing of step S616, a process similar to that of the class classification prediction filter 410 (FIG. 85) is performed.

That is, the ILF 606 performs the same initial class classification as the ILF 511 on the pixel of interest of the decoded image from the calculation unit 305, and obtains the initial class of the pixel of interest. Moreover, the ILF 606 converts the initial class of the pixel of interest into a merged class according to the merge pattern corresponding to the employed combination updated in step S604 of FIG. 94 among the merge patterns determined for every combination of the number of subclasses. The ILF 606 acquires the tap coefficient of the merged class of the pixel of interest among the tap coefficients of every merged class updated in step S604 of FIG. 94. Thereafter, the ILF 606 performs the filtering process as the prediction process of applying the predictive equation formed by the tap coefficient of the merged class of the pixel of interest on the decoded image, so as to generate a filtered image. The filtered image is supplied from the ILF 606 to the sorting buffer 307 and the frame memory 310.

Thereafter, processes similar to steps S317 to S319 of FIG. 66 are performed in steps S617 to S619, respectively.

In the above, the case where the present technology employs the class classification of the GALF as the initial class classification has been described. However, the present technology can be applied in a case of employing the class classification by subclass classification of a plurality of feature amounts other than the class classification of the GALF as the initial class classification.

For example, it can be said that the class classification using reliability in the inclination direction described with reference to FIGS. 24 and 25 is class classification performed by subclass classification of the inclination intensity ratio, the direction, the activity sum, and the reliability in the inclination direction as a plurality of feature amounts. Therefore, the present technology can be applied in a case where the class classification using the reliability in the inclination direction described in FIGS. 24 and 25 is employed as the initial class classification.

Note that the class classification prediction filter 110 (FIG. 56) can be applied to an interpolation filter or the like used for generating the predicted image of the motion prediction compensation unit 215 and the motion prediction compensation unit 313 in, for example, the encoding device 160 (FIG. 61) and the decoding device 170 (FIG. 64) in addition to the ILF 211 and the ILF 306. The same applies to the class classification prediction filter 410 (FIG. 86).

<Other Examples of Merge Pattern Set for Every Number of Merged Classes>

Other examples of the merge pattern set for every number of merged classes will be described below.

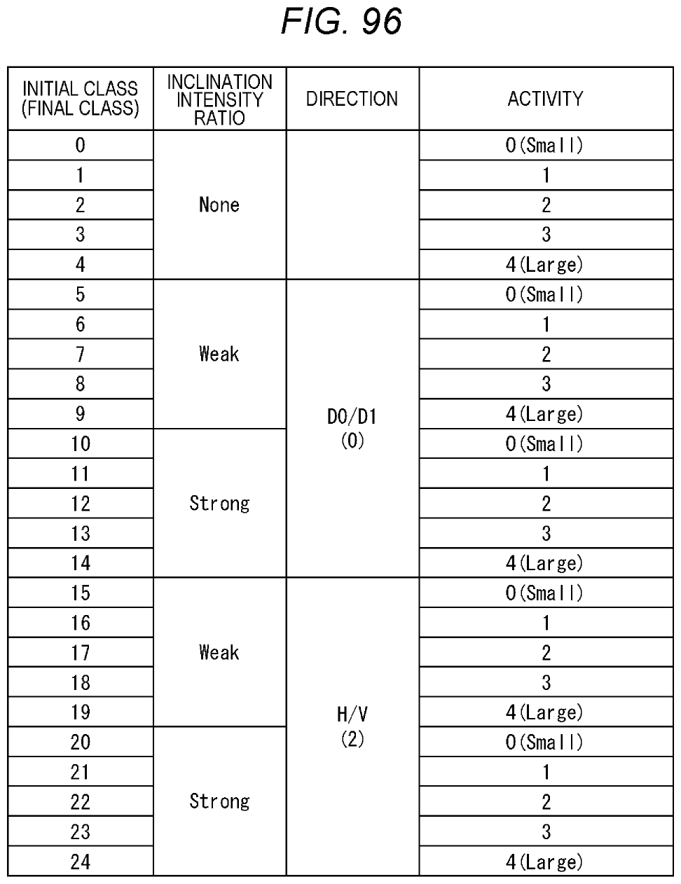

FIG. 96 is a diagram describing the class classification of the GALF.

That is, FIG. 96 illustrates the initial class (final class) obtained by the class classification of the GALF.

In the class classification of the GALF, the pixel of interest is classified by the inclination intensity ratio subclass classification into one of three subclasses, non class, weak class, and strong class, according to the inclination intensity ratio, classified by the activity subclass classification into one of five subclasses of activity subclass 0 to 5 according to the activity sum, and classified by the direction subclass classification into the H/V class and the D0/D1 class (direction subclasses 0 and 2) according to the direction in a case where the inclination intensity ratio subclass is other than the none class, thereby classifying the pixel of interest into one of the twenty-five initial classes 0 to 24.

Here, the activity subclasses 0 to 4 are subclasses whose activity is lower (smaller) as the index #1 of the activity subclass #i is smaller.

As the initial class classification, in a case of employing the class classification of the GALF that classifies the pixel of interest into one of twenty five classes of initial classes 0 to 24 as described above, when a purge pattern is set for every number of merged classes, a merge pattern can be set corresponding to, at the maximum, each of the numbers of merged classes (twenty five merged classes equal to the number of initial classes) of one to twenty five of respective values of natural numbers equal to or less than the number of initial classes.

From the viewpoint of improving performance of the filtering process, that is, image quality and encoding efficiency of the filtered image, it is desirable to set the merge pattern corresponding to each of the numbers of merged classes (hereinafter, also referred to as the total number of merged classes) of respective values of natural numbers equal to or less than the number of initial classes.

Thus, in the following, taking a case of employing the class classification of the GALF as the initial class classification, setting of the merge pattern will be described that corresponds to each of the total number of merged classes of one to twenty five as another example of the merge pattern set for every number of merged classes.

Setting of the merge pattern corresponding to each of all the numbers of merged classes of one to twenty five (hereinafter, also referred to as all the merge patterns) can be performed by merging into one merged class any two merged classes of the merged classes that constitute the merge pattern corresponding to the maximum of the numbers of merged classes of twenty five (the merged classes that constitute a sequence of (the class numbers of) merged classes representing the merge pattern), to thereby set the merge pattern corresponding to the number of merged classes of twenty four, and thereafter, similarly, merging into one merged class any two merged classes of the merged classes that constitute the merge pattern corresponding to the number of merged classes set immediately previously, to thereby set the merge pattern corresponding to the number −1 of merged classes set immediately previously, and repeating this until the number of merged classes becomes the minimum of one.

However, upon setting the merge pattern corresponding to the number C-1 of merged classes, if two merged classes of the merged classes that constitute the merge pattern corresponding to the number C of merged classes are combined into one merged class at random, it is possible that merge patterns that are not appropriate in terms of performance of filtering process are obtained.

Accordingly, in the present technology, upon setting the merge pattern corresponding to the number C-1 of merged classes, two merged classes of the merged classes constituting the merge pattern corresponding to the number C of merged classes are merged into one merged class according to a predetermined rule. A predetermined rule that is followed when merging two merged classes of the merged classes that constitute the merge pattern corresponding to the number C of merged classes into one merged class will be hereinafter also referred to as a merge rule below.

Hereinafter, all the merge pattern settings according to the first to fourth merge rules will be described, but before that, the relationship between the merge pattern and the subclass will be described.

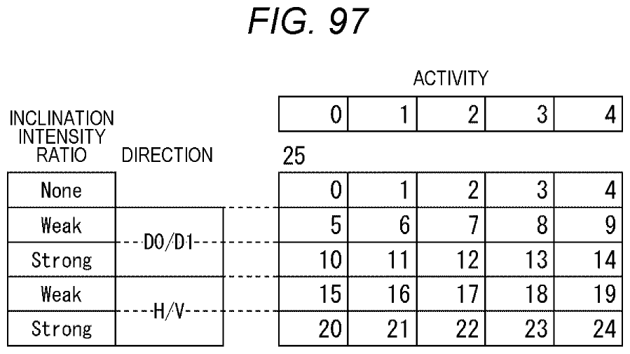

FIG. 97 is a diagram describing a relationship between the merge pattern and the subclasses.

That is, FIG. 97 illustrates the merge pattern with the number of merged classes of twenty five.

As explained in FIG. 6, in the merge pattern represented in a 5×5 tabular format, the horizontal direction corresponds to the activity subclass. Specifically, the first column (first column from the left) corresponds to the activity subclass 0 (without subclass merging). That is, the merged class in the first column is a merged class with the activity subclass of 0. Similarly, columns 2 to 5 correspond to the activity subclasses 1 to 4 (without subclass merging), respectively.

Furthermore, in the merge pattern, the vertical direction corresponds to the inclination intensity ratio subclass and the direction subclass. Specifically, the first row (first row from the top) corresponds to the none class of the inclination intensity ratio subclass, and the second and fourth rows correspond to the weak class of the inclination intensity ratio subclass, and the third row and fifth rows correspond to the strong class of the inclination intensity ratio subclass. Further, the second and third rows correspond to the D0/D1 class of the direction subclass, and the fourth and fifth rows correspond to the H/V class of the direction subclass.

In the merge pattern with the number of merged classes of twenty five, for example, when the merged class 15 is expressed with the subclasses, it can be said that the activity subclass is 0, the direction subclass is the H/V class, and the inclination intensity ratio subclass is the merged class of the weak class. Furthermore, for example, when the merged class 20 is expressed with the subclasses, it can be said that the activity subclass is 0, the direction subclass is the H/V class, and the inclination intensity ratio subclass is the merged class of the strong class. Therefore, in a merge pattern with the number of merged classes of twenty five, it can be said that merging of the merged class 15 and the merged class 20 is, for example, it is merging of the weak class and the strong class of the inclination intensity ratio subclass in a case where the activity subclass is 0 and the direction subclass is the H/V class.

Hereinafter, the setting of all the merge patterns according to the first to fourth merge rules will be described using such expressions as appropriate.

<First Merge Rule>

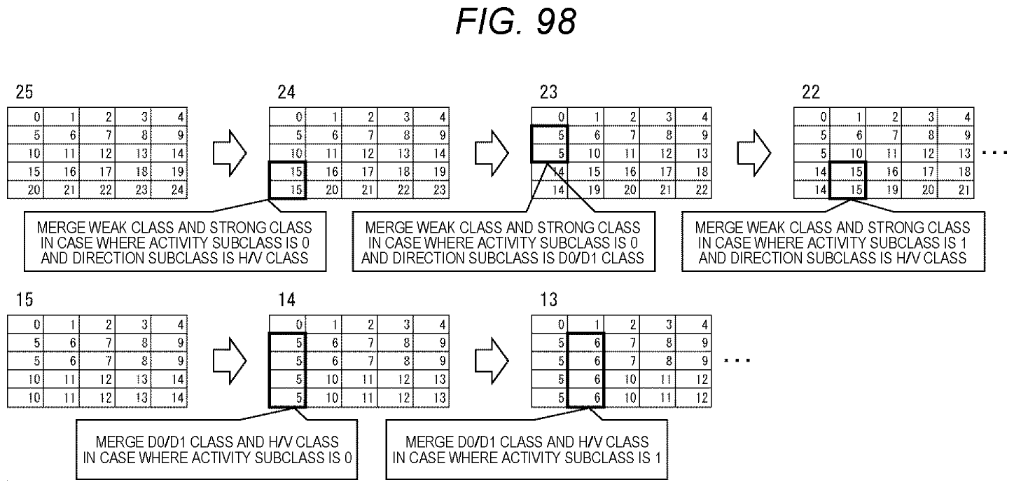

FIG. 98 is a diagram describing a first merge rule.

In the first merge rule, first, as a first step, for the H/V class and the D0/D1 class of the direction subclass, the weak class and the strong class of the inclination intensity ratio subclass are merged from the activity subclass of low activity, respectively. Moreover, in the first merge rule, as a second step, the H/V and D0/D1 classes of the direction subclasses are merged from the activity subclass of low activity. Thereafter, in the first merge rule, as a third step, if the subclass after merging the weak class and the strong class of the inclination intensity ratio subclass (hereinafter, also referred to as the merged subclass) is referred to as a high class, the none class and the high-class of the inclination intensity ratio subclass are merged from the activity subclass of low activity. Finally, in the first merge rule, as a fourth step, the activity subclass is merged from the activity subclass of low activity.

According to the first merge rule, as illustrated in FIG. 98, the merged class 15 and the merged class 20 that constitute the merge pattern corresponding to the number of merged classes of twenty five are merged into the merged class 15, to thereby set the merge pattern corresponding to the number of merged classes of twenty four. Moreover, the merged class 5 and the merged class 10 that constitute the merge pattern corresponding to the number of merged classes of twenty four are merged into the merged class 5, to thereby set the merge pattern corresponding to the number of merged classes of twenty three, and the merged class 15 and the merged class 19 that constitute the merge pattern corresponding to 23 are merged into the merged class 15, to thereby set the merge pattern corresponding to the number of merged classes of twenty two. Thereafter, the merged classes are merged according to the first merge rule, to thereby set the merge patterns corresponding respectively to the numbers of merged classes of twenty one to fifteen.

Then, according to the first merge rule, the merged class 5 and the merged class 10 that constitute the merge pattern corresponding to the number of merged classes of fifteen are merged into the merged class 5, to thereby set the merge pattern corresponding to the number of merged classes of fourteen, and the merged class 6 and the merged class 10 that constitute the merge pattern corresponding to the number of merged classes of fourteen are merged into the merged class 6, to thereby set the merge pattern corresponding to the number of merged classes of thirteen. Thereafter, the merged classes are merged according to the first merge rule, to thereby set the merge patterns corresponding respectively to the numbers of merged classes of twelve to one.

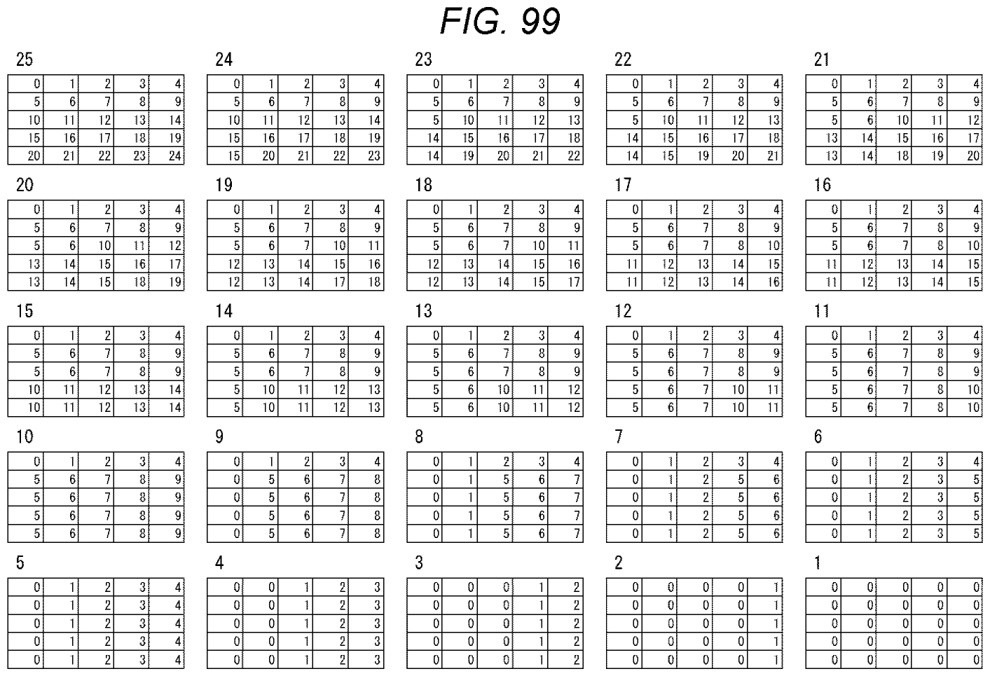

FIG. 99 is a diagram illustrating all the merge patterns set according to the first merge rule.

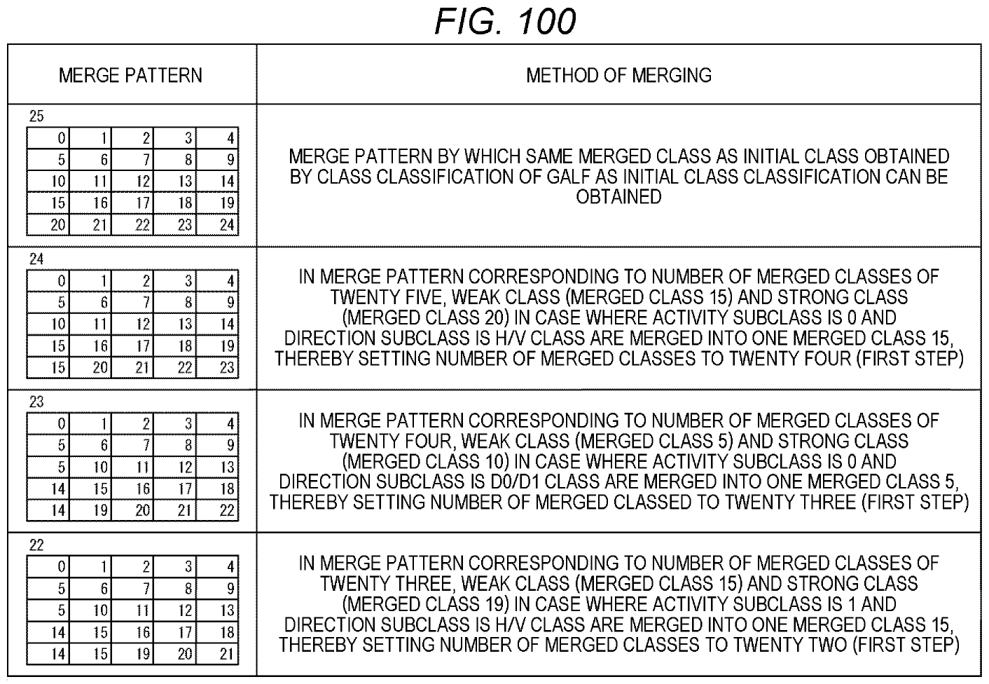

FIGS. 100, 101, 102, 103, 104, and 105 are diagrams describing methods of merging when setting all the merge patterns according to the first merge rule.

In FIG. 100, the merge pattern corresponding to the number of merged classes of twenty five is a merge pattern by which the same merged class as the initial class obtained by the class classification of the GALF as the initial class classification can be obtained.

The merge pattern corresponding to the number of merged classes of twenty four can be obtained by merging, in the merge pattern corresponding to the number of merged classes of twenty five, the weak class (merged class 15) and the strong class (merged class 20) in a case where the activity subclass is 0 and the direction subclass is the H/V class into one merged class 15 (first step).

The merge pattern corresponding to the number of merged classes of twenty three can be obtained by merging, in the merge pattern corresponding to the number of merged classes of twenty four, the weak class (merged class 5) and the strong class (merged class 10) in a case where the activity subclass is 0 and the direction subclass is the D0/D1 class into one merged class 5 (first step).

The merge pattern corresponding to the number of merged classes of twenty two can be obtained by merging, in the merge pattern corresponding to the number of merged classes of twenty three, the weak class (merged class 15) and the strong class (merged class 19) in a case where the activity subclass is 1 and the direction subclass is the H/V class into one merged class 15 (first step).

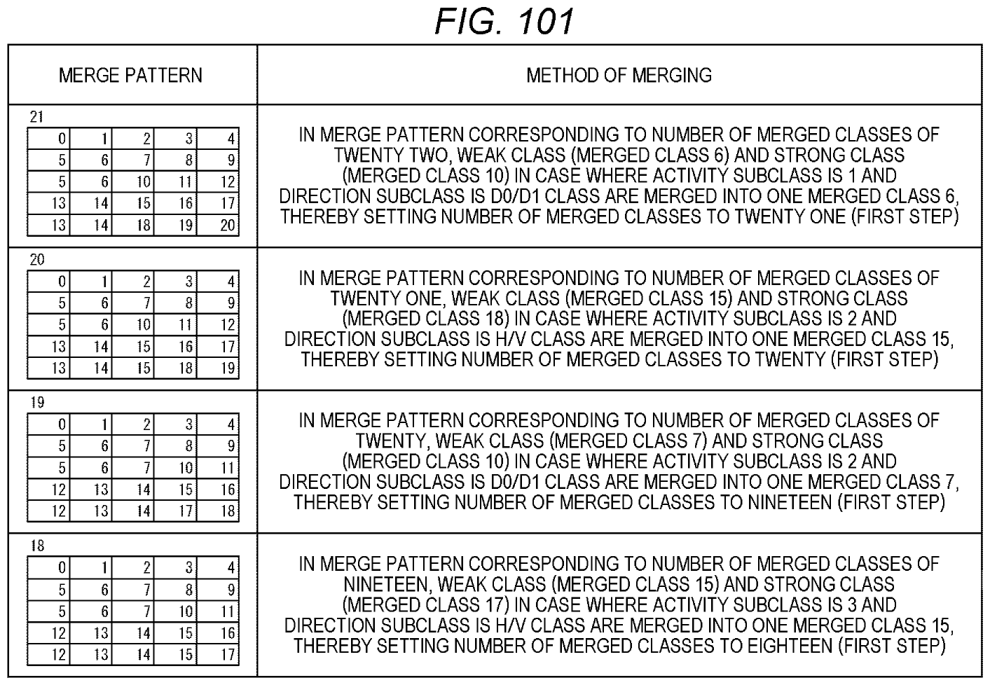

In FIG. 101, the merge pattern corresponding to the number of merged classes of twenty one can be obtained by merging, in the merge pattern corresponding to the number of merged classes of twenty two, the weak class (merged class 6) and the strong class (merged class 10) in a case where the activity subclass is 1 and the direction subclass is the D0/D1 class into one merged class 6 (first step).

The merge pattern corresponding to the number of merged classes of twenty can be obtained by merging, in the merge pattern corresponding to the number of merged classes of twenty one, the weak class (merged class 15) and the strong class (merged class 18) in a case where the activity subclass is 2 and the direction subclass is the H/V class into one merged class 15 (first step).

The merge pattern corresponding to the number of merged classes of nineteen can be obtained by merging, in the merge pattern corresponding to the number of merged classes of twenty, the weak class (merged class 7) and the strong class (merged class 10) in a case where the activity subclass is 2 and the direction subclass is the D0/D1 class into one merged class 7 (first step).

The merge pattern corresponding to the number of merged classes of eighteen can be obtained by merging, in the merge pattern corresponding to the number of merged classes of nineteen, the weak class (merged class 15) and the strong class (merged class 17) in a case where the activity subclass is 3 and the direction subclass is the H/V class into one merged class 15 (first step).

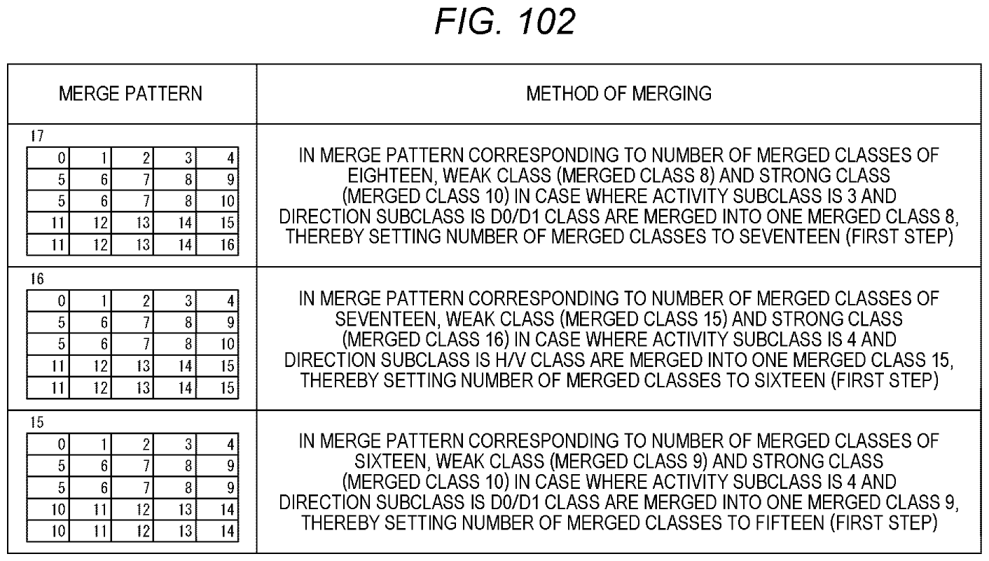

In FIG. 102, the merge pattern corresponding to the number of merged classes of seventeen can be obtained by merging, in the merge pattern corresponding to the number of merged classes of eighteen, the weak class (merged class 8) and the strong class (merged class 10) in a case where the activity subclass is 3 and the direction subclass is the D0/D1 class into one merged class 8 (first step).

The merge pattern corresponding to the number of merged classes of sixteen can be obtained by merging, in the merge pattern corresponding to the number of merged classes of seventeen, the weak class (merged class 15) and the strong class (merged class 16) in a case where the activity subclass is 4 and the direction subclass is the H/V class into one merged class 15 (first step).

The merge pattern corresponding to the number of merged classes of fifteen can be obtained by merging, in the merge pattern corresponding to the number of merged classes of sixteen, the weak class (merged class 9) and the strong class (merged class 10) in a case where the activity subclass is 4 and the direction subclass is the D0/D1 class into one merged class 9 (first step).

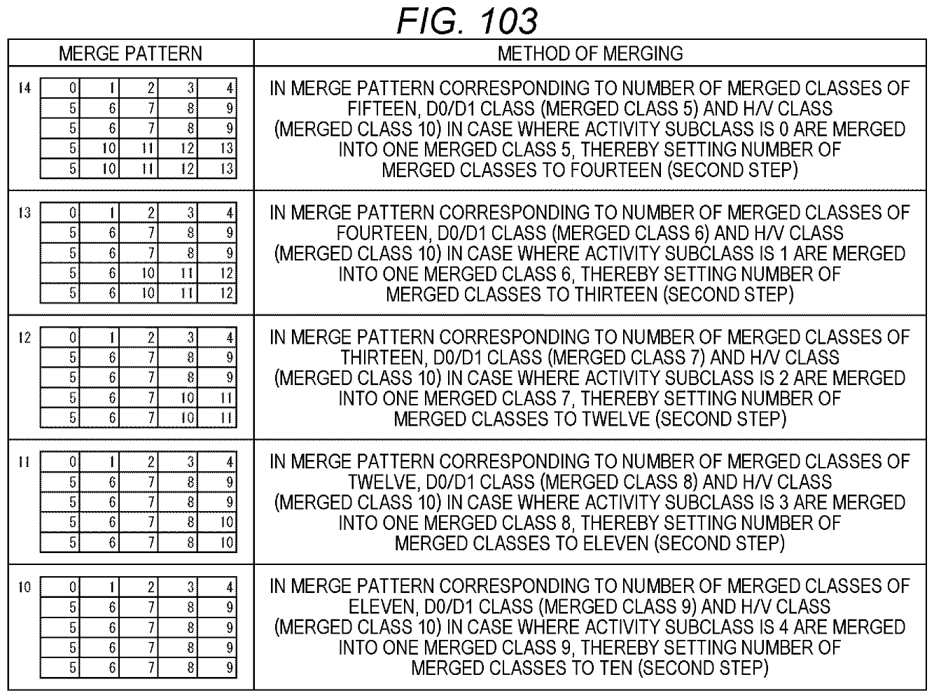

In FIG. 103, the merge pattern corresponding to the number of merged classes of fourteen can be obtained by merging, in the merge pattern corresponding to the number of merged classes of fifteen, the D0/D1 class (merged class 5) and the H/V class (merged class 10) in a case where the activity subclass is 0 into one merged class 5 (second step).

The merge pattern corresponding to the number of merged classes of thirteen can be obtained by merging, in the merge pattern corresponding to the number of merged classes of fourteen, the D0/D1 class (merged class 6) and the H/V class (merged class 10) in a case where the activity subclass is 1 into one merged class 6 (second step).

The merge pattern corresponding to the number of merged classes of twelve can be obtained by merging, in the merge pattern corresponding to the number of merged classes of thirteen, the D0/D1 class (merged class 7) and the H/V class (merged class 10) in a case where the activity subclass is 2 class into one merged class 7 (second step).

The merge pattern corresponding to the number of merged classes of eleven can be obtained by merging, in the merge pattern corresponding to the number of merged classes of twelve, the D0/D1 class (merged class 8) and the H/V class (merged class 10) in a case where the activity subclass is 3 into one merged class 8 (second step).

The merge pattern corresponding to the number of merged classes of ten can be obtained by merging, in the merge pattern corresponding to the number of merged classes of eleven, the D0/D1 class (merged class 9) and the H/V class (merged class 10) in a case where the activity subclass is 4 class into one merged class 9 (second step).

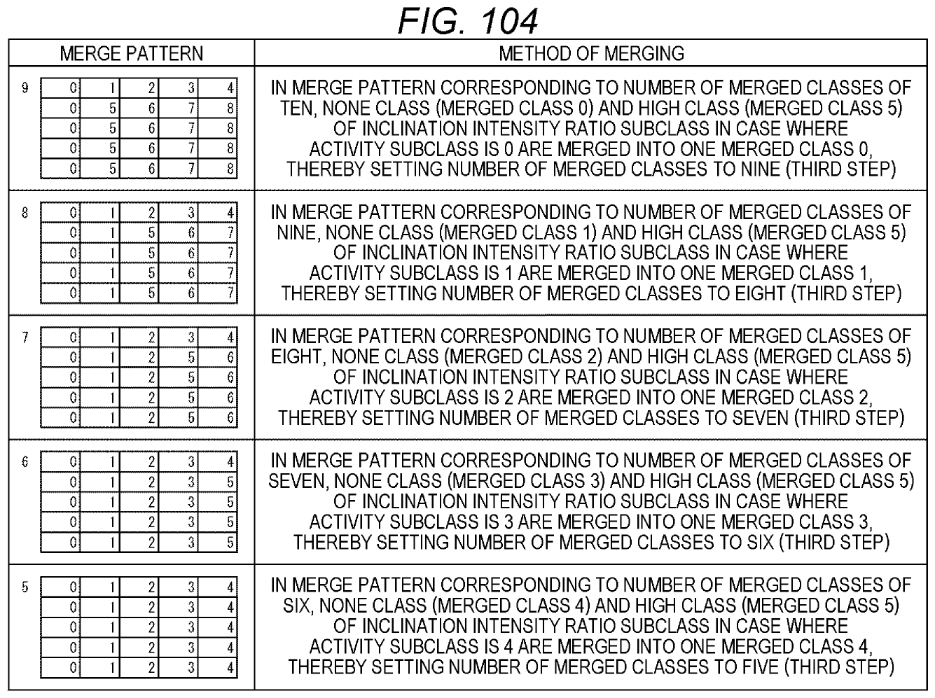

In FIG. 104, the merge pattern corresponding to the number of merged classes of nine can be obtained by merging, in the merge pattern corresponding to the number of merged classes of ten, the none class (merged class 0) and the high class (merged class 5), after merging the weak class and the strong class, of the inclination intensity ratio subclass in a case where the activity subclass is 0 into one merged class 0 (third step).

The merge pattern corresponding to the number of merged classes of eight can be obtained by merging, in the merge pattern corresponding to the number of merged classes of nine, the none class (merged class 1) and the high class (merged class 5), after merging the weak class and the strong class, of the inclination intensity ratio subclass in a case where the activity subclass is 1 into one merged class 1 (third step).

The merge pattern corresponding to the number of merged classes of seven can be obtained by merging, in the merge pattern corresponding to the number of merged classes of eight, the none class (merged class 2) and the high class (merged class 5), after merging the weak class and the strong class, of the inclination intensity ratio subclass in a case where the activity subclass is 2 into one merged class 2 (third step).

The merge pattern corresponding to the number of merged classes of six can be obtained by merging, in the merge pattern corresponding to the number of merged classes of seven, the none class (merged class 3) and the high class (merged class 5), after merging the weak class and the strong class, of the inclination intensity ratio subclass in a case where the activity subclass is 3 into one merged class 3 (third step).

The merge pattern corresponding to the number of merged classes of five can be obtained by merging, in the merge pattern corresponding to the number of merged classes of six, the none class (merged class 4) and the high class (merged class 5), after merging the weak class and the strong class, of the inclination intensity ratio subclass in a case where the activity subclass is 4 into one merged class 4 (third step).

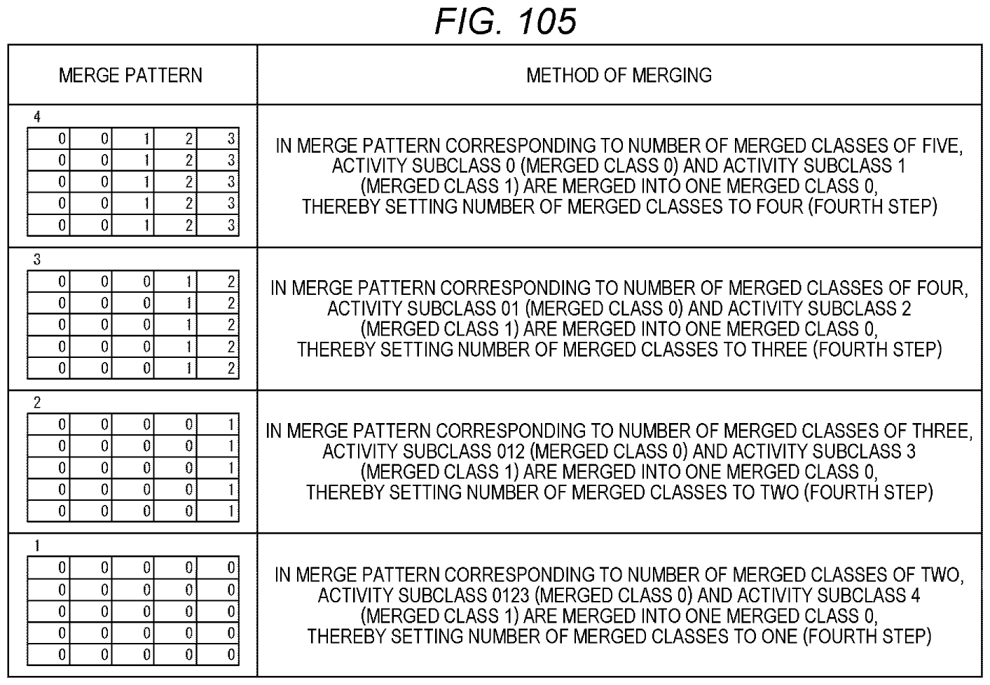

In FIG. 105, the merge pattern corresponding to the number of merged classes of four can be obtained by merging, in the merge pattern corresponding to the number of merged classes of five, the activity subclass 0 (merged class 0) and the activity subclass 1 (merged class 1) into one merged class 0 (fourth step).

The merge pattern corresponding to the number of merged classes of three can be obtained by merging, in the merge pattern corresponding to the number of merged classes of four, the activity subclass 01 (merged class 0) and the activity subclass 2 (merged class 1) into one merged class 0 (fourth step). Here, the activity subclass 01 means a subclass in which the activity subclass 0 and the activity subclass 1 are merged.

The merge pattern corresponding to the number of merged classes of two can be obtained by merging, in the merge pattern corresponding to the number of merged classes of three, the activity subclass 012 (merged class 0) and the activity subclass 3 (merged class 1) into one merged class 0 (fourth step). Here, the activity subclass 012 means a subclass in which the activity subclass 01 and the activity subclass 2 are merged.

The merge pattern corresponding to the number of merged classes of one can be obtained by merging, in the merge pattern corresponding to the number of merged classes of two, the activity subclass 0123 (merged class 0) and the activity subclass 4 (merged class 1) into one merged class 0 (fourth step). Here, the activity subclass 0123 means a subclass in which the activity subclass 012 and the activity subclass 3 are merged.

<Second Merge Rule>

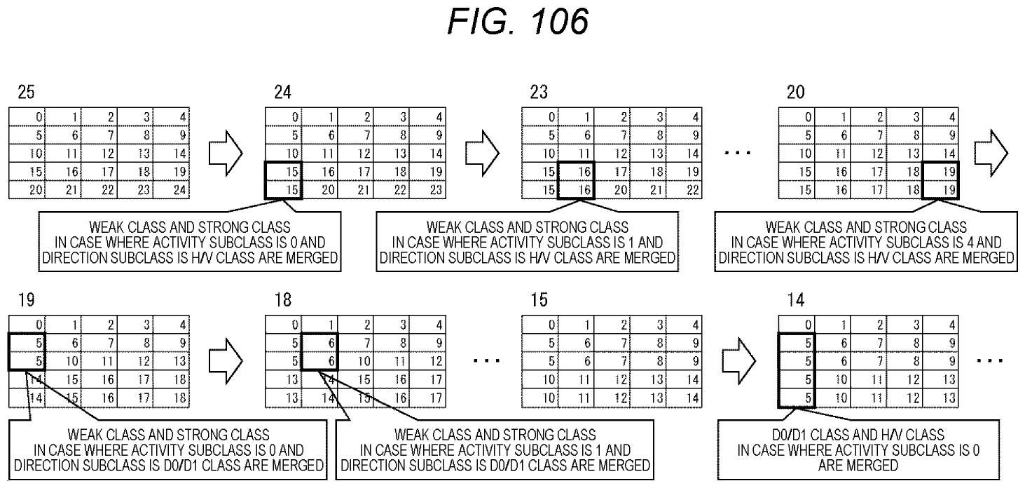

FIG. 106 is a diagram describing a second merge rule.

In the second merge rule, first, in a first step, for example, for the H/V class that is one of the H/V and D0/D1 subclasses of the direction subclass, the weak class and the strong class of the inclination intensity ratio subclass are merged from the activity subclass of low activity, and then, for example, for the D0/D1 class as other subclass, the weak class and the strong class of the inclination intensity ratio subclass are merged from the activity subclass of low activity. Moreover, in the second merge rule, as the second step, the H/V class and the D0/D1 class of the direction subclass are merged from the activity subclass of low activity similarly to the first merge rule. Thereafter, in the second merge rule, as a third step, similarly to the first merge rule, the high class and the none class, which are the merged subclasses after merging the weak class and the strong class of the inclination intensity ratio subclass, are merged from the activity subclass of low activity. Finally, in the second merge rule, as a fourth step, the activity subclass is merged from the activity subclass of low activity, similarly to the first merge rule.

According to the second merge rule, as illustrated in FIG. 106, the merged class 15 and the merged class 20 that constitute the merge pattern corresponding to the number of merged classes of twenty five are merged into the merged class 15, to thereby set the merge pattern corresponding to the number of merged classes of twenty four. Moreover, the merged class 16 and the merged class 20 that constitute the merge pattern corresponding to the number of merged classes of twenty four are merged into the merged class 16, to thereby set the merge pattern corresponding to the number of merged classes of twenty three. Thereafter, the merged classes are merged according to the second merge rule, to thereby set the merge patterns corresponding respectively to the numbers of merged classes of twenty two to twenty.

Then, according to the second merge rule, the merged class 5 and the merged class 10 that constitute the merge pattern corresponding to the number of merged classes of twenty are merged into the merged class 5, to thereby set the merge pattern corresponding to the number of merged classes of nineteen. Moreover, the merged class 6 and the merged class 10 that constitute the merge pattern corresponding to the number of merged classes of nineteen are merged into the merged class 6, to thereby set the merge pattern corresponding to the number of merged classes of eighteen. Thereafter, the merged classes are merged according to the second merge rule, to thereby set the merge patterns corresponding respectively to the numbers of merged classes of seventeen to fifteen.

Then, according to the second merge rule, the merged class 5 and the merged class 10 that constitute the merge pattern corresponding to the number of merged classes of fifteen are merged into the merged class 5, to thereby set the merge pattern corresponding to the number of merged classes of fourteen. Thereafter, the merged classes are merged according to the second merge rule, to thereby set the merge patterns corresponding respectively to the numbers of merged classes of thirteen to one.

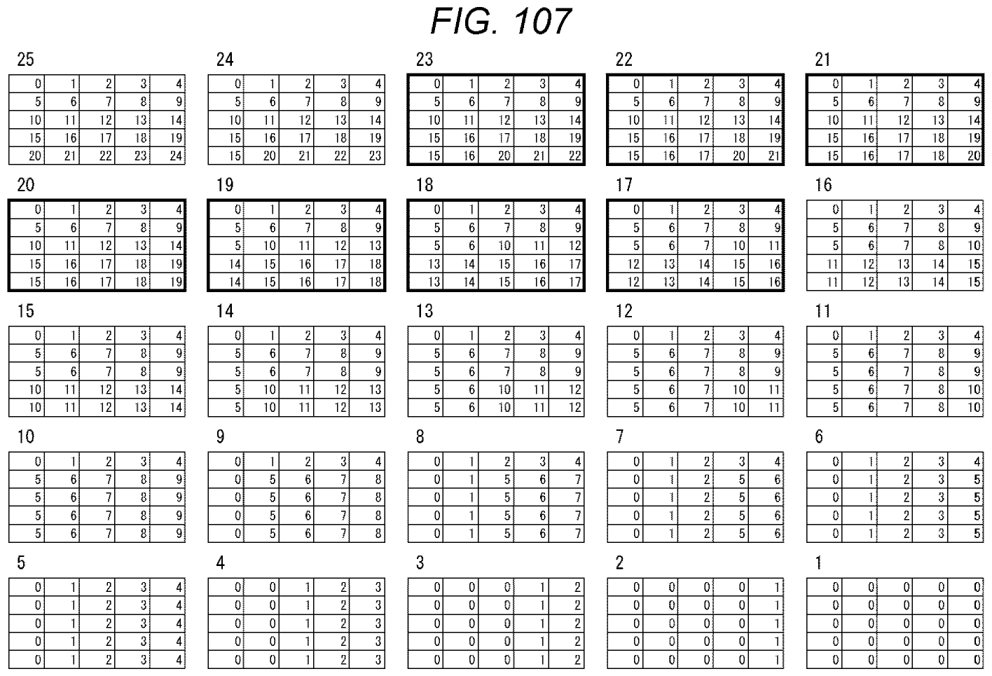

FIG. 107 is a diagram illustrating all the merge patterns set according to the second merge rule.

Note that among all the merge patterns set according to the second merge rule, the merge patterns corresponding to the numbers of merged classes other than the numbers of merged classes of twenty three to seventeen surrounded by a thick line in FIG. 107 are, consequently, the same as the merge patterns set according to the first merge rule (FIG. 99).

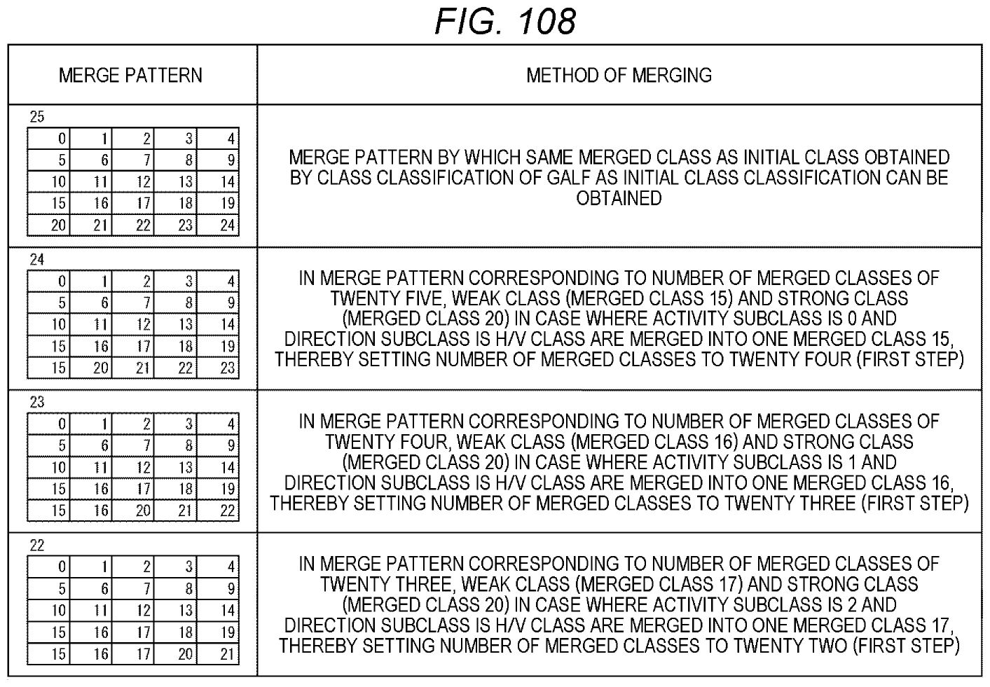

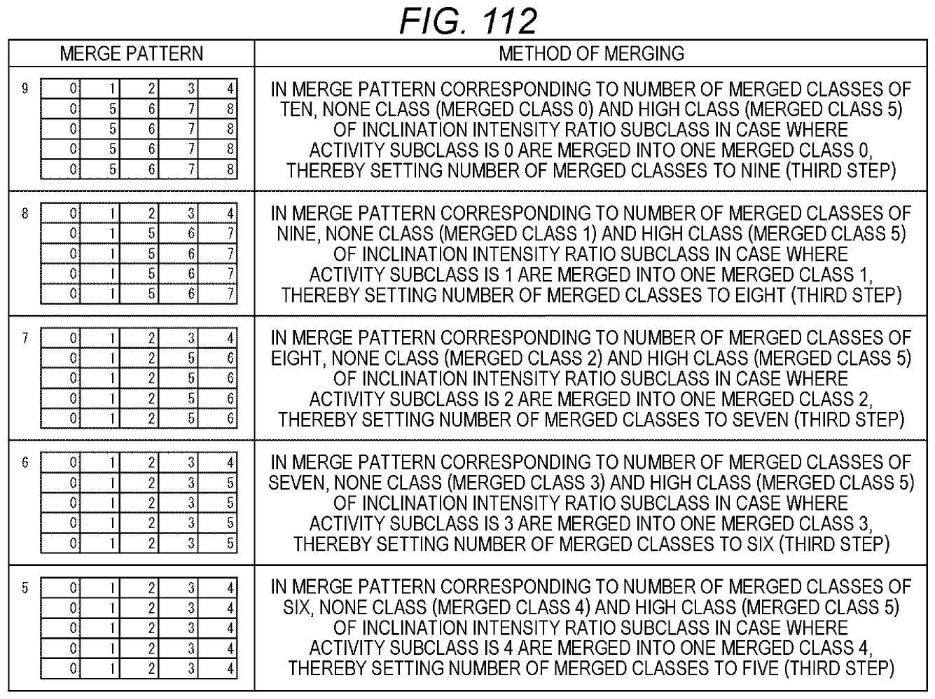

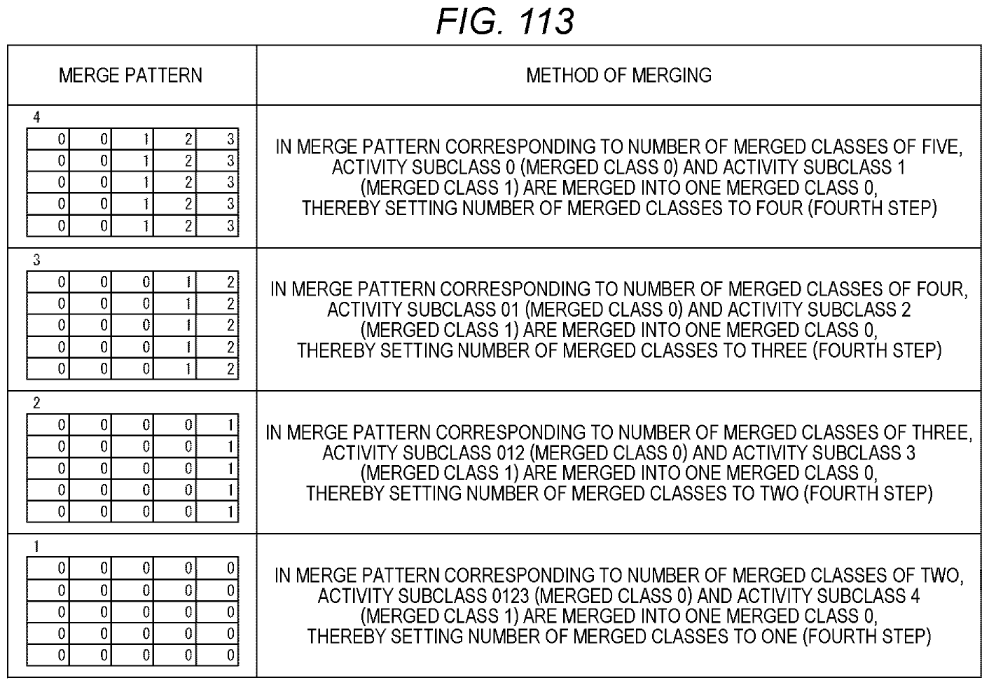

FIGS. 108, 109, 110, 111, 112, and 113 are diagrams describing methods of merging when setting all the merge patterns according to the second merge rule.

In FIG. 108, the merge pattern corresponding to the number of merged classes of twenty five is a merge pattern by which the same merged class as the initial class obtained by the class classification of the GALF as the initial class classification can be obtained.

The merge pattern corresponding to the number of merged classes of twenty four can be obtained by merging, in the merge pattern corresponding to the number of merged classes of twenty five, the weak class (merged class 15) and the strong class (merged class 20) in a case where the activity subclass is 0 and the direction subclass is the H/V class into one merged class 15 (first step).

The merge pattern corresponding to the number of merged classes of twenty three can be obtained by merging, in the merge pattern corresponding to the number of merged classes of twenty four, the weak class (merged class 16) and the strong class (merged class 20) in a case where the activity subclass is 1 and the direction subclass is the H/V class into one merged class 16 (first step).

The merge pattern corresponding to the number of merged classes of twenty two can be obtained by merging, in the merge pattern corresponding to the number of merged classes of twenty three, the weak class (merged class 17) and the strong class (merged class 20) in a case where the activity subclass is 2 and the direction subclass is the H/V class into one merged class 17 (first step).

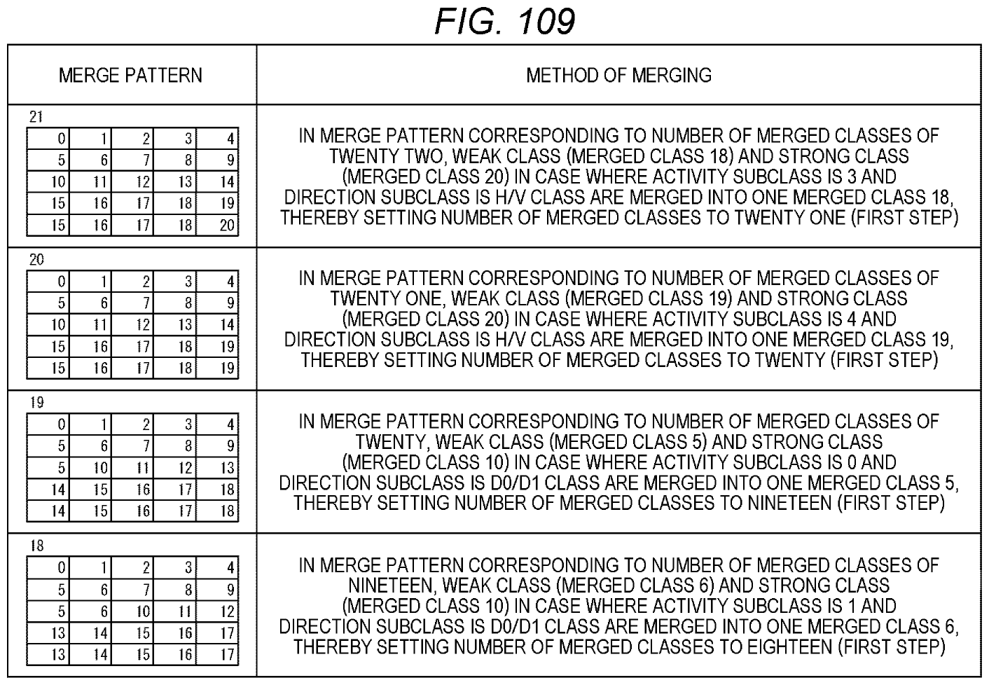

In FIG. 109, the merge pattern corresponding to the number of merged classes of twenty one can be obtained by merging, in the merge pattern corresponding to the number of merged classes of twenty two, the weak class (merged class 18) and the strong class (merged class 20) in a case where the activity subclass is 3 and the direction subclass is the H/V class into one merged class 18 (first step).

The merge pattern corresponding to the number of merged classes of twenty can be obtained by merging, in the merge pattern corresponding to the number of merged classes of twenty one, the weak class (merged class 19) and the strong class (merged class 20) in a case where the activity subclass is 4 and the direction subclass is the H/V class into one merged class 19 (first step).

The merge pattern corresponding to the number of merged classes of nineteen can be obtained by merging, in the merge pattern corresponding to the number of merged classes of twenty, the weak class (merged class 5) and the strong class (merged class 10) in a case where the activity subclass is 0 and the direction subclass is the D0/D1 class into one merged class 5 (first step).

The merge pattern corresponding to the number of merged classes of eighteen can be obtained by merging, in the merge pattern corresponding to the number of merged classes of nineteen, the weak class (merged class 6) and the strong class (merged class 10) in a case where the activity subclass is 1 and the direction subclass is the D0/D1 class into one merged class 6 (first step).

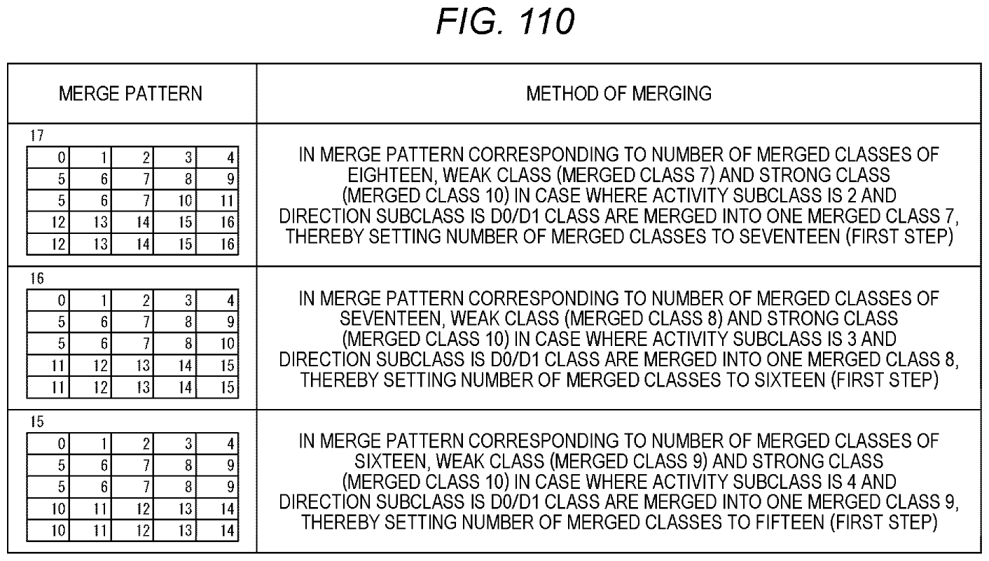

In FIG. 110, the merge pattern corresponding to the number of merged classes of seventeen can be obtained by merging, in the merge pattern corresponding to the number of merged classes of eighteen, the weak class (merged class 7) and the strong class (merged class 10) in a case where the activity subclass is 2 and the direction subclass is the D0/D1 class into one merged class 7 (first step).

The merge pattern corresponding to the number of merged classes of sixteen can be obtained by merging, in the merge pattern corresponding to the number of merged classes of seventeen, the weak class (merged class 8) and the strong class (merged class 10) in a case where the activity subclass is 3 and the direction subclass is the D0/D1 class into one merged class 8 (first step).

The merge pattern corresponding to the number of merged classes of fifteen can be obtained by merging, in the merge pattern corresponding to the number of merged classes of sixteen, the weak class (merged class 9) and the strong class (merged class 10) in a case where the activity subclass is 4 and the direction subclass is the D0/D1 class into one merged class 9 (first step).

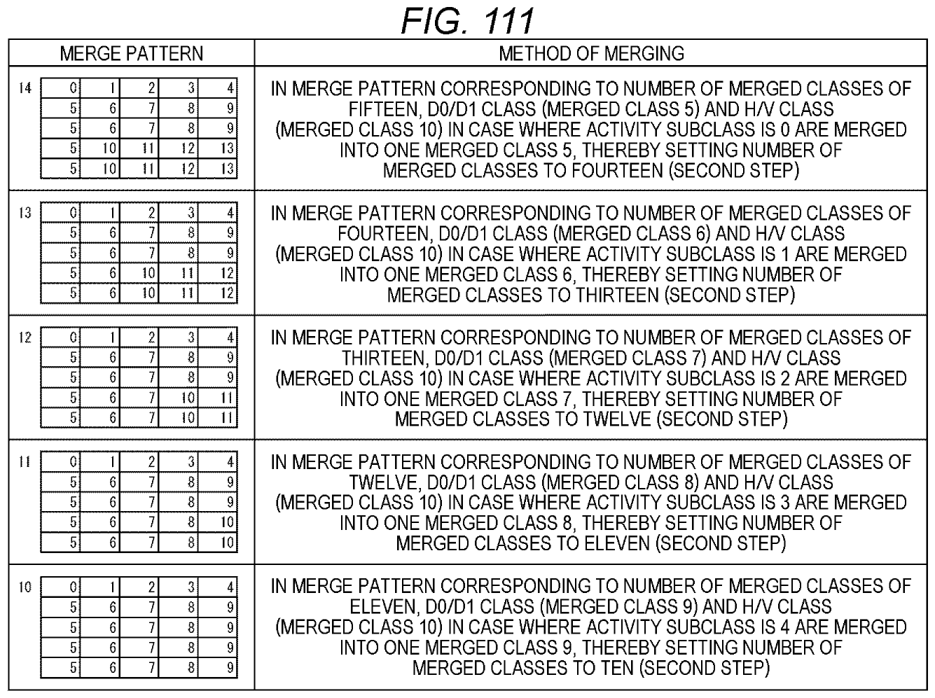

In FIGS. 111 to 113, the methods of merging when obtaining the merge pattern corresponding respectively to the numbers of merged classes of fourteen to one according to the second merge rule are similar to the methods of merging when obtaining the merge pattern corresponding respectively to the numbers of merged classes of fourteen to one according to the first merge rule described in FIGS. 103 to 105, and thus the description is omitted.

<Third Merge Rule>

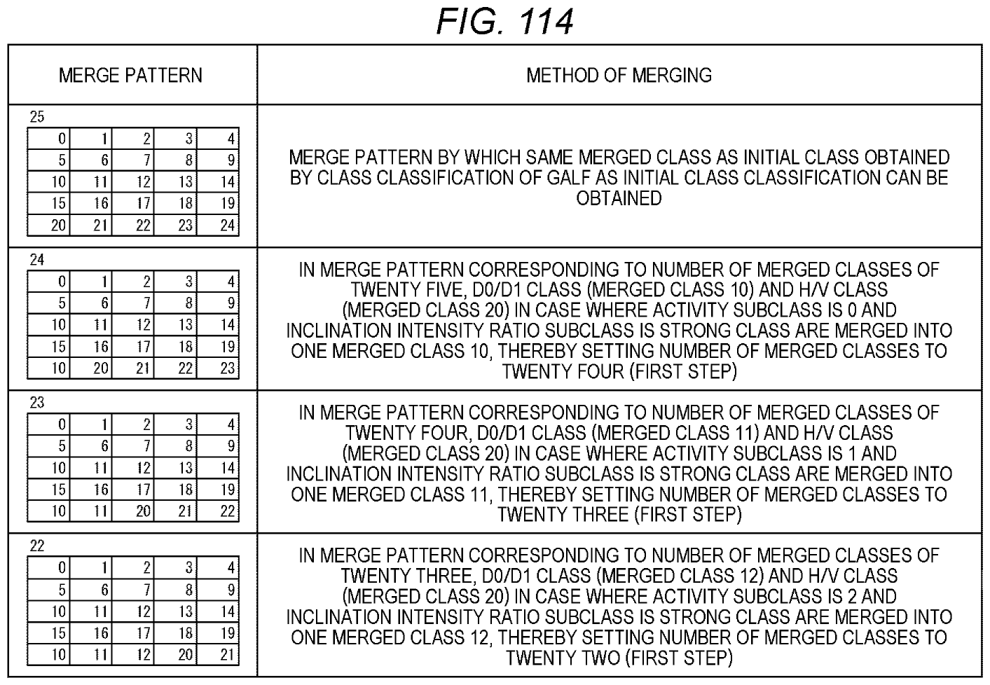

FIGS. 114, 115, 116, 117, 118, and 119 are diagrams describing methods of merging when setting all the merge patterns according to the third merge rule.

In the third merge rule, first, in a first step, for the strong class with a largest inclination intensity ratio among the inclination intensity ratio subclasses, the D0/D1 and the H/V classes of the direction subclass are merged from the activity subclass of low activity, and then, for the weak class with a second largest inclination intensity ratio among the inclination intensity ratio subclasses, the D0/D1 and the H/V subclasses of the direction subclass are merged from the activity subclass of low activity. Thereafter, in the third merge rule, as a second step, the weak class and the strong class of the inclination intensity ratio subclass are merged from the activity subclass of low activity. Moreover, in the third merge rule, as a third step, the high class and the none class, which are the merged subclasses after merging the weak class and the strong class of the inclination intensity ratio subclass, are merged from the activity subclass of low activity. Finally, in the third merge rule, as a fourth step, the activity subclass is merged from the activity subclass of low activity, similarly to the first merge rule.

In FIG. 114, the merge pattern corresponding to the number of merged classes of twenty five is a merge pattern by which the same merged class as the initial class obtained by the class classification of the GALF as the initial class classification can be obtained.

The merge pattern corresponding to the number of merged classes of twenty four can be obtained by merging, in the merge pattern corresponding to the number of merged classes of twenty five, the D0/D1 (merged class 10) and the H/V class (merged class 20) in a case where the activity subclass is 0 and the inclination intensity ratio subclass is the strong class into one merged class 10 (first step).

The merge pattern corresponding to the number of merged classes of twenty three can be obtained by merging, in the merge pattern corresponding to the number of merged classes of twenty four, the D0/D1 (merged class 11) and the H/V class (merged class 20) in a case where the activity subclass is 1 and the inclination intensity ratio subclass is the strong class into one merged class 11 (first step).

The merge pattern corresponding to the number of merged classes of twenty two can be obtained by merging, in the merge pattern corresponding to the number of merged classes of twenty three, the D0/D1 (merged class 12) and the H/V class (merged class 20) in a case where the activity subclass is 2 and the inclination intensity ratio subclass is the strong class into one merged class 12 (first step).

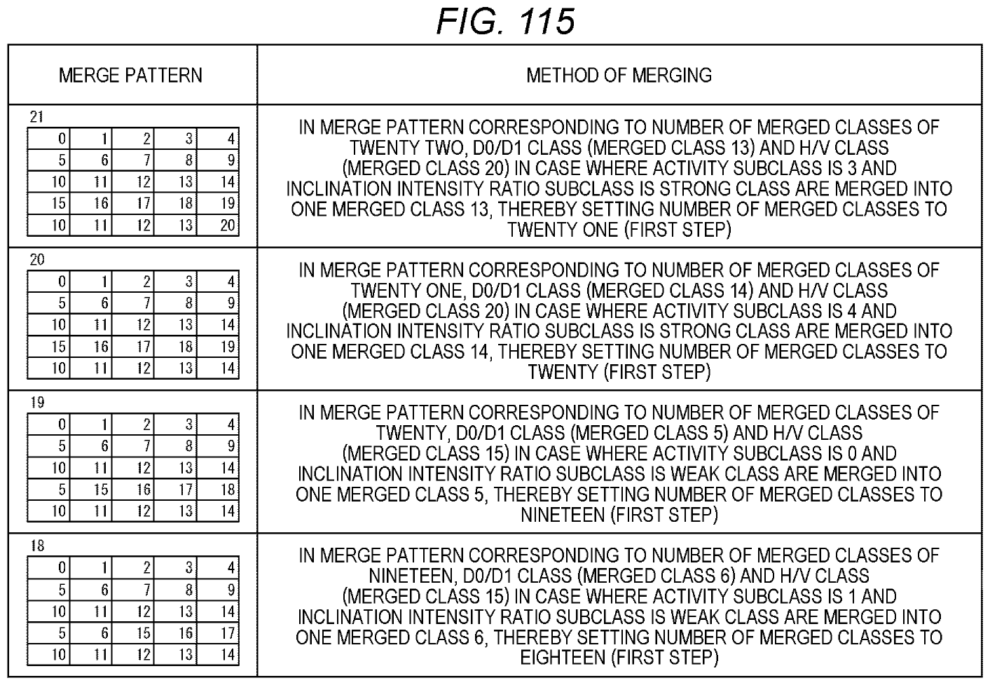

FIG. 115, the merge pattern corresponding to the number of merged classes of twenty one can be obtained by merging, in the merge pattern corresponding to the number of merged classes of twenty two, the D0/D1 (merged class 13) and the H/V class (merged class 20) in a case where the activity subclass is 3 and the inclination intensity ratio subclass is the strong class into one merged class 13 (first step).

The merge pattern corresponding to the number of merged classes of twenty can be obtained by merging, in the merge pattern corresponding to the number of merged classes of twenty one, the D0/D1 (merged class 14) and the H/V class (merged class 20) in a case where the activity subclass is 4 and the inclination intensity ratio subclass is the strong class into one merged class 14 (first step).

The merge pattern corresponding to the number of merged classes of nineteen can be obtained by merging, in the merge pattern corresponding to the number of merged classes of twenty, the D0/D1 (merged class 5) and the H/V class (merged class 15) in a case where the activity subclass is 0 and the inclination intensity ratio subclass is the weak class into one merged class 5 (first step).

The merge pattern corresponding to the number of merged classes of eighteen can be obtained by merging, in the merge pattern corresponding to the number of merged classes of nineteen, the D0/D1 (merged class 6) and the H/V class (merged class 15) in a case where the activity subclass is 1 and the inclination intensity ratio subclass is the weak class into one merged class 6 (first step).

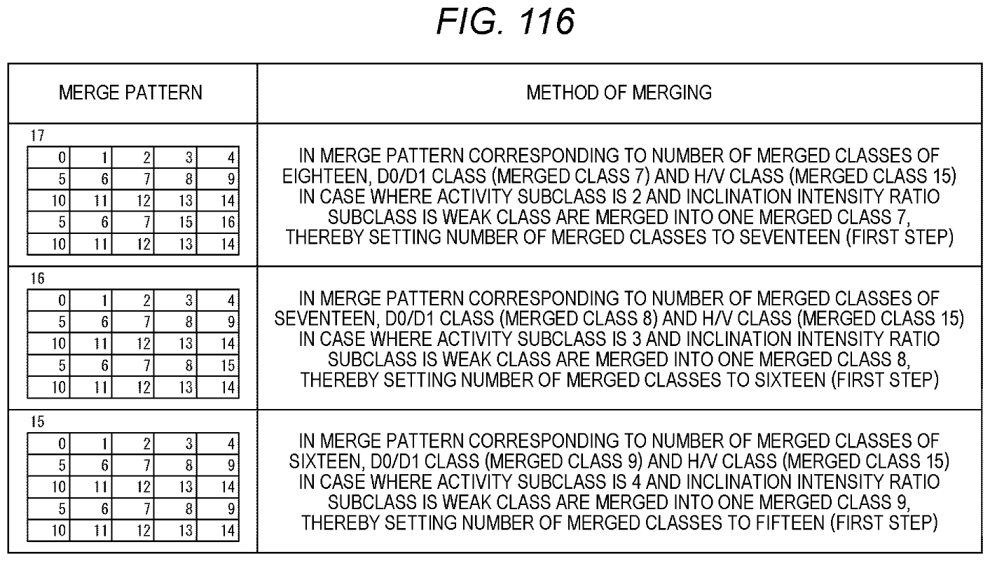

FIG. 116, the merge pattern corresponding to the number of merged classes of seventeen can be obtained by merging, in the merge pattern corresponding to the number of merged classes of eighteen, the D0/D1 (merged class 7) and the H/V class (merged class 15) in a case where the activity subclass is 2 and the inclination intensity ratio subclass is the weak class into one merged class 7 (first step).

The merge pattern corresponding to the number of merged classes of sixteen can be obtained by merging, in the merge pattern corresponding to the number of merged classes of seventeen, the D0/D1 (merged class 8) and the H/V class (merged class 15) in a case where the activity subclass is 3 and the inclination intensity ratio subclass is the weak class into one merged class 8 (first step).

The merge pattern corresponding to the number of merged classes of fifteen can be obtained by merging, in the merge pattern corresponding to the number of merged classes of sixteen, the D0/D1 (merged class 9) and the H/V class (merged class 15) in a case where the activity subclass is 4 and the inclination intensity ratio subclass is the weak class into one merged class 9 (first step).

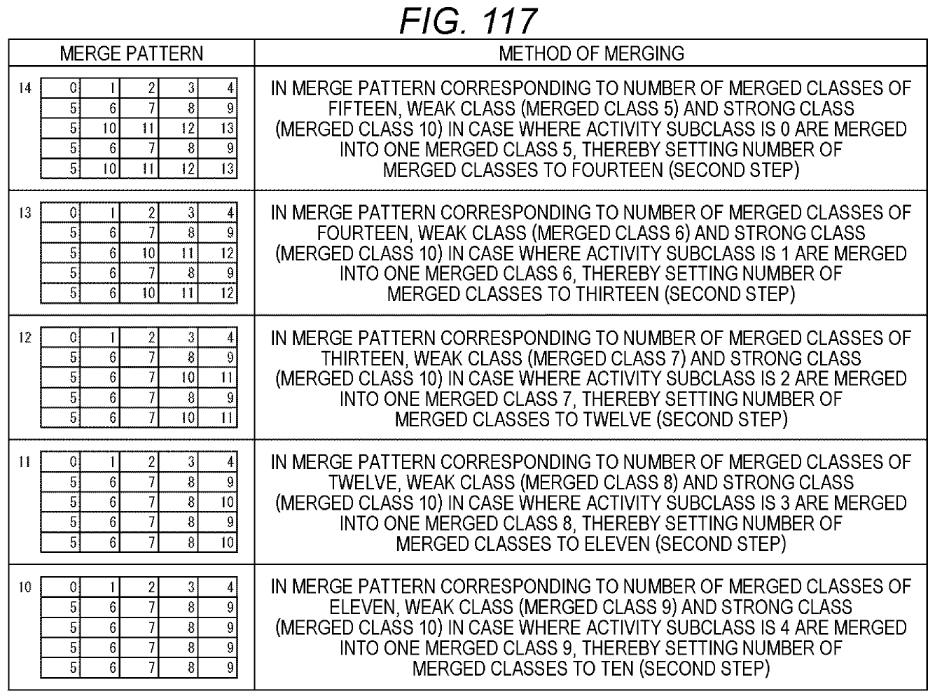

In FIG. 117, the merge pattern corresponding to the number of merged classes of fourteen can be obtained by merging, in the merge pattern corresponding to the number of merged classes of fifteen, the weak class (merged class 5) and the strong class (merged class 10) in a case where the activity subclass is 0 into one merged class 5 (second step).

The merge pattern corresponding to the number of merged classes of thirteen can be obtained by merging, in the merge pattern corresponding to the number of merged classes of fourteen, the weak class (merged class 6) and the strong class (merged class 10) in a case where the activity subclass is 1 into one merged class 6 (second step).

The merge pattern corresponding to the number of merged classes of twelve can be obtained by merging, in the merge pattern corresponding to the number of merged classes of thirteen, the weak class (merged class 7) and the strong class (merged class 10) in a case where the activity subclass is 2 into one merged class 7 (second step).

The merge pattern corresponding to the number of merged classes of eleven can be obtained by merging, in the merge pattern corresponding to the number of merged classes of twelve, the weak class (merged class 8) and the strong class (merged class 10) in a case where the activity subclass is 3 into one merged class 8 (second step).

The merge pattern corresponding to the number of merged classes of ten can be obtained by merging, in the merge pattern corresponding to the number of merged classes of eleven, the weak class (merged class 9) and the strong class (merged class 10) in a case where the activity subclass is 4 class into one merged class 9 (second step).

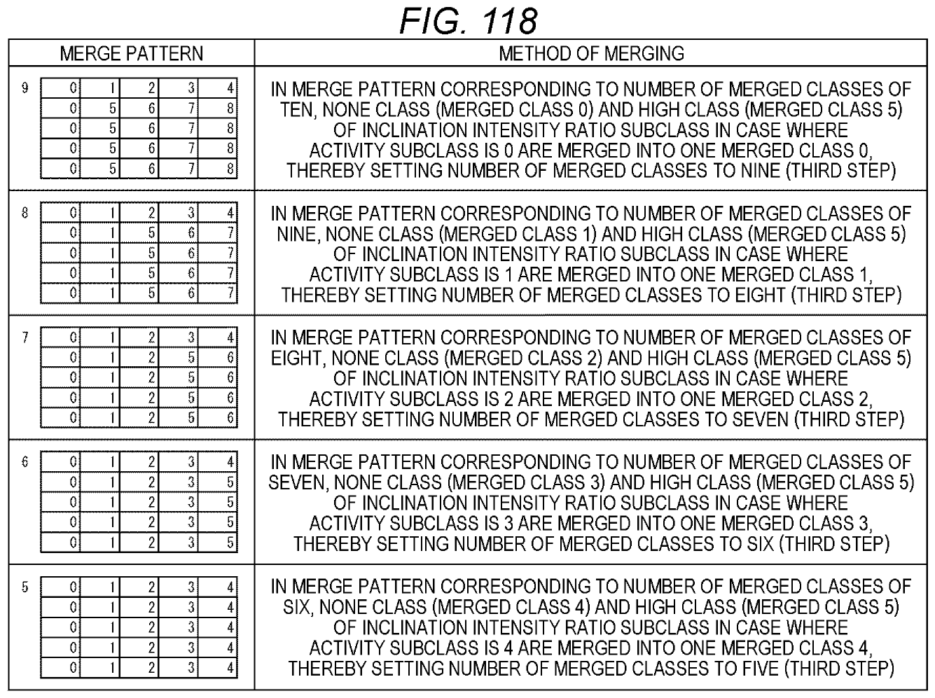

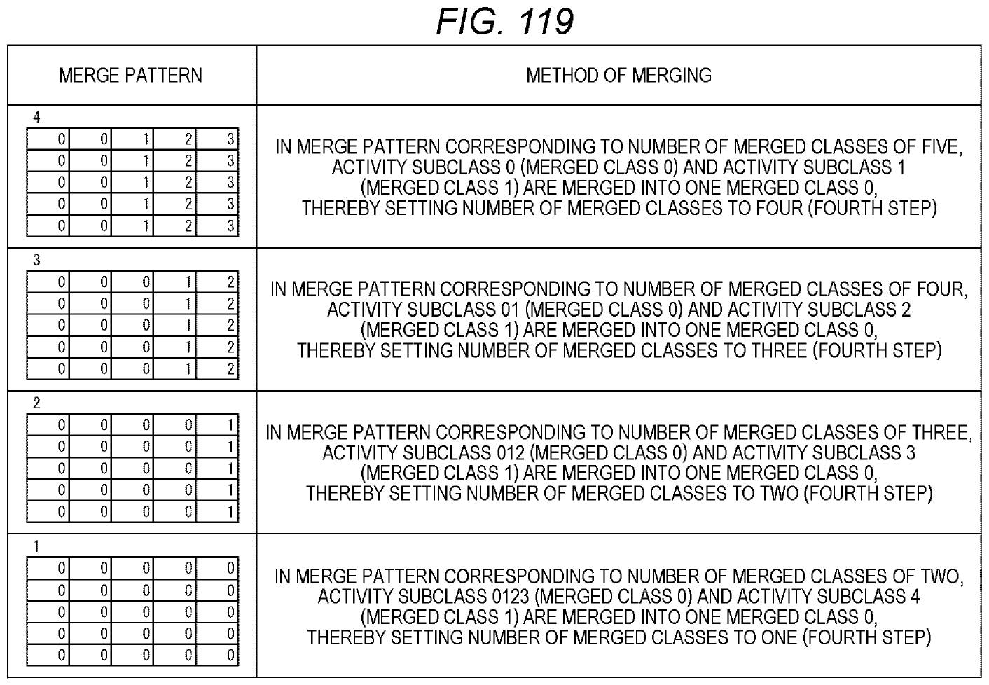

In FIGS. 118 and 119, the methods of merging when obtaining the merge pattern corresponding respectively to the numbers of merged classes of nine to one according to the third merge rule are similar to the methods of merging when obtaining the merge pattern corresponding respectively to the numbers of merged classes of nine to one according to the first merge rule described in FIGS. 104 and 105, and thus the description is omitted.

<Fourth Merge Rule>

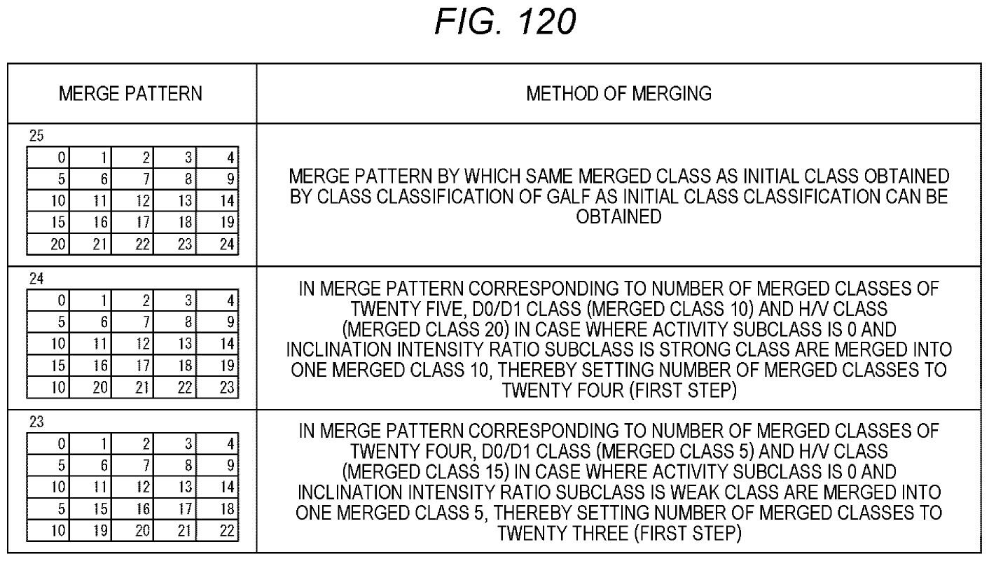

FIGS. 120, 121, 122, 123, 124, and 125 are diagrams describing methods of merging when setting all the merge patterns according to the fourth merge rule.

In the fourth merge rule, first, in a first step, the strong class with a largest inclination intensity ratio among the inclination intensity ratio subclasses and the weak class with a second largest inclination intensity ratio, the D0/D1 and the H/V subclasses of the direction subclass are merged from the activity subclass of low activity. Thereafter, in the fourth merge rule, as a second step, similarly to the third merge rule, the weak class and the strong class of the inclination intensity ratio subclass are merged from the activity subclass of low activity. Moreover, in the fourth merge rule, as a third step, similarly to the first merge rule, the high class and the none class, which are the merged subclasses after merging the weak class and the strong class of the inclination intensity ratio subclass, are merged from the activity subclass of low activity. Finally, in the fourth merge rule, as a fourth step, the activity subclass is merged from the activity subclass of low activity, similarly to the first merge rule.

In FIG. 120, the merge pattern corresponding to the number of merged classes of twenty five is a merge pattern by which the same merged class as the initial class obtained by the class classification of the GALF as the initial class classification can be obtained.

The merge pattern corresponding to the number of merged classes of twenty four can be obtained by merging, in the merge pattern corresponding to the number of merged classes of twenty five, the D0/D1 (merged class 10) and the H/V class (merged class 20) in a case where the activity subclass is 0 and the inclination intensity ratio subclass is the strong class into one merged class 10 (first step).

The merge pattern corresponding to the number of merged classes of twenty three can be obtained by merging, in the merge pattern corresponding to the number of merged classes of twenty four, the D0/D1 (merged class 5) and the H/V class (merged class 15) in a case where the activity subclass is 0 and the inclination intensity ratio subclass is the weak class into one merged class 5.

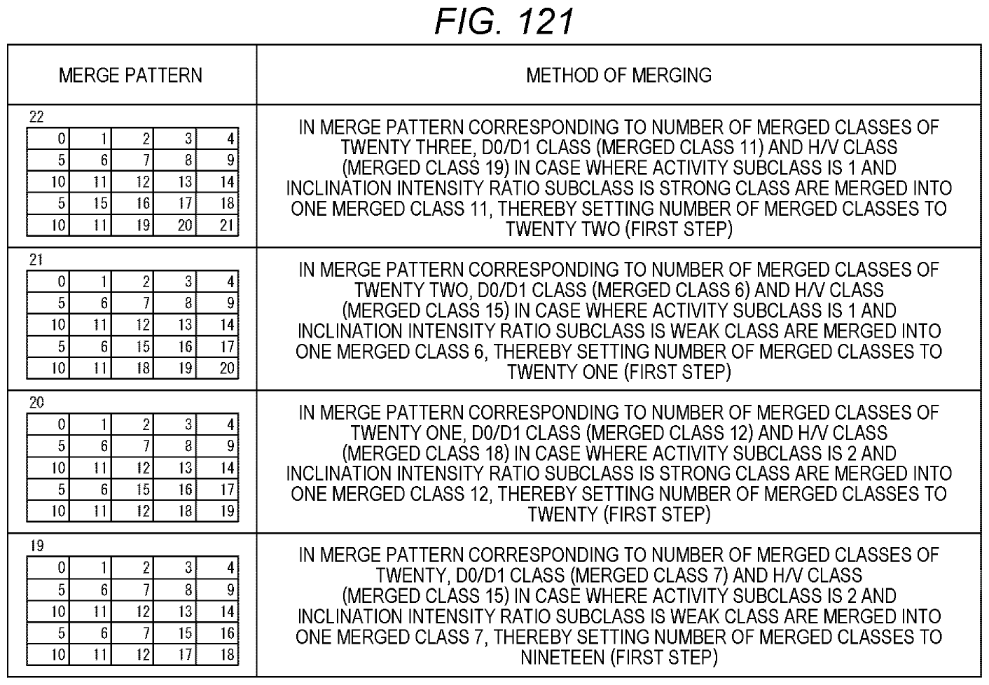

In FIG. 121, the merge pattern corresponding to the number of merged classes of twenty two can be obtained by merging, in the merge pattern corresponding to the number of merged classes of twenty three, the D0/D1 (merged class 11) and the H/V class (merged class 19) in a case where the activity subclass is 1 and the inclination intensity ratio subclass is the strong class into one merged class 11 (first step).

The merge pattern corresponding to the number of merged classes of twenty one can be obtained by merging, in the merge pattern corresponding to the number of merged classes of twenty two, the D0/D1 (merged class 6) and the H/V class (merged class 15) in a case where the activity subclass is 1 and the inclination intensity ratio subclass is the weak class into one merged class 6 (first step).

The merge pattern corresponding to the number of merged classes of twenty can be obtained by merging, in the merge pattern corresponding to the number of merged classes of twenty one, the D0/D1 (merged class 12) and the H/V class (merged class 18) in a case where the activity subclass is 2 and the inclination intensity ratio subclass is the strong class into one merged class 12 (first step).

The merge pattern corresponding to the number of merged classes of nineteen can be obtained by merging, in the merge pattern corresponding to the number of merged classes of twenty, the D0/D1 (merged class 7) and the H/V class (merged class 15) in a case where the activity subclass is 2 and the inclination intensity ratio subclass is the weak class into one merged class 7 (first step).

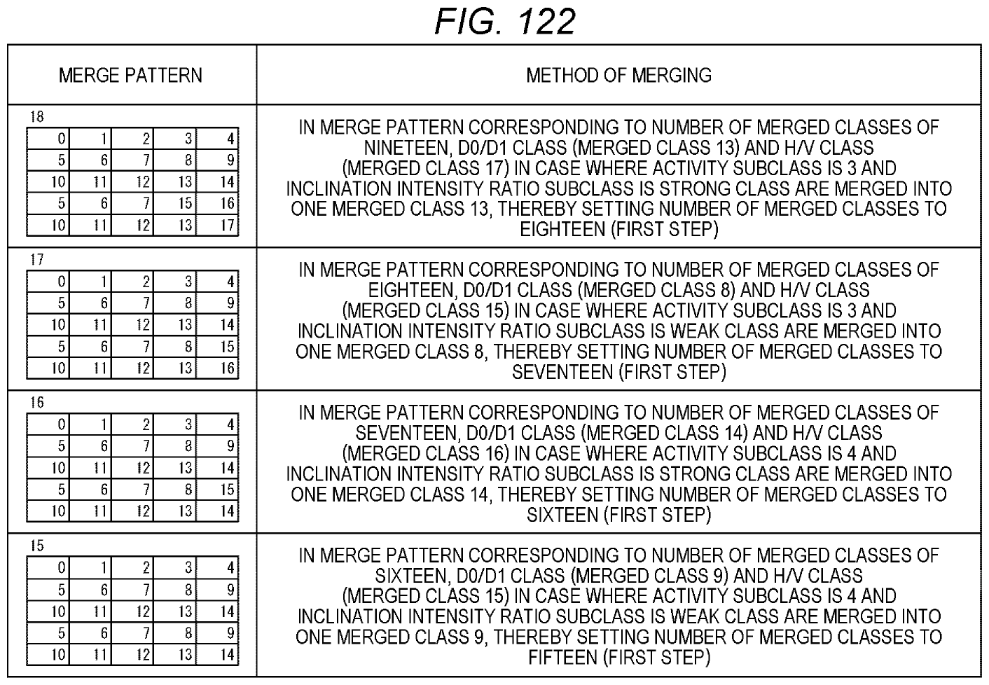

In FIG. 122, the merge pattern corresponding to the number of merged classes of eighteen can be obtained by merging, in the merge pattern corresponding to the number of merged classes of nineteen, the D0/D1 (merged class 13) and the H/V class (merged class 17) in a case where the activity subclass is 3 and the inclination intensity ratio subclass is the strong class into one merged class 13 (first step).

The merge pattern corresponding to the number of merged classes of seventeen can be obtained by merging, in the merge pattern corresponding to the number of merged classes of eighteen, the D0/D1 (merged class 8) and the H/V class (merged class 15) in a case where the activity subclass is 3 and the inclination intensity ratio subclass is the weak class into one merged class 8 (first step).

The merge pattern corresponding to the number of merged classes of sixteen can be obtained by merging, in the merge pattern corresponding to the number of merged classes of seventeen, the D0/D1 (merged class 14) and the H/V class (merged class 16) in a case where the activity subclass is 4 and the inclination intensity ratio subclass is the strong class into one merged class 14 (first step).

The merge pattern corresponding to the number of merged classes of fifteen can be obtained by merging, in the merge pattern corresponding to the number of merged classes of sixteen, the D0/D1 (merged class 9) and the H/V class (merged class 15) in a case where the activity subclass is 4 and the inclination intensity ratio subclass is the weak class into one merged class 9 (first step).

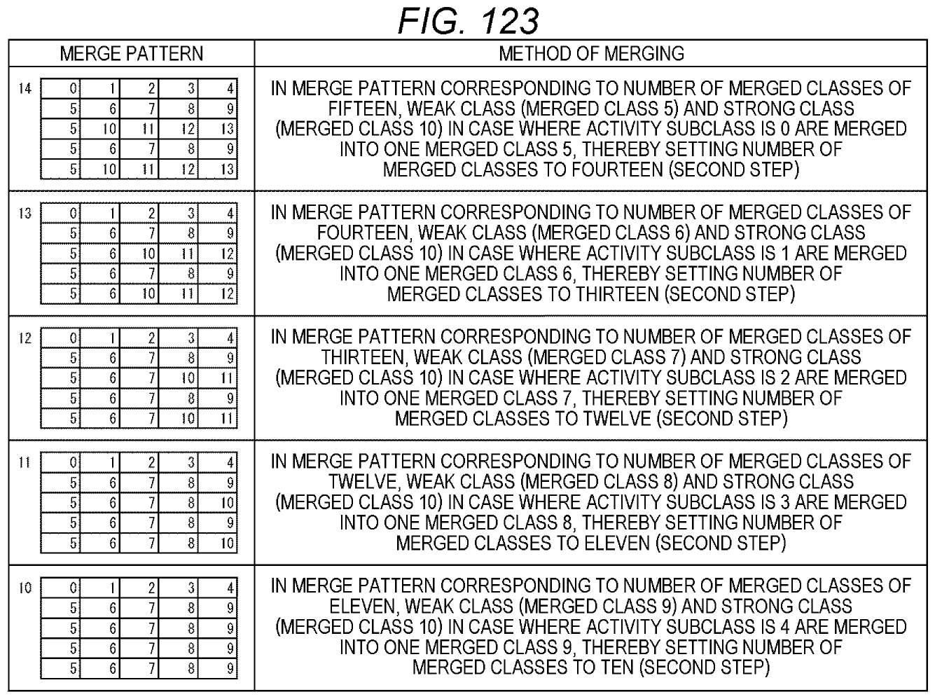

In FIGS. 123, the methods of merging when obtaining the merge pattern corresponding respectively to the numbers of merged classes of fourteen to ten according to the fourth merge rule are similar to the methods of merging when obtaining the merge pattern corresponding respectively to the numbers of merged classes of fourteen to ten according to the third merge rule described in FIG. 117, and thus the description is omitted.

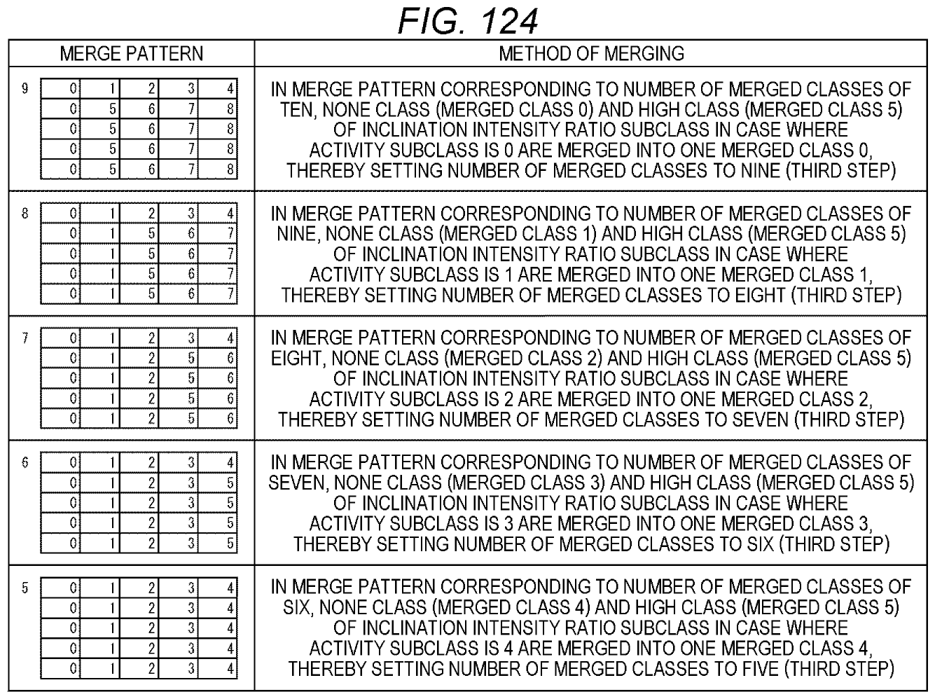

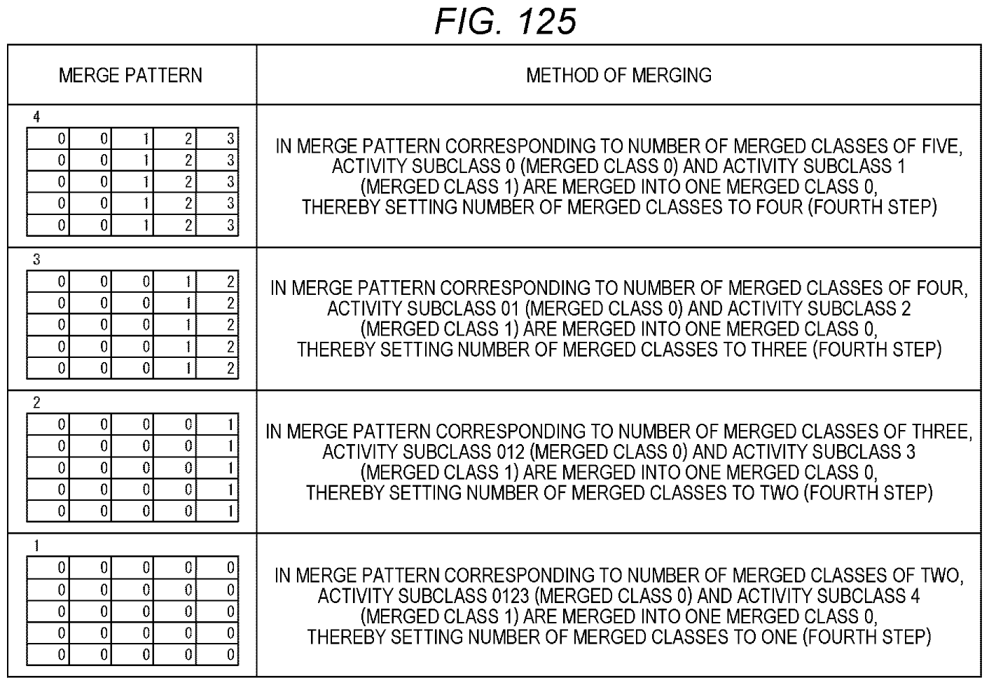

In FIGS. 124 and 125, the methods of merging when obtaining the merge pattern corresponding respectively to the numbers of merged classes nine to one according to the fourth merge rule are similar to the methods of merging when obtaining the merge pattern corresponding respectively to the number of merged classes of nine to one according to the first merge rule described in FIGS. 104 and 105, and thus the description is omitted.

In the class classification prediction filter 110 of FIG. 56 and the encoding device 160 and the decoding device 170 of FIG. 58, a process can be performed using a merge pattern (all merge patterns) corresponding to each of all the number of merged classes set according to any one of the first to fourth merge rules as described above.

Note that, here, the class classification of the GALF is employed as the initial class classification, but the setting of the merge pattern corresponding to each of the total number of merged classes can also be applied in a case where classification other than the class classification of the GALF is employed as the initial class classification.

<Description of Computer to which Present Technology is Applied>

Next, the series of processes described above can be performed by hardware or software. In a case where the series of processing is executed by software, a program constituting the software is installed in a computer or the like.

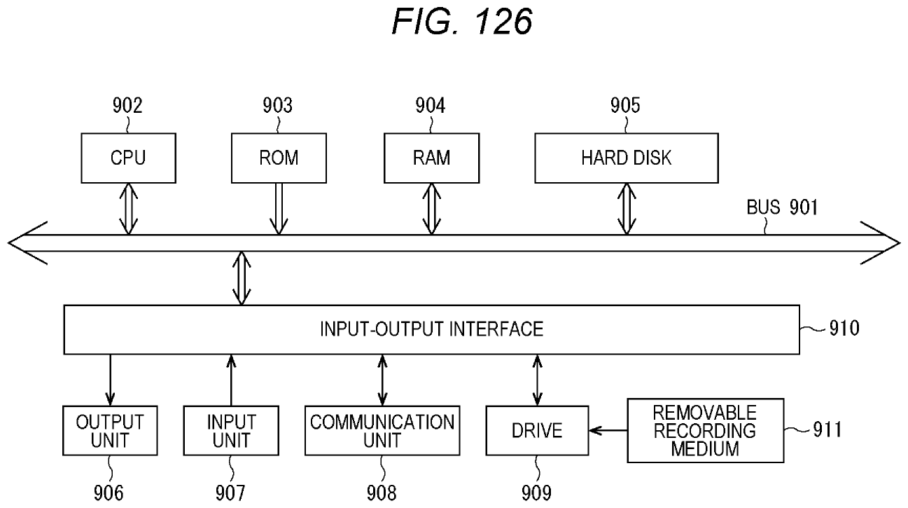

FIG. 126 is a block diagram illustrating a configuration example of one embodiment of the computer on which the program for executing the above-described series of processing is installed.

The program can be pre-recorded on a hard disk 905 or ROM 903 as a recording medium incorporated in the computer.

Alternatively, the program can be stored (recorded) in a removable recording medium 911. Such a removable recording medium 911 can be provided as what is called package software. Here, examples of the removable recording medium 911 include, for example, a flexible disk, a compact disc read only memory (CD-ROM), a magneto optical (MO) disk, a digital versatile disc (DVD), a magnetic disk, a semiconductor memory, and the like.

Note that in addition to installing the program on the computer from the removable recording medium 911 as described above, the program can be downloaded to the computer via a communication network or a broadcasting network and installed on the incorporated hard disk 905. That is, for example, the program can be transferred to the computer wirelessly from a download site via an artificial satellite for digital satellite broadcasting, or transferred to the computer by wire via a network such as a local area network (LAN) or the Internet.

The computer has an incorporated central processing unit (CPU) 902, and an input-output interface 910 is connected to the CPU 902 via a bus 901.

If a command is input by a user through the input-output interface 910 by operating an input unit 907 or the like, the CPU 902 executes the program stored in the read only memory (ROM) 903 accordingly. Alternatively, the CPU 902 loads the program stored in the hard disk 905 into a random access memory (RAM) 904 and executes the program.

Thus, the CPU 902 performs the processing according to the above-described flowchart or the processing performed according to the above-described configuration of the block diagram. Then, the CPU 902 outputs a processing result thereof from an output unit 906 or sends the processing result from a communication unit 908 if necessary via the input-output interface 910 for example, and further causes recording of the processing result on the hard disk 905, or the like.

Note that the input unit 907 includes a keyboard, a mouse, a microphone, and the like. Furthermore, the output unit 906 includes a liquid crystal display (LCD), a speaker, and the like.

Here, in the present description, the processing performed by the computer according to the program does not necessarily have to be performed in time series in the order described as the flowchart. That is, the processing performed by the computer according to the program also includes processing that is executed in parallel or individually (for example, parallel processing or object processing).

Furthermore, the program may be processed by one computer (processor) or may be processed in a distributed manner by a plurality of computers. Moreover, the program may be transferred to a distant computer and executed.

Moreover, in the present description, a system means a set of a plurality of components (devices, modules (parts), and the like), and it does not matter whether or not all components are in the same housing. Therefore, both of a plurality of devices housed in separate housings and connected via a network and a single device in which a plurality of modules is housed in one housing are systems.

Note that the embodiments of the present technology are not limited to the above-described embodiments, and various modifications are possible without departing from the gist of the present technology.

For example, the present technology can take a configuration of cloud computing in which one function is shared by a plurality of devices via a network and processed jointly.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

Furthermore, the effects described in the present description are merely examples and are not limited, and other effects may be provided.

<Applicable Target of the Present Technology>

The present technology can be applied to any image encoding and decoding method. That is, as long as it does not contradict the present technology described above, the specifications of various processes related to the image encoding and decoding, such as conversion (inverse conversion), quantization (inverse quantization), encoding (decoding), and prediction are arbitrary, and are not limited to the above-described examples. Furthermore, some of these processes may be omitted as long as they do not contradict the present technology described above.

<Units of Processing>

The data units in which the various information described above is set and the data units targeted by the various processes are arbitrary and are not limited to the above-described examples. For example, these information and processes may be set in every TU (transformation unit), transform unit (TU), transform block (TB), prediction unit (PU), prediction block (PB), coding unit (CU), largest coding unit (LCU), subblock, block, tile, slice, picture, sequence, or component, or data in those data units may be targeted. Of course, this data unit can be set for every pieces of information or process, and it is not necessary that the data units of all the pieces of information or processes are unified. Note that the storage location of these information is arbitrary, and may be stored in a header, parameter set, or the like of the above-described data units. Furthermore, it may be stored in a plurality of places.

<Control Information>

The control information related to the present technology described in each of the above embodiments may be transmitted from the encoding side to the decoding side. For example, control information (for example, enabled_flag) that controls whether or not the application of the present technology described above is permitted (or prohibited) may be transmitted. Furthermore, for example, control information indicating a target to which the present technology is applied (or a target to which the present technology is not applied) may be transmitted. For example, the control information may be transmitted that specifies a block size (upper or lower limits, or both) by which the present technology is applied (or application thereof is allowed or prohibited), frame, component, layer, or the like.

<Block Size Information>

Upon specifying the size of the block by which the present technology is applied, not only the block size may be specified directly, but also the block size may be indirectly specified. For example, the block size may be specified using identification information that identifies the size. Furthermore, for example, the block size may be specified by a ratio or difference with the size of the reference block (for example, LCU, SCU, or the like). For example, in a case of transmitting information for specifying the block size as a syntax element or the like, information for indirectly specifying the size as described above may be used as this information. In this manner, the amount of information of the information can be reduced, and encoding efficiency may be improved. Furthermore, the specification of the block size also includes a specification of the range of the block size (for example, the specification of the range of an allowable block size, or the like).

<Others>

Note that in the present description, the “flag” is information for identifying a plurality of states, and includes not only information used for identifying two states of true (1) or false (0), but also information that can identify three or more states. Therefore, the value that this “flag” can take may be, for example, two values of 1 and 0, or 3 or more values. That is, the number of bits constituting this “flag” is arbitrary, and may be 1 bit or a plurality of bits. Furthermore, identification information (including the flag) is assumed to include not only identification information thereof in a bitstream but also difference information of the identification information with respect to a certain reference information in the bitstream, and thus, in the present description, the “flag” and “identification information” include not only the information thereof but also the difference information with respect to the reference information.

### REFERENCE SIGNS LIST

10 Class classification unit
110 Class classification prediction filter
111 Class classification unit
112 Merge conversion unit
113 Tap coefficient acquisition unit
114 Prediction unit
121 Learning unit
160 Encoding device
161 Encoding unit
162 Local decoding unit
163 Filter unit
164 Class classification unit
165 Merge conversion unit
170 Decoding device
171 Parsing unit
172 Decoding unit
173 Filter unit
174 Class classification unit
175 Merge conversion unit
201 A/D conversion unit
202 Sorting buffer
203 Calculation unit
204 Orthogonal transformation unit
205 Quantization unit
206 Reversible encoding unit
207 Accumulation buffer
208 Inverse quantization unit
209 Inverse orthogonal transformation unit
210 Calculation unit
211 ILF
212 Frame memory
213 Selection unit
214 Intra-prediction unit
215 Motion prediction compensation unit
216 Predicted image selection unit
217 Rate control unit
301 Accumulation buffer
302 Reversible decoding unit
303 Inverse quantization unit
304 Inverse orthogonal transformation unit
305 Calculation unit
306 ILF
307 Sorting buffer
308 D/A conversion unit
310 Frame memory
311 Selection unit
312 Intra-prediction unit
313 Motion prediction compensation unit
314 Selection unit
410 Class classification prediction filter
412 Merge conversion unit
421 Learning unit
463 Filter unit
465 Merge conversion unit
473 Filter unit
475 Merge conversion unit
511, 606 ILF
901 Bus
902 CPU
903 ROM
904 RAM
905 Hard disk
906 Output unit
907 Input unit
908 Communication unit
909 Drive
910 Input-output interface
911 Removable recording medium

1. A decoding device comprising:
a decoding unit that decodes encoded data included in an encoded bitstream and generates a decoded image;
a class classification unit that performs class classification with respect to a pixel of interest of the decoded image, which is generated by the decoding unit, by subclass classification of each of a plurality of feature amounts;
a merge conversion unit that converts an initial class of the pixel of interest obtained by the class classification performed by the class classification unit into a merged class obtained by merging the initial class by merging a subclass of the feature amounts according to a merge pattern set in advance for every number of merged classes; and
a filter unit that performs a filtering process that applies to the decoded image a predictive equation that performs a product-sum operation of a tap coefficient of a merged class of the pixel of interest converted by the merge conversion unit and a pixel of the decoded image, so as to generate a filtered image.

2. The decoding device according to claim 1, wherein
the merge pattern for the every number of merged classes is set in a manner that a number of classes decreases from an initial class obtained by predetermined class classification.

3. The decoding device according to claim 1, wherein
the class classification unit performs class classification on the pixel of interest by using an inclination intensity ratio representing intensity of inclination of a pixel value of the pixel of interest, an inclination direction representing an inclination direction of the pixel value of the pixel of interest, and an activity sum in a plurality of directions obtained by adding an activity in every direction of the plurality of directions of each of a plurality of pixels in a peripheral region of the pixel of interest.

4. The decoding device according to claim 3, wherein
the class classification unit performs class classification with respect to the pixel of interest using reliability in the inclination direction.

5. The decoding device according to claim 1, wherein
the merge pattern for the every number of merged classes is set by partial merging that merges a subclass of another of the feature amounts in a case where a subclass of one of the feature amounts is a specific subclass.

6. The decoding device according to claim 5, wherein
as the merge pattern obtained by the partial merging, a merge pattern corresponding to a number of merged classes that interpolates among a number of merged classes of a merge pattern obtained by merging the subclass is set.

7. The decoding device according to claim 1, further comprising
a parsing unit that parses an employed number of merged classes employed for conversion from the encoded bitstream to the merged class from the initial class,
wherein the merge conversion unit converts the initial class of the pixel of interest into the merged class according to the merge pattern corresponding to the employed number of merged classes parsed by the parsing unit.

8. The decoding device according to claim 1, wherein
the decoding unit decodes the encoded data using a coding unit (CU) of a quad-tree block structure or a quad tree plus binary tree (QTBT) block structure as a processing unit.

9. A decoding method comprising:
decoding encoded data included in an encoded bitstream and generating a decoded image;
performing class classification with respect to a pixel of interest of the decoded image by subclass classification of each of a plurality of feature amounts;
converting an initial class of the pixel of interest obtained by the class classification into a merged class obtained by merging the initial class by merging a subclass of the feature amounts according to a merge pattern set in advance for every number of merged classes; and
performing a filtering process that applies to the decoded image a predictive equation that performs a product-sum operation of a tap coefficient of a merged class of the pixel of interest and a pixel of the decoded image, so as to generate a filtered image.

10. An encoding device comprising:
a class classification unit that performs class classification with respect to a pixel of interest of a locally decoded image that is locally decoded by subclass classification of each of a plurality of feature amounts;
a merge conversion unit that converts an initial class of the pixel of interest obtained by the class classification performed by the class classification unit into a merged class obtained by merging the initial class by merging a subclass of the feature amounts according to a merge pattern set in advance for every number of merged classes;
a filter unit that performs a filtering process that applies to the locally decoded image a predictive equation that performs a product-sum operation of a tap coefficient of a merged class of the pixel of interest converted by the merge conversion unit and a pixel of the locally decoded image, so as to generate a filtered image; and
an encoding unit that encodes an original image using the filtered image generated by the filter unit.

11. The encoding device according to claim 10, wherein
the merge pattern for the every number of merged classes is set in a manner that a number of classes decreases from an initial class obtained by predetermined class classification.

12. The encoding device according to claim 10, wherein
the class classification unit performs class classification on the pixel of interest by using an inclination intensity ratio representing intensity of inclination of a pixel value of the pixel of interest, an inclination direction representing an inclination direction of the pixel value of the pixel of interest, and an activity sum in a plurality of directions obtained by adding an activity in every direction of the plurality of directions of each of a plurality of pixels in a peripheral region of the pixel of interest.

13. The encoding device according to claim 12, wherein
the class classification unit performs class classification with respect to the pixel of interest using reliability in the inclination direction.

14. The encoding device according to claim 1C, wherein
the merge pattern for the every number of merged classes is set by partial merging that merges a subclass of another of the feature amounts in a case where a subclass of one of the feature amounts is a specific subclass.

15. The encoding device according to claim 14, wherein
as the merge pattern obtained by the partial merging, a merge pattern corresponding to a number of merged classes that interpolates among a number of merged classes of a merge pattern obtained by merging the subclass is set.

16. The encoding device according to claim 10, wherein
the filter unit determines a number of merged classes that minimizes a cost in a case where the initial class is merged according to the merge pattern corresponding to the number of merged classes as an employed number of merged classes employed in conversion from the initial class to the merged class, and
the encoding unit generates the encoded bitstream including encoded data obtained by encoding the original image and the employed number of merged classes.

17. The encoding device according to claim 10, wherein
the decoding unit decodes the encoded data using a coding unit (CU) of a quad-tree block structure or a quad tree plus binary tree (QTBT) block structure as a processing unit.

18. An encoding method comprising:
performing class classification with respect to a pixel of interest of a locally decoded image that is locally decoded by subclass classification of each of a plurality of feature amounts;
converting an initial class of the pixel of interest obtained by the class classification into a merged class obtained by merging the initial class by merging a subclass of the feature amounts according to a merge pattern set in advance for every number of merged classes;
performing a filtering process that applies to the locally decoded image a predictive equation that performs a product-sum operation of a tap coefficient of a merged class of the pixel of interest and a pixel of the locally decoded image, so as to generate a filtered image; and
encoding an original image using the filtered image.

19. The decoding device according to claim 1, wherein
as the merge pattern for the every number of the merged classes, all merge patterns are set that are merge patterns corresponding to each of numbers of merged classes of each value of natural numbers equal to or less than a number of initial classes of an initial class obtained by predetermined class classification.

20. The decoding device according to claim 19, wherein
the all merge patterns are set by repeating
setting a merge pattern corresponding to a number C-1 of merged classes by merging any two merged classes of merged classes that constitute a merge pattern corresponding to a number C of merged classes into one merged class.

21. The decoding device according to claim 20, wherein
the class classification unit performs class classification with respect to the pixel of interest by an inclination intensity ratio subclass obtained by subclass classification of an inclination intensity ratio representing intensity of inclination of a pixel value of the pixel of interest, a direction subclass obtained by subclass classification of an inclination direction representing an inclination direction of the pixel value of the pixel of interest, and an activity subclass obtained by class classification of an activity sum in a plurality of directions obtained by adding an activity in every direction of the plurality of directions of each of a plurality of pixels in a peripheral region of the pixel of interest, and
the merge pattern is set by merging, with respect to a predetermined direction subclass, two inclination intensity ratio subclasses from an activity subclass of low activity.

22. The decoding device according to claim 21, wherein
the merge pattern is further set by merging two direction subclasses from the activity subclass of low activity.

23. The decoding device according to claim 22, wherein
the merge pattern is further set by merging a merged subclass, which is obtained by merging the two inclination intensity ratio subclasses, and another inclination intensity ratio subclass, from the activity subclass of low activity.

24. The decoding device according to claim 23, wherein
the merge pattern is further set by merging an activity subclass from the activity subclass of low activity.

25. The decoding device according to claim 20, wherein
the class classification unit performs class classification with respect to the pixel of interest by an inclination intensity ratio subclass obtained by subclass classification of an inclination intensity ratio representing intensity of inclination of a pixel value of the pixel of interest, a direction subclass obtained by subclass classification of an inclination direction representing an inclination direction of the pixel value of the pixel of interest, and an activity subclass obtained by class classification of an activity sum in a plurality of directions obtained by adding an activity in every direction of the plurality of directions of each of a plurality of pixels in a peripheral region of the pixel of interest, and
the merge pattern is set by merging, with respect to a predetermined inclination intensity ratio subclass, two direction subclasses from an activity subclass of low activity.

26. The decoding device according to claim 25, wherein
the merge pattern is further set by merging two inclination intensity ratio subclasses from the activity subclass of low activity.

27. The decoding device according to claim 26, wherein
the merge pattern is further set by merging a merged subclass, which is obtained by merging the two inclination intensity ratio subclasses, and another inclination intensity ratio subclass, from the activity subclass of low activity.

28. The decoding device according to claim 27, wherein
the merge pattern is further set by merging an activity subclass from the activity subclass of low activity.

29. The encoding device according to claim 10, wherein
as the merge pattern for the every number of the merged classes, all merge patterns are set that are merge patterns corresponding to each of numbers of merged classes of each value of natural numbers equal to or less than a number of initial classes of an initial class obtained by predetermined class classification.

30. The encoding device according to claim 29, wherein
the all merge patterns are set by repeating setting a merge pattern corresponding to a number C-1 of merged classes by merging any two merged classes of merged classes that constitute a merge pattern corresponding to a number C of merged classes into one merged class.

31. The encoding device according to claim 30, wherein
the class classification unit performs class classification with respect to the pixel of interest by an inclination intensity ratio subclass obtained by subclass classification of an inclination intensity ratio representing intensity of inclination of a pixel value of the pixel of interest, a direction subclass obtained by subclass classification of an inclination direction representing an inclination direction of the pixel value of the pixel of interest, and an activity subclass obtained by class classification of an activity sum in a plurality of directions obtained by adding an activity in every direction of the plurality of directions of each of a plurality of pixels in a peripheral region of the pixel of interest, and
the merge pattern is set by merging, with respect to a predetermined direction subclass, two inclination intensity ratio subclasses from an activity subclass of low activity.

32. The encoding device according to claim 31, wherein
the merge pattern is further set by merging two direction subclasses from the activity subclass of low activity.

33. The encoding device according to claim 32, wherein
the merge pattern is further set by merging a merged subclass, which is obtained by merging the two inclination intensity ratio subclasses, and another inclination intensity ratio subclass, from the activity subclass of low activity.

34. The encoding device according to claim 33, wherein
the merge pattern is further set by merging an activity subclass from the activity subclass of low activity.

35. The encoding device according to claim 30, wherein
the class classification unit performs class classification with respect to the pixel of interest by an inclination intensity ratio subclass obtained by subclass classification of an inclination intensity ratio representing intensity of inclination of a pixel value of the pixel of interest, a direction subclass obtained by subclass classification of an inclination direction representing an inclination direction of the pixel value of the pixel of interest, and an activity subclass obtained by class classification of an activity sum in a plurality of directions obtained by adding an activity in every direction of the plurality of directions of each of a plurality of pixels in a peripheral region of the pixel of interest, and
the merge pattern is set by merging, with respect to a predetermined inclination intensity ratio subclass, two direction subclasses from an activity subclass of low activity.

36. The encoding device according to claim 35, wherein
the merge pattern is further set by merging two inclination intensity ratio subclasses from the activity subclass of low activity.

37. The encoding device according to claim 36, wherein
the merge pattern is further set by merging a merged subclass, which is obtained by merging the two inclination intensity ratio subclasses, and the other of the inclination intensity ratio subclasses, from the activity subclass of low activity.

38. The encoding device according to claim 37, wherein
the merge pattern is further set by merging an activity subclass from the activity subclass of low activity.
